(19) United States
(12) Patent Application Publication
(10) Pub. No.: US 2021/0121275 A1
(43) Pub. Date: Apr. 29, 2021

(54) DENTAL TREATMENT SYSTEM

(71) Applicant: SONENDO, INC., Laguna Hills, CA (US)

(72) Inventors: Tate Ray Parham, Silverado, CA (US); Patrick O'Fallon, Laguna Hills, CA (US); Mehrzad Khakpuor, Laguna Hills, CA (US); Bjarne Bergheim, Mission Viejo, CA (US); Branden Tarkeshian, Orange, CA (US); Christopher Lindsey, Aliso Viejo, CA (US); Manu Sharma, Ladera Ranch, CA (US); Nick Nabavian, Irvine, CA (US); Jeremy Links, Tustin, CA (US)

(21) Appl. No.: 16/894,667

(22) Filed: Jun. 5, 2020

Related U.S. Application Data
(60) Provisional application No. 62/860,131, filed on Jun. 11, 2019.
(60) Provisional application No. 62/934,348, filed on Nov. 12, 2019.
(60) Provisional application No. 62/860,710, filed on Jun. 12, 2019.
(60) Provisional application No. 62/858,851, filed on Jun. 7, 2019.
(60) Provisional application No. 62/859,590, filed on Jun. 10, 2019.

(51) Int. Cl. A61C 17/02

(52) U.S. Cl. CPC A61C 17/0208; A61C 17/0202

(57) ABSTRACT

A treatment instrument can include a fluid platform comprising a chamber and an access port to provide fluid communication between a treatment region of the tooth and the chamber, the chamber having a central axis. The treatment instrument can include a first fluid supply port disposed to direct a fluid stream of a first material into the chamber along a stream axis non-parallel to the central axis. The treatment instrument can include a second supply port distal the first fluid supply port, the second supply port disposed to direct a second material to be entrained with the fluid stream into the chamber.

### CROSS-REFERENCE TO RELATED APPLICATIONS

This application claims priority to U.S. Provisional Patent Application No. 62/858,851, filed Jun. 7, 2019; U.S. Provisional Patent Application No. 62/860,131, filed Jun. 11, 2019; U.S. Provisional Patent Application No. 62/934,348, filed Nov. 12, 2019; U.S. Provisional Patent Application No. 62/860,710, filed Jun. 12, 2019; and U.S. Provisional Patent Application No. 62/859,590, filed Jun. 10, 2019, the entire contents of each of which are incorporated by reference herein in their entirety and for all purposes.

### BACKGROUND

### Field of the Invention

The field relates to a dental treatment system.

### Description of the Related Arts

In conventional endodontic procedures, an opening is drilled through the crown of a diseased tooth, and endodontic files are inserted into the root canal system to open the canal spaces and remove organic material therein. The root canal is then filled with solid matter such as gutta percha and an obturation material, and the tooth is restored. However, this procedure will not remove all organic material from the canal spaces, which can lead to post-procedure complications such as infection. In addition, motion of the endodontic file may force organic material through an apical opening into periapical tissues. In some cases, the end of the endodontic file itself may pass through the apical opening. Such events may result in trauma to the soft tissue near the apical opening and lead to post-procedure complications.

Current treatment techniques for tooth decay (caries) generally include mechanical removal of the caries and diseased tissue (e.g., using dental burs, excavators, etc.), which will expose healthy dentin. However, the bur (or other mechanical instrument) may not differentiate between diseased and healthy dentin, and other instruments such as excavators and explorers may not be able to accurately determine the extent to which tooth removal should continue. This may result in either incomplete removal of caries or overly-aggressive removal of healthy dentin, which may in turn reduce the longevity of the tooth. The removed portions of the tooth can then be filled with solid matter such as composite, resin, gold, porcelain, etc., and the tooth can be restored. However, this procedure may not remove all decayed material from the tooth, which combined with inadequate penetration of the restorative material can result in bacterial leakage and subsequently post-procedure complications such as infection or recurrent caries. In part to minimize the risk of reinfection, endodontic material placement typically uses a gutta percha point to encourage penetration of the obturation material into lateral canals and isthmi. In addition, the use of a dental drill and anesthetics may be uncomfortable for the patient. Various filling spaces within or adjacent to a tooth can benefit from improvements in dental treatment techniques. Examples of such filling spaces include but are not limited to root canals, cavities resulting from the removal of caries, other openings such as cracks and gaps, and/or missing portions of teeth (e.g., resulting from fracture and/or wear). Accordingly, it can be advantageous to provide improved compositions, methods and apparatus for treating dental decay.

### SUMMARY

In one embodiment, a treatment instrument is disclosed. The treatment instrument can include a fluid platform comprising a chamber and an access port to provide fluid communication between a treatment region of the tooth and the chamber, the chamber having a central axis. The treatment instrument can include a first fluid supply port disposed to direct a fluid stream of a first material into the chamber along a stream axis non-parallel to the central axis. The treatment instrument can include a second supply port distal the first fluid supply port, the second supply port disposed to direct a second material to be entrained with the fluid stream into the chamber.

In some embodiments, the first fluid supply port can comprise a nozzle configured to form a liquid jet comprising the first material. A first composition supply line can deliver the first material to the first supply port and a second composition supply line can deliver the second material to the second supply port. The fluid platform can comprise a manifold body having an inner sidewall that at least partially defines the chamber and a supply pathway in the manifold body, the supply pathway in fluid communication with the second supply port. The supply pathway can comprise a first vertical supply pathway extending from the second composition supply line and a second lateral supply pathway extending laterally from the first vertical supply pathway relative to the chamber. The second lateral supply pathway can comprise an at least partially annular channel disposed around the central axis of the chamber. The second supply port can be in fluid communication with the second lateral supply pathway and is disposed through the inner sidewall of the chamber to deliver the second material to the chamber. The supply pathway can comprise a first lateral supply pathway comprising an at least partially annular channel disposed about the central axis of the chamber and a second vertical supply pathway extending distally from the first lateral supply pathway. The supply pathway can comprise a second lateral supply pathway extending radially inwardly from the second vertical supply pathway, the second supply port providing fluid communication between the second lateral supply pathway and the chamber. The fluid platform can comprise a guide channel extending proximally from an inlet opening of the chamber, the first fluid supply port disposed at a proximal portion of the guide channel, the second supply port disposed to supply the second material to at least the guide channel. A pressure wave generator can be configured to generate pressure waves having sufficient energy to treat the treatment region. The pressure wave generator can comprise the first fluid supply port. A suction port can be exposed to the chamber. The chamber can have a maximum lateral dimension in a plane extending substantially transverse to the central axis, the plane delimited by the wall along a boundary, a projection of the suction port onto the plane being closer to the boundary than to the central axis of the chamber. A vent can be exposed to ambient air, the vent in fluid communication with an outlet line connected to the suction port, the vent positioned along the outlet line at a location downstream of the suction port. The first fluid supply port can be disposed to direct the fluid stream across the chamber to impinge on a portion of a wall of the chamber opposite the first fluid supply port. The central axis can pass substantially transversely through a center of the access port. A reservoir can hold at least one of the first material and the second material. The reservoir can be disposed in or on a handpiece body of the treatment instrument.

In another embodiment, a treatment instrument is disclosed. The treatment instrument can include a fluid platform comprising a chamber and a mounting surface configured to be positioned against a tooth to retain fluid in the chamber between the fluid platform and the tooth, the fluid platform having an access port to provide fluid communication between a treatment region of the tooth and the chamber. The treatment instrument can include a first fluid supply port disposed to direct a fluid stream of a first material into the chamber. The treatment instrument can include a second supply port distal the first fluid supply port, the second supply port disposed to direct a second material to be entrained with the fluid stream into the chamber.

In some embodiments, the first fluid supply port can comprise a nozzle configured to form a liquid jet comprising the first material. A first composition supply line can deliver the first material to the first supply port and a second composition supply line can deliver the second material to the second supply port. The fluid platform can comprise a manifold body having an inner sidewall that at least partially defines the chamber and a supply pathway in the manifold body, the supply pathway in fluid communication with the second supply port. The supply pathway can comprises a first vertical supply pathway extending from the second composition supply line and a second lateral supply pathway extending laterally from the first vertical supply pathway relative to the chamber. The second lateral supply pathway can comprise an at least partially annular channel disposed around a central axis of the chamber. The second supply port can be in fluid communication with the second lateral supply pathway and is disposed through the inner sidewall of the chamber to deliver the second material to the chamber. The supply pathway can comprise a first lateral supply pathway comprising an at least partially annular channel disposed about a central axis of the chamber and a second vertical supply pathway extending distally from the first lateral supply pathway. The supply pathway can comprise a second lateral supply pathway extending radially inwardly from the second vertical supply pathway, the second supply port providing fluid communication between the second lateral supply pathway and the chamber. The fluid platform can comprise a guide channel extending proximally from an inlet opening of the chamber, the first fluid supply port disposed at a proximal portion of the guide channel, the second supply port disposed to supply the second material to at least the guide channel. A pressure wave generator can be configured to generate pressure waves having sufficient energy to treat the treatment region. The pressure wave generator can comprise the first fluid supply port. A suction port can be exposed to the chamber. The chamber can have a maximum lateral dimension in a plane extending substantially transverse to a central axis of the chamber, the plane delimited by the wall along a boundary, a projection of the suction port onto the plane being closer to the boundary than to the central axis of the chamber. A vent can be exposed to ambient air, the vent in fluid communication with an outlet line connected to the suction port, the vent positioned along the outlet line at a location downstream of the suction port. The first fluid supply port can be disposed to direct the fluid stream across the chamber to impinge on a portion of a wall of the chamber opposite the first fluid supply port. A reservoir can hold at least one of the first material and the second material. The reservoir can be disposed in or on a handpiece body of the treatment instrument.

In another embodiment, a treatment instrument is disclosed. The treatment instrument can include a fluid platform comprising a chamber and an access port to provide fluid communication between a treatment region of a tooth and the chamber, the fluid platform comprising a manifold body having an inner sidewall that at least partially defines the chamber and a supply pathway in the manifold body. The treatment instrument can include a first fluid supply port disposed to direct a fluid stream of a first material into the chamber. The treatment instrument can include a second supply port in fluid communication with the supply pathway, the second supply port disposed to direct a second material from the supply pathway into the chamber.

In some embodiments, the first fluid supply port can comprise a nozzle configured to form a liquid jet of the first material. A first composition supply line can deliver the first material to the first supply port and a second composition supply line can deliver the second material to the second supply port. The supply pathway can comprise a first vertical supply pathway extending from the second composition supply line and a second lateral supply pathway extending laterally from the first vertical supply pathway relative to the chamber. The second lateral supply pathway can comprise an at least partially annular channel disposed around a central axis of the chamber. The second supply port can be in fluid communication with the second lateral supply pathway and is disposed through the inner sidewall of the chamber to deliver the second material to the chamber. The supply pathway can comprise a first lateral supply pathway comprising an at least partially annular channel disposed about a central axis of the chamber and a second vertical supply pathway extending distally from the first lateral supply pathway. The supply pathway can comprise a second lateral supply pathway extending radially inwardly from the second vertical supply pathway, the second supply port providing fluid communication between the second lateral supply pathway and the chamber. The fluid platform can comprise a guide channel extending proximally from an inlet opening of the chamber, the first fluid supply port disposed at a proximal portion of the guide channel, the second supply port disposed to supply the second material to at least the guide channel. A pressure wave generator can be configured to generate pressure waves having sufficient energy to treat the treatment region. The pressure wave generator can comprise the first fluid supply port. A suction port can be exposed to the chamber. The chamber can have a maximum lateral dimension in a plane extending substantially transverse to a central axis of the chamber, the plane delimited by the wall along a boundary, a projection of the suction port onto the plane being closer to the boundary than to the central axis of the chamber. A vent can be exposed to ambient air, the vent in fluid communication with an outlet line connected to the suction port, the vent positioned along the outlet line at a location downstream of the suction port. The first fluid supply port can be disposed to direct the fluid stream across the chamber to impinge on a portion of a wall of the chamber opposite the first fluid supply port. A reservoir can hold at least one of the first material and the second material. The reservoir can be disposed in or on a handpiece body of the treatment instrument.

In another embodiment, a treatment instrument is disclosed. The treatment instrument can include a fluid platform comprising a chamber, a guide channel extending proximally from an inlet opening of the chamber, and an access port to provide fluid communication between a treatment region of the tooth and the chamber. The treatment instrument can include a first fluid supply port disposed at a proximal portion of the guide channel to direct a fluid stream of a first material into the guide channel and the chamber. The treatment instrument can include a second supply port disposed distal the first fluid supply port to supply a second material to at least the guide channel.

In some embodiments, the first fluid supply port can comprise a nozzle configured to form a liquid jet comprising the first material. A first composition supply line can deliver the first material to the first supply port and a second composition supply line can deliver the second material to the second supply port. A pressure wave generator can be configured to generate pressure waves having sufficient energy to treat the treatment region. The pressure wave generator can comprise the first fluid supply port. A suction port can be exposed to the chamber. The chamber can have a maximum lateral dimension in a plane extending substantially transverse to a central axis of the chamber, the plane delimited by the wall along a boundary, a projection of the suction port onto the plane being closer to the boundary than to the central axis of the chamber. A vent can be exposed to ambient air, the vent in fluid communication with an outlet line connected to the suction port, the vent positioned along the outlet line at a location downstream of the suction port. The first fluid supply port can be disposed to direct the fluid stream across the chamber to impinge on a portion of a wall of the chamber opposite the first fluid supply port. A reservoir can hold at least one of the first material and the second material. The reservoir can be disposed in or on a handpiece body of the treatment instrument.

In another embodiment, a treatment instrument can comprise a fluid platform comprising a chamber and an access port to provide fluid communication between a treatment region of the tooth and the chamber. The treatment instrument can include a first fluid supply port disposed to direct a fluid stream of a first material into the chamber to generate rotational fluid motion in the chamber. The treatment instrument can include a second supply port disposed to supply a second material into the rotational fluid motion generated in the chamber.

In some embodiments, the first fluid supply port can be disposed to direct a fluid stream of a first material into the chamber along a stream axis non-parallel to a central axis of the chamber. The first fluid supply port can comprise a nozzle configured to form a liquid jet comprising the first material. A first composition supply line can deliver the first material to the first supply port and a second composition supply line can deliver the second material to the second supply port. The fluid platform can comprise a manifold body having an inner sidewall that at least partially defines the chamber and a supply pathway in the manifold body, the supply pathway in fluid communication with the second supply port. A first vertical supply pathway can extend from the second composition supply line and a second lateral supply pathway can extend laterally from the first vertical supply pathway relative to the chamber. The second lateral supply pathway can comprise an at least partially annular channel disposed around the central axis of the chamber. The second supply port can be in fluid communication with the second lateral supply pathway and is disposed through the inner sidewall of the chamber to deliver the second material to the chamber. The supply pathway can comprises a first lateral supply pathway comprising an at least partially annular channel disposed about the central axis of the chamber and a second vertical supply pathway extending distally from the first lateral supply pathway. The supply pathway can comprise a second lateral supply pathway extending radially inwardly from the second vertical supply pathway, the second supply port providing fluid communication between the second lateral supply pathway and the chamber. The fluid platform can comprise a guide channel extending proximally from an inlet opening of the chamber, the first fluid supply port disposed at a proximal portion of the guide channel, the second supply port disposed to supply the second material to at least the guide channel. A pressure wave generator can be configured to generate pressure waves having sufficient energy to treat the treatment region. The pressure wave generator can comprise the first fluid supply port and a channel distal the first fluid supply port. A suction port can be exposed to the chamber. The chamber can have a maximum lateral dimension in a plane extending substantially transverse to the central axis, the plane delimited by the wall along a boundary, a projection of the suction port onto the plane being closer to the boundary than to the central axis of the chamber. A vent can be exposed to ambient air, the vent in fluid communication with an outlet line connected to the suction port, the vent positioned along the outlet line at a location downstream of the suction port. The first fluid supply port can be disposed to direct the fluid stream across the chamber to impinge on a portion of a wall of the chamber opposite the first fluid supply port. The central axis can pass substantially transversely through a center of the access port. A reservoir can hold at least one of the first material and the second material. The reservoir can be disposed in or on a handpiece body of the treatment instrument.

In another embodiment, a method of treating a tooth is disclosed. The method can include directing a fluid stream of a first material into a chamber in a manner generating rotational fluid motion in the chamber. The method can include supplying a second material into the rotational fluid motion generated in the chamber.

In some embodiments, directing the fluid stream comprises directing a liquid jet into the chamber. Supplying the second material can comprise entraining the second material with the first material inside a guide channel disposed between the chamber and a first fluid supply port through which the first material is supplied. Supplying the second material can comprise directing the second material along a flow pathway within a manifold that at least partially defines the chamber. Directing the second material along the flow pathway can comprise directing the second material along a first at least partially annular lateral flow pathway, and along a second vertical flow pathway extending from the first at least partially annular lateral flow pathway. The method can include directing the second material radially inward to the chamber from the second vertical flow pathway. Directing the second material along the flow pathway can comprise directing the second material along a first vertical flow pathway and along a second at least partially annular flow pathway extending from the first vertical flow pathway. The method can include directing the second material radially inward to the chamber from the second at least partially annular flow pathway. The method can include directing the fluid stream along a direction non-parallel to a central axis of the chamber.

In another embodiment, a treatment instrument can include a first composition supply line and a second composition supply line. The treatment instrument can include a chamber in fluid communication with the first composition supply line and the second composition supply line. The treatment instrument can include a pressure wave generator comprising an orifice in fluid communication with the first composition supply line, the orifice sized and shaped to pressurize a carrier liquid delivered by the first composition supply line to the chamber. The second composition supply line can deliver a component to the chamber at a location distal the orifice so as to form a mixture of the component and the carrier liquid. The pressure wave generator can be configured to generate pressure waves having sufficient energy to cause the mixture to substantially fill a treatment region of a tooth.

In some embodiments, the pressure wave generator comprises a liquid jet device, with the orifice sized to form the liquid jet. The pressure wave generator further can comprise a guide tube having an impingement member at a distal portion thereof, the chamber disposed between the impingement member and the orifice. One or a plurality of openings can be disposed in the guide tube disposed proximal the impingement member. The orifice can be disposed to direct the carrier liquid non-parallel to a central axis of the chamber. A fluid platform can comprise a manifold body that at least partially defines the chamber, the manifold body comprising a supply pathway that includes the second composition supply line. The first composition supply line and the orifice can be configured to direct the carrier liquid along an axis, and wherein the second composition supply line has a directional component parallel to the axis. The second composition supply line can comprise a plurality of supply lines disposed around the first composition supply line. A reservoir can hold the composition. A valve can control the supply of the composition along the second composition supply line. The valve can comprise a rupture valve. The rupture valve can include a flexible material selected to rupture when a pressure of the composition exceeds a threshold. The rupture valve can include a spike that punctures a flexible material to permit the composition to flow through the second composition supply line. The reservoir can be slidable relative to the valve such that a drive member coupled to or formed with the reservoir engages with the valve to open the valve upon distal movement of the reservoir. The valve can comprise a pinch valve. The valve can comprise a valve body and a clamping member that engages the valve body to pinch a flexible portion of the second composition supply line. Distal movement of the clamping member to a position distal the valve body can release a pinching force on the flexible portion to permit the composition to flow through the second fluid composition supply line. A pressure of the composition inside the flexible portion can impart a radially outward force against the clamping member to release a pinching force on the flexible portion to permit the composition to flow through the second fluid composition supply line. A slidable track and a plate can be disposed proximal the reservoir, the slidable track and plate configured to slidably engage with the reservoir along a distal direction to open the valve. A slidable outlet line can be coupled to or formed with the slidable track. Distal movement of the slidable track and slidable outlet during a filling treatment can expose a waste canister such that waste material from the filling treatment is conveyed proximally along through the slidable outlet line and into the waste canister. The treatment instrument can have a cleaning mode in which the pressure wave generator is configured to clean a treatment region of the tooth and a filling mode in which the pressure wave generator is configured to fill the treatment region of the tooth. One or more vents can be exposed to ambient air, the one or more vents configured to regulate pressure in the treatment region. A suction port can draw waste fluid from the treatment region of the tooth and to convey the waste fluid to an outlet line.

In another embodiment, a treatment instrument is disclosed. The treatment instrument can include a first composition supply line that supplies a first composition. The treatment instrument can include a second composition supply line that supplies a second composition. The treatment instrument can include a reservoir that holds the second composition. The treatment instrument can include a valve to control the supply of the second composition along the second composition supply line.

In some embodiments, the valve can comprise a rupture valve. The rupture valve can include a flexible material selected to rupture when a pressure of the composition exceeds a threshold. The rupture valve can include a spike that punctures a flexible material to permit the second composition to flow through the second composition supply line. The reservoir can be slidable relative to the valve such that a drive member coupled to or formed with the reservoir engages with the valve to open the valve upon distal movement of the reservoir. The valve can comprise a pinch valve. The valve can comprise a valve body and a clamping member that engages the valve body to pinch a flexible portion of the second composition supply line. Distal movement of the clamping member to a position distal the valve body can release a pinching force on the flexible portion to permit the second composition to flow through the second fluid composition supply line. A pressure of the composition inside the flexible portion can impart a radially outward force against the clamping member to release a pinching force on the flexible portion to permit the composition to flow through the second fluid composition supply line. A slidable track and a plate can be disposed proximal the reservoir, the slidable track and plate configured to slidably engage with the reservoir along a distal direction to open the valve. A slidable outlet line can be coupled to or formed with the slidable track. Distal movement of the slidable track and slidable outlet during a filling treatment can expose a waste canister such that waste material from the filling treatment is conveyed proximally along through the slidable outlet line and into the waste canister. A pressure wave generator can be configured to generate pressure waves in fluid supplied by at least one of the first and second fluid supply lines. The treatment instrument can include a cleaning mode in which the pressure wave generator is configured to clean a treatment region of a tooth and a filling mode in which the pressure wave generator is configured to fill the treatment region of the tooth. A mixing chamber can be in fluid communication with the first and second composition supply lines.

In another embodiment, a system for coating a treatment region of a tooth is disclosed. The system can include a fluid reservoir to supply a coating agent to the treatment region of the tooth. The system can include a treatment device in fluid communication with the fluid reservoir, the treatment device configured to be positioned at or near the treatment region, the treatment device comprising a pressure wave generator. The pressure wave generator can be configured to generate pressure waves so as to cause the coating agent to flow through the treatment region to coat or remineralize the treatment region.

In some embodiments, the coating agent can comprise a remineralization agent. The pressure wave generator can comprise a liquid jet device. A chamber can be positioned against the tooth, the chamber configured to retain the coating agent at the treatment region. A tooth cap can be attached to the tooth, the tooth cap configured to provide a platform against which the treatment device is positioned. The system can include a device for ionizing the coating agent. The device for ionizing the coating agent can comprise the pressure wave generator.

In another embodiment, a method for coating a treatment region of a tooth is disclosed. The method can comprise supplying a coating agent to the treatment region. The method can comprise activating a pressure wave generator to cause the coating agent to flow through the treatment region to coat or remineralize the treatment region.

In some embodiments, activating the pressure wave generator can comprise activating a liquid jet device. Activating the liquid jet device can comprise forming a coherent, collimated jet beam with the coating agent. The method can comprise ionizing the coating agent. Ionizing the coating agent can comprise activating the liquid jet device and passing the jet beam through coating agent that at least partially fills the treatment region. Supplying the coating agent can comprise supplying a remineralization agent. The method can comprise ionizing the remineralization agent. Supplying the remineralization agent can comprise supplying calcium fluoride solution. Supplying the remineralization agent can comprise supplying an ionized remineralization agent. Supplying the remineralization agent can comprise supplying a non-ionized remineralization agent. The method can comprise passing a jet beam of the non-ionized remineralization agent through a pool of liquid to ionize the non-ionized remineralization agent. Activating the pressure wave generator can comprise causing the coating agent to flow through portions of the treatment region that are remote from the pressure wave generator. The method can comprise attaching a tooth cap to the tooth. Attaching the tooth cap can comprise attaching the tooth cap over a side exterior surface of the tooth. The method can comprise applying a coupling material between the treatment region and the tooth cap. The method can comprise applying a sacrificial material between the coupling material and the treatment region. Activating the pressure wave generator can comprise removing the sacrificial material to expose the treatment region.

In another embodiment, a method of treating a tooth is disclosed. The method can comprise positioning a pressure wave generator to be in fluid communication with an interior of the tooth. The method can comprise activating the pressure wave generator to generate pressure waves that clean unhealthy materials from a pulp chamber and root canal spaces of the tooth and that propagate through tubules of the tooth to clean a carious region on an exterior surface of the tooth.

In some embodiments, activating the pressure wave generator can comprise causing the pressure waves to clean a broken portion of the exterior surface of the tooth. The method can comprise applying a sacrificial material over the carious region on the exterior surface of the tooth. The method can comprise activating the pressure wave generator to apply a coating over portions of interior surfaces of the tooth and over portions of exterior surfaces of the tooth.

In another embodiment, a treatment instrument is disclosed. The treatment instrument can include a pressure wave generator comprising an elongated actuator having a longitudinal axis, the actuator configured to oscillate along the longitudinal axis to generate pressure waves in liquid supplied to a treatment region of the tooth, the pressure waves having sufficient energy to treat the treatment region.

In some embodiments, the actuator can comprise a lumen for delivering the liquid to the treatment region. The pressure wave generator can be configured to generate pressure waves having a frequency in a range of 20 kHz to 200 MHz. The pressure wave generator can be configured to generate pressure waves having a frequency in a range of 20 kHz to 50 kHz. The treatment instrument can include a fluid platform including a chamber to be positioned against the treatment region to retain the liquid in the chamber. The pressure wave generator can extend distal the fluid platform. The fluid platform can comprise a suction port to remove fluid from the chamber. The fluid platform can comprise a vent in fluid communication with an outlet line downstream from the suction port.

In another embodiment, a dental treatment system is disclosed. The system can include a first pump coupled to a first fluid supply line. The system can include a second pump coupled to a second fluid supply line. The system can include a controller in communication with the first pump to send a first signal to the first pump to drive a first fluid composition through the first fluid supply line at a first flow rate, the controller in communication with the second pump to send a second signal to the second pump to drive a second fluid composition through the second fluid supply line at a second flow rate different from the first flow rate.

In some embodiments, the system can include one or more fluid containers configured to supply one or more fluids to the first pump. The system can include one or more fluid containers configured to supply one or more fluids to the second pump. The system can include a console, wherein the first pump is positioned within the console and the second pump is positioned outside of the console. One or more fluid containers can be configured to supply one or more fluids to the first pump are positioned within the console. The one or more fluid containers configured to supply one or more fluids to the second pump can be positioned outside of the console. The one or more fluid containers configured to supply one or more fluids to the first pump can comprise a plurality of fluid containers configured to supply a plurality of fluids to the first pump, the system further comprising a mixing system configured to mix the plurality of fluids to form the first fluid composition upstream of the first pump. The one or more fluid containers configured to supply one or more fluids to the second pump can comprise a plurality of fluid containers configured to supply a plurality of fluids to the second pump, the system further comprising a mixing system configured to mix the plurality of fluids to form the second fluid composition upstream of the second pump. The system can include a first temperature control coupled to the first fluid supply line to change the temperature of the first fluid composition. The system can include a second temperature control coupled to the second fluid supply line to change the temperature of the second fluid composition. The system can include a temperature sensor coupled to the first fluid supply line to measure a temperature of the first fluid composition, wherein the controller is configured to change an output of the first pump based on the measured temperature of the first fluid composition. The system can include a temperature sensor coupled to the second fluid supply line to measure a temperature of the second fluid composition, wherein the controller is configured to change an output of the second pump based on the measured temperature of the second fluid composition.

In another embodiment, a dental treatment system is disclosed. The system can include a console. The system can include a first pump coupled to a first fluid supply line and positioned within the console, the first fluid supply line being coupled to a dental treatment instrument such that actuation of the first pump drives a first fluid composition through the first fluid supply line to the dental treatment instrument. The system can include a second pump coupled to a second fluid supply line and positioned outside of the console, the second fluid supply line being coupled to the dental treatment instrument such that actuation of the second pump drives a second fluid composition through the second fluid supply line to the dental treatment instrument.

In some embodiments, the system can include a controller in communication with the first pump to send a first instruction to the first pump to drive the first fluid composition through the first fluid supply line at a first flow rate. The controller can be in communication with the second pump to send a second instruction to the second pump to drive a second fluid composition through the second fluid supply line at a second flow rate. The system can include one or more fluid containers configured to supply one or more fluids to the first pump. The system can include one or more fluid containers configured to supply one or more fluids to the second pump. The one or more fluid containers can be configured to supply one or more fluids to the first pump comprises a plurality of fluid containers configured to supply a plurality of fluids to the first pump, the system further comprising a mixing system configured to mix the plurality of fluids to form the first fluid composition upstream of the first pump. The one or more fluid containers can be configured to supply one or more fluids to the second pump comprises a plurality of fluid containers configured to supply a plurality of fluids to the second pump, the system further comprising a mixing system configured to mix the plurality of fluids to form the second fluid composition upstream of the second pump.

In another embodiment, a dental treatment system is disclosed. The system can include a first fluid supply line coupled to a dental treatment instrument and a pump such that actuation of the pump drives a first fluid composition through the first fluid supply line to the dental treatment instrument. The system can include a second fluid supply line coupled to the dental treatment instrument to deliver a second fluid composition to the dental treatment instrument without a pump.

In some embodiments, a negative pressure created by a flow of the first fluid composition can drive the second fluid composition through the second fluid supply line to the dental treatment instrument. The system can include a console housing the pump. The second fluid supply line can be positioned outside of the console. The system can include one or more fluid containers configured to supply one or more fluids to the pump. The system can include one or more fluid containers configured to supply one or more fluids to the second fluid supply line. The one or more fluid containers configured to supply one or more fluids to the pump can comprise a plurality of fluid containers configured to supply a plurality of fluids to the pump, the system further comprising a mixing system configured to mix the plurality of fluids to form the first fluid composition upstream of the first pump. The one or more fluid containers configured to supply one or more fluids to the second fluid supply line can comprise a plurality of fluid containers.

In another embodiment, a fluid container is disclosed. The fluid container can include a fluid container body housing a fluid. The fluid container can comprise a connector coupled to the fluid container body and configured to be received by a receiver of a console, the connector comprising a poppet movable within the connector and biased to a sealed position in which the poppet seals a passage through the connector, wherein receipt of the connector within the receiver causes the poppet to unseal the passage through connector.

In some embodiments, the poppet can include a head configured to seal an orifice of the connector when the poppet is in the sealed position. The poppet can include a shaft extending proximally of the connector. The container system can a filter, the filter comprising a lumen configured to receive the shaft of the poppet, the shaft configured to move within the lumen of the filter when the poppet moves from the sealed position to an unsealed position. The filter can comprise a porous titanium filter. The connector can comprise a spring positioned to apply a biasing force to the poppet to bias the poppet towards the sealed position. A dental treatment system can comprises the console, the console comprising the receiver, the receiver comprising a plunger movable within the receiver and biased to a sealed position in which the plunger seals a passage through the receiver. Receipt of the connector within the receiver can cause the plunger to unseal the passage through the receiver. The poppet can comprise a protrusion extending from the head of the poppet and positioned to contact the plunger when the connector is received within the receiver to exert a biasing force on the plunger causing the plunger to move from a sealed position to an unsealed position. When the connector is received within the receiver, the plunger can exert a biasing force on the protrusion of the poppet causing the plunger to move from a sealed position to an unsealed position. The receiver can comprise a spring positioned to apply a biasing force to the plunger to bias the plunger towards the sealed position. A retention spring can be configured to apply a biasing force to maintain a connection between the connector and the receiver after connector is received in the receiver.

In another embodiment, a dental treatment system is disclosed. The system can include a waste container removably coupled to a vacuum line to receive waste fluid therefrom. The system can include a container holder shaped to receive the waste container such that at least a portion of a wall of the waste container is airtight relative to at least a portion of a wall of the container holder. The system can include a level sensor coupled to the at least a portion of the wall of the container holder and configured to measure a height of fluid within the waste container.

In some embodiments, the level sensor can comprise a capacitive strip. The system can include a processing unit in communication with the level sensor, the processing unit configured to determine a number of procedures that can be performed using the waste container based on the height of fluid within the waste container. The system can include a processing unit in communication with the level sensor, the processing unit configured to determine if the waste container has sufficient capacity to receive waste from a predetermined treatment procedure. The waste container can comprise a first connector, the system further comprising a vacuum line coupled to a second connector configured to couple to the first connector to form a vacuum seal interface. The second connector can comprise one or more springs configured to exert a biasing force on the first connector. The second connector can be positioned relative to the level sensor so that the biasing force is exerted in a direction towards the sensor to cause the at least a portion of the wall of the waste container to seal against the at least a portion of the wall of the container holder.

In another embodiment, a dental treatment system is disclosed. The system can include a console. The system can include a waste container positioned within a drawer of the console, the waste container comprising a first connector. The system can include a vacuum line coupled to a second connecter. The first connector and the second connector can be aligned so the first connector and the second connector connect to form a vacuum seal interface when the drawer is fully inserted into the console.

In some embodiments, the first connector can be positioned on a lid of the waste container. The first connector can comprise a rubber gasket. The system can include a ball latch configured to couple the waste container to the console.

In another embodiment, a dental treatment system is disclosed. The system can include a mixing system configured to receive a plurality of fluids for the dental treatment. The mixing system can include a first valve selectively controlling flow of a first fluid of a plurality of fluids into a fluid delivery line and a second valve selectively controlling flow of a second fluid of a plurality of fluids into a fluid delivery line, the mixing system being configured to mix at least the first fluid and the second fluid by facilitating the flow of both the first fluid and the second fluid into at least the fluid delivery line to produce a delivery fluid. The system can include a degassing system receiving the delivery fluid and removing dissolved gases from the delivery fluid. The system can include an interface member configured to connect to a dental treatment instrument, the interface member being configured to receive the delivery fluid after dissolved gases are removed from the delivery fluid. The system can include a concentration sensor system disposed between the mixing system and the degassing system, the concentration sensor system measuring a concentration of at least one component of the delivery fluid to be supplied to the degassing system. The system can include a controller in communication with the concentration sensor system and the mixing system, the controller configured to receive concentration measurement data from the concentration sensor system and to adjust the operation of one or both of the first valve and the second valve to adjust the concentration of the at least one component of the delivery fluid based on the measurement data from the concentration sensor system.

In some embodiments, the system can include the dental treatment instrument, wherein the dental treatment instrument includes a port that directs the delivery fluid to a space near a surface of a tooth. The concentration sensor system can comprise one or more photometers. The concentration sensor system can comprise a first photometer emitting light at a first wavelength and a second photometer emitting light at a second wavelength different than the first wavelength. The concentration sensor system can comprise a first photometer configured to measure a concentration of a first fluid component of the delivery fluid and a second photometer configured to measure a concentration of a second fluid component of the delivery fluid. The concentration sensor system can comprise one or more broadband light sources. The concentration sensor system can comprise one or more modular components. The controller can comprise a proportional-integral-derivative (PID) controller. The controller can comprise a concentration measurement module configured to receive and process data from the concentration sensor system. The first fluid can be EDTA and the second fluid can be NaOCl. The first fluid can be water and the second fluid can be one of NaOCl, EDTA, and NaCl. The concentration sensor system can comprise a flame ionization detector. The concentration sensor system can comprise an atomic absorption sensor. The concentration sensor system can be configured to measure an absorbance of a diluted fluid comprising the delivery fluid and a fixed volume of another fluid of known concentration. The concentration sensor system can comprise a pH sensor. The concentration sensor system can comprise a mass spectrometer. The concentration sensor system can comprise an ion measurement system. The concentration sensor system can be configured to detect a viscosity of the delivery fluid and determine a concentration of the at least one component of the delivery fluid based on the detected viscosity. The concentration sensor system can be configured to detect depigmentation and determine a concentration of the at least one component of the delivery fluid based on the detected depigmentation. The concentration sensor system can be configured to measure a precipitate formed by a chemical indicator and the delivery fluid and determine the concentration of the at least one component of the delivery fluid based on the measured precipitate. The concentration sensor system can be configured to measure heat of an exothermic reaction between two or more components of the delivery fluid. The concentration sensor system can comprise a chlorine gas detector. The concentration sensor system can comprise a capacitance sensor. The concentration sensor system can comprise a Hall effect sensor. The concentration sensor system can comprise a light scatter sensor. The light scatter sensor can be a turbidity sensor. The concentration sensor system can comprise an ultrasonic sensor. The system can include one or more temperature controls positioned upstream of the concentration sensor system to change a temperature of the delivery fluid. The system can include one or more temperature controls position adjacent the concentration sensor system to change an ambient temperature at the concentration sensor system. The concentration sensor system can comprise a flowcell and one or more temperature controls coupled to the flowcell to change the temperature of the flowcell. The system can include one or more desiccants positioned adjacent the concentration sensor system to decrease the humidity at the concentration sensor system.

In some embodiments, a dental treatment system is provided. The dental treatment system can include a mixing system configured to mix a plurality of fluids to produce a delivery fluid. The dental treatment system can include an interface member configured to connect to a dental treatment instrument, the interface member being configured to receive the delivery fluid from the mixing system. The dental treatment system can include a concentration sensor system positioned between the mixing system and the treatment instrument. The concentration sensor system can include a first light source configured to emit light at a first wavelength and direct light through the delivery fluid while the delivery fluid flows between the mixing system and the treatment instrument, the first wavelength being suitable for measurement of a concentration of a first fluid component within the delivery fluid. The concentration sensor system can include a first collection photodiode configured to receive light directed from the first light source through the delivery fluid. The concentration sensor system can include a second light source configured to emit light at a second wavelength different from the first wavelength and to direct light through the delivery fluid while the delivery fluid flows between the mixing system and the treatment instrument, the second wavelength being suitable for measurement of a concentration of a second fluid component within the delivery fluid. The concentration sensor system can include a second collection photodiode configured to receive light directed from the second light source through the delivery fluid. The dental treatment system can include a controller in communication with the concentration sensor system and the mixing system, the controller configured to receive concentration measurement data from the concentration sensor system and to control the operation of the mixing system to adjust the concentration of at least one component of the delivery fluid based at least in part on the concentration measurement data from the concentration sensor system.

In some embodiments, the dental treatment system can include further the dental treatment instrument, wherein the dental treatment instrument is configured to deliver the delivery fluid to a tooth of a patient. In some embodiments, at least one of the first light source, the second light source, the first detector and the second detector are is a modular component that is configured to be replaced independent of at least one of the other ones of the first light source, the second light source, the first detector and the second detector. In some embodiments, the first fluid component is NaOCl and the second fluid component is EDTA. In some embodiments, the first wavelength is between 335 nm to 385 nm and the second wavelength is between 230 nm to 280 nm. In some embodiments, the first wavelength is 360 nm and the second wavelength is 280 nm. In some embodiments, the dental treatment instrument can include one or more reference photodiodes receiving light from the first light source without the light passing through the delivery fluid. In some embodiments, the dental treatment system can include a first photometer comprising the first light source and the first collection photodiode and a second photometer comprising the second light source and the second collection photodiode. In some embodiments, the dental treatment system can include a degassing system configured to receive the delivery fluid and remove dissolved gases from the delivery fluid, the concentration sensor system being positioned between the mixing system and the degassing system. In some embodiments, the mixing system includes a first valve selectively increasing flow of a first fluid of a plurality of fluids into a fluid delivery line and selectively decreasing the flow of the first fluid into the fluid delivery line and a second valve selectively increasing flow of a second fluid of a plurality of fluids into a fluid delivery line and selectively decreasing the flow of the second fluid into the fluid delivery line, the mixing system mixing the first fluid and the second fluid by facilitating the flow of both the first fluid and the second fluid into the fluid delivery line to produce the delivery fluid. In some embodiments, the concentration sensor system is configured to measure the concentration of the first fluid component and the second fluid component in the delivery fluid while the delivery fluid flows through the fluid delivery line. In some embodiments, the controller includes a proportional-integral-derivative (PID) controller. In some embodiments, the controller includes a concentration measurement module configured to receive and process data from the concentration sensor system. In some embodiments, the concentration sensor system is configured to measure one of absorbance, transmittance, and scattering. In some embodiments, the concentration sensor system is configured to measure turbidity. In some embodiments, the concentration sensor system comprises an optics cartridge including optical components configured to direct light from the first light source to the first photodiode. In some embodiments, the optics cartridge is replaceable with a second optics cartridge having a different optical configuration. In some embodiments, the concentration sensor system is configured to measure an absorbance of a diluted fluid comprising the delivery fluid and a fixed volume of another fluid of known concentration. In some embodiments, the concentration sensor system is configured to measure a concentration of obturation material. In some embodiments, the concentration sensor is configured to measure a concentration of necrotic tissue. In some embodiments, the dental treatment system includes one or more temperature controls positioned upstream of the concentration sensor system to change a temperature of the delivery fluid. In some embodiments, the dental treatment system includes one or more temperature controls position adjacent the concentration sensor system to change an ambient temperature at the concentration sensor system. In some embodiments, the concentration sensor system comprises a flowcell and one or more temperature controls coupled to the flowcell to change the temperature of the flowcell. In some embodiments, the dental treatment system includes one or more desiccants positioned adjacent the concentration sensor system to decrease the humidity at the concentration sensor system.

In some embodiments, a dental treatment system is provided. The dental treatment system can include a fluid delivery system configured to provide one or more fluids to a treatment instrument during a dental treatment procedure. The dental treatment system can include a concentration sensor system measuring a concentration of at least one component of an outflow fluid flowing out of a tooth during a dental treatment procedure, the concentration sensor configured to detect blood in the outflow fluid. The dental treatment system can include a controller in electrical and data communication with the fluid delivery system and the concentration sensor, the controller receiving concentration measurement data from the concentration sensor system and actuating adjustments to the fluid delivery system based on a detection of blood in the outflow fluid.

In some embodiments, the controller is configured to actuate adjustments to the fluid delivery system based on a detection of blood in the outflow fluid above a threshold level. In some embodiments, the controller is configured to actuate the fluid delivery system to halt the delivery of fluids to the tooth based on a detection of blood in the outflow fluid. In some embodiments, the controller is configured to actuate the fluid delivery system to deliver an anti-hemorrhagic agent to the tooth based on a detection of blood in the outflow fluid. In some embodiments, the controller is configured to actuate the fluid delivery system to entrain the anti-hemorrhagic agent in a delivery fluid based on a detection of blood in the outflow fluid.

In some embodiments, a dental treatment system is provided. The dental treatment system can include a fluid delivery system configured to provide one or more fluids to a treatment instrument during a dental treatment procedure. In some embodiments, a dental treatment system is provided. The dental treatment system can include a concentration sensor system measuring a concentration of at least one component of an outflow fluid flowing out of a tooth during a dental treatment procedure, the concentration sensor configured to detect bacteria in the outflow fluid. The dental treatment system can include a controller in electrical and data communication with the fluid delivery system and the concentration sensor, the controller receiving concentration measurement data from the concentration sensor system and actuating adjustments to the fluid delivery system based on a detection of bacteria in the outflow fluid.

In some embodiments, the controller is configured to actuate adjustments to the fluid delivery system based on a detection of bacteria in the outflow fluid above a threshold level. In some embodiments, the controller is configured to actuate the fluid delivery system to halt the delivery of fluids to the tooth based on a detection of bacteria in the outflow fluid. In some embodiments, the controller is configured to actuate the fluid delivery system to deliver an antibacterial agent to the tooth based on a detection of bacteria in the outflow fluid. In some embodiments, the controller is configured to actuate the fluid delivery system to entrain the antibacterial agent in a delivery fluid based on a detection of bacteria in the outflow fluid.

For purposes of this summary, certain aspects, advantages, and novel features of certain disclosed inventions are summarized. It is to be understood that not necessarily all such advantages may be achieved in accordance with any particular embodiment of the invention. Thus, for example, those skilled in the art will recognize that the inventions disclosed herein may be embodied or carried out in a manner that achieves one advantage or group of advantages as taught herein without necessarily achieving other advantages as may be taught or suggested herein. Further, the foregoing is intended to summarize certain disclosed inventions and is not intended to limit the scope of the inventions disclosed herein.

### BRIEF DESCRIPTION OF THE DRAWINGS

The foregoing and other features, aspects, and advantages of the embodiments of the apparatus and methods of treating teeth (e.g., cleaning teeth) are described in detail below with reference to the drawings of various embodiments, which are intended to illustrate and not to limit the embodiments of the invention. The drawings comprise the following figures in which:

FIG. 1A is a schematic diagram of a system that includes components capable of removing unhealthy or undesirable materials from a tooth, coating or restoring portion(s) of the tooth, and/or filling a treatment region of the tooth.

FIG. 1B is a schematic diagram of a system, in accordance with embodiments of a treatment instrument as disclosed herein.

FIG. 1C is a schematic diagram of a system that includes components configured to clean unhealthy or undesirable material from a treatment region on an exterior surface of the tooth.

FIG. 1D is a schematic diagram of the system of FIG. 1C, in which the system is configured to fill the treated carious region of the tooth.

FIG. 1E is a schematic diagram of a dental treatment instrument having a removable tip device.

FIG. 1F illustrates a system configured to coat and/or remineralize a portion of an exterior surface of the tooth.

FIG. 1G illustrates a system configured to coat and/or remineralize a portion of an interior surface of the tooth and a portion of an exterior surface of the tooth.

FIG. 1H is a schematic diagram of a system that includes components capable of removing unhealthy or undesirable materials from a tooth, coating or restoring portion(s) of the tooth, and/or filling a treatment region of the tooth, according to another embodiment.

FIGS. 2A and 2B depict a delivery device that can be used to combine a plurality of compositions at the treatment region for cleaning, coating, remineralization, filling, or other types of dental treatments.

FIGS. 3A-3E illustrate an embodiment of a delivery device comprising a treatment instrument configured to combine multiple components of treatment material for delivery to a treatment region.

FIGS. 4A-4J illustrate another embodiment of a delivery device comprising a treatment instrument configured to combine multiple components of treatment material to a treatment region of the tooth.

FIGS. 5A-5H illustrate another embodiment of a delivery device comprising a treatment instrument configured to combine multiple components of treatment material to a treatment region of the tooth.

FIG. 5I illustrates another embodiment of a delivery device comprising a treatment instrument configured to combine multiple components of treatment material to a treatment region of the tooth.

FIGS. 6A-6E illustrate another example of a delivery device comprising a treatment instrument configured to combine multiple components of treatment material for delivery to a treatment region of a tooth.

FIGS. 7A-7B illustrate another embodiment of a delivery device including a treatment instrument.

FIGS. 8A-8B illustrate another embodiment of a delivery device including a treatment instrument.

FIGS. 9A-9B illustrate a treatment assembly which can be used in various embodiments disclosed herein.

FIGS. 10A-10D illustrate a delivery device comprising a treatment instrument according to another embodiment.

FIGS. 11A-11B illustrate a distal portion of a treatment instrument, according to various embodiments.

FIGS. 12A-12E illustrate another embodiment of a delivery device that includes a treatment instrument configured to clean and/or fill a treatment region of the tooth.

FIGS. 13A-13E illustrate various examples of evacuation systems for removing waste from the treatment region of the tooth.

FIGS. 13F-13P are schematic perspective views illustrating additional examples of treatment instruments, according to various embodiments.

FIG. 14 is a schematic system diagram of a pneumatic drive system configured to supply pressurized fluid to the treatment instrument to drive the second composition along the second supply line.

FIG. 15 is a schematic perspective view of the pneumatic drive system shown in FIG. 14.

FIG. 16A is a schematic system diagram of an embodiment of a dental treatment system.

FIG. 16B is a schematic system diagram of another embodiment of a dental treatment system.

FIG. 16C is a schematic system diagram of an embodiment of a processing unit.

FIG. 17 is a schematic system diagram of another embodiment of a dental treatment system.

FIG. 17A is a schematic system diagram of a section of the dental treatment system of FIG. 17.

FIG. 17B is a schematic system diagram of a section of the dental treatment system of FIG. 17.

FIG. 17C is a schematic system diagram of a section of the dental treatment system of FIG. 17.

FIG. 17D is a schematic system diagram of a section of the dental treatment system of FIG. 17.

FIG. 17E is a schematic cross-sectional view of an embodiment of a container connector.

FIG. 17F is a schematic cross-sectional view of an embodiment of a receiver for container connector.

FIG. 17G is a schematic cross-section view of an example of the container connector of FIG. 17E coupled to the receiver of FIG. 17F.

FIG. 17H is a schematic perspective view of an embodiment of a poppet of a container connector.

FIG. 17I is a schematic cross-section view of an embodiment of a waste container system.

FIG. 17J is a schematic perspective sectional view of a section of the waste container system of FIG. 17I.

FIG. 17K is a schematic perspective sectional view of a section of the waste container system of FIG. 17I.

FIG. 17L is a schematic system diagram of an alternative embodiment of the section of the dental treatment system shown in FIG. 17B.

FIG. 17M is a schematic system diagram of an alternative embodiment of the section of the dental treatment system shown in FIG. 17B.

FIG. 18A is a schematic system diagram of an embodiment of a system for delivering fluid at a controlled concentration.

FIG. 18B is a schematic system diagram of another embodiment of a system for delivering fluid at a controlled concentration.

FIG. 19 is a schematic system diagram of an embodiment of a monitoring system.

FIG. 20 is a schematic perspective view of an embodiment of an illumination system.

FIG. 21A is a schematic top view of the illumination system of FIG. 20.

FIG. 21B is a schematic top view of an alternative embodiment of the illumination system of FIG. 20.

FIG. 21C is a schematic top view of an alternative embodiment of the illumination system of FIG. 20.

FIG. 21D is a schematic top view of an alternative embodiment of the illumination system of FIG. 20.

FIG. 21E is a schematic top view of an alternative embodiment of the illumination system of FIG. 20.

FIG. 22 is a schematic side view of an embodiment of an optical path.

FIG. 23 is a schematic cross-sectional view of an embodiment of a photometer.

FIG. 24 is a schematic top view of another embodiment of an illumination system.

FIG. 25 is a schematic system diagram of an embodiment of an ultrasonic transducer system.

FIG. 26 is a schematic system diagram of an embodiment of a capacitance measurement system.

### DETAILED DESCRIPTION

The present disclosure describes apparatus, methods, and compositions for performing dental and/or endodontic procedures. Various embodiments disclosed herein can effectively and safely remove unhealthy material from a treatment region of a tooth, e.g., from within the tooth and/or from outside surfaces of the tooth. In particular, the embodiments disclosed herein can remove unhealthy materials, such as unhealthy organic matter, inorganic matter, pulp tissue, caries, stains, calculus, plaque, biofilm, bacteria, pus, decayed tooth matter, and food remnants from the treatment region without substantially damaging healthy dentin or enamel. For example, the disclosed apparatus, methods, and compositions advantageously may be used with root canal cleaning treatments, e.g., to efficiently remove unhealthy or undesirable materials such as organic and/or inorganic matter from a root canal system and/or to disinfect the root canal system. The disclosed embodiments may also be used to treat carious regions (e.g., remove decayed material) on an exterior surface of the tooth. Organic material (or organic matter) includes organic substances typically found in healthy or diseased teeth or root canal systems such as, for example, soft tissue, pulp, blood vessels, nerves, connective tissue, cellular matter, pus, and microorganisms, whether living, inflamed, infected, diseased, necrotic, or decomposed. Inorganic matter includes calcified tissue and calcified structures, which are frequently present in the root canal system.

Various embodiments disclosed herein also can be used in filling or restoration procedures. For example, in some embodiments, a treatment instrument can be used to fill the root canal with an obturation material (e.g., a flowable obturation material that can be hardened into a solid or semi-solid state, gutta percha or other solid or semi-solid materials) after treatment of the root canal. The treatment instrument can also be used to fill a treated carious region on an exterior surface of the tooth with a filling material. In some embodiments, the treatment instruments disclosed herein can be used to deliver a coating or remineralization agent to the treatment region to protect the tooth from decay and/or to remineralize the tooth.

### I. Overview of Various Disclosed Embodiments

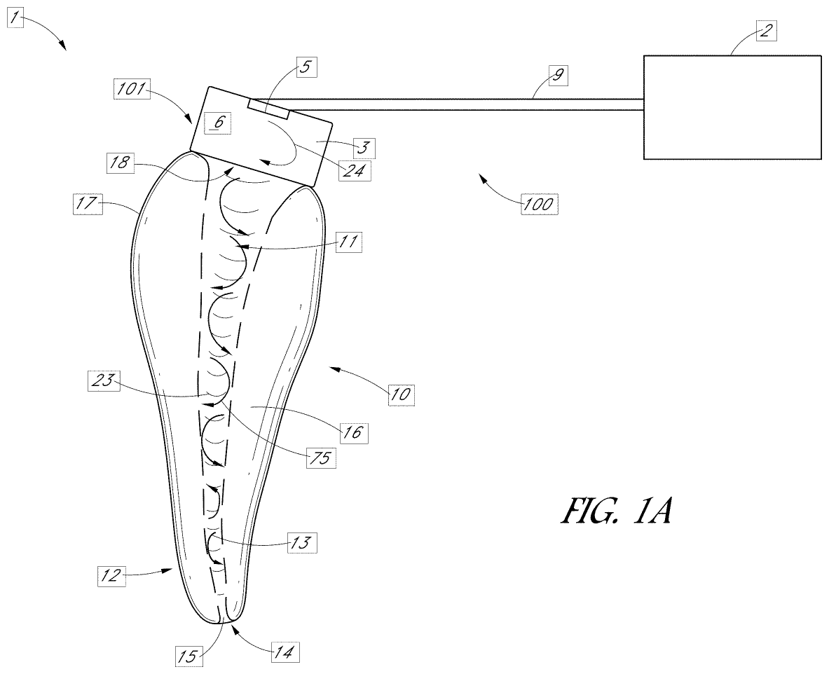

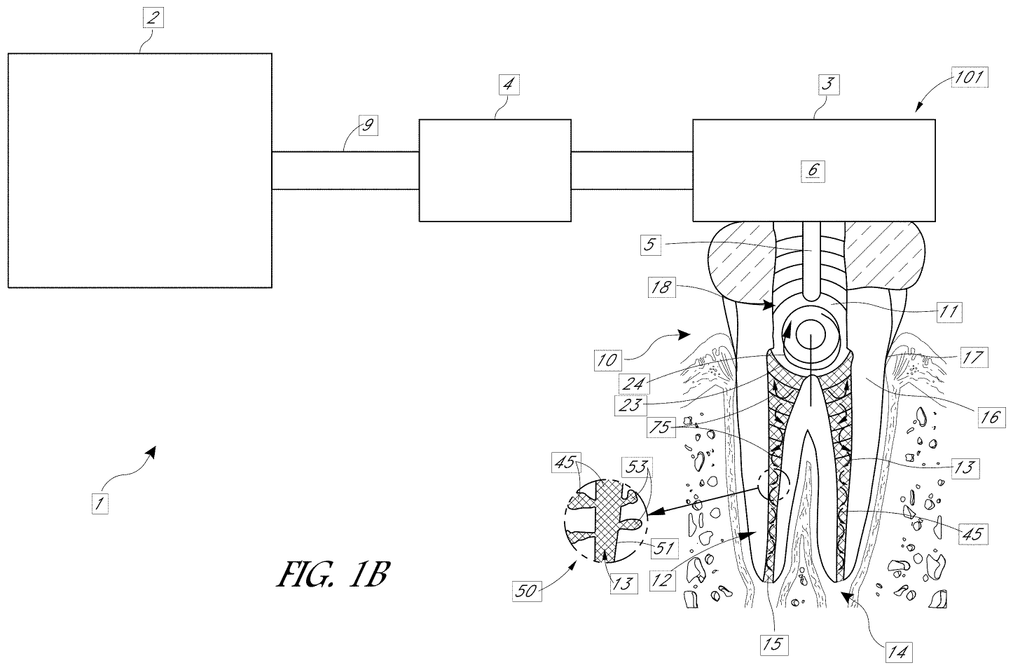

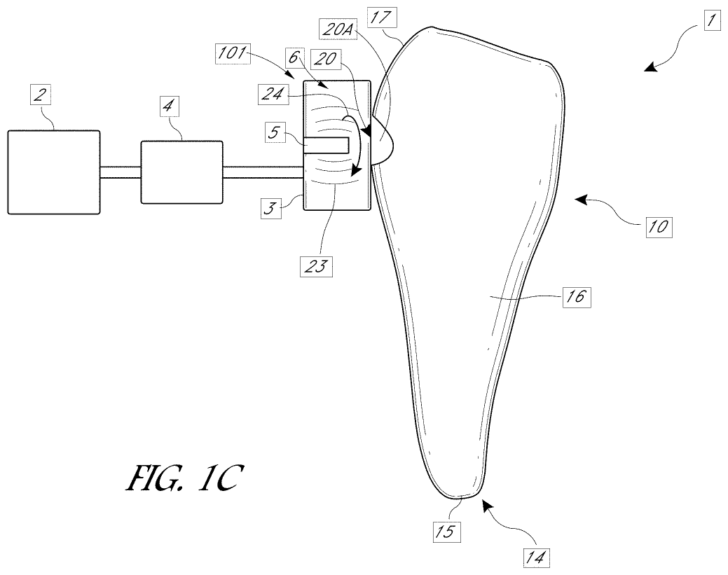

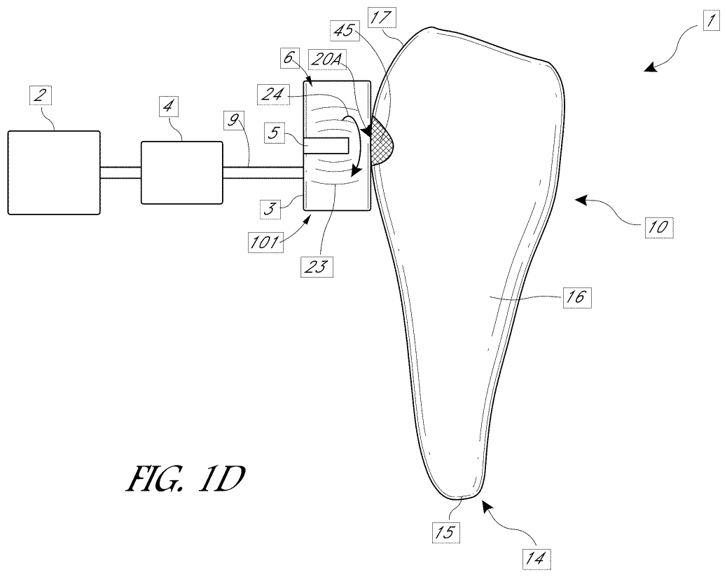

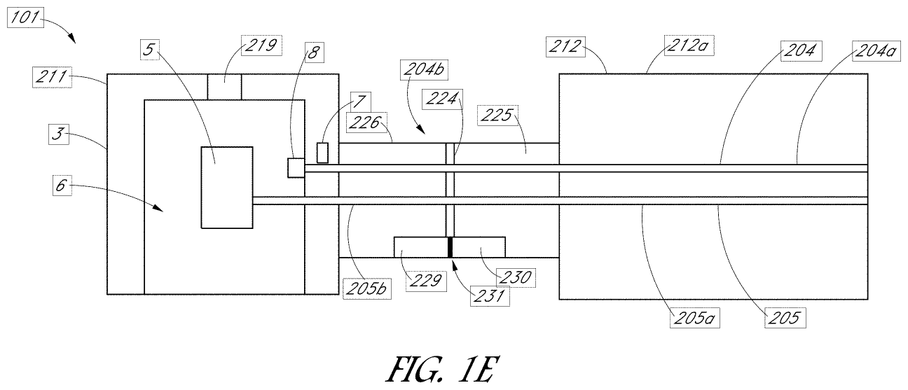

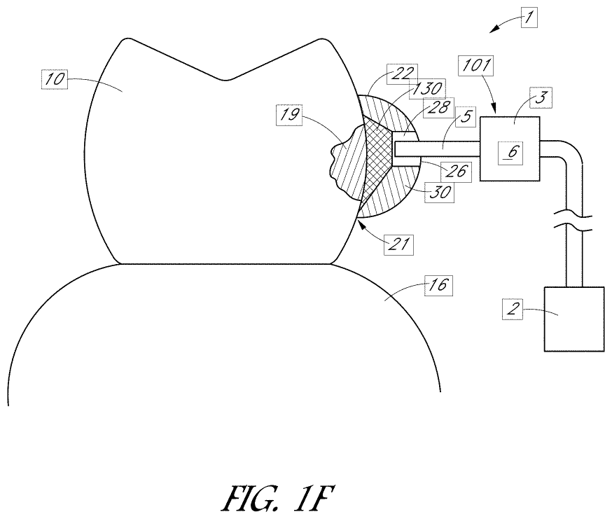

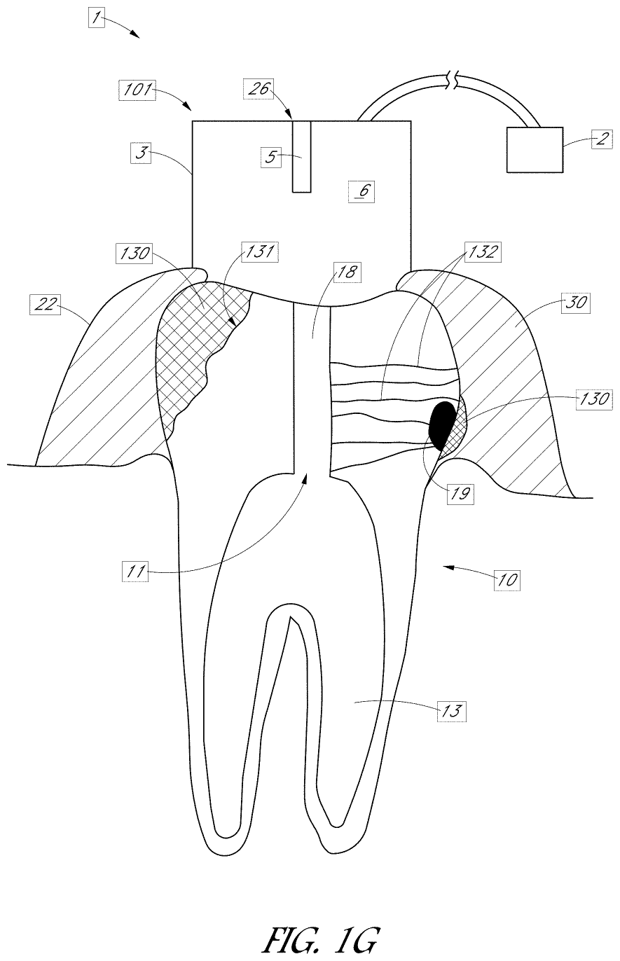

FIG. 1A is a schematic diagram of a system 1 that includes components capable of removing unhealthy or undesirable materials from a tooth 10, coating or restoring portion(s) of the tooth 10, and/or filling a treatment region of the tooth 10. The tooth 10 illustrated in FIG. 1A is a premolar tooth, e.g., a tooth located between canine and molar teeth in a mammal such as a human. Although the illustrated tooth 10 comprises a premolar tooth, it should be appreciated that the tooth 10 to be treated can be any type of tooth, such as a molar tooth or an anterior tooth (e.g., an incisor or canine tooth). The tooth 10 includes hard structural and protective layers, including a hard layer of dentin 16 and a very hard outer layer of enamel 17. A pulp cavity 11 is defined within the dentin 16. The pulp cavity 11 comprises one or more root canals 13 extending toward an apex 14 of each root 12. The pulp cavity 11 and root canal 13 contain dental pulp, which is a soft, vascular tissue comprising nerves, blood vessels, connective tissue, odontoblasts, and other tissue and cellular components. Blood vessels and nerves enter/exit the root canal 13 through a tiny opening, the apical foramen or apical opening 15, near a tip of the apex 14 of the root 12. It should be appreciated that, although the tooth 10 illustrated herein is a premolar, the embodiments disclosed herein can advantageously be used to treat any suitable type of tooth, including molars, canines, incisors, etc.

As illustrated in FIG. 1A, the system 1 can be used to remove unhealthy materials (such as organic and inorganic matter) from an interior of the tooth 10, e.g., from the root canal 13 of the tooth 10. For example, an endodontic access opening 18 can be formed in the tooth 10, e.g., on an occlusal surface, or on a side surface such as a buccal surface or a lingual surface. The access opening 18 provides access to a portion of a pulp cavity 11 of the tooth 10. The system 1 can include a console 2 and a treatment instrument 101 comprising a pressure wave generator 5 and a fluid platform 3 adapted to be positioned over or against a treatment region of the tooth 10. The fluid platform 3 can define a chamber 6 configured to retain fluid therein. In some embodiments, the fluid platform 3 can be part of a removable tip device that is removably coupled to a handpiece which can be held or pressed against the tooth 10 by the clinician. In other embodiments, the fluid platform 3 may not be removably connected to the handpiece, e.g., the fluid platform 3 may be integrally formed with the handpiece, or may be connected to the handpiece in a manner intended to be non-removable. In some embodiments, the fluid platform 3 can be attached to the tooth, e.g., using an adhesive. For example, in some embodiments, the fluid platform 3 may not be used with a handpiece. One or more conduits 9 can electrically, mechanically, and/or fluidly connect the console 2 with the fluid platform 3 and pressure wave generator 5. The console 2 can include a control system and various fluid management systems configured to operate the pressure wave generator 5 during a treatment procedure. Additional examples of system components that can be used in the system 1 are described herein. Some additional examples are also disclosed throughout U.S. Pat. No. 9,504,536, the entire contents of which are incorporated by reference herein in their entirety and for all purposes.

As explained herein, the system 1 can be used in cleaning procedures to clean substantially the entire root canal system. For example, in various embodiments disclosed herein, the pressure wave generator 5 can generate pressure waves with a single frequency or multiple frequencies. The single frequency may be a low frequency below the audible range, a frequency within the audible range, or a relatively higher frequency above the audible range. For example, in various embodiments disclosed herein, the pressure wave generator 5 can generate pressure waves 23 of sufficient power and relatively low frequencies to produce fluid motion 24 in the chamber 6—such that the pressure wave generators 5 disclosed herein can act as a fluid motion generator—and can generate pressure waves of sufficient power and at relatively higher frequencies to produce surface effect cavitation on a dental surface, either inside or outside the tooth. That is, for example, the pressure wave generators 5 disclosed herein can act as fluid motion generators to generate large-scale or bulk fluid motion 24 in or near the tooth 10, and can also generate smaller-scale fluid motion at higher frequencies. In some arrangements, the fluid motion 24 in the chamber 6 can generate induced fluid motion such as vortices 75, swirl, a chaotic or turbulent flow, etc. in the tooth 10 and root canal 13 that can clean and/or fill the canal 13. As explained herein, system 1 can additionally or alternatively be used to coat and/or remineralize a treatment region of the tooth 10.

In some embodiments, the system 1 can additionally or alternatively be used in filling procedures to fill a treated region of the tooth, e.g., to obturate a treated root canal system. The treatment instrument 101 can generate pressure waves and fluid motion that can cause a flowable filling material to substantially fill the treated region. The flowable filling material can be hardened to restore the tooth. Additional details of systems that utilize pressure wave generators 5 to fill a treatment region can be found throughout U.S. Pat. No. 9,877,801, the entire contents of which are hereby incorporated by reference herein in their entirety and for all purposes.

For example, to protect the long-term health of the tooth, it can be advantageous to substantially fill the filling space or spaces of a tooth created from removal of caries, root canal treatment, and/or natural wear. When the restoration follows a root canal treatment it can be important to fill not only the major canal spaces, but also any minor cracks and open spaces in the tooth with the filling material. Similarly, when the restoration follows a caries treatment it can be important to fill the resulting dental spaces in order to provide dimensional stability and/or structural integrity to the tooth.

In various embodiments, the filling material is an obturation material. Obturation materials can include a material that is configured to fill root canals, restore carious lesions, and/or modify the surface of the tooth. The obturation material can be a polymerizable restorative composition that includes a curable mixture that is cured or hardened to form the final material, which may be referred to as a cured mixture or “tooth filling.” Indeed, it should be appreciated that terms such as setting, curing, hardening, polymerizing, etc. all refer to processes by which the obturation material components are transformed into the final cured mixture in the tooth. The obturation materials disclosed herein can be used in conjunction with filling root canals after root canal treatments, with filling treated carious regions after treatment, and/or adding to the existing tooth and/or adjacent bone structure either with or without the removal of existing tooth and/or adjacent bone structure. For example, the obturation materials disclosed herein can be used in the manner described in U.S. Pat. No. 9,877,801, the entire contents of which are incorporated herein by reference in their entirety and for all purposes.

The treatment instrument 101 may be used to apply one or a plurality of materials to the tooth 10. In some embodiments, the material applied to a tooth can be any material used to treat a tooth, for example such as a filling material. In some embodiments, the filling material may be a curable mixture (e.g. a curable obturation material) and/or a cured mixture (e.g. a cured obturation material). In some embodiments, the filling material comprises an obturation compound. In some embodiments, the obturation compound is selected from the group of a polysaccharide, a calcium silicate compound, a water soluble acrylate-based monomer, a water-soluble acrylamide-based monomer, a water-soluble chelating monomer, and mixtures thereof. In some embodiments, the polysaccharide can comprise an alginate polymer, a chitosan polymer, a pectinate polymer, and mixtures thereof. In some embodiments, the alginate polymer comprises guluronic units and mannuronic units in a ratio of the guluronic units to the mannuronic units in the range of about 1:1 to about 4:1. In some embodiments, a polysaccharide is a polymerizable polysaccharide and/or a cross-linkable polysaccharide. In some embodiments, the calcium silicate compound includes calcium silicate, dicalcium silicate and tricalcium silicate, and mixtures thereof. In some embodiments, the water-soluble acrylate-based monomer is a diacrylate monomer or a triacrylate monomer. In some embodiments, the water-soluble acrylamide-based monomer is an acrylamide monomer that is cationically charged. Various water-soluble chelating monomers and mixtures thereof are suitable for use in the curable mixture of ingredients. Examples of a chelating monomer include but are not limited to 4-methacryloxyethyl trimellitic acid (4-MET) and glycerol phosphate dimethacrylate (GPDM).

The filling material may further include additional components, such an activating agent, a filler material, an X-ray radiopaque material, an accelerating agent, a surface-active agent, a primary carrier liquid, a secondary carrier liquid, and mixtures thereof. In some embodiments, the activating agent is selected from water, a divalent cation ionic material, free-radical polymerization initiator, and mixtures thereof. In some embodiments, the divalent cation comprises an element selected from Ca, Ba, Sr, or a mixture thereof. Free-radical polymerization initiators suitable for use in the curable mixtures described herein include a halogen molecule, azo compound, organic peroxide, an inorganic peroxide, or other free-radical polymerization initiators. In some embodiments, the primary and secondary carrier liquids individually comprise a non-aqueous liquid and an aqueous liquid. In some embodiment, the ingredients of the filling material are provided in in a single mixture. In some embodiment, the ingredients of the filling material are provided in multiple parts (e.g., two-parts). For example, in some embodiments the first part of the filling material comprises a non-aqueous carrier liquid, and the second part of the filling material comprises an aqueous carrier liquid. In some embodiments, the filling material comprises two or more components that react with one another to form a hardened obturation material. The two or more components can be respectively supplied to the treatment instrument along the respective first and second fluid composition supply lines 112, 114, as explained herein. In other embodiments, the filling material may comprise a composition that is curable from a flowable state to a hardened state by exposure to an energy source such as light or heat, or both light and heat. Additional examples of filling materials that can be used with any of the embodiments disclosed herein may be found throughout International Publication No. WO 2019/236917; U.S. patent application Ser. No. 16/865,208, filed May 1, 2020; and U.S. patent application Ser. No. 16/875,193, filed May 15, 2020, the entire contents of each of which are hereby incorporated by reference in their entirety and for all purposes.

In some embodiments, various obturation material compositions or components thereof as described herein can be formed into a coherent collimated jet. For example, in an embodiment, an obturation material composition or components thereof as described herein can be formed into a liquid jet that forms a substantially parallel beam (e.g., is “collimated”) over distances ranging from about 0.01 cm to about 10 cm. In some embodiments, the velocity profile transverse to the propagation axis of the jet is substantially constant (e.g., is “coherent”). For example, in some implementations, away from narrow boundary layers near the outer surface of the jet (if any), the jet velocity is substantially constant across the width of the jet. Therefore, in certain advantageous embodiments, the liquid jet (e.g., as delivered by an apparatus as described herein) may comprise a coherent, collimated jet (a “CC jet”). In some implementations, the CC jet may have velocities in a range from about 100 m/s to about 300 m/s, for example, about 190 m/s in some embodiments. In some implementations, the CC jet can have a diameter in a range from about 5 microns to about 1000 microns, in a range from about 10 microns to about 100 microns, in a range from about 100 microns to about 500 microns, or in a range from about 500 microns to about 1000 microns. Further details with respect to CC jets that can be comprised of obturation material compositions or components thereof as described herein can be found in U.S. Patent Publication No. 2007/0248932, which is hereby incorporated by reference herein in its entirety for all that it discloses or teaches.

The curable filling materials and obturation materials described herein can be formed and applied to a tooth by various methods and devices. The filling or obturation material can be formed in any suitable manner. For example, in some embodiments, a clinician can form the obturation material by mixing the obturation material ingredients, e.g., by hand, by a mechanical tool, or by a mixing device. Furthermore, the obturation material can be applied to a tooth in any suitable manner. For example, in some embodiments, a clinician can apply the obturation material by placing it in the tooth, e.g., by hand, by syringe, by a mechanical tool, or by an application device. As described below and in the accompanying figures, embodiments of a mixing device and/or an application device that can be used to form and/or apply an obturation material are disclosed. In various embodiments, the application or treatment device can combine a first composition with a second composition to form the filling material within the treatment device. Any suitable number of compositions can be combined to form the filling material. The treatment instrument 101 can be configured to generate pressure waves to cause the filling material to flow into spaces within the treatment region (e.g., into a treated root canal, a treated carious region, etc.). The filling material can be cured or hardened in any suitable manner.

FIG. 1B is a schematic diagram of a system 1, in accordance with embodiments of a treatment instrument 101 as disclosed herein. The system 1 can be configured to perform various types of treatment procedures, including, e.g., cleaning treatments, coating and/or remineralization treatments, obturation or other filling treatments, restoration treatments, etc. In the embodiment shown in FIG. 1B, the system 1 is illustrated as being coupled to (e.g., positioned against in some arrangements) a tooth 10 that is a molar tooth of a mammal, such as a human. However, the tooth 10 can be any other suitable type of tooth, such as a pre-molar, bicuspid, incisor, canine, etc. Furthermore, the system 1 shown in FIG. 1B can include components configured to remove unhealthy or undesirable materials from a tooth or surrounding gum tissue, for example, a root canal 13 of the tooth 10. Thus, in the embodiment of FIG. 1B, the system 10 can also be configured to clean the tooth 10, in addition to being configured to fill or obturate the tooth. Moreover, although the treatment shown in FIG. 1B is a root canal treatment, in other embodiments, the application device and obturation material(s) disclosed herein can be used to fill other types of treatment regions, such as a treated carious region of the tooth.

In the illustrated embodiment, the pressure wave generator 5 can extend into the pulp cavity 11 of the tooth 10. In other embodiments, as shown in FIG. 1A, the pressure wave generator 5 may be disposed outside the tooth 10, e.g., within, in fluid communication with, coupled with, or exposed to the chamber 6. In various embodiments, the pressure wave generator 5 can comprise a nozzle, a guide tube, and an impingement plate, as described herein.

A system interface member 4 can electrically, mechanically, and/or fluidly connect the console 2 with the fluid platform 3 and pressure wave generator 5. For example, in some embodiments, the system interface member 4 can removably couple the fluid platform 3 to the console 2. In such embodiments, the clinician can use the fluid platform 3 one time (or a few times), and can dispose the fluid platform 3 after each procedure (or after a set number of procedures). The console 2 and interface member 4 can be reused multiple times to removably couple (e.g., to connect and/or disconnect) to multiple fluid platform 3 using suitable engagement features, as discussed herein. The interface member 4 can include various electrical and/or fluidic pathways to provide electrical, electronic, and/or fluidic communication between the console 2 and the fluid platform 3. The console 2 can include a control system and various fluid and/or electrical systems configured to operate the pressure wave generator 5 during a treatment procedure. The console 2 can also include a management module configured to manage data regarding the treatment procedure. The console 2 can include a communications module configured to communicate with external entities about the treatment procedures.

Additionally, the console 2 can include a control system comprising a processor and non-transitory memory. Computer-implemented instructions can be stored on the memory and can be executed by the processor to assist in controlling cleaning and/or filling procedures. Additional details of the console 2 are described herein.

In FIG. 1B, the system 1 is used to fill or obturate the root canal 13 with an obturation material 45, which can be the same as or generally similar to the filler materials described herein. For example, the clinician can clean the root canal 13 in any suitable way, such as by using drills or files, or by using a pressure wave generator (which can be the same as or different from the pressure wave generator 5 shown in FIGS. 1A-1B). When the root canal 13 is cleaned, the clinician can supply an obturation material 45 in its flowable state to the pulp cavity 11, canals 13, or other internal chambers of the tooth 10.

As explained herein, the clinician can supply the obturation material 45 to the treatment region (e.g., the root canal) in any suitable manner. For example, in some embodiments, the pressure wave generator 5 (which can be coupled to or formed with a handpiece) can have one or more openings configured to deliver the flowable obturation material 45 to the tooth 10. In other embodiments, the clinician can supply the obturation material 45 to the tooth by manually placing it in the tooth 10, e.g., by hand, by syringe, or by a mechanical tool. In still other embodiments, a dental handpiece can include one or more supply lines that are configured to route the flowable obturation material 45 to the tooth 10. For example, as explained herein, one or multiple components of the obturation material 45 can be delivered to the treatment instrument 101 along the first and second fluid composition supply lines 112, 114 as described below. The obturation material 45 can be any suitable obturation material disclosed herein. In particular, the obturation material 45 can have a flowable state in which the obturation material 45 flows through the treatment region to fill the root canals 13 and/or pulp cavity 11. The obturation material 45 can have a hardened state in which the obturation material 45 solidifies after filling the treatment region.

Advantageously, the pressure wave generator 5 can be activated to enhance the obturation or filling procedure. For example, the pressure wave generator 5 can be activated to assist in flowing the obturation material 45 throughout the treatment region to be filled. The pressure wave generator 45 can thereby assist in substantially filling the tooth 10. As shown in inset 50 of FIG. 1B, for example, when activated, the pressure wave generator 5 can cause the obturation material 45 to flow into major canal spaces 51 of the tooth 10, as well as into small spaces 53 of the tooth 10. Thus, the system 1 shown in FIG. 1B can assist in filling even small cracks, tubules, and other tiny spaces (e.g., the small spaces 53) of the tooth 10. By filling the small spaces 53 of the tooth, the system 1 can ensure a more robust obturation procedure which results in long-term health benefits for the patient. As explained herein, the pressure waves 23 and/or fluid motion 24 (which can include vortices 75) generated by the pressure wave generator 5 can interact with the obturation material 45 to assist in filling the small spaces 53 and the major spaces 51 of the tooth 10. Furthermore, in some embodiments, the pressure wave generator 5 can be activated to assist in curing or hardening the obturation material 45. For example, as explained herein, some types of obturation materials can cure or harden (or the curing or hardening can be enhanced) when agitated by pressure waves 23 generated by the pressure wave generator 5. In addition, in various embodiments, the obturation or filling material can be degassed, which can help deliver the obturation material to small spaces of the tooth. Accordingly, the pressure wave generator 5 can enhance the obturation procedure in a variety of ways.

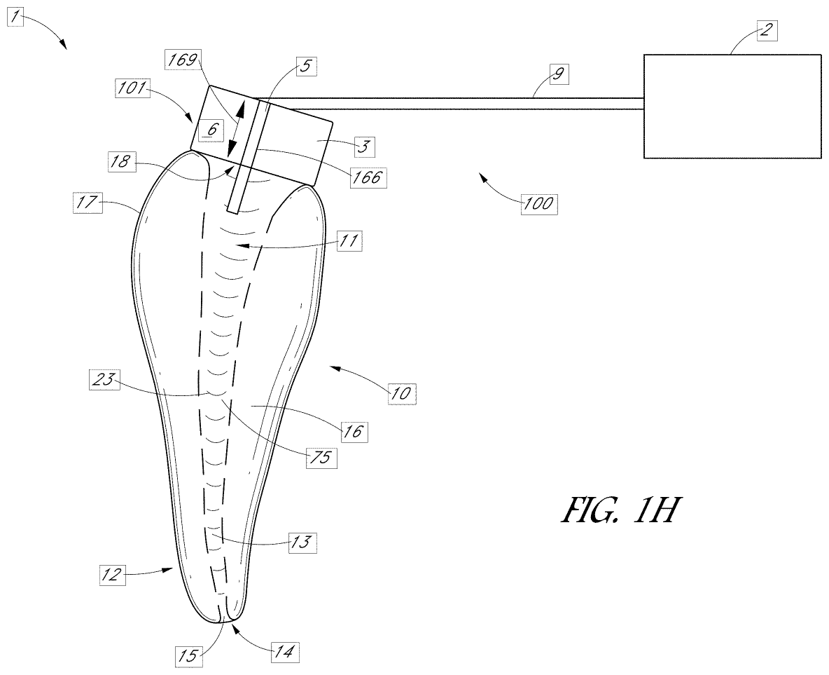

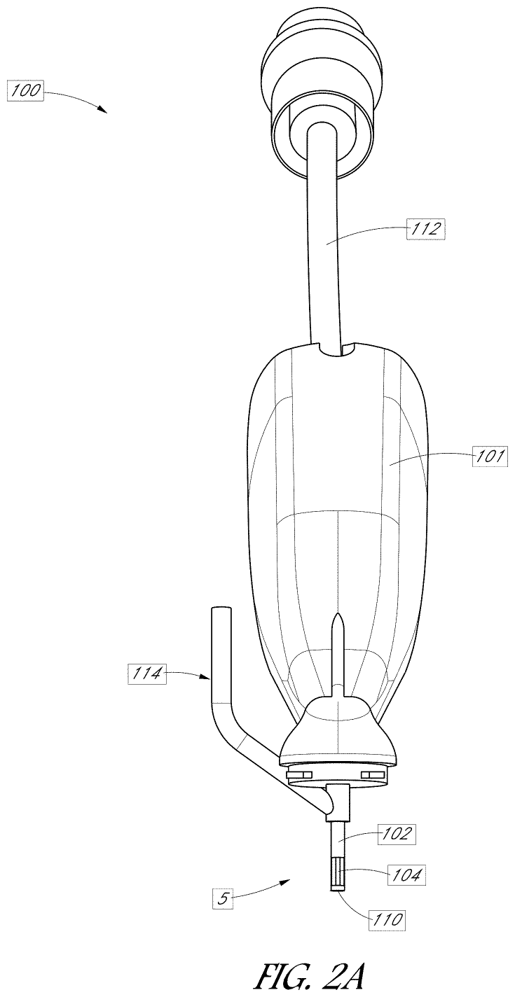

In some embodiments, the obturation material 45 is supplied to the tooth 10, and the pressure wave generator 5 is subsequently activated to enhance the obturation procedure (e.g., to improve the filling process and/or to enhance or activate the curing process). For example, in such embodiments, the clinician can supply the obturation material 45 to the tooth 10 using a syringe or other device, and the pressure wave generator 5 can subsequently (or concurrently) be activated to fill the treatment region. In other embodiments, the pressure wave generator 5 can supply the obturation material 45 and generate pressure waves through the obturation material (or other fluids at the treatment region). In some embodiments, supplying the obturation material and generating pressure waves can occur substantially simultaneously, or can overlap by some amount over time. For example, the pressure wave generator 5 can be activated to supply the obturation material 45 to the treatment region. For example, in embodiments in which the pressure wave generator 5 comprises a liquid jet, a jet of obturation material 45 can interact with fluids in the tooth 10 (e.g., other portions of the obturation material or other treatment fluid) to generate pressure waves that propagate through the fluids. The resulting pressure waves can enhance the obturation procedure. In various embodiments, the pressure waves can have a broadband spectrum of multiple frequencies, which can further enhance the filling of the treatment region. Additional details regarding the generation of broadband pressure waves is shown and described at least in FIGS. 2A-2C, and the associated disclosure, of U.S. Pat. No. 9,877,801, the entire contents of which are incorporated by reference in their entirety and for all purposes. In other embodiments, different types of fluids (e.g., water or other treatment fluids) can form the jet, and the jet can pass through obturation materials in the treatment region. Interaction of the fluid jet and the obturation material can enhance the obturation procedure. As explained herein, the filling or obturation material 45 can comprise a multi-component material including at least a first composition and a second composition. The first and second compositions can be combined to form the filling or obturation material 45.

As disclosed herein, the pressure wave generator 5 can comprise any suitable type of pressure wave generator, e.g., a liquid jet device, a laser, a mechanical stirrer, an ultrasonic transducer, etc. The pressure wave generator 5 can be sized such that the pressure wave generator 5 is disposed outside the region of the tooth 10 that is to be obturated. For example, the pressure wave generator 5 can be disposed in the chamber 6 such that it is disposed outside the tooth 10, for example, as shown in FIG. 1A. In other arrangements, the pressure wave generator 5 can extend partially into the tooth 10 as shown in FIG. 1B. In some arrangements, the pressure wave generator 5 can extend to a depth that does not interfere with the filling. The system 1 can include a cleaning mode for cleaning the treatment region and a filling mode to fill or obturate the treatment region. The console 2 can include a control system comprising a processor and memory. The control system can be programmed or configured to switch the system 1 from the cleaning mode to the filling mode and vice versa. The control system of the console 2 can also control the operation of cleaning and/or filling procedures. Additional details of the delivery device shown in FIG. 1B can be found throughout U.S. Pat. No. 9,877,801, the entire contents of which are incorporated herein by reference and particularly for the purpose of describing such details.

FIG. 1C is a schematic diagram of a system 1 that includes components configured to clean unhealthy or undesirable material from a treatment region 20 on an exterior surface of the tooth 10. For example, as in FIGS. 1A-1B, the system 1 can include a fluid platform 3 and a pressure wave generator 5. The fluid platform 3 can communicate with a console 2 by way a system interface member 4. Unlike the system 1 illustrated of FIG. 1B, however, the fluid platform 3 is coupled to (e.g., positioned against by a clinician) a treatment region 20 on an exterior surface of the tooth 10. In some embodiments, the fluid platform 3 can be stably positioned against the treatment region and can be sealed to the tooth 10, e.g., by way of an adhesive or other seal. The system 1 of FIG. 1C can be activated to clean an exterior surface of the tooth 10, e.g., a carious region of the tooth 10 and/or remove undesirable dental deposits, such as plaque, calculus biofilms, bacteria, etc, from the tooth 10 and/or surround gum tissue. In other embodiments (see FIG. 1D), the system 1 can be activated to fill a treated region on the exterior surface of the tooth 10 with a filling or restoration material. In still other embodiments, as explained herein, the system 1 can be used to coat and/or remineralize the treatment region 20. As with the embodiment of FIG. 1B, pressure waves 23 and/or fluid motion 24 can be generated in the fluid platform 3 and chamber 6, which can act to clean the treatment region 20 of the tooth 10, forming a cleaned treatment region 20A in which the carious (or other unhealthy material) is removed. Additional details of systems and methods for treating carious regions of teeth can be found in US 2015/0044632, filed Sep. 19, 2014, entitled “APPARATUS AND METHODS FOR CLEANING TEETH,” the entire contents of which are incorporated by reference herein in their entirety and for all purposes. Additional details of systems and methods for removing undesirable dental deposits (such as plaque, calculus, etc.) from teeth and/or gums can be found in U.S. Patent Publication No. US 2014/0099597, filed Apr. 11, 2013, entitled “APPARATUS AND METHODS FOR CLEANING TEETH AND GINGIVAL POCKETS,” each of which is incorporated by reference herein in its entirety and for all purposes.

FIG. 1D is a schematic diagram of the system 1 of FIG. 1C, in which the system 1 is configured to fill the treated carious region 20A of the tooth 10, and can be used in combination with any of the filling materials disclosed herein. As with the embodiment of FIG. 1C, the system 1 can include a pressure wave generator 5, a fluid platform 3, an interface member 4, and a console 2. When the carious or other unhealthy material is removed from the tooth 10, the clinician can fill the cleaned treatment region 20A with a suitable filling material 45. As with the embodiment of FIG. 1B, the filling material 45 can be supplied to the cleaned treatment region 20A. The pressure wave generator 5 can act to substantially fill the treatment region 20A and/or to enhance or activate the hardening of the filling material 45. In some embodiments, the filling material 45 is supplied to the tooth 10, and the pressure wave generator 5 is subsequently activated to enhance the filling procedure (e.g., to improve the filling process and/or to enhance or activate the curing process). For example, in such embodiments, the clinician can supply the filling material 45 to the treatment region 20A using a syringe, and the pressure wave generator 5 can subsequently be activated to fill the treatment region. In other embodiments, the pressure wave generator 5 is activated to supply the filling 45 to the treatment region 20A and to generate pressure waves through the material. For example, in embodiments in which the pressure wave generator 5 comprises a liquid jet, a jet of filling material 45 (or other type of fluid) can interact with fluids at the treatment region 20A (e.g., other portions of the filler or obturation material or other treatment fluid) to generate pressure waves that propagates through the fluids. The resulting pressure waves can enhance the filling procedure. The embodiment of FIG. 1D can be used in other procedures as well, including, e.g., coating or remineralization procedures.

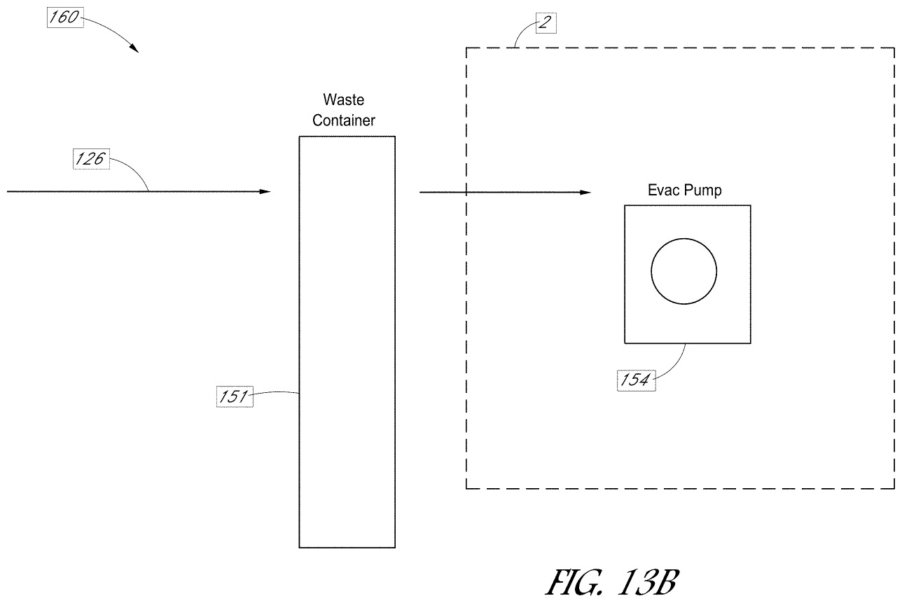

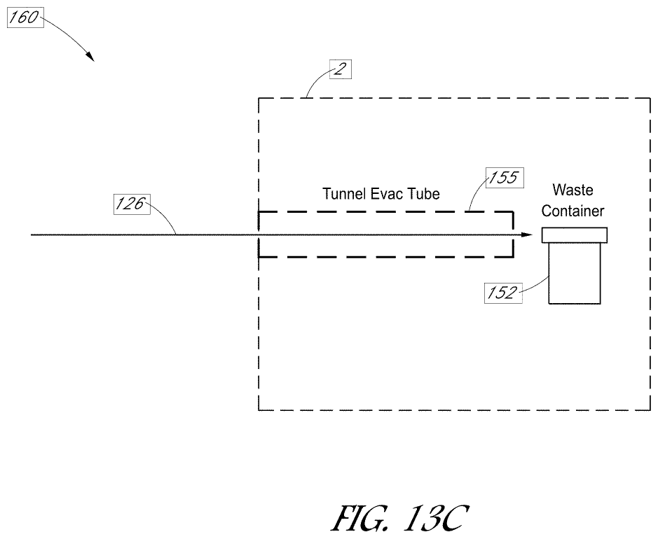

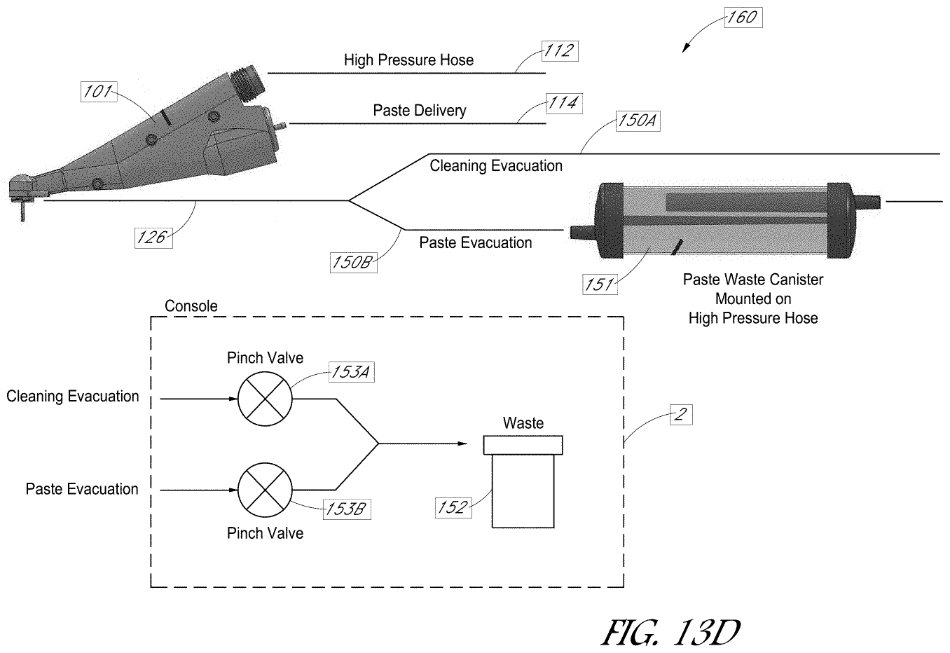

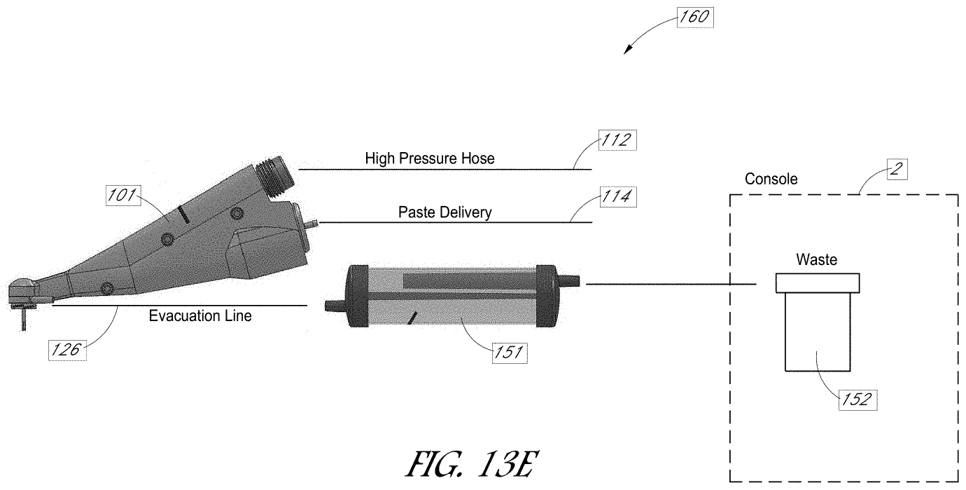

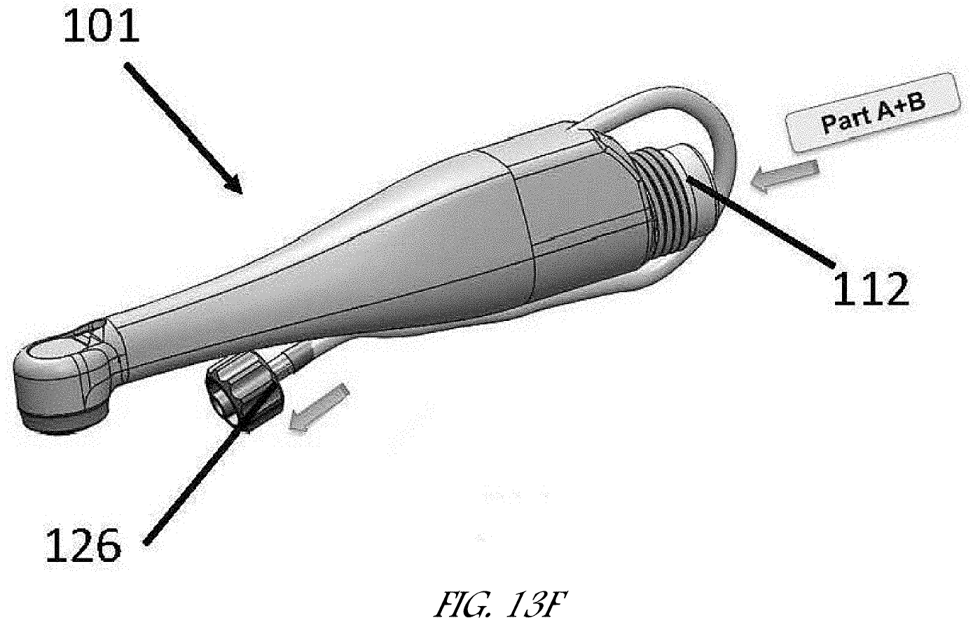

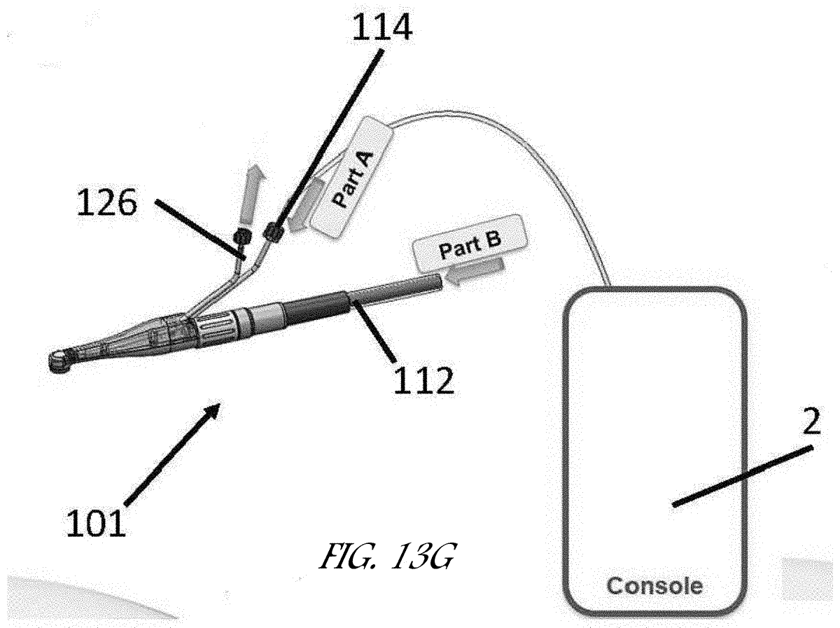

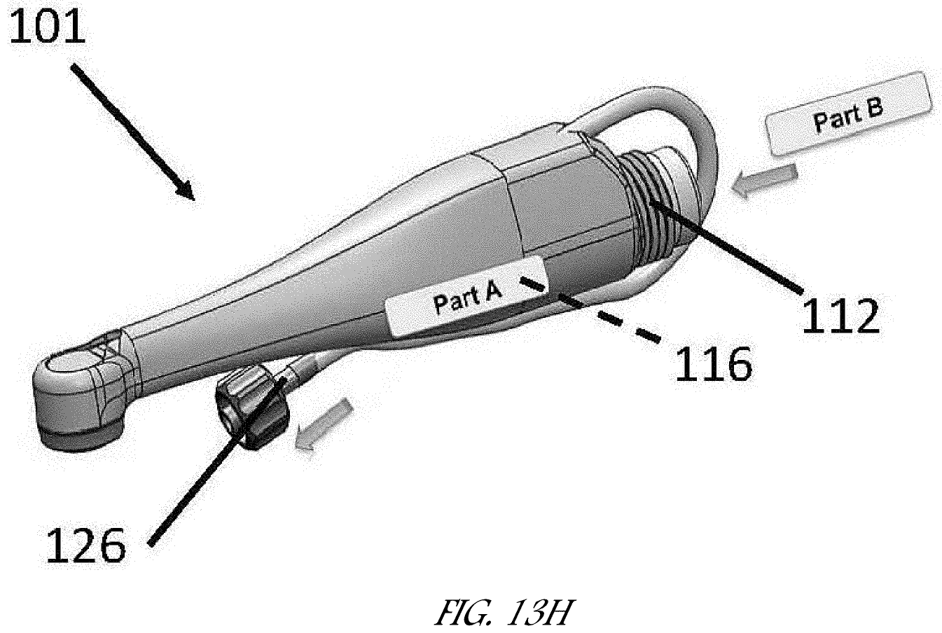

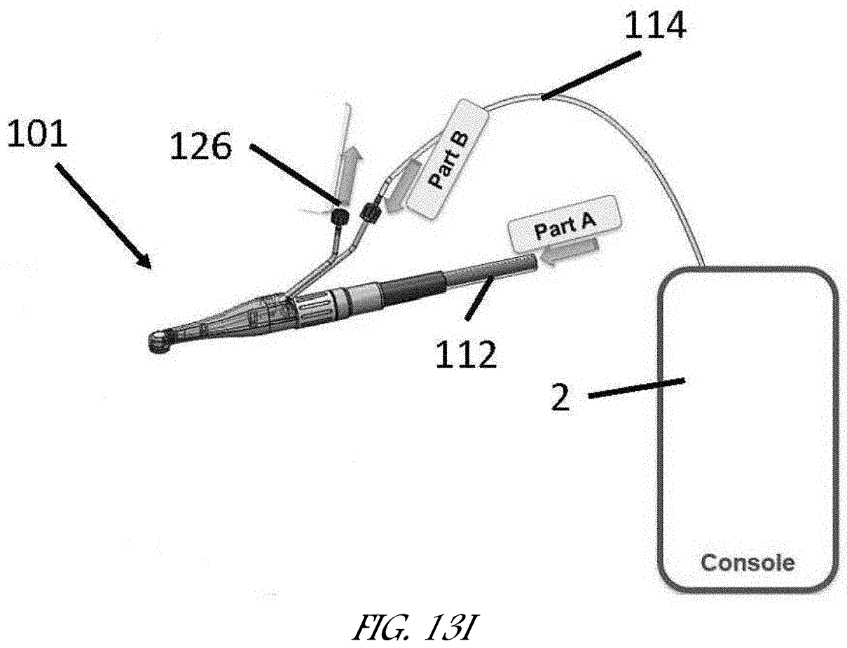

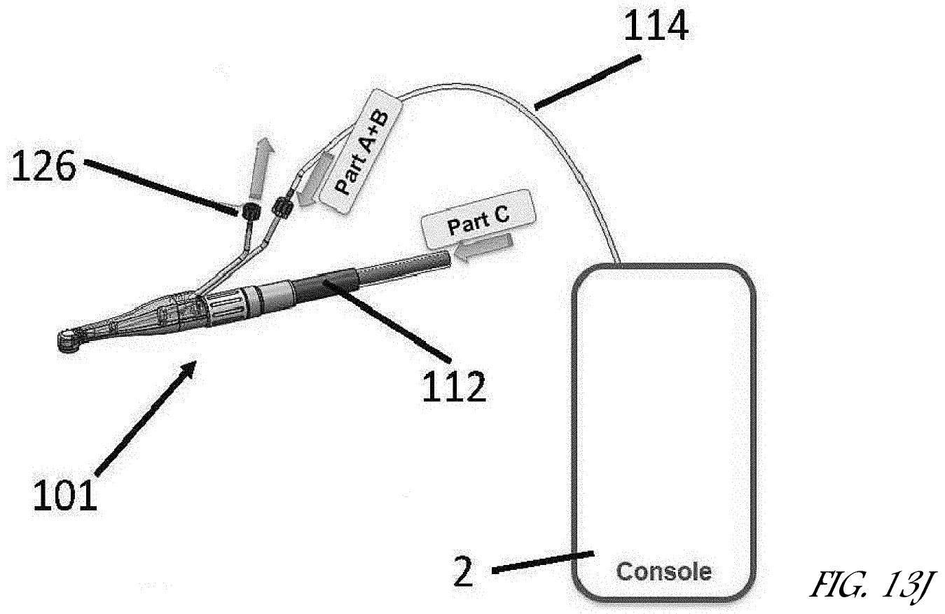

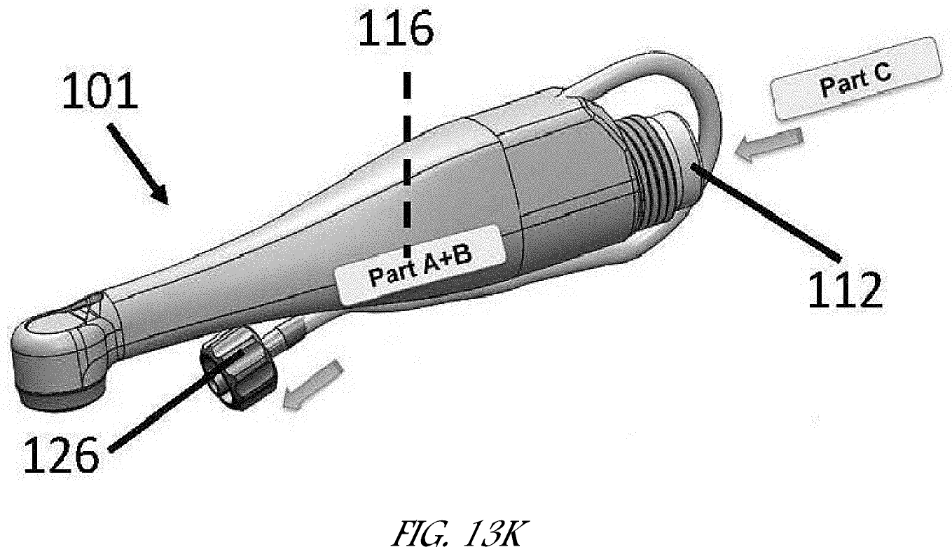

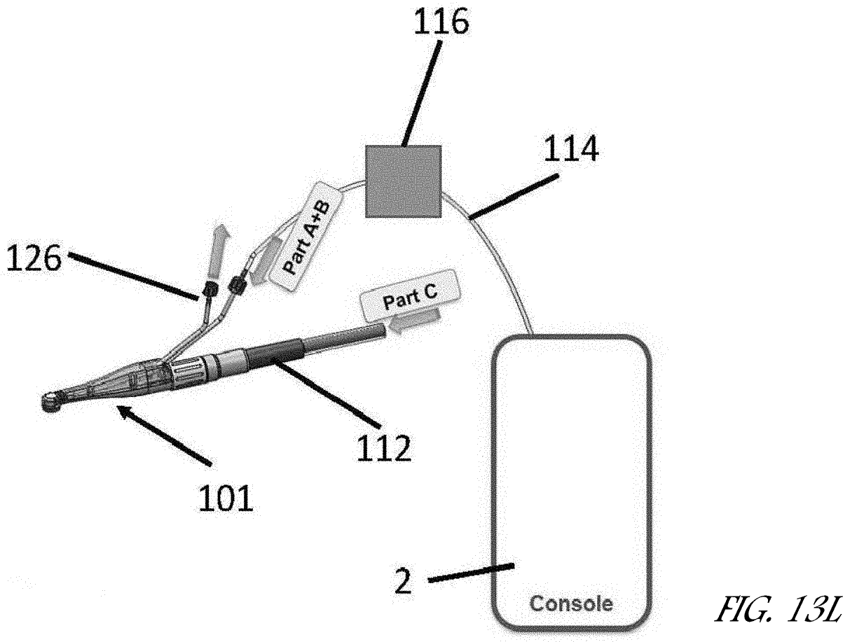

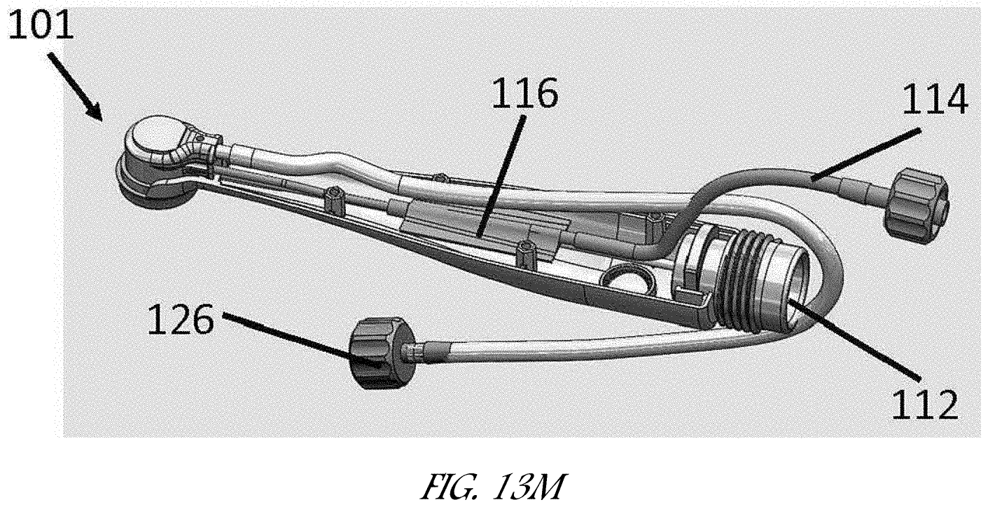

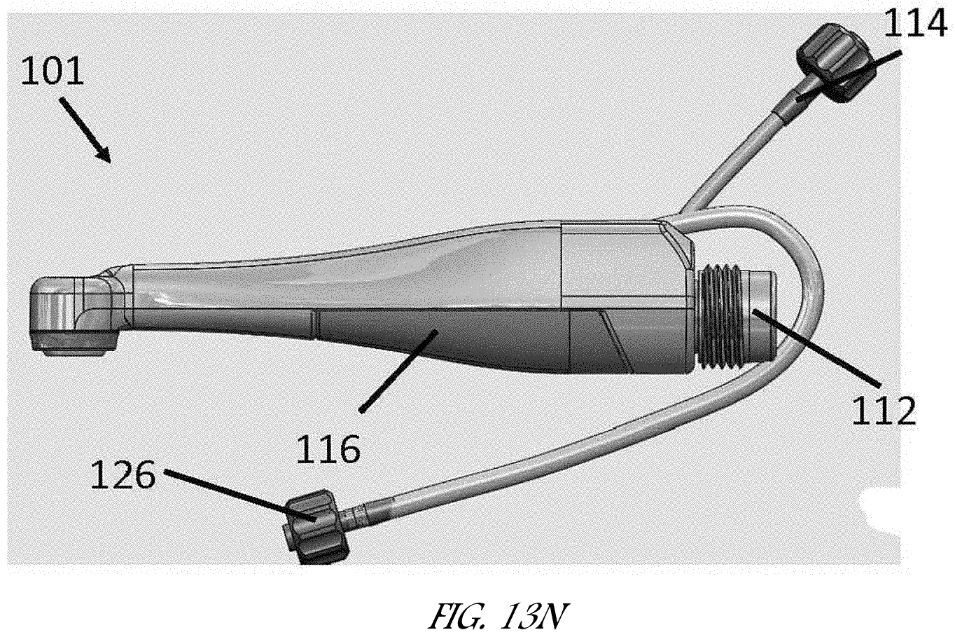

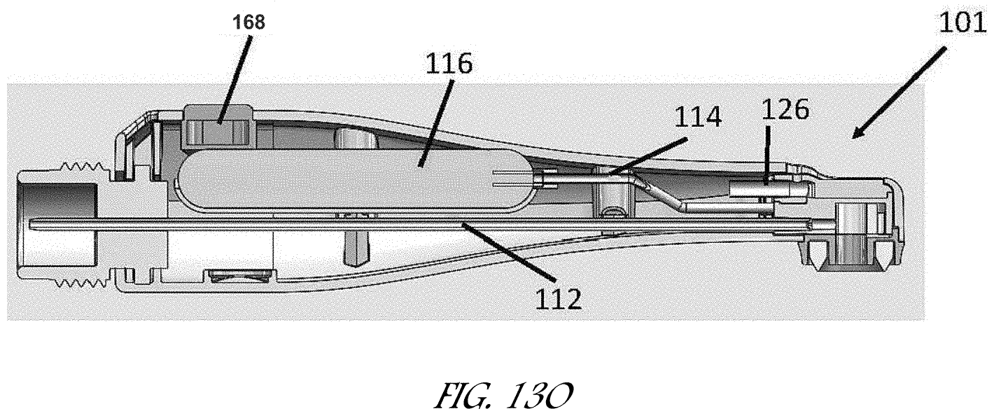

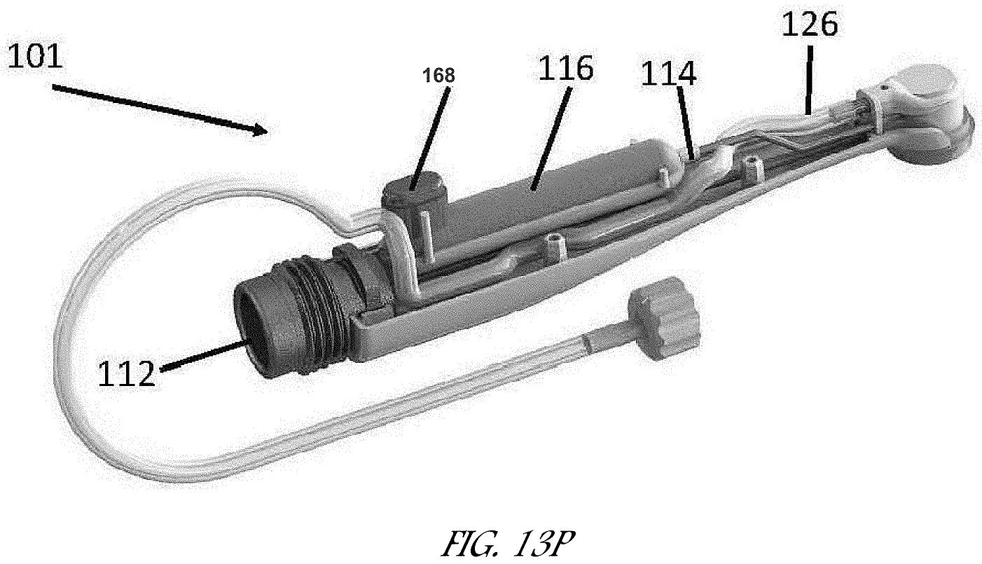

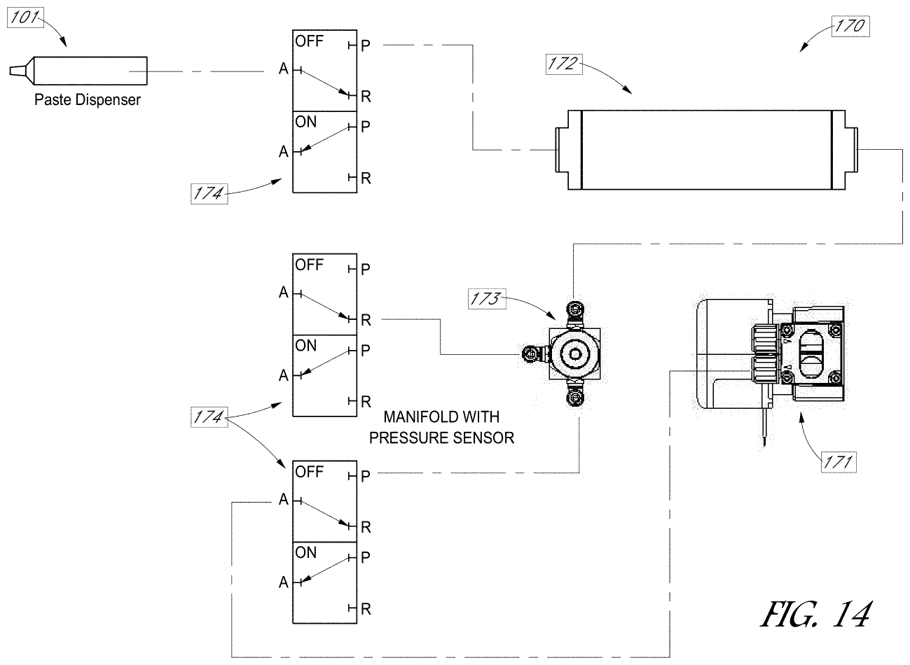

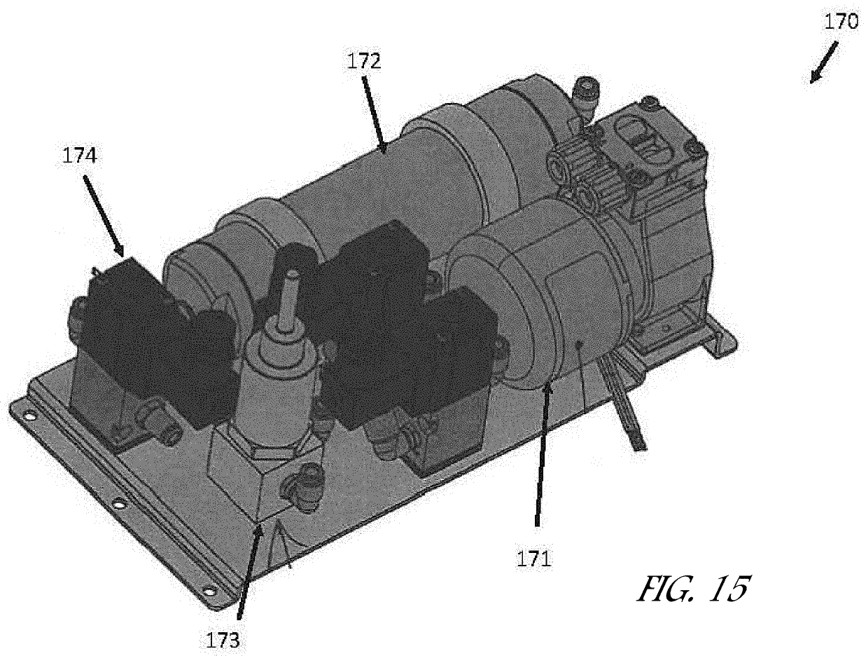

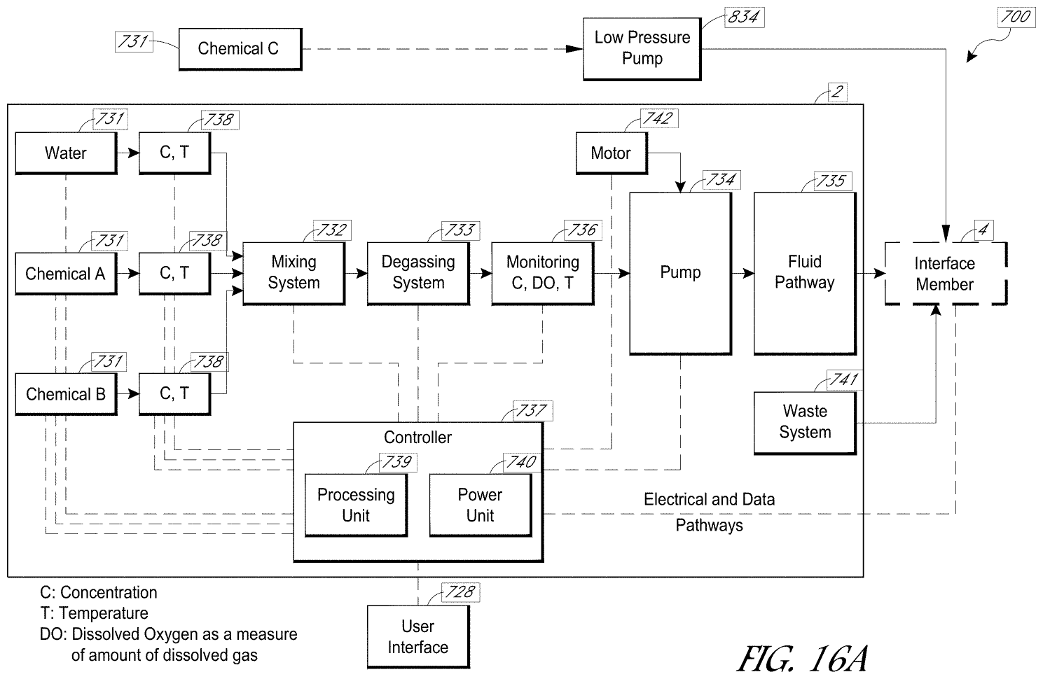

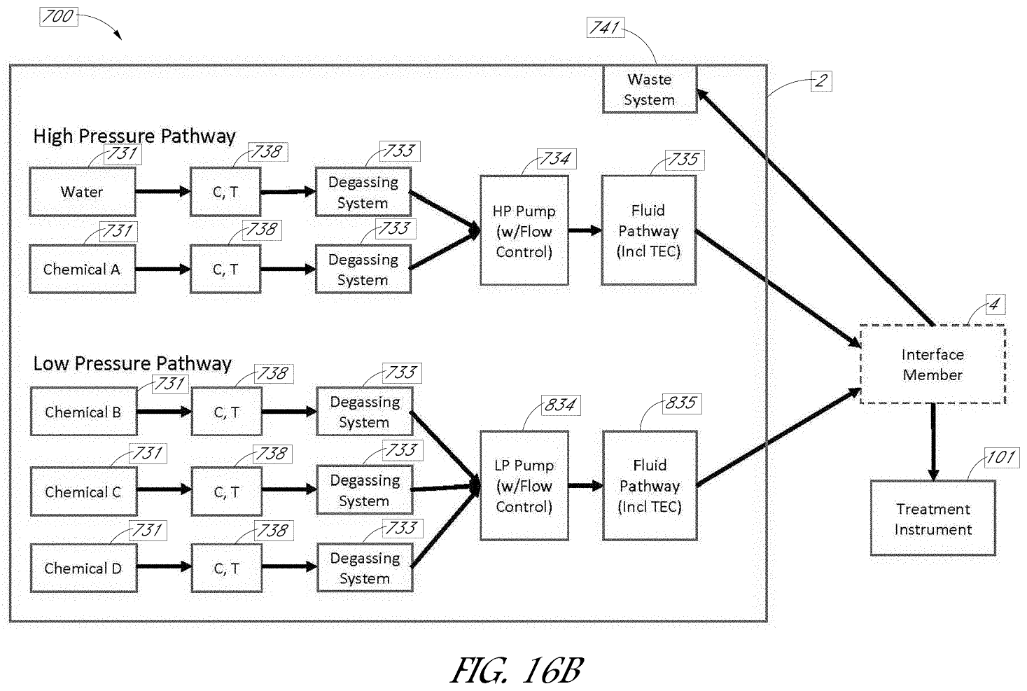

The pressure wave generators 5 disclosed herein can generate pressure waves having a broadband acoustic spectrum with multiple frequencies. The pressure wave generator 5 can generate a broadband power spectrum of acoustic power with significant power extending from about 1 Hz to about 1000 kHz, including, e.g., significant power in a range of about 1 kHz to about 1000 kHz (e.g., the bandwidth can be about 1000 kHz). The bandwidth of the acoustic energy spectrum may, in some cases, be measured in terms of the 3-decibel (3-dB) bandwidth (e.g., the full-width at half-maximum or FWHM of the acoustic power spectrum). In various examples, a broadband acoustic power spectrum can include significant power in a bandwidth in a range from about 1 Hz to about 500 kHz, in a range from about 1 kHz to about 500 kHz, in a range from about 10 kHz to about 100 kHz, or some other range of frequencies. In some implementations, a broadband spectrum can include acoustic power above about 1 MHz. Beneficially, a broadband spectrum of acoustic power can produce a relatively broad range of bubble sizes in the cavitation cloud and on the surfaces on the tooth, and the implosion of these bubbles may be more effective at disrupting tissue than bubbles having a narrow size range. Relatively broadband acoustic power may also allow acoustic energy to work on a range of length scales, e.g., from the cellular scale up to the tissue scale. Accordingly, pressure wave generators that produce a broadband acoustic power spectrum (e.g., some embodiments of a liquid jet) can be more effective at tooth cleaning, coating, remineralization, and filling for some treatments than pressure wave generators that produce a narrowband acoustic power spectrum. Additional examples of pressure wave generators that produce broadband acoustic power are described in FIGS. 2A-2B-2 and the associated disclosure of U.S. Pat. No. 9,675,426, and in FIGS. 13A-14 and the associated disclosure of U.S. Pat. No. 10,098,717, the entire contents of each of which are hereby incorporated by reference herein in their entirety and for all purposes.

The dental treatments disclosed herein can be used with any suitable type of treatment fluid, e.g., cleaning fluids. In filling procedures, the treatment fluid can comprise a flowable filling material that can be hardened to fill the treatment region. The treatment fluids disclosed herein can be any suitable fluid, including, e.g., water, saline, etc. In some embodiments, the treatment fluid can be degassed, which may improve cavitation and/or reduce the presence of gas bubbles in some treatments. In some embodiments, the dissolved gas content can be less than about 1% by volume. Various chemicals can be added to treatment solution, including, e.g., tissue dissolving agents (e.g., NaOCl), disinfectants (e.g., chlorhexidine), anesthesia, fluoride therapy agents, EDTA, citric acid, and any other suitable chemicals. For example, any other antibacterial, decalcifying, disinfecting, mineralizing, or whitening solutions may be used as well. Various solutions may be used in combination at the same time or sequentially at suitable concentrations. In some embodiments, chemicals and the concentrations of the chemicals can be varied throughout the procedure by the clinician and/or by the system to improve patient outcomes. The pressure waves 23 and fluid motion 24 generated by the pressure wave generator 5 can beneficially improve the efficacy of cleaning by inducing low-frequency bulk fluid motion and/or higher-frequency acoustic waves that can remove undesirable materials throughout the treatment region.

In some systems and methods, the treatment fluids used with the system 1 can comprise degassed fluids having a dissolved gas content that is reduced when compared to the normal gas content of the fluid. The use of degassed treatment fluids can beneficially improve cleaning efficacy, since the presence of bubbles in the fluid may impede the propagation of acoustic energy and reduce the effectiveness of cleaning. In some embodiments, the degassed fluid has a dissolved gas content that is reduced to approximately 10%-40% of its normal amount as delivered from a source of fluid (e.g., before degassing). In other embodiments, the dissolved gas content of the degassed fluid can be reduced to approximately 5%-50% or 1%-70% of the normal gas content of the fluid. In some treatments, the dissolved gas content can be less than about 70%, less than about 50%, less than about 40%, less than about 30%, less than about 20%, less than about 10%, less than about 5%, or less than about 1% of the normal gas amount. In some embodiments, the degassed fluids may be exposed to a specific type of gas, such as ozone, and carry some of the gas (e.g., ozone) with them into the treatment region, for example, in the form of gas bubbles. At the treatment region, the gas bubbles expose the treatment region to the gas (e.g., ozone) for further disinfection of the region. Additional details regarding the use of degassed treatment liquids may be found in U.S. Pat. No. 9,675,426, which is incorporated by reference herein in its entirety and for all purposes.

### II. Examples of Treatment Instruments with Removable Tip Devices

FIG. 1E is a schematic diagram of a dental treatment instrument 101 having a removable tip device 211, according to various embodiments. The dental treatment instrument 101 of FIG. 1E can utilize a removable tip device 211 with any of the embodiments disclosed herein. Additional examples of treatment instruments with removable tip devices may be found throughout U.S. patent application Ser. No. 16/879,093 (“the '093 Application”), filed May 20, 2020, the entire contents of which are incorporated by reference in their entirety and for all purposes. The treatment instruments 101 and devices shown herein can be used with any of the removable tip devices described in the '093 Application.

Unless otherwise noted, components of FIG. 1E may be same as or generally similar to like-numbered components of FIGS. 1A-1D. The dental treatment instrument 101 can include a tip device 211 and a handpiece 212 having a handpiece body 212a. The tip device 211 can be removably connected to a distal portion of the handpiece body 212a. In various embodiments, the handpiece body 212a can include a connector 225 that removably connects the handpiece body 212a to the tip device 211. The tip device 211 can include a connector 226 that removably connects the tip device 211 to the handpiece body 212a. The connector 225 can couple with the connector 226 to removably couple the tip device 211 to the handpiece body 212a. The tip device 211 can be configured to be positioned against or over a treatment region to treat the tooth (e.g., to clean, coat, remineralize, and/or fill the treatment region of the tooth).

In some embodiments, the connector 225 can include external threads to engage corresponding internal threads of the connector 226. In some embodiments, the connector 225 can include internal threads to engage corresponding external threads of the connector 226. In some embodiments, the connector 225 can include a plurality of protrusions to engage a plurality of receptacles of the connector 226. In some embodiments, the connector 225 can include a plurality of protrusions extending from a radial wall to engage to engage a plurality of receptacles of the connector 226.

In some embodiments, the connector 225 can couple to the connector 226 via a quick connect coupling. In some embodiments, the quick connect coupling includes a plurality of retractable ball bearings. In some embodiments, the quick connect coupling includes a sliding collar. In some embodiments, a sliding collar on one of the connectors 225 or 226 can slide along an axis of connection allowing ball bearings to retract. When the collar is slid forward, the ball bearings can be pushed into features on the other connector 225 or 226 to thereby prevent detachment of the disposable tip. In some embodiments, the quick connect coupling can be implemented with an active connector (e.g., collar with ball bearings) or a passive connector (e.g., a fixed geometry which interfaces with the bearings) on the handpiece body 212a. In some embodiments, the handpiece body 212a can beneficially include the passive connector to facilitate effective decontamination and sterilization.

In some embodiments, the connector 225 can couple to the connector 226 via a snap fitting. Either the connector 225 or the connector 226 can include one or more snap features which can be depressed by pressing or squeezing the feature. Complementary mating components on the other connector 225 or 226 can include features or undercuts to which the snap features engage.

In some embodiments, the connector 226 can include internal threads to engage corresponding external threads of the connector 225. In some embodiments, the connector 226 can include external threads to engage corresponding internal threads of the connector 225. In some embodiments, the connector 226 can include a plurality of receptacles to engage corresponding protrusions the connector 225. In some embodiments, the connector 226 can include a plurality of receptacles to engage corresponding protrusions extending from a radial wall of the connector 225. In some embodiments, the connector 226 includes a plurality of protrusions to engage corresponding receptacles of the connector 225.

In various embodiments, therefore, the tip device 211 can be connected to the handpiece body 212a before a treatment procedure. After the tip device 211 is connected to the handpiece body 212a, a clinician can conduct a treatment procedure, such as a cleaning procedure. After the treatment procedure, the clinician can remove the treatment tip device 11 from the handpiece body 212a.

In various embodiments, the handpiece body 212a can be used in multiple procedures, e.g., a predetermined number of procedures. In various embodiments, the handpiece body 212a can be configured to connect to multiple tip devices 211. In some embodiments, the handpiece body 212a can be configured to connect to multiple tip devices 211 having the same configuration. In other embodiments, the handpiece body 212a can be configured to connect to multiple tip devices 211 having different configurations. For example, in some embodiments, the handpiece body 212a can connect to multiple tip devices 211 configured for treatment of different types of teeth, e.g., a first tip device for treatment of a molar tooth and a second tip device for treatment of an anterior or pre-molar tooth. In some embodiments, the handpiece body 212a can connect to multiple tip devices configured for treatment of different types of treatment regions, e.g., a first tip device for treatment of a root canal and a second tip device for treatment of an external carious region. In still other embodiments, the handpiece body 212a can connect to multiple tip devices for different types of treatment procedures, e.g., a first tip device for a cleaning treatment, a second tip device for a filling procedure, a third tip for a coating procedure, etc.

In various embodiments, the tip device 211 can be disposable. Beneficially, providing a disposable tip device 211 in conjunction with a generally reusable handpiece body 212a can enable the clinician to reduce costs associated with disposing the handpiece body 212a after a single use. The tip device 211 can be used with any of the fluid platforms 3 and pressure wave generators 5 disclosed herein. For example, the tip device 211 can include fluid platforms 3 that include a pressure wave generator 5, a suction port 8, and a vent 7. In some embodiments, the tip device 211 can comprise the supply pathway 69 disclosed herein.

The handpiece body 212a can include a conduit 205a configured to be in communication with a conduit 205b of the tip device 211 to form a fluid inlet line 205 when the handpiece body 212a is coupled to the tip device 211. Although only one fluid inlet line 205 is shown in FIG. 1E, as explained herein, multiple fluid inlet or fluid composition supply lines can be provided in the handpiece 212 and tip device 211. The fluid inlet line 205 can serve as the first fluid composition supply line 112 described below. Additional fluid inlet lines can be provided to serve as the second fluid composition supply line 114 described below.

In some embodiments, the line 205 can be coupled to the pressure wave generator 5. In some embodiments, the line 205 can be a fluid inflow line or fluid inlet line (also referred to herein as a fluid composition supply line). For example, in embodiments in which the pressure wave generator 5 includes a liquid jet device, the line 205 can deliver fluid to the liquid jet device. Additional composition supply lines can be provided as explained herein.

In various embodiments, the tip device 211 can include one or more fluid outlets or suction ports 8 to convey fluid from the chamber 6. The suction port(s) 8 can be in communication with a suction pump (which, for example, may be located in the console). When the suction pump is active, liquid can be drawn out of the chamber 6, through the suction port(s) 8 and to an outlet line 204, which can convey the removed liquid to a waste container, which may be located in the console for example. The fluid outlet line 204 may be arranged in a similar manner to the fluid outlet line 126 described herein.

In some embodiments, the handpiece body 212a can include a conduit 204a configured to be in communication with a conduit 204b of the tip device 211 to form outlet line 204 when the handpiece body 212a is coupled to the tip device 211. The line 204 can be coupled to the suction port(s) 8 to form the fluid outlet line 204.

In various embodiments, the tip device 211 can include one or more vents 7 configured to permit ambient air to be drawn into the line 204 downstream of the suction port(s) 8. The vent(s) 7 can beneficially provide a pressure regulation function, as explained in, e.g., U.S. Pat. Nos. 9,675,426, 10,363,120, and U.S. Publication No. 2015/0044632, the entire contents of each of which are incorporated by reference herein in their entirety and for all purposes.

In various embodiments, the handpiece body 212a can include one or more seals 224. The seals 224 can provide a fluid seal between the handpiece body 212a and the tip device 211. In some embodiments, the one or more seals 224 can include one or more O-rings. In some embodiments, the one or more seals 224 can include one or more face seals. In some embodiments, the one or more seals 224 can include one or more elastomeric sleeves.

In various embodiments, the dental treatment instrument 101 can include a locking mechanism 231 for removably securing the distal tip device 211 in a fixed orientation relative to the handpiece body 212a. In certain embodiments, the tip device 211 can include a locking member 229 configured to couple with a corresponding locking member 230 of the handpiece body 212a to secure the distal tip device 211 in a fixed orientation relative to the handpiece body 212a. In some embodiments, the locking member 230 can be coupled to or part of the connector 225. In some embodiments, the locking member 229 can be coupled to or part of the connector 226.

In some embodiments, the locking member 230 can include one or more protrusions positioned to be received in one or more recesses of the locking member 229. In some embodiments, the protrusions can be hemispherical protrusions. In some embodiments, the locking member 229 can include one or more protrusions positioned to be received in one or more recesses of the locking member 230. In some embodiments, the protrusions can be hemispherical protrusions. In some embodiments, the locking member 229 can include a sliding lock positioned to be received in a slot of the locking member 230. In some embodiments, the locking member 230 can include a sliding lock positioned to be received in a slot of the locking member 229. In some embodiments, the locking mechanism 231 can include one or more ball detents configured to secure the tip device 211 in a fixed orientation relative to the handpiece body 212a.

In some embodiments, the connection between the connectors 225 and 226 can be capable of withstanding pressures of at least 10,200 psi, and at least 15,000 psi. In some embodiments, a connection between the connectors 225 and 226 can be sufficiently secure so as to not unthread, or otherwise detach on its own, while the inlet 205 is pressurized. In other embodiments, for example, in some embodiments in which the connectors 225 and 226 are threads, the locking mechanism 231 may be employed to limit or prevent the ability of the connectors 225 and 226 from detaching. In some embodiments, the connectors 225 and 226 and seals 224 can be designed so that the seal is breached prior to full detachment of the tip device 211. Such a mechanism can ensure that in the event of a clog or occlusion, stored pressure within the line 205 is released prior to full mechanical detachment of the tip device 211.

In some embodiments, the tip device 211 can include a tracking mechanism or communication device 219 storing a unique identified associated with the tip device 11. The communication device can be one or more of a radio-frequency identification tag (RFID), a barcode, a quick response (QR) code or an electrically erasable programmable read-only memory (EEPROM). As explained in U.S. Pat. No. 9,504,536, the entire contents of which are incorporated by reference herein in their entirety and for all purposes, the communications device 219 can wirelessly or otherwise communicate with a reader, which can comprise processing circuitry configured to monitor a status of the tip device 211 and/or the treatment procedure. In various embodiments, the system can be configured to ensure that only authorized tip devices 211 may be used with the handpiece body 212a. In various embodiments, the system can be configured to ensure that the tip device 211 is used in only a single procedure. In other embodiments, the system can be configured to determine in how many procedures the tip device 211 has been used. The communications device 219 can serve various other functions, including those described in connection with the RFID devices disclosed in U.S. Pat. No. 9,504,536, the entire contents of which are incorporated by reference herein in their entirety and for all purposes. Similarly, in certain embodiments, a handpiece body 212a can include a tracking mechanism or communications device, which can wirelessly or otherwise communicate with a reader, which can comprise processing circuitry configured to monitor a status of the handpiece body 212a and/or the treatment procedure. In certain embodiments, the communications device 219 can be writeable or programmable so as to provide data which allows the console to detect previous use of the tip device 211. In certain embodiments, the communications device 219 can be integrated into the tip device 211, into a protective cover for the tip device 211, or into the packaging of the tip device 211.

### III. Examples of Coating and Remineralization Treatments

Various embodiments disclosed herein can be used to apply a protective coating (e.g., a thin film or layer) over portions of a treatment region (including, for example, after cleaning), including treatment regions inside or outside the tooth. The coating can be applied with a coating agent so as to fill small cracks and spaces in the tooth, and can be applied over portions of the tooth to build up a coating or film over the treatment region. The coating can be applied over any suitable dental surface. For example, surfaces being coated can include organic surfaces or inorganic surfaces. The surfaces being coated can be any suitable shape, such as convex, concave, flat, or can define complex three-dimensional shapes. The surfaces to be coated can also be part of a cavity, e.g., a deep cavity or a shallow cavity. In various embodiments, the surfaces being coated can be surfaces of the root canal system of a tooth, the external surfaces of a tooth, surfaces of an exposed root structure, decayed or compromised structure of a tooth, demineralized tooth structure (e.g., demineralized enamel, demineralized dentin, etc.), gum tissue, periodontal pockets, and/or any other suitable surface of the tooth or portion thereof.

In other embodiments, the surfaces to be coated may comprise a portion of a device. For example, the device being coated may comprise a miniature device, e.g., a Micro-Electro-Mechanical Systems (MEMS) device. In some arrangements, the device being coated may comprise an implantable device, such as a stent. Thus, in some embodiments, the embodiments disclosed herein (e.g., pressure wave generators) can be used to coat non-dental surfaces, such as devices.

Various types of coating agents may be used with the embodiments disclosed herein. One example of a coating agent is a remineralization agent, which can be supplied to coat the portions of the treatment region to assist in remineralizing the tooth. In some embodiments, the treatment instrument 101 (which can comprise a pressure wave generator, such as a liquid jet device) can be used to remineralize the tooth and/or to coat portions of the tooth with a protective layer. For example, in some embodiments, the treatment instrument 101 can be disposed near a treatment region during or after a cleaning procedure (e.g., a root canal cleaning procedure, a caries cleaning procedure, etc.) and can be activated to supply a remineralization agent to the treatment region. In some embodiments, the treatment instrument 101 can comprise a pressure wave generator 5, such as a liquid jet device. As explained, the fluid platform 3 can comprise a chamber 6 that can be applied to the treatment region to retain treatment fluid. The pressure wave generator 5 can be activated to generate pressure waves and/or fluid motion through the fluid at the treatment region. The generated pressure waves and/or the fluid motion can cause the remineralization agent to flow throughout the portions of the treatment region that are in fluid communication with the pressure wave generator 5. For example, the multiple frequencies of the pressure waves and the fluid motion can cause the remineralization agent to spread into large and small spaces of the treatment region, including tiny spaces, cracks, tubules, and other locations that are remote from the pressure wave generator. In various arrangements, high frequency waves and fluid motion can cause the remineralization agent to reach tiny spaces, cracks, tubules, etc., while low frequency waves and fluid motion can cause the remineralization agent to be applied over the larger surfaces of the tooth. Advantageously, the embodiments herein can realize improved patient outcomes because the remineralization agent can be supplied to locations that are remote from the treatment instrument 101 that may otherwise become decayed or infected.

The embodiments disclosed herein can advantageously cause the remineralization agent to coat the dental surfaces throughout the treatment region. For example, in some embodiments, the pressure wave generator 5 can supply ionized coating agents (e.g., ionized remineralization agents), which can bond to dental surfaces, such as dentin, enamel, cementum, etc. The pressure wave generator 5 can be used to remineralize external surfaces and/or internal surfaces of the tooth. As one example, in some embodiments, the pressure wave generator 5 can comprise a liquid jet device. The liquid jet device can comprise a nozzle and a guide channel along which the jet passes. A reservoir can include an ionized coating or remineralization agent, which can comprise one or more chemicals that are ionized. The ionized coating or remineralization agent can be supplied to the liquid jet device, which can form the coating or remineralization agent into a liquid jet. As the coating or remineralization agent passes through fluid at the treatment region (e.g., which can be retained in a chamber 6), pressure waves can be generated, which can assist in causing the ionized coating or remineralization agent to coat the dentinal or enamel surfaces of the treatment region. When the coating or remineralization agent is coated on the treatment region, the resulting coating can act as a protective layer to prevent further decay and/or infection. In addition, as the remineralization agent interacts with the dental material (e.g., dentin, enamel, etc.) and causes it to remineralize, the health of the tooth structure can be improved.

In some embodiments, a coating or remineralization agent can be in a non-ionized state in a reservoir and can become ionized before delivery to the treatment region. Ionizing the coating or remineralization agent can be done in a variety of ways. For example, a remineralization agent can be supplied to the pressure wave generator 5 (e.g., a liquid jet device) prior to being ionized. The pressure wave generator 5 can be used to remineralize external surfaces and/or internal surfaces of the tooth. For example, the reservoir can supply non-ionized remineralization agent to the liquid jet device, and the liquid jet device can form the non-ionized remineralization agent into a coherent, collimated jet beam. As the remineralization agent is supplied to the treatment region, fluid can fill the treatment region (e.g., by way of a chamber 6 applied to the treatment region). The jet beam of non-ionized remineralization agent can pass through the relatively still or relatively stagnant fluid in the treatment region, and the interaction between the jet beam and the liquid filling the treatment region or chamber can cause the non-ionized remineralization agent to become ionized. Pressure waves and/or fluid motion generated by the jet beam passing through the liquid can also cause the resulting ionized remineralization agent to flow throughout the treatment region to coat at least portions of dental surfaces. The resulting coating can act as a protective layer to prevent further decay and/or infection. As the remineralization agent interacts with the dental material (e.g., dentin, enamel, etc.) and causes it to remineralize, the health of the tooth structure can be improved.

Any suitable coating agent can be used in conjunction with the pressure wave generator. As explained above, the coating agent can include a remineralization agent in some arrangements. For example, in some embodiments, the remineralization agent can comprise fluoride, calcium fluoride, calcium phosphate, or other solutions with Ca²⁺ and/or F⁻ ions.

In some embodiments, the coating agent can be degassed (e.g., substantially free of dissolved gases), which can enhance the ability of the coating agent to flow into small spaces of the tooth, such as tubules, cracks, etc. The degassed coating agent can have a dissolved oxygen content less than about 9 mg/L, less than about 7 mg/L, less than about 5 mg/L, less than about 3 mg/L, less than about 1 mg/L, or some other value. In some embodiments, the degassed coating agent has a dissolved gas content that is reduced to approximately 10%-40% of its “normal” amount as delivered from a source of fluid (e.g., before degassing). In other embodiments, the dissolved gas content of the degassed coating agent can be reduced to approximately 5%-50% or 1%-70% of the normal gas content of the coating agent. In some treatments, the dissolved gas content of the coating agent can be less than about 70%, less than about 50%, less than about 40%, less than about 30%, less than about 20%, less than about 10%, less than about 5%, or less than about 1% of the normal gas amount.

Other types of coating agents can include a solvent, which can be inorganic (e.g., aqueous solutions) or organic (e.g., inks, paints, etc.). In addition, the coating agent being deposited can contain solid particles. The coating agent can comprise a controlled release agent. The controlled release agent can be time-controlled in various embodiments, for example, in the treatment of periodontal pockets. For example, the controlled release agent can comprise a medication (such as an antibiotic) that can be released over time into the periodontal pockets. The controlled release agent can comprise a water soluble polymer, microcrystalline cellulose, glyceryl stearate, etc.

In various embodiments, the coating agent can include antimicrobial, antibiotic and/or antibacterial agents, such as chlorhexidine or oxycycline. The coating agent can have sealing properties which can be used to seal cracks or microcracks, tooth fractures, dentinal tubules, and/or the exposed surfaces of a tooth such as an exposed root. One example of a coating agent with such sealing properties is cyanoacrylate. The coating agent can also include a desensitization agent, which can be used to help numb or otherwise reduce pain or sensitivity. For example, the desensitizing properties of the desensitization agent can be used in the treatment of thermal sensitivity. The coating agent can comprise a lubricant or surface tension reducing agent which can make it easier to insert or apply the root canal filling material in root canal filling methods. The lubricant can be a fluoropolymer (e.g., polytetrafluoroethylene or PTFE) or silicone-based coatings in various embodiments. In some embodiments, the coating agent can comprise a priming agent (e.g., methacrylates). The priming agent can be used in the filling of root canal in order to promote bonding of the filling material to the tooth. The priming agent can also be used in the restoration of teeth to help the restoration material bond to the tooth.

The treatment instrument 101 used to supply the coating agent can be the same as or different from the treatment device used during the primary cleaning procedure to clean the treatment region (e.g., the root canal, carious region, etc.). In some embodiments, the treatment device used to coat and/or remineralize the treatment region can also be activated to remove biofilms and/or other deposits from the treatment region prior to supplying the coating or remineralization agent. In some embodiments, the same treatment instrument 101 can be used during the primary cleaning procedure to clean the treatment region (e.g., the root canal, carious region, etc.) of diseased materials and biofilms and, after the primary cleaning procedure, to apply a protective coating and/or to provide a remineralization agent to the treatment region.

FIG. 1F illustrates a system 1 configured to coat and/or remineralize a portion of an exterior surface of the tooth 10. In some embodiments, the system 1 shown in FIG. 1F can clean a carious region 19 or undesirable dental deposits (such as plaque, calculus, biofilms, etc.) prior to coating and/or remineralizing the treatment region. In other embodiments, the system 1 can be configured to act in a standalone procedure to coat and/or remineralize the tooth 10. As with the embodiments disclosed above, the system 1 can include a console 2 and a treatment instrument 101 having a fluid platform 3 with a chamber 6 coupled with the console 2. The treatment device 6 can comprise any suitable treatment device, such as a pressure wave generator 5 (which may comprise a liquid jet device) coupled with the fluid platform 3, which may be coupled with a distal portion of a handpiece. In the arrangement of FIG. 1F, a tooth cap 22 can be disposed over a carious region 19 on a side surface of the tooth 10. For example, a distal end 21 of the tooth cap 22 can be attached or coupled to the side surface such that the tooth cap 22 encloses a portion of the tooth 10 that includes the carious region 19. In other embodiments, the tooth cap 22 can be positioned against the tooth 10 by the clinician. The pressure wave generator 5 can be disposed through an access aperture 26. In the illustrated embodiment, the pressure wave generator 5 comprises an elongate member extending out of the fluid platform 3 and chamber 6, but in other embodiments, the pressure wave generator 5 may be disposed in or in fluid communication with the chamber 6.

As shown in FIG. 1F, a sacrificial material 130 can be applied over the carious region 19 (or other region to be treated). A coupling material 30 (such as an impression material) can be supplied around the sacrificial material 130 between the sacrificial material 130 and the tooth cap 22. The coupling material 30 can be used to stably support the tooth 10 and/or the treatment instrument 101 during a treatment procedure, and to prevent fluid from entering or leaving the treatment region during treatment. For example, in some embodiments, the coupling material 30 can comprise an adhesive.

In some embodiments, the pressure wave generator 5 can be activated to clean the carious region 19. Although the distal end of the pressure wave generator 5 is disposed inside the tooth cap 22 (e.g., in a chamber 28 of the tooth cap 22) in FIG. 1F, in other embodiments, the pressure wave generator 5 can be disposed outside the access aperture 26 and tooth cap 22. When activated, the pressure wave generator 5 can remove or break apart the sacrificial material 130 to expose the underlying carious region 19, without removing or damaging the coupling material 30. For example, in some embodiments, a calcium hydroxide paste can be used as the sacrificial material 130. Once the sacrificial material 130 is removed, the pressure waves and/or fluid motion generated by the pressure wave generator 5 can clean the carious region 19, as well as any biofilms that remain on the dental surfaces such as enamel.

In addition or alternatively, the system 1 of FIG. 1F can be used to apply a protective coating over and/or to remineralize the treatment region. In some embodiments, the coating and/or remineralization can be performed after cleaning a carious region or undesirable dental deposits (such as plaque, biofilms, etc.) from the tooth. In other embodiments, the coating and/or remineralization can be performed as a standalone procedure without additional cleaning. As explained above, a coating agent (e.g., a remineralization agent) can be supplied to the treatment region, and the pressure wave generator 5 (which may be the same as or different from the pressure wave generator 5 used to clean the tooth 10) can be activated. The generated pressure waves and/or fluid motion may cause the remineralization or coating agent to coat the treatment region and other regions of the tooth 10 in fluid communication with the pressure wave generator 5. The remineralization or coating agent can interact with the dental materials (e.g., dentin, enamel) to remineralize or otherwise improve the health of the tooth 10.

In some embodiments, the remineralization or coating agent may be ionized prior to being supplied by the tooth. In other embodiments, the remineralization agent may be non-ionized prior to being supplied to the tooth. In such embodiments, the non-ionized remineralization agent may be formed as a liquid jet and can pass through liquid that is retained at the treatment region. As the jet passes through the liquid in the treatment region, the remineralization agent can become ionized and can flow throughout the treatment region, including in small spaces, cracks, tubules, etc. The ionized agent can advantageously stick to the surfaces of the tooth to apply a protective coating over the tooth. The remineralization chemicals can interact with the tooth to enhance remineralization.

FIG. 1G illustrates a system 1 configured to coat and/or remineralize a portion of an interior surface of the tooth 10 and a portion of an exterior surface of the tooth 10. In some embodiments, the system 1 shown in FIG. 1G can clean the root canals 13 of the interior of the tooth 10 and/or a carious region 19 or undesirable dental deposits (such as plaque, calculus, biofilms, etc.) on the exterior of the tooth 10 prior to coating and/or remineralizing the treatment region. In other embodiments, the system 1 can be configured to act in a standalone procedure to coat and/or remineralize the tooth 10. As with the embodiments disclosed above, the system 1 can include a console 2 and a treatment instrument 101 coupled with the console 2. The treatment instrument 101 can comprise any suitable treatment device, such as a pressure wave generator 5 (which may comprise a liquid jet device) coupled with a fluid platform 3. In the arrangement of FIG. 1G, the tooth cap 22 can be disposed over the tooth 10 to be treated. For example, the distal end of the tooth cap 22 can be attached or coupled to the gum tissue such that the tooth cap 22 encloses the tooth 10 or a portion thereof. The pressure wave generator 5 can be disposed through the access aperture 26.

The system 1 shown in FIG. 1G can be used to clean interior portions of the tooth 10, as well as exterior portions of the tooth 10. For example, the clinician can form the access opening 18 which can provide access to the pulp cavity 11 and root canals 13. In FIG. 1G, the tooth 10 includes a broken portion 131 which has broken away from the tooth due to decay. It can be challenging to provide a stable platform to which the pressure wave generator 5 and/or fluid platform 3 can be coupled or pressed. Accordingly, as shown in FIG. 1G, a sacrificial material 130 can be applied over the broken portion 131 of the tooth 10. In addition, a carious region 19 on the exterior surface of the tooth 10 can be covered with sacrificial material 130. A coupling material 30 (such as an impression material) can be supplied within the tooth cap 22 to secure the tooth cap 22 to the tooth 10 and gums. As shown in FIG. 1G, the coupling material 30 can be disposed around the sacrificial material 130 between the sacrificial material 130 and the tooth cap 22. The coupling material 30 can be used to stably support the tooth 10 and/or the treatment device 6 during a treatment procedure, and to prevent fluid from entering or leaving the treatment region during treatment.

In some embodiments, the pressure wave generator 5 can be activated to clean the pulp cavity 11 and/or root canals 13. In addition, when activated, the pressure wave generator 5 can remove or break apart the sacrificial material 130 that is applied over the broken portion 131 to expose the underlying broken portion 131, without removing or damaging the coupling material 30. Removing the sacrificial material 130 overlying the broken portion 131 can create a negative image representing the size and shape of materials that can be supplied to restore the tooth 10, e.g., to replace the broken portion 131. In some embodiments, a calcium hydroxide paste can be used as the sacrificial material 130. Once the sacrificial material 130 is removed, the pressure waves and/or fluid motion generated by the pressure wave generator 5 can clean the surfaces of the exposed broken portion 131, as well as any biofilms that remain on the dental surfaces. Thus, the embodiment of FIG. 1G can advantageously clean the interior of the tooth 10 (e.g., the pulp chamber, root canals, etc., including small cracks, spaces, and tubules) and the exterior of the tooth defined by the broken portion 131 in a single procedure.

Furthermore, the system 1 of FIG. 1G can advantageously clean the carious region 19 on the exterior surface of the tooth 10. The pressure wave generator 5 can be activated to clean unhealthy materials from the pulp cavity 11, and the generated pressure waves 5 can propagate through tubules 132 of the tooth 10 from the pulp cavity 11 to the exterior of the tooth 10. The pressure waves can clean the carious region 19 by way of the tubules 132 in some arrangements. For example, the pressure waves may propagate through tubules that intersect the carious region 19, and the pressure waves can remove the carious region 19. In some embodiments, the pressure waves generated by the pressure wave generator 5 can propagate through the tubules 132 and can interact with the sacrificial material 130 disposed on the outside of the tooth. The pressure waves generated by the pressure wave generator 5 can remove the sacrificial material 130 disposed about the carious region 19 to expose and clean the carious region 19. Thus, the system 1 shown in FIG. 1G can also advantageously clean the carious region 19 on the exterior surface of the tooth by propagating through the thickness of the dentin by way of tubules 132.

In addition, the system 1 of FIG. 1G can be used to apply a protective coating over and/or to remineralize the treatment region. In some embodiments, the coating and/or remineralization can be performed after cleaning the root canal 13, the carious region 19 and/or undesirable dental deposits (such as plaque, biofilms, etc.) from the tooth. In other embodiments, the coating and/or remineralization can be performed as a standalone procedure without additional cleaning. As explained above, a coating agent (e.g., a remineralization agent) can be supplied to the treatment region, and the pressure wave generator 5 (which may be the same as or different from the pressure wave generator 5 used to clean the tooth 10) can be activated. The generated pressure waves and/or fluid motion may cause the remineralization or coating agent to coat the treatment region and other regions of the tooth 10 in fluid communication with the pressure wave generator 5, including the broken portion 131 of the tooth 10, the interior of the tooth (e.g., including the surfaces of the canal spaces and pulp chamber), and the cleaned carious region 19 on the exterior of the tooth 10. The remineralization or coating agent can interact with the dental materials (e.g., dentin, enamel) to remineralize or otherwise improve the health of the tooth 10.

In some embodiments, the remineralization or coating agent may be ionized prior to being supplied by the tooth. In other embodiments, the remineralization agent may be non-ionized prior to being supplied to the tooth. In such embodiments, the non-ionized remineralization agent may be formed as a liquid jet and can pass through liquid that is retained at the treatment region. As the jet passes through the liquid in the treatment region, the remineralization agent can become ionized and can flow throughout the treatment region, including in small spaces, cracks, tubules, etc. The ionized agent can advantageously stick to the surfaces of the tooth to apply a protective coating over the tooth. The remineralization chemicals can interact with the tooth to enhance remineralization.

The system 1 shown in FIG. 1G can also be used to fill the root canals 13 and the pulp cavity 11 and/or to restore the tooth 10, such as the broken portion 131. For example, the pressure wave generator 5 can be configured to fill and/or restore a treatment region of the tooth 10. The pressure wave generator 5 used to fill and/or restore the tooth can be the same as that used to coat and/or clean the tooth 10; in other arrangements, the pressure wave generator 5 used to fill and/or restore the tooth can be different from that used to coat and/or clean the tooth 10. To fill the pulp cavity 11 and root canals 13, the clinician can engage the console 2 to activate a filling procedure. The console 2 can supply a root canal filling material to the treatment instrument 101 as explained herein. The pressure wave generator 5 can be activated to cause the filling material to fill the spaces of the root canals 13 and/or pulp cavity 11.

In addition the clinician can interact with the console 2 to initiate a restoration procedure to restore the broken portion 131 of the tooth 10. For example, a restoration material can be supplied to the pressure wave generator 5 from a reservoir, and the pressure wave generator 5 can be activated to cause the restoration material to fill the remaining spaces within the tooth 10 and also the broken portion 131 of the tooth 10. By removing the sacrificial material 130 overlying the unbroken portion 131, the resulting empty space can represent a mold or negative image that defines the shape of the tooth structure to replace the broken portion 131 of the tooth 10. The restoration material can flow through the space in which the sacrificial material 130 was previously disposed and can be cured to restore the broken portion 131.

Thus, the embodiment of FIG. 1G can be used to clean the interior of the tooth 10 (e.g., the pulp cavity 11 and root canals 13, including small spaces, cracks, tubules, etc.) and to clean the exterior of the tooth 10 (including the broken portion 131, the carious region 19, and undesirable deposits such as biofilm). The embodiment of FIG. 1G can also be used to apply a protective coating (such as a remineralization agent) to the cleaned exterior and/or interior surfaces, and to fill and restore the treatment regions. Advantageously, therefore, in some embodiments, the clinician can use a single treatment instrument 101 to clean, coat, fill and restore the tooth 10.

Additional details of the coating and/or remineralization procedures may be found throughout U.S. Provisional Patent Application No. 62/934,348, the entire contents of which are incorporated by reference in their entirety and for all purposes. Moreover, additional examples of a tooth cap 22 may be found throughout U.S. patent application Ser. No. 14/267,794, the entire contents of which are incorporated by reference in their entirety and for all purposes. The coating and remineralization treatments can be used in combination with any of the treatment instruments 101 described herein.

### IV. Examples of Treatment Instruments with Pressure Wave Generators that Generate Axially-Directed Pressure Waves

FIG. 1H is a schematic diagram of a system 1 that includes components capable of removing unhealthy or undesirable materials from a tooth 10, coating or restoring portion(s) of the tooth, and/or filling a treatment region of the tooth, according to another embodiment. Unless otherwise noted, components of FIG. 1H may be the same as or generally similar to like-numbered components of FIGS. 1A-1G. The components of FIG. 1H may be combined with any of the embodiments disclosed herein.

For cleaning or coating a treatment region of a tooth, it can be desirable that the entire treatment region be substantially cleaned. Similarly, for filling a treatment region of a tooth (e.g., obturation of a root canal, filling a treated carious region, etc.), it can be desirable that all areas of the root canal system be filled homogenously. In some cases, a more viscous material may not fill the root canal system due to resistance to flow. In one embodiment, an ultrasonic mechanical action can propagate flow of filling material to achieve a homogenous result. The embodiments disclosed herein may be more effective than utilizing an ultrasonic descaler. In other embodiments, the system 1 disclosed herein can be used in cleaning procedures, e.g., in cleaning root canals, cleaning carious region(s) on an exterior surface of the tooth, cleaning dental deposits from the tooth and gum tissue, etc. In still other embodiments, the system 1 can be used in coating and/or remineralization procedures.

An ultrasonic treatment instrument (e.g., a handpiece) for phacoemulsification can operate in a range of 28 kHz to 40 kHz. For example, some handpieces can be operated at these ranges during cataract eye surgery. The vibration mode or action can be along a longitudinal axis of a length of the handpiece, e.g., concentrically aligned with the needle. The action of the phacoemulsification handpiece can be orthogonal to the action from an ultrasonic descaler which is perpendicular to the axis of the needle. The stroke length of the distal end of the needle can be about 0.0005″ to 0.003″ depending on power level settings. The ultrasonic motion can create cavitation at the distal end surface. Amplified sound waves radiate away from the distal end of the needle.

In various embodiments, the system 1 can include an elongate pressure wave generator 5. In some embodiments, the elongate pressure wave generator 5 can comprise an elongate actuator or structure with or without a lumen. The elongate pressure wave generator 5 can be symmetric or asymmetric. In some embodiments, the elongate pressure wave generator 5 can comprise an actuator including a vibrating guide tube 166 on a treatment instrument 101. The elongate pressure wave generator 5 (e.g., the guide tube 166) can vibrate along a longitudinal axis 169 of the guide tube 166 as part of a trimodal system. For the first mode, the guide tube 166 can clean the treatment region of the tooth (such as a root canal system, a carious region on the exterior surface of the tooth, dental deposits on the outside of the tooth and/or gum tissue) by vibrating at one or multiple frequencies along the longitudinal axis 169. For example, the guide tube 166 (or another fluid inlet line separate from the guide tube 166) can deliver one or multiple cleaning liquids to the treatment region. The guide tube 166 can vibrate in a manner so as to propagate pressure waves having at least one directional component parallel to the longitudinal axis 169 of the guide tube 166 (e.g., a majority of the energy can be directed along the longitudinal axis 169. In some embodiments, the guide tube 166 can serve as the fluid inlet to deliver the cleaning liquid to the treatment region. In other embodiments, the guide tube 166 may not deliver liquid, and a separate inlet can supply the cleaning liquid(s). In some embodiments, the guide tube 166 can comprise a lumen for delivering liquid(s). In other embodiments, the guide tube 166 may be solid or otherwise be void of an inlet lumen.

For the second mode, the guide tube 166 can serve to fill the treatment region and can introduce, mix, and deliver a filling material into the treatment region (e.g., into the pulp chamber and root canal system, into the treated carious region, etc.). As explained above, in some embodiments, the guide tube 166 can comprise a lumen to deliver one or multiple components of a filling material. In other embodiments, a separate inlet may deliver the one or more components of the filling material. The guide tube 166 can vibrate along the longitudinal axis 169 to generate pressure waves to cause the filling material to fill the treatment region.

For the third mode the guide tube 166 can vibrate along its axis at one or more frequencies that can propagate the flow of material and removal of air bubbles throughout the treatment region (e.g., the root canal system, treated carious region, etc.) to achieve a homogenous outcome. This action can help mix and/or settle the obturation material throughout the root canal system to achieve a homogenous fill.

Accordingly, in various embodiments, a dental treatment instrument 101 is disclosed. The dental treatment instrument 101 can include a pressure wave generator 5 configured to generate acoustic waves at one or more ultrasonic frequencies. The acoustic waves can propagate along an axis of the pressure wave generator 5 (which can comprise an elongate guide tube in some embodiments) to clean and/or fill a treatment region of the tooth. The acoustic waves can comprise frequencies of at least 20 kHz, e.g., in a range of 20 kHz to 200 MHz, in a range of 20 kHz to 50 kHz, or in a range of 28 kHz to 40 kHz. The generated acoustic waves can comprise multiple different frequencies.

In various embodiments, the treatment instrument 101 can be part of a treatment system 1. The treatment system 1 can include a first mode in which a pressure wave generator 5 is activated to clean the treatment region. The system 1 can include a second mode in which a pressure wave generator 5 is activated to fill the treatment region. The system 1 can include a third mode in which a pressure wave generator 5 (such as an ultrasonic device) can be activated to achieve a homogenous filling pattern in the treatment region.

In the illustrated embodiment, the guide tube 166 is shown as extending distal the fluid platform 3 and into the tooth 10. It should be appreciated, however, that in other embodiments, the guide tube 166 can terminate within the chamber 6 or treatment instrument 101. Any suitable fluid platform 3 can be used. For example, the fluid platform 3 can include a suction port connected to a waste or evacuation line. A vent can also be provided to regulate pressure in the treatment instrument 101 and treatment region. In other embodiments, the pressure wave generator 5 may be used without a chamber 6.

### V. Examples of Treatment Instruments for Supplying Multiple Compositions to a Treatment Region

Various embodiments disclosed herein can be used to supply multiple compositions to a treatment region of the tooth 10. In some types of treatment procedures, it can be beneficial to combine multiple compositions or materials. For example, in filling procedures (e.g., procedures to fill a root canal or treated carious region), multiple components can be combined (e.g., mixed) to form the filling material. In some embodiments, two components (e.g., Component A and Component B) can be combined in the treatment instrument 101 or at the treatment region to form a curable filling material. In other embodiments, more than two components or compositions (e.g., three, four, five, or more) can be combined to treat the tooth. In some cleaning treatments, multiple cleaning liquids can be combined to clean the treatment region. For example, water and other treatment fluids (such as sodium hypochloride) can be combined and delivered to the treatment region to clean the tooth. In some embodiments, one or multiple coating or remineralization agents can be supplied and combined to coat or remineralize the tooth. Although various embodiments describe arrangements in which multiple compositions are combined, it should be appreciated that the delivery devices 100 described herein can also be used with single-component treatments, e.g., treatments that utilize only a single treatment material.

In some embodiments, multiple compositions can be supplied to the treatment instrument 101 and can mix within the treatment instrument 101. The mixture (e.g., a cleaning mixture, a filling mixture, a coating mixture, a remineralization mixture, etc.) can be supplied to the treatment region. In other embodiments, multiple compositions can be supplied sequentially and separately to the treatment region and the multiple compositions can combine in the treatment region. Still other combinations may be suitable.

FIGS. 2A and 2B depict a delivery device 100 that can be used to combine a plurality of compositions (e.g., a first composition and a second composition) for cleaning, coating, remineralization, filling, or other types of dental treatments. For example, in a filling treatment, the delivery device 100 can combine a plurality of compositions to form a curable mixture (filling material) and apply it to a treatment region of the tooth to fill the treatment region. In other embodiments, as explained herein, the delivery device 100 can combine a plurality of cleaning liquids and/or one or multiple remineralization or coating liquids. As shown in FIGS. 2A-2B, the delivery device 100 can comprise a treatment instrument 101. The treatment instrument 101 can be used to position the pressure wave generator 5 at or near the treatment region. In the embodiment of FIG. 2A, the treatment instrument 101 comprises a handpiece sized and shaped to be held by the clinician against a portion of the tooth. Further, the delivery device 100 can comprise a first composition supply line 112 (also referred to herein as a first supply line or a first fluid composition supply line) and a second composition supply line 114 (also referred to herein as a second supply line or a second fluid composition supply line). The first composition supply line 112 can be configured to supply the first composition to a distal portion of the handpiece 101. The second composition supply line 114 can be configured to supply the second composition to the distal portion of the handpiece 101. For example, in some embodiments, the first composition line 112 can be configured to supply a carrier liquid to the tooth, and the second composition line 114 can supply other component materials to mix with the carrier liquid.

In FIG. 2A, a pressure wave generator 5 can be coupled to or formed with the distal portion of the treatment instrument 101. As explained above in connection with FIGS. 1A-1C, the pressure wave generator 5 can be activated to generate pressure waves and/or fluid motion at the treatment region, to cause the filling or obturation material to fill the treatment region. As explained above, the pressure wave generator 5 can comprise any suitable type of pressure wave generator, including those described in U.S. Pat. No. 9,877,801, the entire contents of which are incorporated herein by reference in their entirety and for all purposes. For example, the pressure wave generator 5 of FIGS. 2A-2B comprises a liquid jet device. The liquid jet device can comprise a nozzle or orifice 108 sized and shaped to pressurize the first composition that is supplied to the orifice 108 by way of the first composition supply line 112. In some embodiments, the orifice 108 can form the first composition into a liquid jet, e.g., a coherent, collimated liquid jet. The liquid jet formed of the first composition can pass into a guide channel 106 (which can serve as a mixing chamber) disposed distal the orifice 108. Thus, in FIG. 2B, the second supply line 114 can be positioned so as to deliver the second composition to the guide channel or mixing chamber 106 at a location distal the orifice 108, for example, between the orifice 108 and an impingement member 110 at a distal end of the guide tube 102. Thus, the liquid jet of, for example, the carrier material, can be formed and can pass through the guide channel or mixing chamber 106 to interact with other component materials supplied by the second supply line 114.

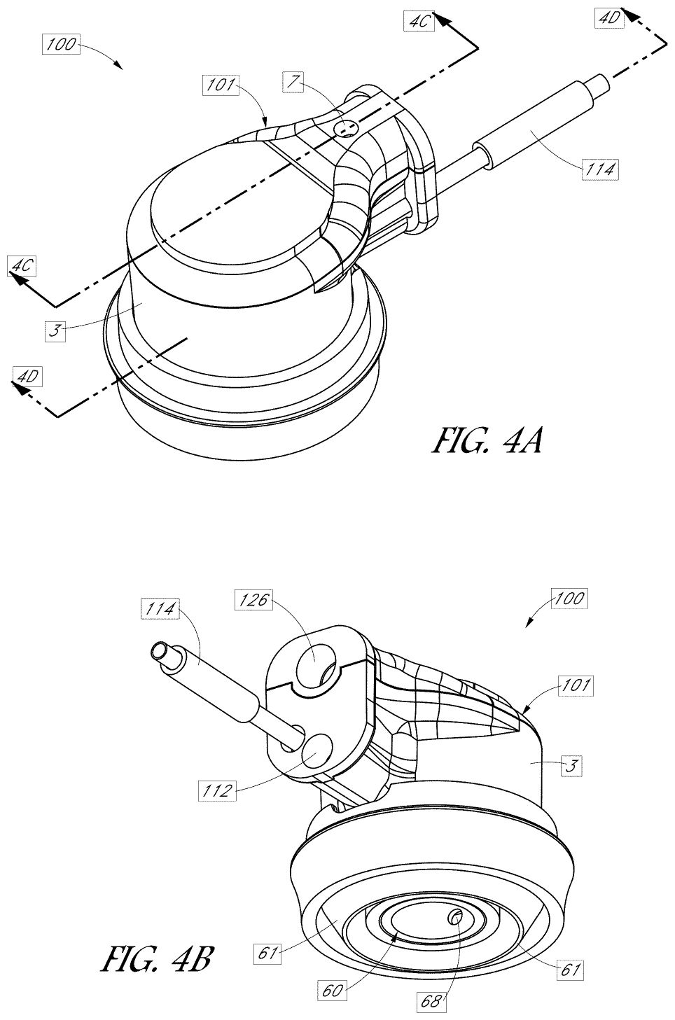

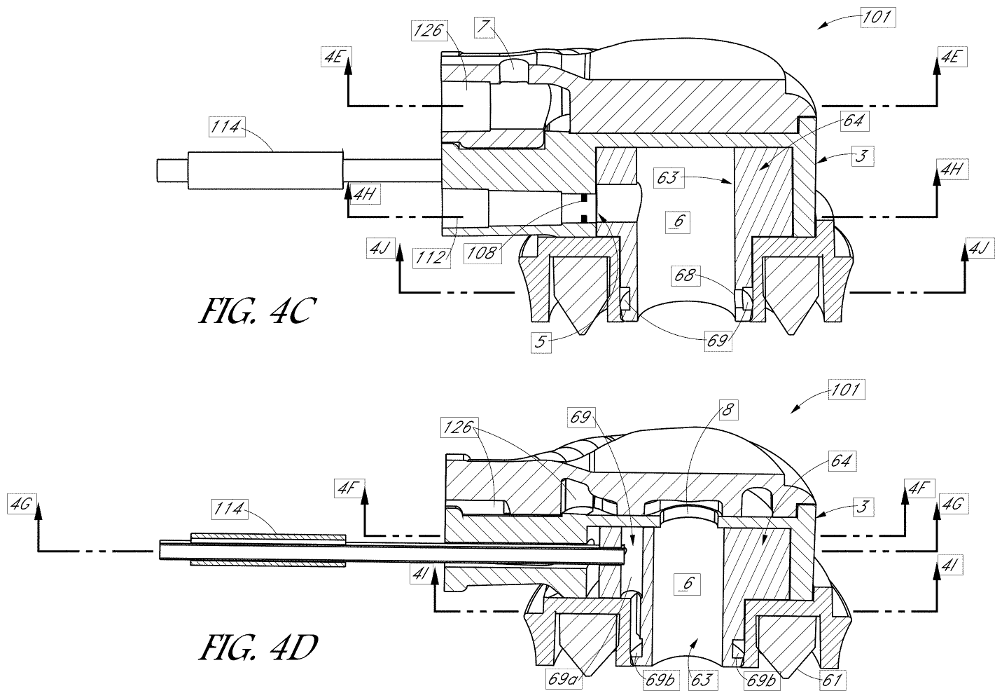

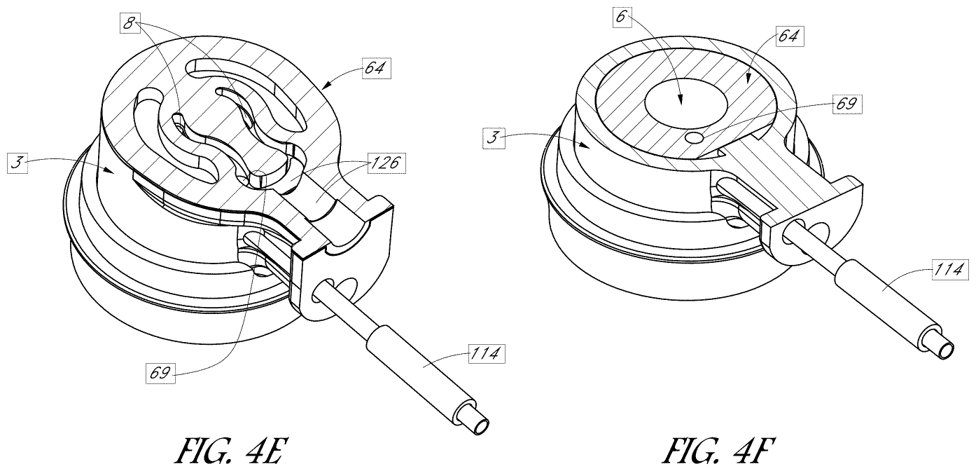

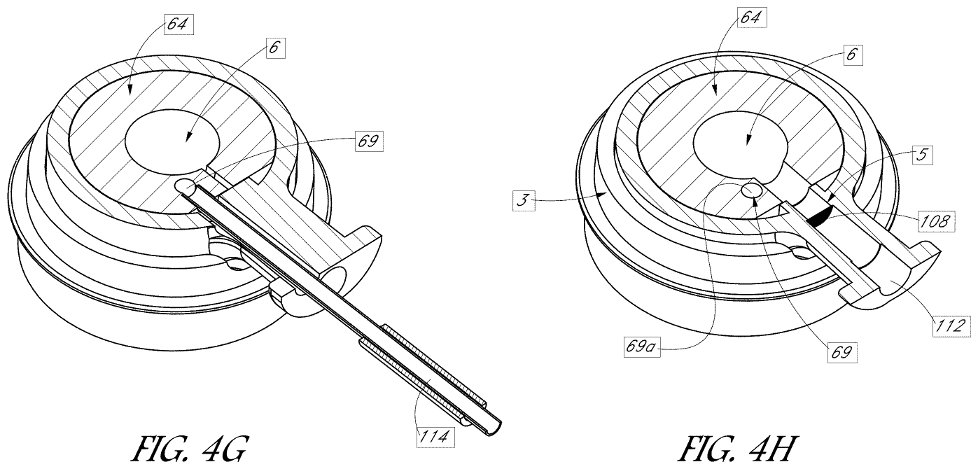

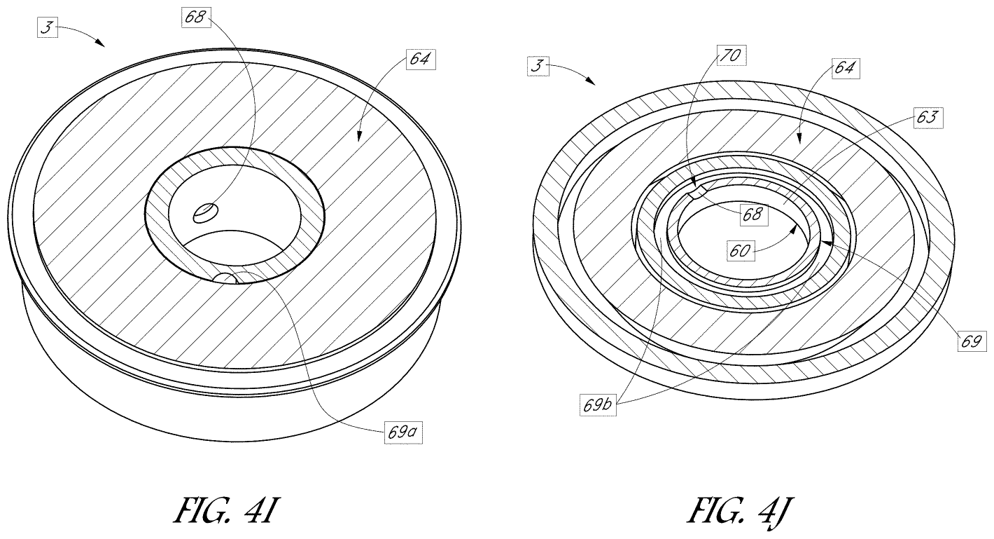

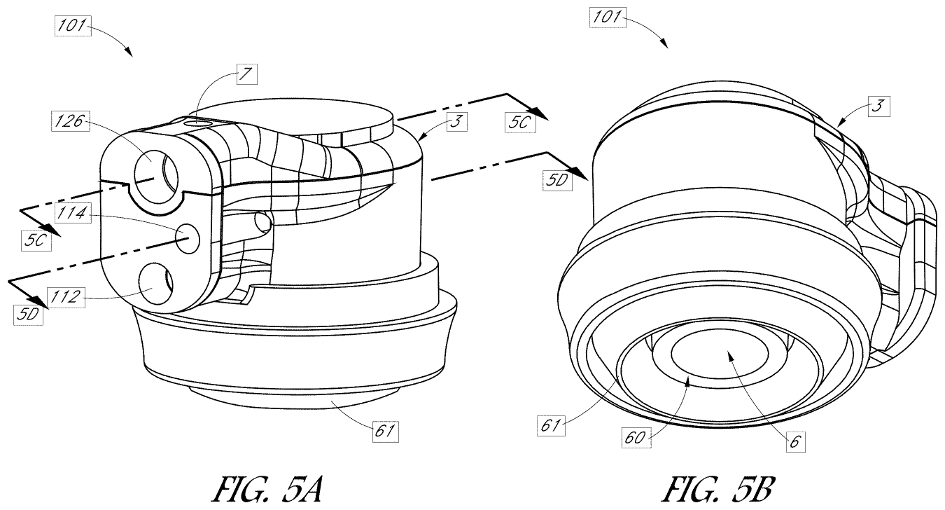

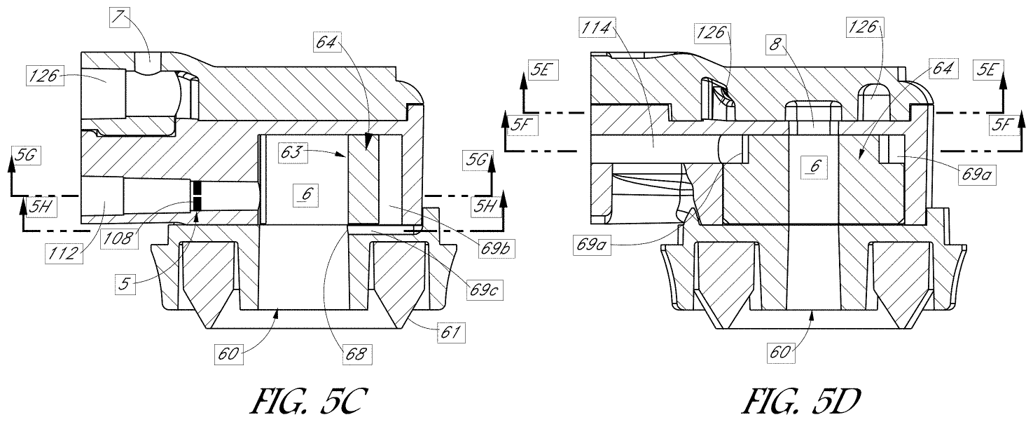

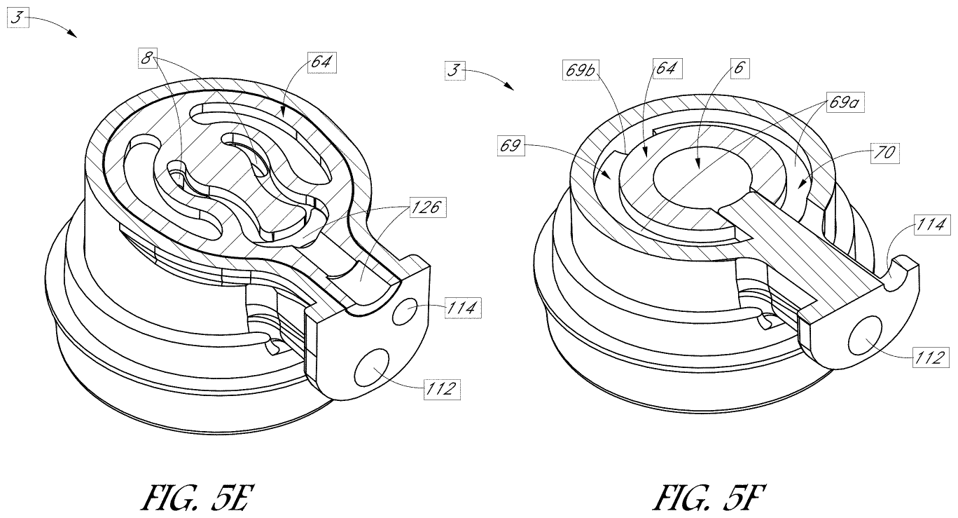

As shown in FIG. 2B, the second composition supply line 114 can supply the second composition to the mixing chamber 106 by way of one or more ports. The first and second compositions can accordingly be mixed within the guide channel 106 (or mixing chamber) to at least partially form the mixed composition of the filling or obturation material. The momentum of the liquid jet can drive the at least partially mixed first and second compositions along a guide tube 102. The liquid jet can impinge on an impingement member 110 located at a distal portion of the guide tube 102. The delivery device 100 can comprise a side port delivery device in which the curable mixture is supplied to the treatment region through one or a plurality of openings 104 in the guide tube 102. The openings 104 can be disposed proximal the impingement member 110. Interaction of the at least partially mixed first and second compositions with fluid in the treatment region can generate pressure waves and/or fluid motion at the treatment region. The pressure waves and/or fluid motion can assist in filling or obturating the treatment region. Additional details of liquid jet devices used for filling a treatment region can be found in FIGS. 4A-8D of U.S. Pat. No. 9,877,801, the entire contents of which are incorporated by reference herein in their entirety and for all purposes.

Accordingly, in some embodiments, the first and second compositions can be kept separate until combined in the guide channel or mixing chamber 106 of the delivery device 100 to form the curable mixture. For example, in some embodiments, the first or second composition can include all the ingredients of the curable mixture for a filling material except for at least one missing ingredient. In some embodiments, the missing ingredient can be the carrier fluid or a portion of the carrier fluid, whereby combination of the second composition decreases the viscosity of the first composition in order to create a curable mixture suitable for delivery to the treatment region. In some embodiments, the missing ingredient can initiate curing or hardening of the curable obturation material formed when combining the first and second compositions. In some embodiments, at least one of the first and second compositions are introduced into the curable mixture as a fluid jet as explained herein. Although FIGS. 2A-2B are described herein as being used to combine multiple compositions to supply a filling material to the treatment region, in some embodiments, the treatment instrument 101 can additionally or alternatively supply one or multiple components of a cleaning fluid, a coating fluid, etc.

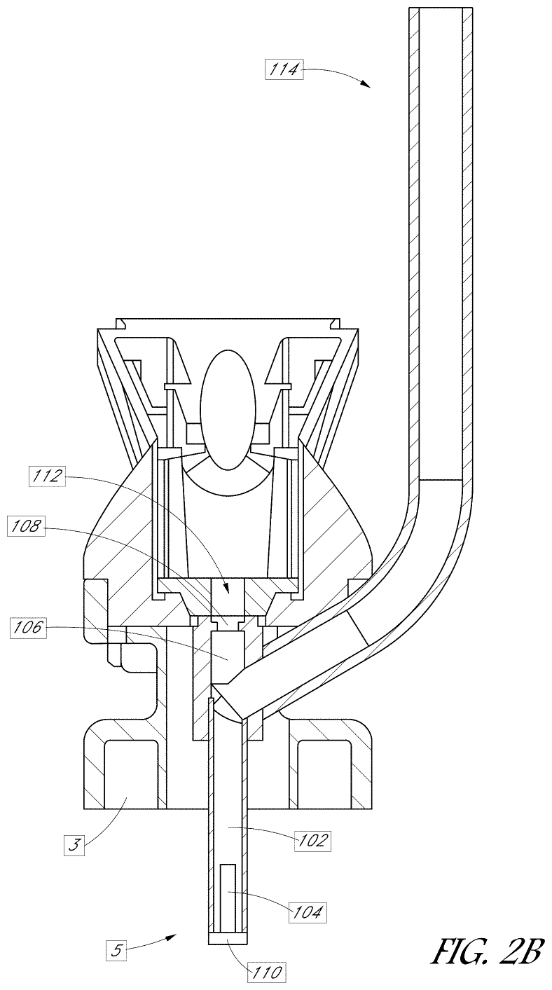

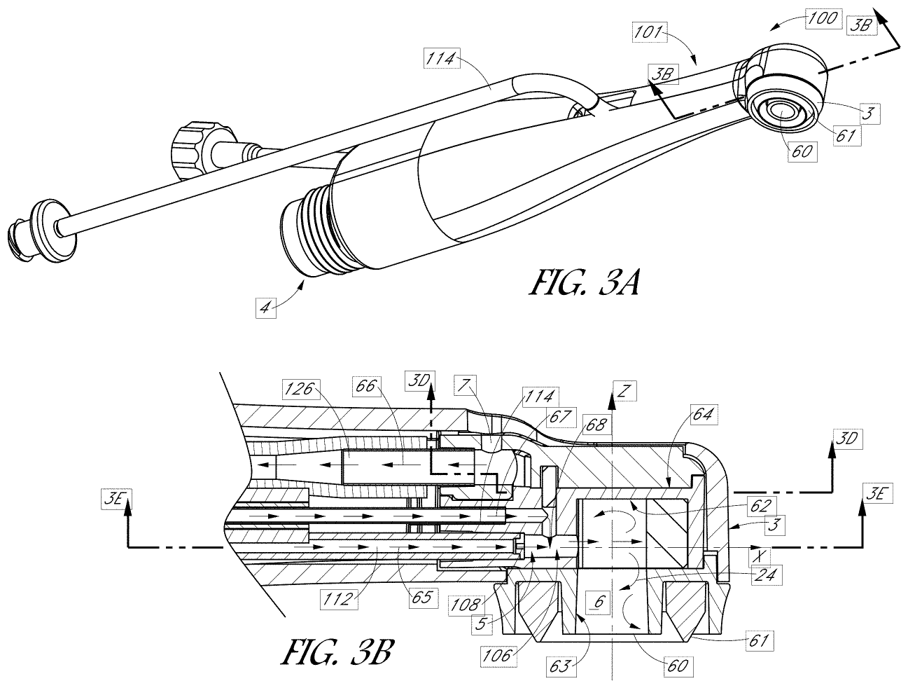

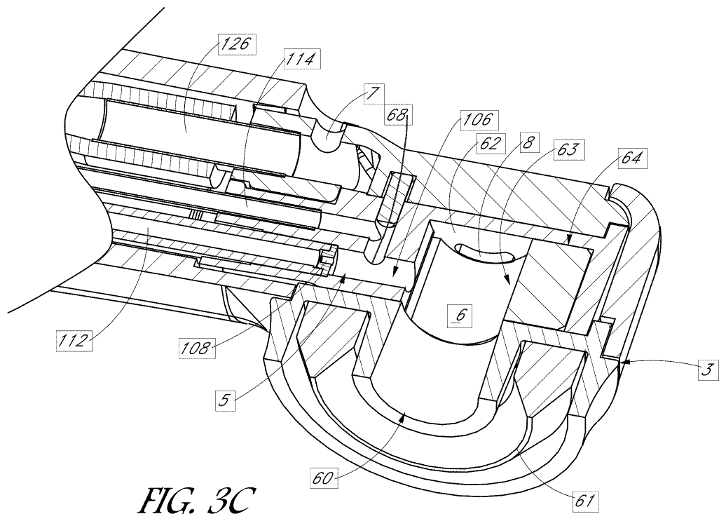

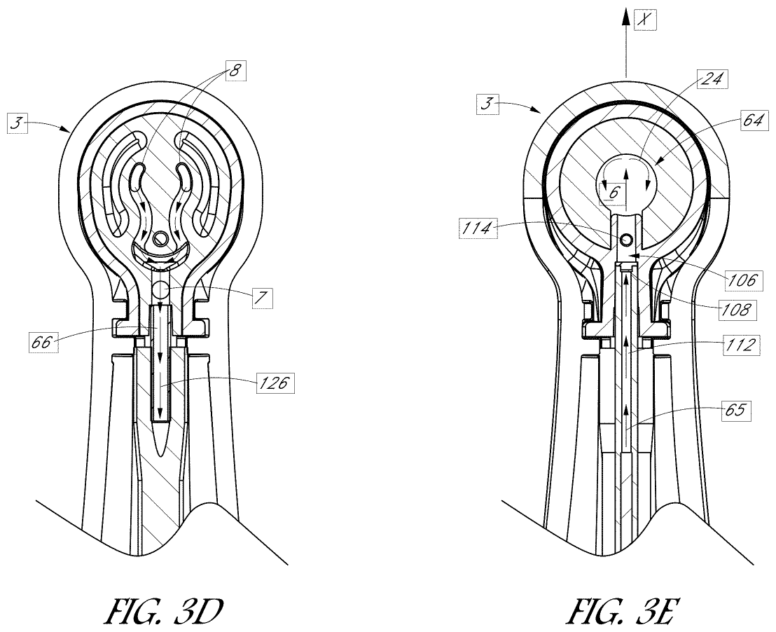

FIGS. 3A-3E illustrate an embodiment of a delivery device 100 comprising a treatment instrument 101 configured to combine multiple components of treatment material for delivery to a treatment region. FIG. 3A is a bottom perspective view of the delivery device 100. FIG. 3B is a schematic side sectional view of a distal portion of the treatment instrument 101, taken along Section 3B-3B of FIG. 3A. FIG. 3C is a bottom perspective sectional view of the distal portion shown in FIG. 3B. FIG. 3D is a top sectional view of the distal portion of the treatment instrument 101, taken along Section 3D-3D of FIG. 3B. FIG. 3E is a top sectional view of the distal portion of the treatment instrument 101, taken along Section 3E-3E of FIG. 3B. Unless otherwise noted, the components of FIGS. 3D-3E may be the same as or generally similar to like-numbered components of FIGS. 1A-2B. Additional details of treatment instruments that may be used in combination with the treatment instrument 101 of FIGS. 3A-3E may be found in U.S. patent application Ser. No. 16/879,093, filed May 20, 2020, the entire contents of which are incorporated by reference in their entirety and for all purposes.

The delivery device 100 of FIGS. 3A-3E includes a treatment instrument 101 comprising a handpiece sized and shaped to be gripped by the clinician. A fluid platform 3 can be coupled to a distal portion of the treatment instrument 101. As explained herein, in some embodiments, the fluid platform 3 can form part of a removable tip device 211 (see FIG. 1E) that can be removably connected to the handpiece. In other embodiments, the fluid platform 3 can be non-removably attached to the handpiece or can be integrally formed with the handpiece. In still other embodiments, the fluid platform 3 may not couple to a handpiece and may instead serve as a treatment cap that is adhered (or otherwise coupled or positioned) to the tooth without using a handpiece. As shown in FIG. 3A, an interface member 4 can be provided at a proximal end portion of the treatment instrument 101, which can removably couple to one or more conduits to provide fluid communication between the console 2 and the treatment instrument 101.

As shown in FIGS. 3B-3C, and as explained herein, a vent 7 can be provided through a portion of the treatment instrument 101 to provide fluid communication between a fluid outlet line 126 and ambient air. As explained herein, the vent 7 can serve to regulate the pressure in the fluid platform 3 and can improve the safety and efficacy of the treatment instrument 101. As shown in FIGS. 3B-3C, an access port 60 can be provided at a distal portion of the fluid platform 3 to provide fluid communication between a chamber 6 defined at least in part by the fluid platform 3 and the treatment region of the tooth 10. For example, a sealing cap 61 at the distal portion of the fluid platform 3 can be positioned against the tooth 10 over the access opening 18 to provide fluid communication between the chamber 6 and the interior of the tooth 10 (e.g., the pulp cavity 11 and root canal(s) 13). In other embodiments, the sealing cap 61 can be positioned against the tooth 10 over the carious region at an exterior surface of the tooth 110 to provide fluid communication between the chamber 6 and the carious region to be treated. The pressure waves 23 and fluid motion 24 can propagate throughout the treatment region to clean, coat, remineralize, and/or fill the treatment region. Thus, as explained above, the treatment instrument of FIGS. 3B-3C can be used in one or more of cleaning procedures, coating procedures, remineralization procedures, filling procedures, and any other suitable dental procedures.

The fluid platform 3 can comprise a manifold body 64 having one or a plurality of walls that define the chamber 6. For example, as shown in FIGS. 3B-3C, the fluid platform 3 can comprise at least one wall including a curved inner sidewall 63 and an upper wall 62 disposed at an upper end of the chamber 6 opposite the access port 60. In the illustrated embodiment, the curved inner sidewall 63 can define a generally cylindrical chamber 6 with a generally circular cross-section, and can extend from the upper wall 62 at an angle. In other embodiments, however, the curved sidewall 63 can be elliptical or can have other curved or angular surfaces. The sidewall 63 can extend non-parallel to (e.g., substantially transverse to) the upper wall 62. The sidewall 63 can extend from the upper wall 62 at any suitable non-zero angle, for example, by about 90° in some embodiments. In other embodiments, the sidewall 63 can extend from the upper wall 62 by an angle greater than or less than 90°. In other embodiments, the sidewall 63 can extend from the upper wall 62 by different angular amounts along a perimeter of the sidewall 63 such that the shape of the chamber 6 may be irregular or asymmetric. In the illustrated embodiment, the interior region between the upper wall 62 and sidewall 63 can comprise an angle or corner. In other embodiments, however, the interior interface between the upper wall 62 and sidewall 63 can comprise a curved or smooth surface without corners. For example, in some embodiments, the one or more walls can comprise a curved profile, such as a quasi-spherical profile.

The sealing cap 61 can be coupled to or formed with the platform 3. The access port 60 can be provided at the distal end portion of the chamber 6 which places the chamber 6 in fluid communication with a treatment region of the tooth 10 when the chamber 6 is coupled to the tooth (e.g., pressed against the tooth, adhered to the tooth, or otherwise coupled to the tooth). For example, the sealing cap 61 can be pressed against the tooth by the clinician to substantially seal the treatment region of the tooth.

The chamber 6 can be shaped to have any suitable profile. In various embodiments, and as shown, the chamber 6 can have a curved sidewall 63, but in other embodiments, the chamber 6 can have a plurality of angled sidewalls 63 that may form angled interior corners. The sectional plan view (e.g., bottom sectional view) of the chamber 6 can accordingly be rounded, e.g., generally circular as shown in, e.g., FIG. 3E. In some embodiments, the sectional plan view (e.g., bottom sectional view) of the chamber 6 can be elliptical, polygonal, or can have an irregular boundary.

The chamber 6 can have a central axis Z. For example, as shown in FIG. 3B, the central axis Z can extend substantially transversely through a center (e.g., a geometric center) of the access port 60 (e.g., through a distal-most plane of the chamber 6 defined at least in part by the access port 60). In various embodiments, and as shown in FIG. 3B, for a chamber 6 with a circular (or approximately circular) cross-section (as viewed from a bottom plan view) the central axis Z can pass substantially transversely through the approximate center of the access port 60 that at least partially defines a distal portion of the chamber 6 and/or the upper wall 62 that at least partially defines the top of the chamber 6. For example, the central axis Z can pass substantially transversely through the geometric center of the upper wall 62 and/or the access port 60 at an angle in a range of 85° to 95°, at an angle in a range of 89° to 91°, or at an angle in a range of 89.5° to 90.5°.

As explained above, although the illustrated chamber 6 has a generally or approximately circular cross-section, the chamber 6 may have other suitable shapes as viewed in various bottom-up cross-sections. In such embodiments, a plurality of planes (e.g., two, three, or more planes) parallel to the plane of the opening of the access port 60 of the chamber 6 (which may be at a distal-most plane of the chamber 6) can be delimited or bounded by the sidewall 63 of the chamber. The central axis Z can pass through the approximate geometric center of each of the bounded planes parallel to the access port 60. For example, the chamber 6 may have a sidewall 63 that is angled non-transversely relative to the upper wall 62, and/or may have a sidewall 63 with a profile that varies along a height h of the chamber 6. The central axis Z can pass through the geometric center of each of the plurality of parallel bounded planes.

A pressure wave generator 5 (which can serve as a fluid motion generator) can be arranged to generate pressure waves and rotational fluid motion in the chamber 6. The pressure wave generator 5 can be disposed outside the tooth during a treatment procedure. The pressure wave generator 5 can comprise a liquid supply port that can deliver a liquid stream (such as a liquid jet) across the chamber 6 (e.g., completely across the chamber 6 to impinge upon a portion of the sidewall 63 opposite the pressure wave generator 5 or supply port) to generate pressure waves and fluid motion. The pressure wave generator 5 can comprise the orifice 108 and a channel distal the orifice 108. For example, the pressure wave generator 5 can comprise a liquid jet device that includes an orifice or nozzle 108 that can serve as a first liquid supply port. The pressure wave generator 5 can comprise the orifice 108 and a channel distal the orifice 108. Pressurized liquid 65 of a first composition can be transferred to the nozzle 108 along a first composition supply line 112. The first composition supply line 112 can be connected to a fluid source in the console 102, for example, by way of one or more conduits (which may also pass through interface member 4). The nozzle 108 can have a diameter selected to form a high velocity, coherent, collimated liquid jet. The nozzle 108 can be positioned at a distal end of the first composition supply line 112. In various embodiments disclosed herein, the nozzle 108 can have an opening with a diameter in a range of 59 microns to 69 microns, in a range of 60 microns to 64 microns, or in a range of 61 microns to 63 microns. For example, in one embodiment, the nozzle 108 can have an opening with a diameter of approximately 62 microns, which has been found to generate liquid jets that are particularly effective at cleaning teeth. Additional details regarding liquid jet devices (including, for example, the orifice or nozzle 108) may be found throughout U.S. Pat. Nos. 9,492,244 and 9,675,426, the entire contents of each of which are hereby incorporated by reference in their entirety and for all purposes. Although the illustrated embodiments are configured to form a liquid jet (e.g., a coherent, collimated jet), in other embodiments, the liquid stream may not comprise a jet but instead a liquid stream in which the momentum of the stream is generally parallel to the stream axis.

As shown in FIGS. 3B, 3C and 3E, the nozzle 108 can be configured to direct a liquid stream comprising a liquid jet laterally through a laterally central region of the chamber 6 along a jet axis X (also referred to as a stream axis) non-parallel to (e.g., substantially perpendicular to) the central axis Z. In other embodiments, the stream or jet axis X can be disposed at an acute or obtuse angle relative to the central axis Z. In some embodiments, the jet axis X can intersect the central axis Z. In various embodiments, the liquid stream (e.g., the jet) can intersect the central axis Z. In other embodiments, the jet axis X can be slightly offset from the central axis Z. In still other embodiments, the jet axis X can be off-center or eccentrically disposed relative to the central axis Z (e.g., disposed at or near sidewall 63). The liquid jet can generate fluid motion 24 (e.g., vortices) that can propagate throughout the treatment region (e.g., throughout a root canal, throughout a carious region on an external surface of the tooth, etc.) to interact with and remove unhealthy material. The nozzle or orifice 108 can also act as a pressure wave generator 5 to generate broadband pressure waves through the fluid in the chamber 6 to clean the treatment region. For example, the interaction of the jet with the liquid in the chamber 6 can generate pressure waves that propagate through the treatment region.

The nozzle 108 can form the coherent, collimated liquid jet, which can pass into a guide channel 106 (which may serve as a mixing chamber in some embodiments) disposed between the nozzle 108 and the chamber 6. The channel 106 can extend proximally from an inlet opening of the chamber 6. As shown in FIGS. 3B-3C, the treatment instrument can include a second fluid composition supply line 114 in fluid communication with one or more fluid reservoirs that may be located inside or outside the console 2. As explained herein, it can be beneficial to provide the second fluid composition supply line 114 so that one or more additional materials (e.g., one or more additional treatment fluids or other compositions) may be combined with the liquid jet formed by the nozzle 108. Thus, a second fluid composition 67 can be delivered along the second fluid composition supply line 114 to the mixing channel 106 by way of a second port 68. In some embodiments, the second composition 67 may or may not be located in reservoirs in the console 2. The second composition 67 can be used in any suitable type of treatment procedures (e.g., cleaning, coating, remineralization, and/or filling procedures). For example, in a cleaning procedure, it may be beneficial to provide sodium hypochloride, or a filling material, outside the console to serve as the second composition. In other embodiments, however, the one or more fluid reservoirs that supply the second composition may be located inside the console 2. Further, as explained above, for filling materials, the filling material may be formed by combining multiple components of the filling material in the mixing channel 106 (and/or at the treatment region).

In various types of treatment procedures, multiple components may be combined in the treatment instrument 101. For example, in filling procedures (e.g., obturation of root canals, filling a treated carious region, etc.), components having different viscosities and physical properties may be combined to form the filling material. The liquid jet device (e.g., the nozzle or orifice 108) may form a coherent, collimated liquid jet if the first composition 65 comprises a liquid composition having a suitably low viscosity for forming a jet. Some types of liquids and mixtures (e.g., powders, pastes, etc.) may not be suitable for forming a jet. Accordingly, in various embodiments, liquids with suitably low viscosities may be supplied to the chamber 6 by way of the first composition supply line 112 and the orifice 108. The second composition 67 can comprise a fluid, e.g., a flowable material that is deliverable along the second composition supply line 114. For example, the second composition 67 can comprise a fluid such as a liquid, a paste, a gel, a gas, a powder or other solid particulates entrained with a gas, or any other suitable composition that can be supplied along the second supply line 114. Thus, the second composition 67 may or may not comprise a liquid with physical properties suitable for forming a liquid jet.

Beneficially, the embodiments disclosed herein can combine materials 65, 67 having different physical properties which can mix in the treatment instrument 101, e.g., in the guide channel 106 or in the chamber 6. Combining (e.g., mixing) the first and second compositions 65, 67 in the treatment instrument 101 can advantageously improve mixing before the mixture sets (e.g., in the case of a filling material). Improved mixing in the treatment instrument 101 can also provide a more uniform mixture in the treatment region since the components may be thoroughly mixed before entering the treatment region.

As explained above, a first pressurized liquid 65 of the first composition can be supplied to the pressure wave generator 5 along the first fluid composition supply line 112 at high pressure. The nozzle 108 can convert the pressurized liquid 65 to a liquid jet which can be delivered across the chamber 6 along the jet axis X. The second fluid composition supply line 114 can supply the second fluid composition 67 to the fluid platform 2, which can join or merge with the guide channel 106 (which can serve as a mixing chamber) at a location distal the nozzle 108 between the nozzle 108 and the chamber 6. Without being limited by theory, the second fluid composition supply line 114 can comprise a low-pressure pathway to supply the second composition 67 to the chamber 6. For example, in some embodiments, the high velocity jet can draw the second fluid 67 into the mixing channel 106 and to the chamber 6 utilizing the Venturi effect. The velocity of the jet can induce a pressure gradient that draws the second fluid 67 into the channel 106 and the chamber 6. In some embodiments, a low pressure pump can drive or assist the delivery of the second composition 67 to the channel 106 along the second supply line 114. In other embodiments, the pressure gradient created by the liquid jet passing the second line 114 may be sufficient to draw the second composition 67 into the guide channel 106 and the chamber 6 without utilizing a pump. In some embodiments, the jet of the first composition 65 can mix with, carry, or otherwise be entrained with the second fluid 67 along the channel 106 and into the chamber 6 as a combined liquid stream.

Beneficially, the combined mixture (e.g., two or more components of a filling material, two or more components of a cleaning material, two or more components of a coating or remineralization material, etc.) can be used to treat the tooth. In some embodiments, the second fluid 67 can be introduced into the chamber 6 and treatment region without requiring that the reservoir for the second fluid 67 be located in the console 2. The introduction of the second fluid 67 and/or its combination with the first composition 65 in the form of the jet can also improve efficacy of cleaning and/or filling. In some embodiments, the jet may passively draw the second fluid 67 along the second fluid composition supply line 114 without actively pumping the second fluid 67. In other embodiments, a low pressure pump may be provided to assist in delivering the second fluid 67 along the second fluid composition supply line 114.

During operation, the chamber 6 can fill with the combined or mixed treatment fluid supplied by the liquid jet of the first composition 65 and the second composition 67 supplied by the second port 68. The combined stream of the first and second compositions 65, 67 can enter the chamber 6 from the mixing or guide channel 106 and can interact with the liquid retained in the chamber 6. The interaction between the supplied fluid stream and the liquid in the chamber 6 can create pressure waves 23 (see FIGS. 1A-1D), which can propagate throughout the treatment region. The mixed liquid stream can impact the sidewall 63 of the chamber 6 at a location opposite the nozzle 108 along the jet axis X. The sidewall 63 of the chamber 6 can serve as an impingement surface such that, when the jet impinges on or impacts the sidewall 63, the curved or angled surface of the sidewall 63 creates rotational fluid motion 24 along the sidewall 63, the upper wall 62, and/or within the fluid retained in the chamber 6. Moreover, the movement of the jet and/or the liquid stream diverted by the sidewall 63 can induce the rotational fluid motion 24 in the chamber 6 and through the treatment region. The rotational fluid motion 24 and pressure waves 23 can deliver the mixed fluids to the treatment region to clean, fill, coat, and/or remineralize the treatment region.

Without being limited by theory, directing the stream including the jet of the first composition 65 and the entrained second composition 67 across the chamber 6 (e.g., completely across the chamber 6) along the jet axis X at a central location within the chamber 6 can induce fluid motion 24 comprising vortices that rotate about an axis non-parallel to (e.g., perpendicular to) the central axis Z of the chamber 6. The vortices can propagate through the treatment region, and can provide bulk fluid motion that flushes undesirable material (e.g., decayed organic matter) out of the treatment region. The combination of the vortex fluid motion 24 and the generated pressure waves 23 can effectively remove undesirable materials of all shapes and sizes from large and small spaces, cracks, and crevices of the treatment region. The fluid motion 24 may be turbulent in nature and may rotate about multiple axes, which can increase the chaotic nature of the flow and improve treatment efficacy.

As shown in FIGS. 3B-3D, the treatment instrument 101 can also include an evacuation or outlet line 126 to convey waste or effluent liquids 66 to a waste reservoir, which may be located in the system console 2. A suction port 8 or fluid outlet can be exposed to the chamber 6 along a wall of the chamber 6 at a location offset from the central axis Z. For example, as shown in FIG. 3C, the suction port 8 can be disposed along the upper wall 62 of the chamber 6 opposite the access port 60. A vacuum pump (not shown) can apply vacuum forces along the outlet line 126 to draw waste or effluent liquids 66 out of the chamber 6 through the suction port 8, along the outlet line 126, and to the waste reservoir. In some embodiments, only one suction port 8 can be provided. However, in the illustrated embodiment, the instrument 101 can include a plurality (e.g., two) of suction ports positioned laterally opposite one another. In some embodiments, more than two suction ports can be provided. The suction ports 8 can be disposed laterally opposite one another, e.g., symmetrically relative to, the central axis Z. As shown, the suction ports 8 can be disposed through the upper wall 62 at or near the sidewall 63, e.g., closer to the sidewall 63 than to the central axis Z of the chamber 6. In the illustrated embodiment, the suction ports 8 can abut or be defined at least in part by the sidewall 63. In other embodiments, the suction ports 8 can be laterally inset from the sidewall 63. In still other embodiments, the suction ports 8 can be disposed on the sidewall 63 of the chamber 6.

Accordingly, in various embodiments, the chamber 6 can have a maximum lateral dimension in a first plane extending substantially transverse to (e.g., at an angle in a range of 85° to 95°, at an angle in a range of 89° to 91°, or at an angle in a range of 89.5° to 90.5° relative to) the central axis Z. The first plane can be delimited by a wall of the chamber along a boundary of the wall. A projection of the suction port 8 onto the first plane can be closer to the boundary than to the central axis Z of the chamber 6. For example, in the illustrated embodiment, the chamber 6 can comprise an approximately circular bottom cross-section, and the first plane substantially transverse to the central axis Z can be delimited along the sidewall 63 by an approximately circular boundary. A projection of the suction port 8 onto that first plane can be closer to the approximately circular boundary than to the central axis Z.

As shown, the suction ports 8 can comprise elongated and curved (e.g. kidney-shaped) openings. The curvature of the suction ports 8 may generally conform to the curvature of the sidewall 63 of the chamber 6 in some embodiments. In other embodiments, the suction ports 8 may not be curved but may be polygonal (e.g., rectangular). Beneficially, the use of an elongate suction port 8, in which a length of the opening is larger than a width, can prevent large particles from clogging the suction port 8 and/or outlet line 126. In some embodiments, the suction port 8 can comprise an opening flush with the upper wall 62. In other embodiments, the suction port 8 can protrude partially into the chamber 6.

In some embodiments, pressure wave generator 5 and the suction port(s) 8 can be shaped and positioned relative to the chamber 6 such that, during operation of the treatment instrument 101 in a treatment procedure, pressure at a treatment region of the tooth (e.g., within the root canals of the tooth as measured in the apex) can be maintained within a range of 50 mmHg to −500 mmHg. Maintaining the pressure at the treatment region within desired ranges can reduce the risk of pain to the patient, prevent extrusion of liquids apically out of the apical opening 15, and/or improve cleaning efficacy. For example, the pressure wave generator 5 and the suction port(s) 8 can be shaped and positioned relative to the chamber 6 such that, during operation of the treatment instrument 101 in a treatment procedure, apical pressure at or near the apex 14 and apical opening 15 are maintained at less than 50 mmHg, at less than 5 mmHg, at less than −5 mmHg, e.g., within a range of −5 mmHg to −200 mmHg, within a range of −5 mmHg to −55 mmHg, or within a range of −10 mmHg to −50 mmHg. Maintaining the apical pressure within these ranges can reduce the risk of pain to the patient, prevent extrusion of liquids apically out of the apical opening 15, and/or improve cleaning efficacy.

In some embodiments, to regulate apical pressure, the suction ports 8 can be circumferentially offset from the nozzle 108. For example, in the illustrated embodiment, the suction ports 8 can be circumferentially offset from the nozzle 108 by about 90°.

Further, the chamber 6 can have a width w (e.g., a diameter or other major lateral dimension of the chamber 6) and a height h extending from the upper wall 62 to the access port 60. The width w and height h can be selected to provide effective cleaning outcomes while maintaining apical pressure in desired ranges. In various embodiments, for example, the width w of the chamber 6 can be in a range of 2 mm to 4 mm, in a range of 2.5 mm to 3.5 mm, or in a range of 2.75 mm to 3.25 mm (e.g., about 3 mm). A height h of the chamber 6 can be in a range of about 1 mm to 30 mm, in a range of about 2 mm to 10 mm, or in a range of about 3 mm to 5 mm.

The pressure wave generator 5 (e.g., the nozzle 108) can be positioned relative to the chamber 6 at a location that generates sufficient fluid motion 24 to treat the tooth. As shown, the pressure wave generator 5 (including, e.g., the nozzle 108) can be disposed outside the chamber 6 as shown (for example, recessed from the chamber 6). In some embodiments, the pressure wave generator 5 can be exposed to (or flush with) the chamber 6 but may not extend into the chamber 6. In still other embodiments, at least a portion of the pressure wave generator 5 may extend into the chamber 6. The pressure wave generator 5 (for example, including the nozzle 108) can be positioned below or distal the suction ports 8. Moreover, in the illustrated embodiment, the jet (with the entrained second composition 67) can be directed substantially perpendicular to the central axis Z (such that an angle between the jet axis X and the central axis Z is approximately 90°). The jet or stream can pass proximate the central axis Z of the chamber, e.g., pass through a laterally central region of the chamber 6. For example, in some embodiments, the jet axis X or the liquid jet can intersect the central axis Z of the chamber. In some embodiments, the jet may pass through a laterally central region of the chamber 6 but may be slightly offset from the central axis Z. For example, the central axis Z can lie in a second plane that is substantially transverse to the jet axis X (e.g., the second plane can be angled relative to the jet axis X in a range of 85° to 95°, in a range of 89° to 91°, or in a range of 89.5° to 90.5°). The stream or jet axis X can intersect the second substantially transverse plane at a location closer to the central axis Z than to the sidewall 63.

Accordingly, as explained above, the chamber 6 can have a maximum lateral dimension in a first plane extending substantially transverse to the central axis Z, and the central axis Z can lie in the second plane extending substantially transverse to the stream or jet axis X. The first plane can be delimited by a wall (for example, the sidewall 63) of the chamber 6 along a boundary of the wall. As explained above, the suction port 8 can be closer to the boundary (e.g., the sidewall 63 in some embodiments) than to the central axis Z. The suction port 8 may also be closer to the boundary than to the location at which the stream or jet axis X intersects the second plane. Further, the location at which the stream or jet axis X intersects the second plane can be closer to the central axis Z than to the suction port 8 (or to a projection of the suction port 8 onto that second plane). Although the wall illustrated herein can comprise an upper wall and sidewall extending therefrom, in other embodiments, the wall can comprise a single curved wall, or can have any other suitable shape.

As explained above, the vent 7 can be provided through the platform 3 and can be exposed to ambient air. The vent 7 can be in fluid communication with the evacuation line 126 that is fluidly connected to the suction port 8. The vent 7 can be disposed along the evacuation or outlet line 126 at a location downstream of the suction port 8. The vent 7 can beneficially prevent or reduce over-pressurization in the chamber 6 and treatment region. For example, ambient air from the outside environs can be entrained with the effluent liquid 66 removed along the outlet line 126. The vent 7 can regulate pressure within the treatment region by allowing the application of a static negative pressure. For example, a size of the vent 7 can be selected to provide a desired amount of static negative pressure at the treatment region. The vent 7 can be positioned at a location along the outlet line 126 so as to prevent ambient air from entering the chamber 6 and/or the treatment region of the tooth 10. Additional details regarding vented fluid platforms can be found throughout U.S. Pat. No. 9,675,426, the entire contents of which are incorporated by reference herein in their entirety and for all purposes.

Beneficially, the embodiment of FIGS. 3A-3E and like embodiments can create sufficient fluid motion and pressure waves to provide a thorough cleaning, remineralization, coating, and/or filling of the entire treatment region. Components such as the pressure wave generator 5, the chamber 6, the suction port 8, the vent 7, etc. can be arranged as shown and described in the illustrated embodiment, so as to provide effective treatment (e.g., effective cleaning, coating, remineralization, or filling), improved pressure regulation (e.g., maintain pressures at the treatment region within suitable ranges), and improved patient outcomes as compared with other devices.

FIGS. 4A-4J illustrate another embodiment of a delivery device 100 comprising a treatment instrument 101 configured to combine multiple components of treatment material to a treatment region of the tooth. In particular, FIG. 4A is a schematic top perspective view of the delivery device 100. FIG. 4B is a schematic bottom perspective view of the delivery device 100. FIG. 4C is a schematic side sectional view of a distal portion of the treatment instrument 101 taken along Section 4C-4C of FIG. 4A. FIG. 4D is a schematic side sectional view of the distal portion of the treatment instrument 101 taken along Section 4D-4D of FIG. 4A. FIG. 4E is a schematic top sectional view of the treatment instrument 101 taken along Section 4E-4E of FIG. 4C. FIG. 4F is a schematic top sectional view of the treatment instrument 101 taken along Section 4F-4F of FIG. 4D. FIG. 4G is a schematic top sectional view of the treatment instrument 101 taken along Section 4G-4G of FIG. 4D. FIG. 4H is a schematic top sectional view of the treatment instrument 101 taken along Section 4H-4H of FIG. 4C. FIG. 4I is a schematic top sectional view of the treatment instrument 101 taken along Section 4I-4I of FIG. 4D. FIG. 4J is a schematic top sectional view of the treatment instrument 101 taken along Section 4J-4J of FIG. 4C.

Unless otherwise noted, the components of FIGS. 4A-4J may be the same as or generally similar to like-numbered components of FIGS. 3A-3E and may operate or function in a generally similar manner. For example, as with FIGS. 3A-3E, the treatment instrument 101 of FIGS. 4A-4J can include a fluid platform 3 in fluid communication with a first fluid composition supply line 112 and a second fluid composition supply line 114. The fluid platform 3 can also include the manifold body 64 that at least partially defines the chamber 6. The first composition 65 (see FIGS. 3A-3E) can be delivered along the first fluid composition supply line 112, as shown in FIG. 4C. In FIG. 4C, a pressure wave generator 5 comprising the nozzle 108 can pressurize the liquid that includes the first composition 65 so as to form a liquid jet (e.g., a coherent, collimated liquid jet). The liquid jet can be delivered across the chamber 6 and impinge on the sidewall 63 of the chamber 6, as explained above in connection with FIGS. 3A-3E. The suction ports 8 (see FIGS. 4D and 4E) can draw waste liquid (and/or other outgoing materials) along the outlet line 126 (FIGS. 4C-4E). As shown in FIGS. 4A-4B, the vent 7 can be provided to regulate the pressure in the fluid platform 3.

Further, as with the embodiment of FIGS. 3A-3E, the second fluid composition supply line 114 can supply the second composition 67 to the fluid platform 3. In some embodiments, a low pressure pump can be provided in the console 2 or outside the console 2 to drive the second composition 67 to the fluid platform 3. In the embodiment of FIGS. 3A-3E, the second composition 67 was delivered to the mixing or guide channel 106 by way of the second port 68 at a location distal the nozzle 108 between the nozzle 108 and the chamber 6. Unlike the embodiment of FIGS. 3A-3E, in FIGS. 4A-4J, the second composition 67 can be supplied to a fluid supply pathway 69 formed or provided in the manifold body 64 of the fluid platform 3. As shown in FIGS. 4B, 4I, and 4J, the fluid supply pathway 69 can be in fluid communication with the chamber 6 by way of the second port 68, which can be provided at a distal portion of the manifold body 64 and the chamber 6.

For example, as shown in FIG. 4D, the second fluid supply composition line 114 can deliver the second composition 67 to the supply pathway 69, which can extend vertically downwardly (or distally) through the manifold body 64, as shown in FIGS. 4D and 4F. As shown in FIGS. 4D, 4G and 4H, the supply pathway 69 can comprise a first vertical supply pathway 69a that can extend downwardly or distally through the manifold body 64 to transfer the second composition 67 distally, e.g., along a direction substantially parallel with the central axis Z of the chamber 6 (or that includes a directional or flow component parallel to the central axis Z). Turning to FIGS. 4I and 4J, the supply pathway 69 can extend further distally in the manifold body 64 and can fluidly communicate with an annular channel 70, which can comprise a laterally-extending second portion 69b of the supply pathway 69. The annular channel 70 of the supply pathway 69 can comprise a complete or partial annulus disposed around the chamber 6, e.g., revolved around the central axis Z. The second composition 67 can exit the supply pathway 69 through the second port 68 at a distal portion of the manifold body 64. As shown in FIG. 4J, the second port 68 can be disposed distal the orifice 108 (e.g., the first supply port) and can be oriented radially inwardly towards an interior of the chamber 6.

Thus, in FIGS. 4A-4J, the second composition 67 can be delivered to the chamber 6 and can mix with (or be entrained with) the first composition 65 within the treatment instrument 101 (e.g., within the chamber 6). As explained above, the first composition 65 may be delivered to the chamber 6 as a liquid jet and can impact the wall 63 of the chamber 6. Rotational fluid motion can be induced in the first composition 65 in the chamber 6 and the treatment region. The second composition 67 can be supplied into the rotating fluid flow of the first composition 65 within the chamber 6. The first and second compositions 65, 67 can mix or otherwise be combined, and can propagate into the treatment region. As explained above, the fluid motion and pressure waves can cause the first and second compositions 65, 67 to uniformly mix or combine before being delivered to the treatment region through the access port 60. As explained herein, the first and second compositions 65, 67 can be used to, e.g., clean, fill, coat, and/or remineralize the treatment region. Although the second port 68 is shown as communicating with the chamber 6 in FIG. 4J, in other embodiments, the second port 68 can be distally facing to deliver the second composition 67 to the treatment region without being supplied to the chamber 6.

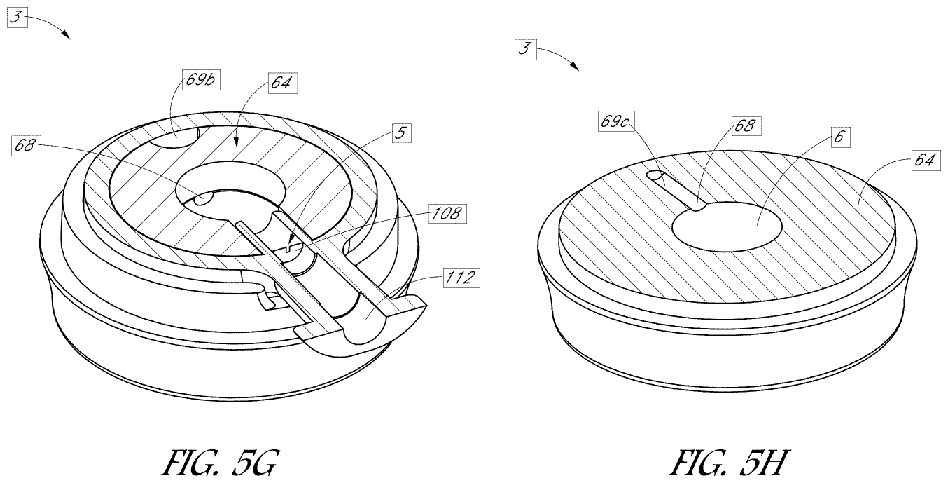

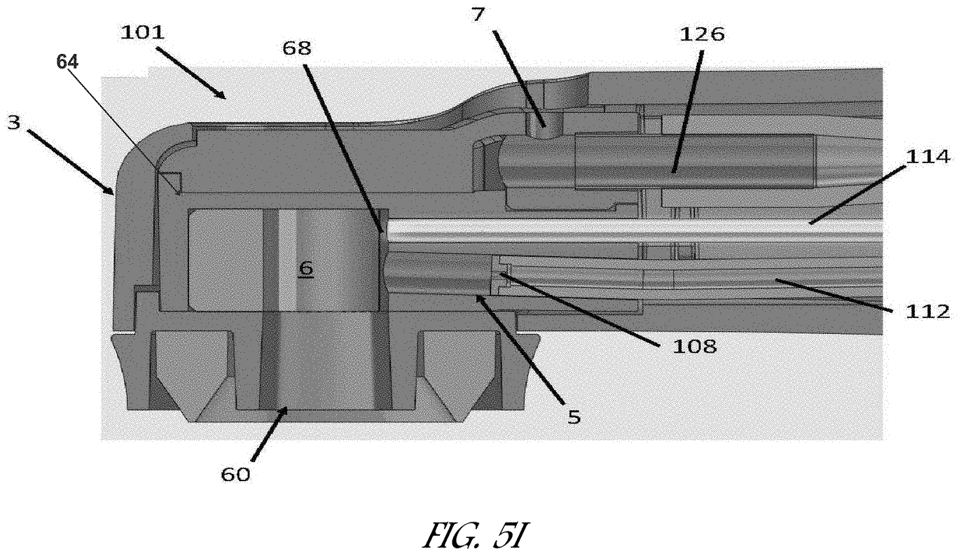

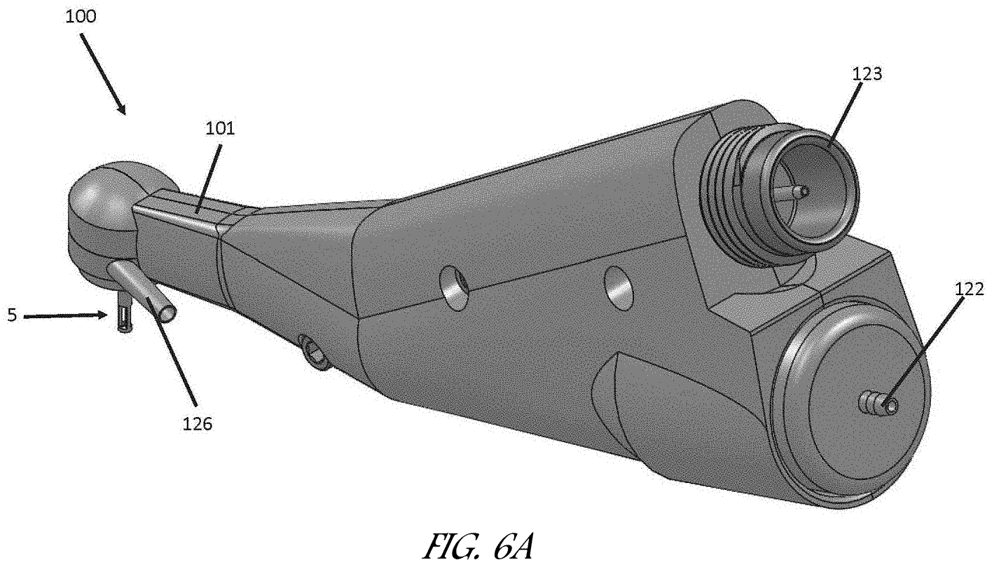

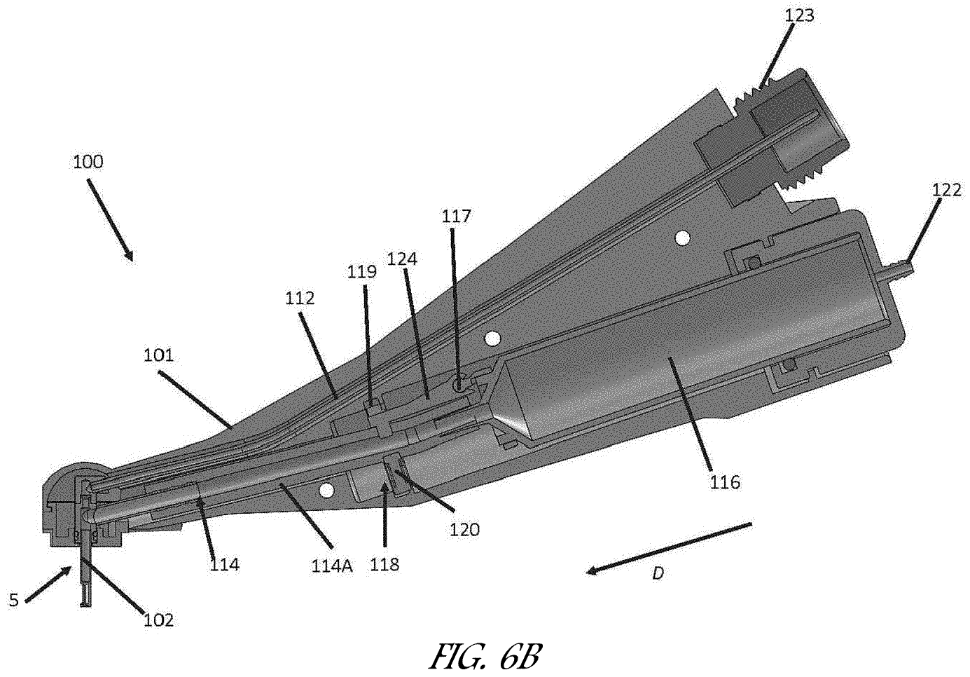

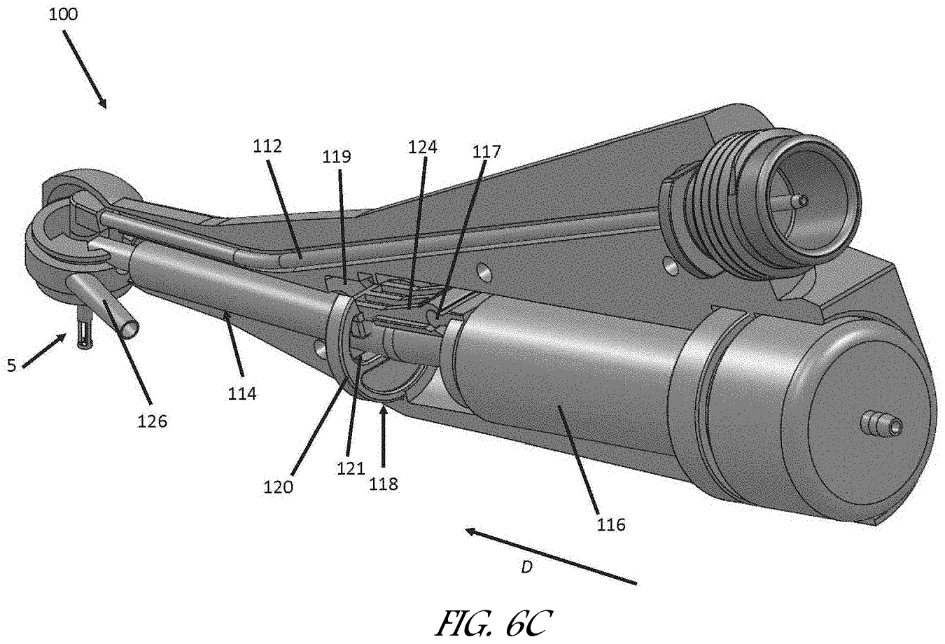

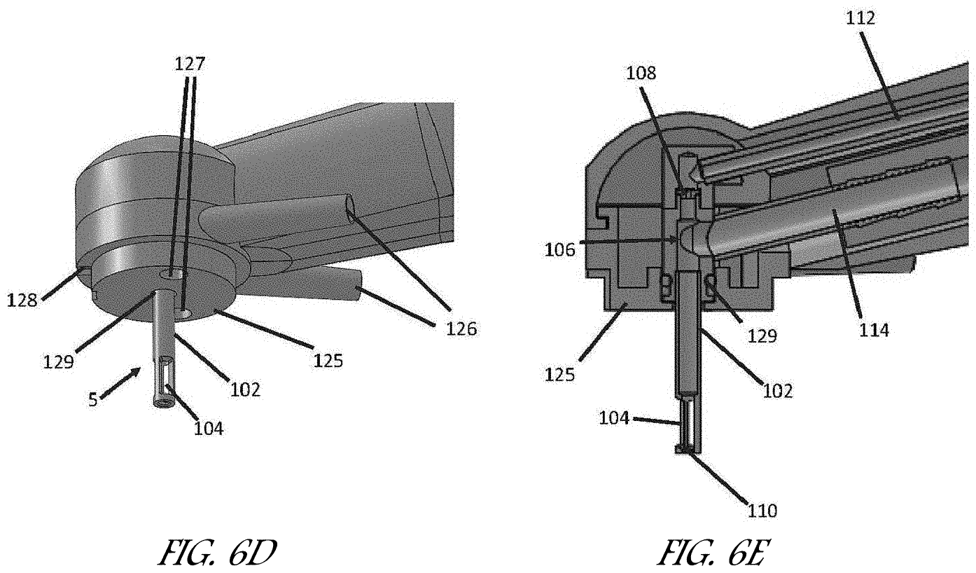

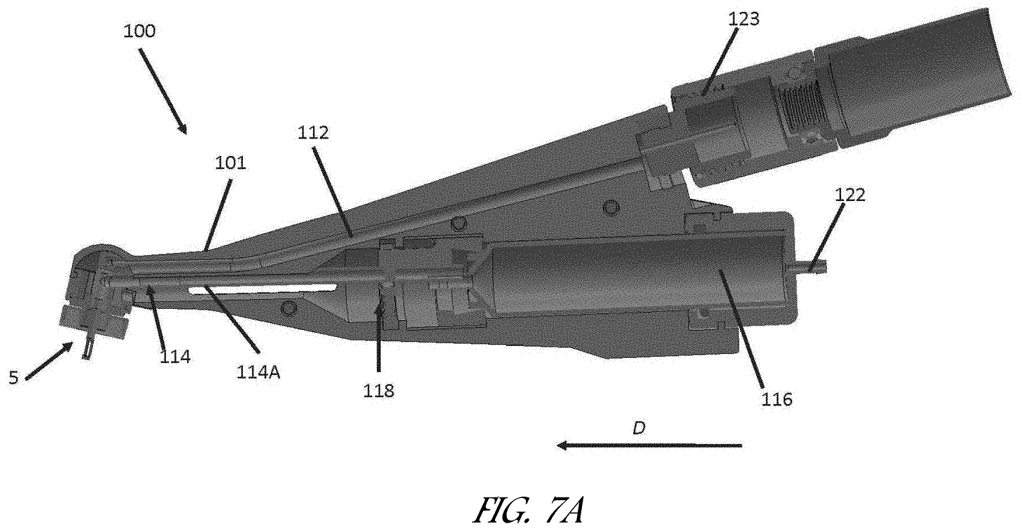

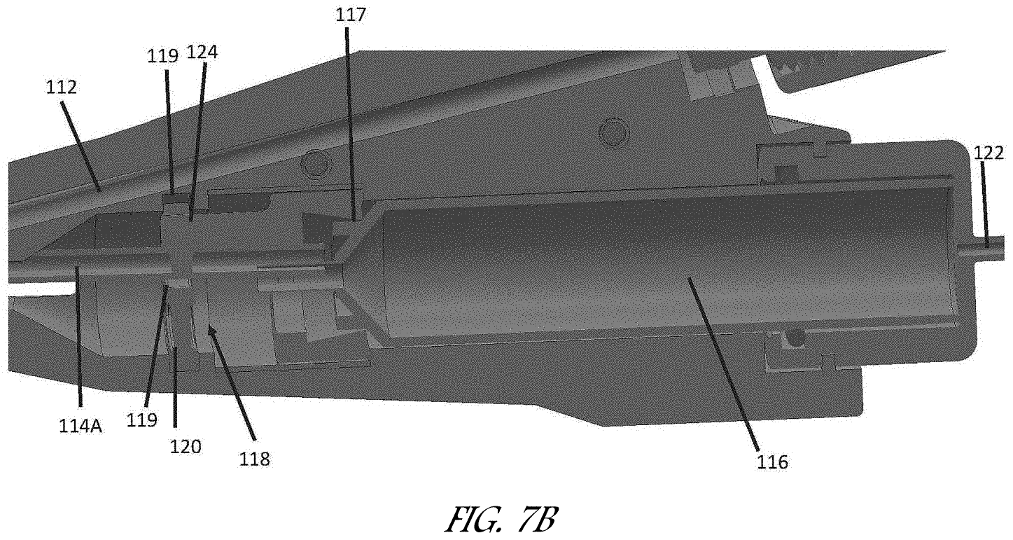

FIGS. 5A-5H illustrate another embodiment of a delivery device 100 comprising a treatment instrument 101 configured to combine multiple components of treatment material to a treatment region of the tooth. In particular, FIG. 5A is a schematic top perspective view of a distal portion of the treatment instrument 101. FIG. 5B is a schematic bottom perspective view of the distal portion of the treatment instrument 101. FIG. 5C is a schematic side sectional view of the treatment instrument, taken along Section 5C-5C of FIG. 5A. FIG. 5D is a schematic side sectional view of the treatment instrument, taken along Section 5D-5D of FIG. 5A. FIG. 5E is a schematic top sectional view of the treatment instrument 101, taken along Section 5E-5E of FIG. 5D. FIG. 5F is a schematic top sectional view of the treatment instrument 101, taken along Section 5F-5F of FIG. 5D. FIG. 5G is a schematic top sectional view of the treatment instrument 101, taken along Section 5G-5G of FIG. 5C. FIG. 5H is a schematic top sectional view of the treatment instrument 101, taken along Section 5H-5H of FIG. 5C.

Unless otherwise noted, components of FIGS. 5A-5H may be the same as or generally similar to like-numbered components of FIGS. 4A-4J. For example, as with FIGS. 4A-4J, the treatment instrument 101 of FIGS. 5A-5H can include a fluid platform 3 in fluid communication with a first fluid composition supply line 112 and a second fluid composition supply line 114. The fluid platform 3 can also include the manifold body 64 that at least partially defines the chamber 6. The first composition 65 (see FIGS. 3A-3E) can be delivered along the first fluid composition supply line 112, as shown in FIG. 5C. In FIG. 5C, a pressure wave generator 5 comprising the nozzle 108 can pressurize the liquid that includes the first composition 65 so as to form a liquid jet (e.g., a coherent, collimated liquid jet). The liquid jet can be delivered across the chamber 6 and impinge on the sidewall 63 of the chamber 6, as explained above in connection with FIGS. 3A-3E. The suction ports 8 (see FIGS. 5D and 5E) can draw waste liquid (and/or other outgoing materials) along the outlet line 126 (FIGS. 5C-5E). As shown in FIGS. 5A and 5C, the vent 7 can be provided to regulate the pressure in the fluid platform 3.

Further, as with the embodiment of FIGS. 4A-4J, the second fluid composition supply line 114 can supply the second composition 67 to the fluid platform 3. In some embodiments, a low pressure pump can be provided in the console 2 or outside the console 2 to drive the second composition 67 to the fluid platform 3. Moreover, as with the embodiment of FIG. 4A-4J, the second composition 67 can be supplied to a fluid supply pathway 69 formed or provided in the manifold body 64 of the fluid platform 3. As shown in FIGS. 5C and 5H, the fluid supply pathway 69 can be in fluid communication with the chamber 6 by way of the second port 68, which can be provided at a middle or intermediate portion of the manifold body 64 and the chamber 6.

As shown in FIGS. 5D and 5F, the second fluid composition supply line 114 can deliver the second composition 67 to the supply pathway 69 in the manifold body 64 along a first lateral supply portion 69a comprising an annular pathway that can be revolved completely or partially about the chamber 6 and the central axis Z. As shown in FIGS. 5C and 5G, the supply pathway 69 can turn distally along a second vertical supply portion 69b directly substantially parallel to the central axis Z of the chamber 6 (or that includes a directional or flow component parallel to the central axis Z). As shown in FIGS. 5C and 5H, the supply pathway can turn radially inwardly along a second lateral supply portion 69c towards the chamber 6 and can fluidly communicate with the chamber 6 by way of the second port 68.

Thus, in FIGS. 5A-5H, the second composition 67 can be delivered to the chamber 6 and can mix with (or be entrained with) the first composition 65 within the treatment instrument 101 (e.g., within the chamber 6). As explained above, the first composition 65 may be delivered to the chamber 6 as a liquid jet and can impact the wall 63 of the chamber 6. Rotational fluid motion can be induced in the first composition 65 in the chamber 6 and the treatment region. The second composition 67 can be supplied into the rotating fluid flow of the first composition 65 within the chamber 6 at the second port 68 shown in FIGS. 5C and 5H. The first and second compositions 65, 67 can mix or otherwise be combined, and can propagate into the treatment region. As explained above, the fluid motion and pressure waves can cause the first and second compositions 65, 67 to uniformly mix or combine before being delivered to the treatment region through the access port 60. As explained herein, the first and second compositions 65, 67 can be used to, e.g., clean, fill, coat, and/or remineralize the treatment region.

FIG. 5I is a schematic side sectional view of a treatment instrument 101, according to another embodiment. Unless otherwise noted, components of FIG. 5I may be the same as or generally similar to like-numbered components of FIGS. 3A-5H. For example, as with FIGS. 3A-5H, the treatment instrument 101 of FIG. 5I can include a fluid platform 3 in fluid communication with a first fluid composition supply line 112 and a second fluid composition supply line 114. The fluid platform 3 can also include the manifold body 64 that at least partially defines the chamber 6. The first composition 65 (see FIGS. 3A-3E) can be delivered along the first fluid composition supply line 112. A pressure wave generator 5 comprising the nozzle 108 can pressurize the liquid that includes the first composition 65 so as to form a liquid jet (e.g., a coherent, collimated liquid jet). The liquid jet can be delivered across the chamber 6 and impinge on the sidewall 63 of the chamber 6, as explained above in connection with FIGS. 3A-3E. The suction ports 8 (not illustrated in FIG. 5I) can draw waste liquid (and/or other outgoing materials) along the outlet line 126. The vent 7 can be provided to regulate the pressure in the fluid platform 3.

Further, as with the embodiment of FIGS. 3A-5H, the second fluid composition supply line 114 can supply the second composition 67 to the fluid platform 3. In some embodiments, a low pressure pump can be provided in the console 2 or outside the console 2 to drive the second composition 67 to the fluid platform 3. In other embodiments, the vacuum created by the liquid jet can draw the second composition into the chamber 6. In the embodiment of FIG. 5I, the second supply line 114 can deliver the second composition 67 to the chamber 67 by way of the second port 68, which can be distal the orifice 108. In other embodiments, the orifice 108 can be flush with the sidewall 63 of the chamber 6 (or can extend into the chamber 6). As with FIGS. 3A-5H, the first and second compositions 65, 67 can be combined or mixed in the chamber 6. The fluid motion and pressure waves generated by the liquid jet can thoroughly mix the compositions 65, 67 before delivery to the treatment region.

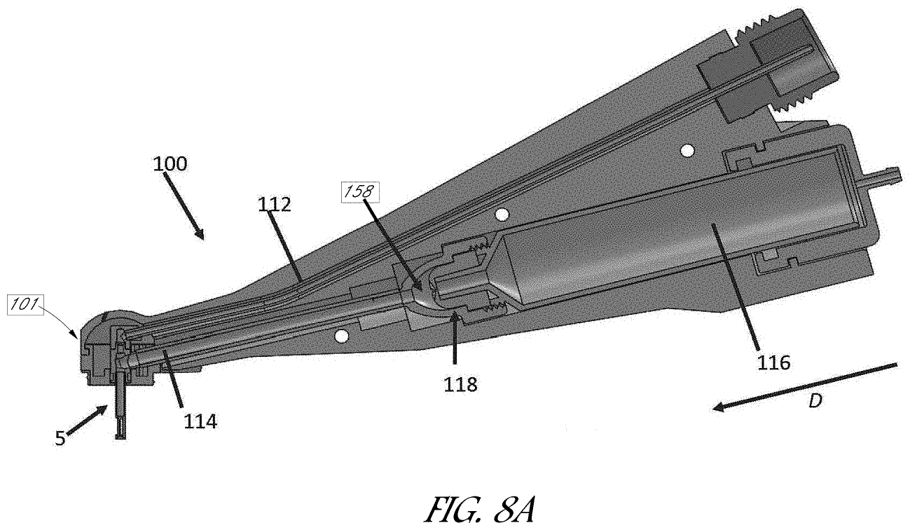

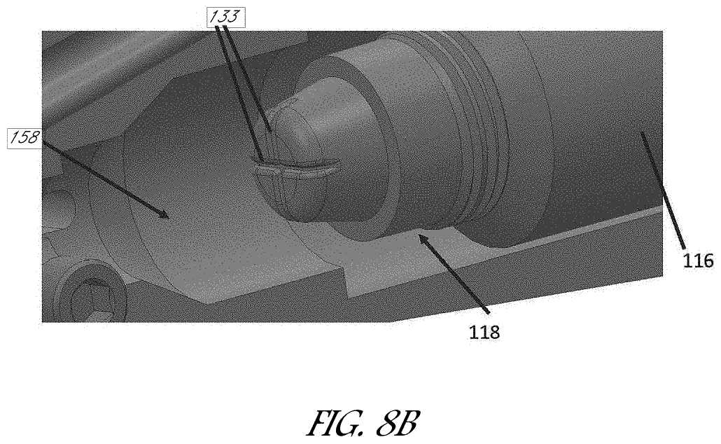

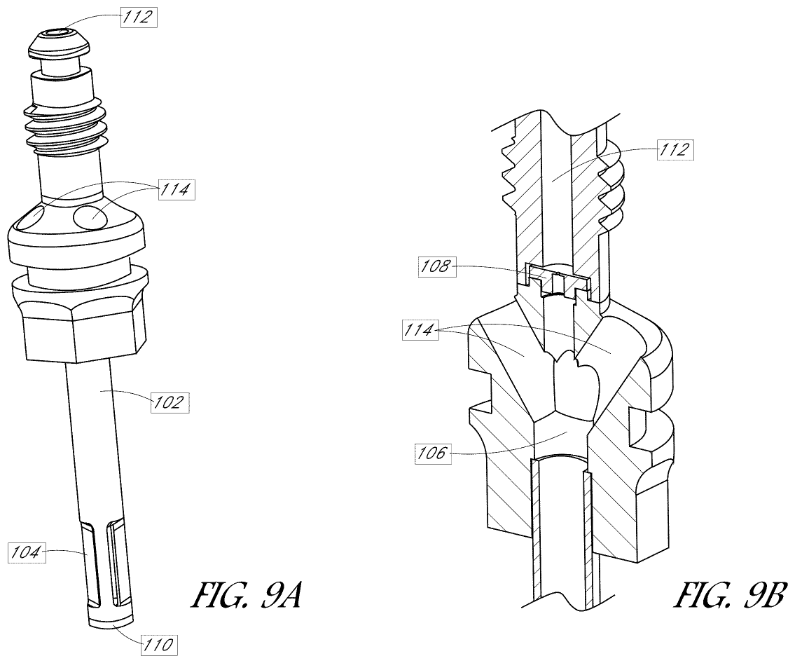

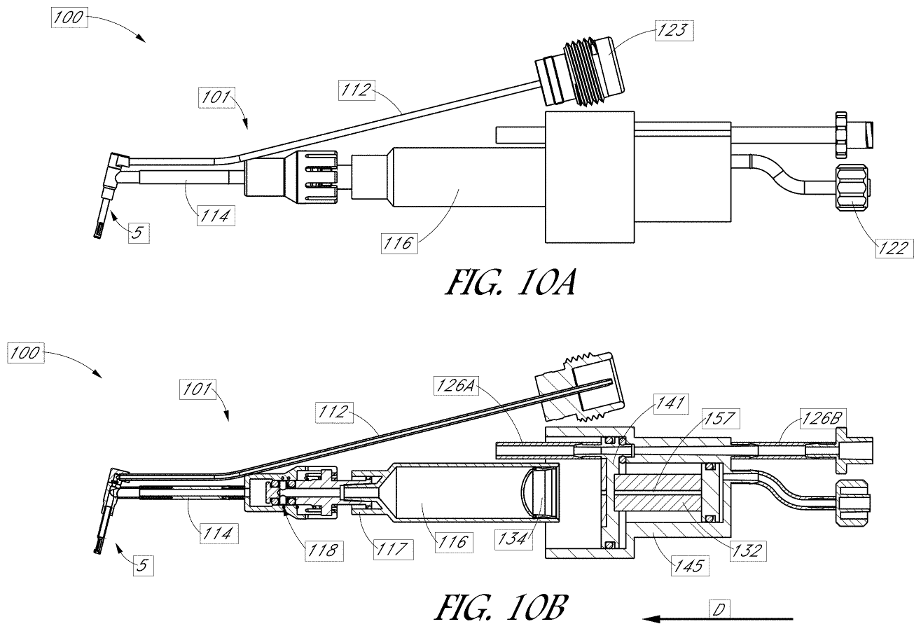

FIGS. 6A-6E illustrate another example of a delivery device 100 comprising a treatment instrument 101 configured to combine multiple components of treatment material for delivery to a treatment region, e.g., to deliver a filling material to a treatment region of a tooth. Unless otherwise noted, the components of FIGS. 6A-6E may be generally similar to or the same as like-numbered components of FIGS. 1A-5I. As shown in FIG. 6A, the treatment instrument 101 can comprise a pressure wave generator 5 (e.g., a liquid jet device) coupled with a distal portion of the treatment instrument 101. A first connector 123 can be configured to removably connect with a high pressure fluid line to supply pressurized liquid to the first composition supply line 112. A second connector 122 can be configured to removably connect with a pneumatic fluid line to supply pressurized fluid (e.g., pressurized air) to drive the second composition along the second composition supply line 114. In other embodiments, as explained herein, a low pressure pump can drive a second liquid composition along the second composition supply line 114. In still other embodiments, the second composition can be drawn along the second supply line 114 by the Venturi effect created by the liquid jet of the first composition. In addition, an evacuation or outlet line 126 can be provided to remove waste fluid (e.g., cleaning fluid, biological materials, and/or filling material) from the treatment region of the tooth to a waste reservoir in the console. As shown in FIG. 6D, in various embodiments, multiple outlet lines 126 (e.g., two outlet lines) can be provided to remove waste fluid from the treatment region.

As explained above, the treatment instrument 101 can be configured to perform one or a plurality of dental treatment procedures. For example, the treatment instrument 101 can be configured to perform both cleaning procedures (e.g., root canal cleaning procedures, caries cleaning procedures, hygiene procedures, etc.), coating or remineralization procedures, and/or filling procedures (e.g., root canal obturation procedures, treated caries filling procedures, restoration procedures, etc.). In FIG. 6B, the first composition supply line 112 can be configured to deliver a pressurized liquid to the treatment region. For example, during a cleaning procedure, the first composition supply line 112 can be configured to deliver cleaning liquids (e.g., water, bleach, EDTA) to the treatment region. The orifice or nozzle 108 can form the cleaning liquid into a coherent, collimated liquid jet. The jet can pass along the guide tube 102 and can interact with liquid at the treatment region by way of the openings 104. Interaction of the cleaning liquid(s) with the liquid in the treatment region can generate broadband pressure waves and liquid motion to clean the treatment region.

Once the treatment region is cleaned, the clinician can move from a cleaning mode to a filling mode to fill the treated portion of the tooth. For example, the clinician can engage the console to initiate the filling procedure or filling mode. In various embodiments, the treatment instrument 101 can deliver a multi-component filling material by supplying a first composition (for example, a carrier liquid) along the first composition supply line 112 to the orifice 108 and a second composition (for example, a paste or other fluid) along the second composition supply line 114. The first and second compositions can be combined in the mixing chamber 106 within a portion of the guide tube 102 distal the orifice 108. As shown in FIG. 6E, for example, the first and second compositions can mix within the mixing chamber 106 between the orifice 108 and a distal end of the guide tube 102 (e.g., at or near the impingement plate 110).

As shown in FIG. 6B, the treatment instrument 101 can further include a reservoir 116 that includes the second composition of the filling material. The reservoir 116 can be fluidly connected to the second composition supply line 114. During a cleaning procedure, it can be important to prevent or block the second composition from entering the guide tube 102 and mixing chamber 106, such that the second composition does not interfere with the efficacy of the cleaning procedure. Accordingly, as shown in FIGS. 6B-6C, the treatment instrument 101 can include a valve 118 configured to controllably permit or block the second composition from flowing along the second composition supply line 114. In the embodiment of FIGS. 6A-6E, the valve 118 comprises a pinch valve in which a flexible portion 114A of the second supply line 114 is pinched to block the flow of the second composition along the second supply line 114 during a cleaning procedure.

The valve 118 can comprise a valve body 120 and an aperture 121 through which the flexible portion 114A of the second supply line 114 is disposed. The valve 118 is shown in FIGS. 6B-6C in a normally closed configuration in which a clamping member 124 presses downwardly against the valve body 120 to pinch the flexible portion 114A of the second supply line 114 to prevent the second composition from entering the second supply line 114 and the mixing chamber 106. When the cleaning procedure is finished and the filling procedure is initiated, pressurized fluid (e.g., pressurized air) can be supplied to the second connector 122. The pressurized fluid can drive a plunger (not shown) disposed in the reservoir 116 along a distal direction D. The plunger can urge the second composition distally D, and can also move a drive member 117 distally D. Since the valve 118 in the closed condition prevents the second composition from flowing through the second supply line 114, the reservoir 116 can be driven distally with the plunger. The drive member 117 can engage with the clamping member 124 in a manner such that distal motion of the drive member 117 causes the clamping member 124 to move radially outward into a recess 119. For example, as the drive member 117 and clamping member 124 move distally, the pressure of the second composition flowing through the flexible portion 114A of the second supply line 114 can urge the walls of the flexible portion 114A radially outwardly, which can in turn move the clamping member 124 radially outward into the recess 119. Radially outward movement of the clamping member 124 can release the pinching forces against the flexible portion 114A of the second supply line 114, thereby allowing the second composition to be driven from the reservoir 116 along the second composition supply line 114 and to the mixing chamber 106.

Turning to FIGS. 6D-6E, and as explained above, the first composition can pass through the orifice 108 and form a coherent, collimated liquid jet. The second composition can intermix with the first composition in the mixing chamber 106 at a location distal the orifice 108 between the orifice 108 and the impingement member 110. The first composition (e.g., a carrier liquid) can accordingly mix with and drive the mixed composition into the treatment region to fill the treatment region of the tooth. As explained above, generated pressure waves and fluid motion can cause the filling material to fill small and large spaces of the treatment region. One or more outlet or suction ports 127 can be provided through a sealing cap 125 removably engaged (e.g., threadably engaged) with the distal portion of the treatment instrument 101. An evacuation pump in the console can draw waste liquid (e.g., biological materials, portions of filling material, etc.) through the outlet ports 127 into the treatment instrument 101 and can be conveyed to a waste reservoir along the outlet line(s) 126. As shown in FIGS. 6D-6E, a seal 129 (e.g., an o-ring) can be provided around the guide tube 102 to prevent liquid(s) from leaking out around the interface between the guide tube 102 and the sealing cap 125. One or more vents 128 can be provided through the distal portion of the treatment instrument 101 and can be exposed to ambient air. The vents 128 can enable air to be entrained into the outlet line(s) 126, which can prevent overpressurization of the treatment region during cleaning and/or filling procedures.

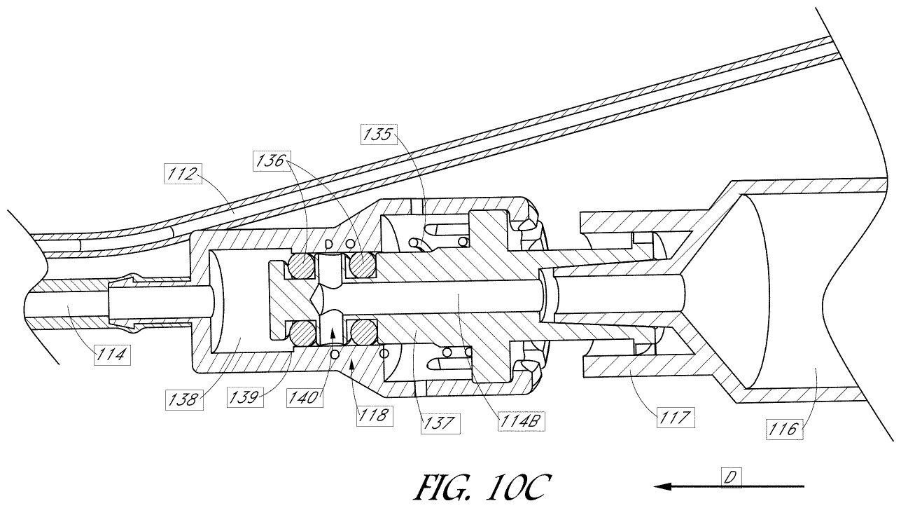

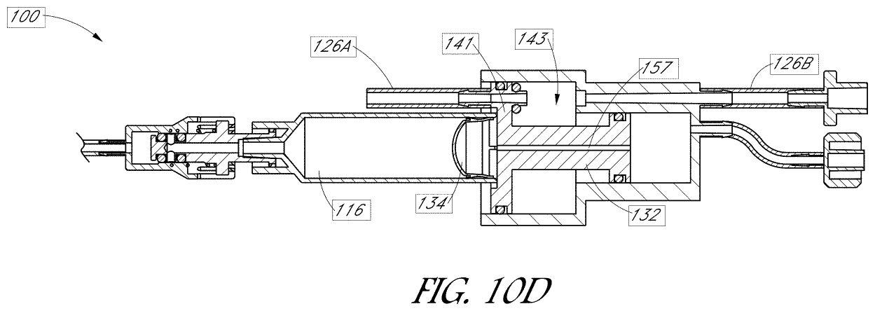

FIGS. 7A-7B illustrate another embodiment of a delivery device 100 including a treatment instrument 101. Unless otherwise noted, the components of FIGS. 7A-7B may be the same as or generally similar to like-numbered components of FIGS. 6A-6E. As with FIGS. 6A-6E, the treatment instrument 101 includes the reservoir 116 to hold and deliver the second composition of the filling material. Moreover, as with FIGS. 6A-6E, the treatment instrument 101 includes a valve 118 comprising a pinch valve having a valve body 120, an aperture 121, and a clamping member 124. The treatment instrument 101 also includes the drive member 117, which is different from the drive member 117 of FIGS. 6A-6E. The drive member 117 can comprise a sloped surface which can engage with a proximal end of the clamping member 124. Pressurized fluid (e.g., air) can drive a plunger (not shown) to cause the drive member 117 to move distally D. The drive member 117 can engage with the clamping member 124 in such a manner as to cause the clamping member 124 to move distally beyond the valve body 120. When the clamping member 124 is distal the valve body 120, the clamping member 124 may release the pinching forces against the flexible portion 114A of the second supply line 114 to enable the second composition to flow along the second composition supply line 114.

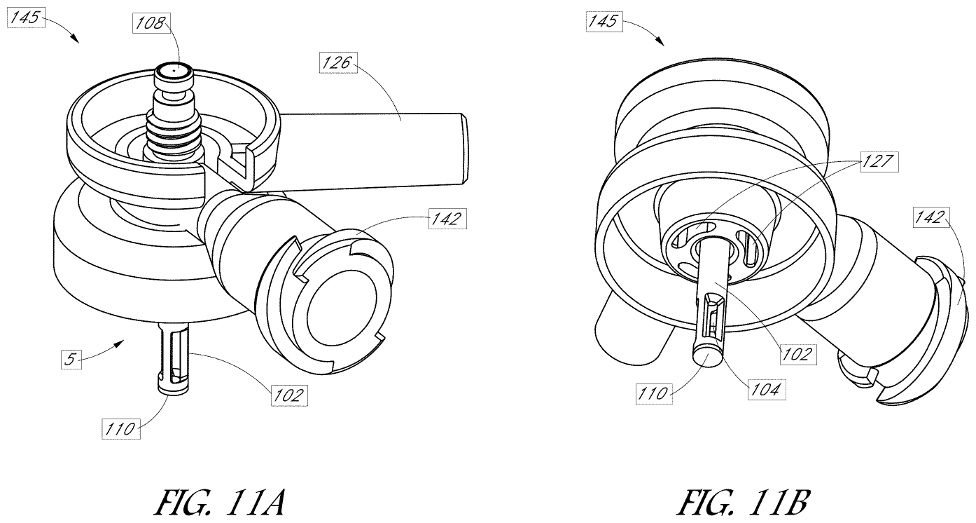

FIGS. 8A-8B illustrate another embodiment of a delivery device 100 including a treatment instrument 101. Unless otherwise noted, the components of FIGS. 8A-8B may be generally similar to or the same as like-numbered components of FIGS. 7A-7B. For example, as with FIGS. 7A-7B, a valve 118 can be provided to controllably permit and block the second composition from entering the second composition supply line 114 from the reservoir 116. Unlike the embodiment of FIGS. 7A-7B, however, the valve 118 can comprise a rupture valve. As shown in FIG. 8B, the valve 118 can comprise a flexible material having one or more grooves 133 defined therein. The grooves 133 can comprise portions of the valve 118 having a reduced thickness. The grooves 133 and material for the valve 118 can be selected to rupture when the pressure of the second composition exceeds a threshold or rupture pressure. When the pressure of the second composition exceeds a rupture pressure, the second composition can be driven into a distal recess 158 and into the second supply line 114.

During a cleaning procedure, the valve 118 can be closed while a liquid jet is formed by the orifice 108. The high velocity jet can cause a Venturi effect in which negative pressure is applied to the valve 118 during cleaning. Accordingly, the valve 118 can be structured and formed of a material that is sufficiently strong so as to resist the negative pressures caused during cleaning, but that ruptures when pressure is applied to the second composition during a filling procedure. In various embodiments, for example, the valve 118 can be structured to rupture at applied pressure in a range of 15 psi to 40 psi. The valve 118 can comprise a polymer material. In various embodiments, the valve 118 can comprise a biocompatible thermoplastic elastomer (TPE), such as Santoprene™, sold by Exxon Mobil Corporation of Irving, Tex.

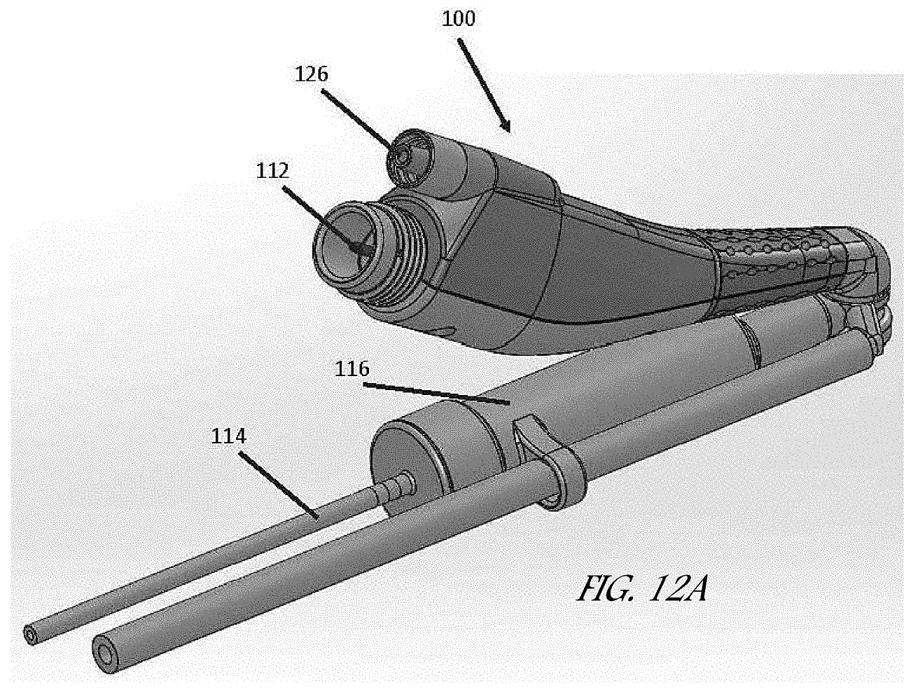

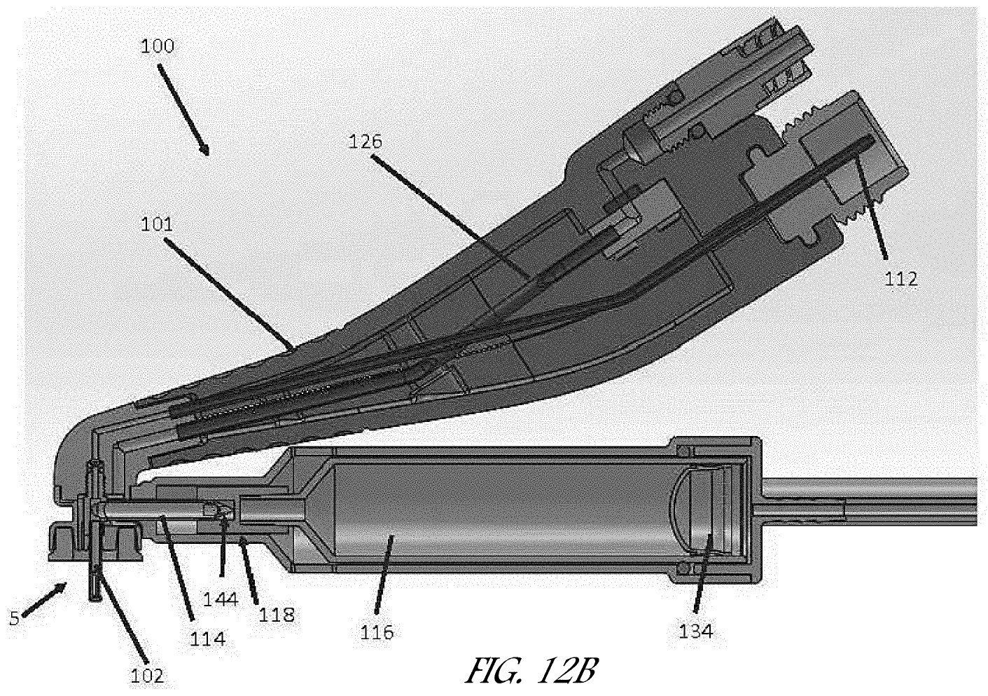

FIGS. 9A-9B illustrate a treatment assembly which can be used in various embodiments disclosed herein. For example, in various embodiments, the treatment assembly can be used in conjunction with a handpiece or treatment instrument that is reusable. In other embodiments, the handpiece or treatment instrument may not be reusable. Unless otherwise noted, the components of FIGS. 9A-9B can be the same as or similar to like-numbered components of FIGS. 1A-8B. In FIGS. 6A-8B, the second composition is shown as being delivered from a side delivery device along the second supply line 114. Unlike the embodiments of FIGS. 6A-8B, the treatment assembly of FIGS. 9A-9B can comprise a diffuse delivery assembly that can deliver the second composition from above and through a plurality of ports to the mixing chamber 106. For example, as shown in FIGS. 9A-9B, a plurality (e.g., four) of second composition supply lines 114 can be disposed circumferentially about the guide tube 102. The second composition can be delivered downwardly at an angle through the multiple supply lines 114 to mix with the first composition in the mixing chamber 106. The arrangement of FIGS. 9A-9B may be beneficial, in that the second composition can be supplied with a component of momentum parallel to the momentum of the liquid jet formed by the first carrier composition, which may reduce the extent to which the jet is disrupted by the second composition entering from a side direction. Moreover, positioning multiple supply lines 114 in a symmetric arrangement about the guide tube 102 may further improve the directionality of the liquid jet.

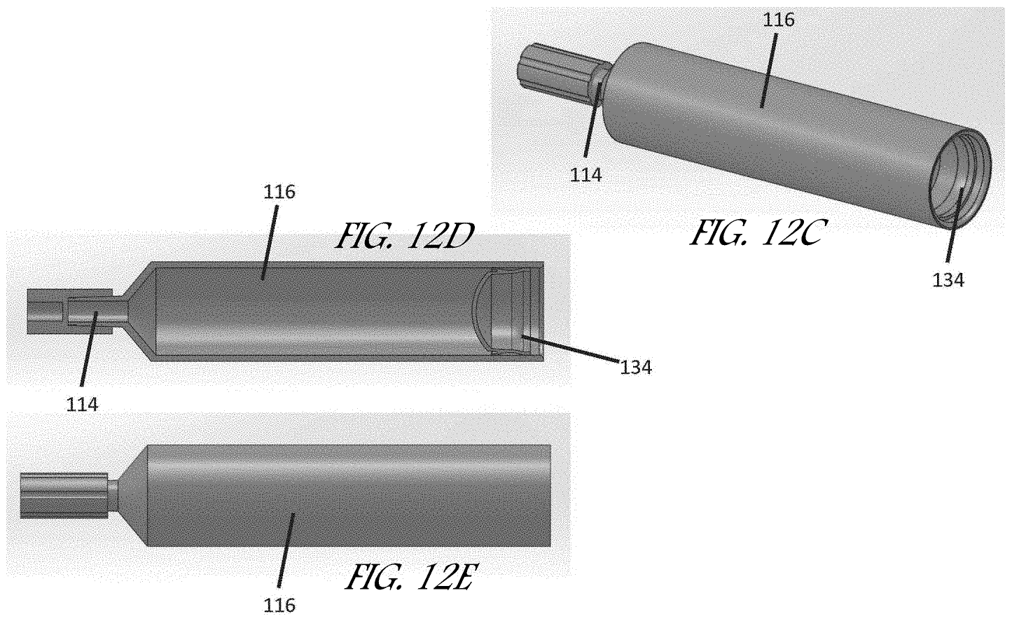

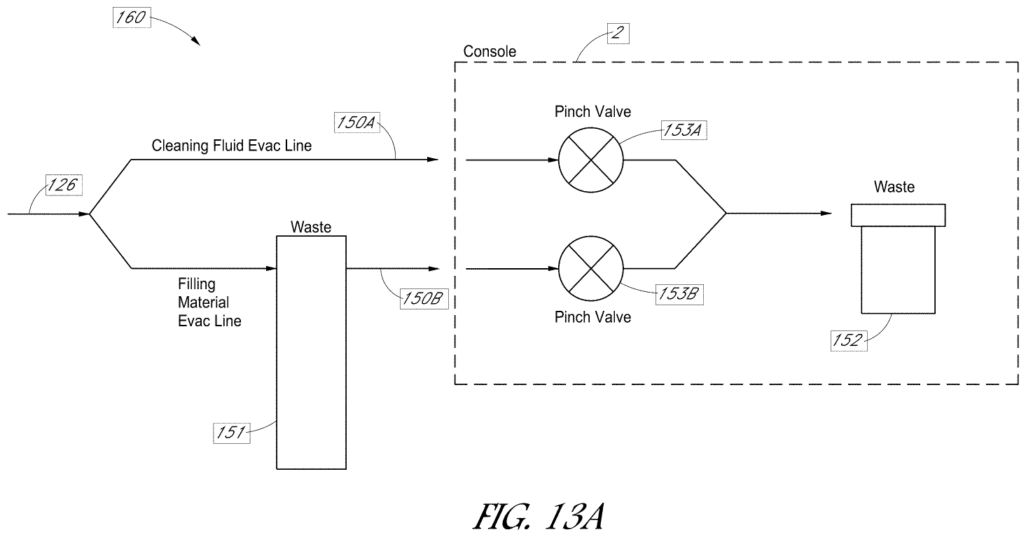

FIGS. 10A-10D illustrate a delivery device 100 comprising a treatment instrument 101 according to another embodiment. Unless otherwise noted, the components of FIGS. 10A-10D can be the same as or similar to like-numbered components of FIGS. 1A-9B. As with the embodiments of FIGS. 6A-8B, the treatment instrument 101 can include a valve 118 to regulate the flow of the second composition from the reservoir 116 to the second composition supply line 114. Unlike the embodiments of FIGS. 6A-8B, however, the valve 118 can slide distally D to permit the second composition to flow around an outer periphery of the valve 118.

For example, the treatment instrument 101 can include a slidable track 132 having a lumen or channel 157 therethrough. A slidable portion 126A of the outlet line 126 can be coupled to or formed with the slidable track 132. During a cleaning treatment, the slidable track 132 can be disposed at a proximal position, as shown in FIGS. 10B-10C. In the proximal position, the slidable portion 126A of the outlet line 126 can fluidly connect to a proximal portion 126B of the outlet line 126 to convey the waste cleaning fluid from the treatment region of the tooth, along the slidable portion 126A and the proximal portion 126B of the waste line 126, and into a waste reservoir (not shown). In some embodiments, during a filling treatment, waste filling material may also be transferred to the waste container along the same waste line 126 as the waste cleaning fluid. However, in some arrangements, conveying waste filling fluids to the conduit(s) of the console may degrade the material(s) of the conduits in the console. In the embodiment of FIGS. 10A-10D, the device 100 can utilize a waste canister 143 disposed in or near the treatment device 100, which may be different from the waste reservoir used for waste cleaning fluids.

During a filling treatment, pressurized fluid (e.g., air) can be supplied through the second connector 122. The pressurized fluid can pass through the channel 157 of the slidable track 132 and can impinge upon a plate 141 to drive the plate 141 and the slidable portion 126A of the outlet line 126 distally D. The plate 141 can engage with a proximal portion of the reservoir 116 and can drive the reservoir 116 distally D to a distal position as shown in FIG. 10D. In the distal position of FIG. 10D, the plate 141 and slidable track 132 can move out of an outer shell 145 in which the plate 141 and slidable track 132 are disposed when in the proximal position during a cleaning treatment. The plate 141 can include one or more openings (not shown) to enable the pressurized fluid to pass through the plate 141 and to impinge upon a plunger 134. The pressurized fluid can drive the plunger 134 distally D to drive the second composition through an upstream portion 114B of the second supply line 114.

A drive member 117 at a distal portion of the reservoir 116 can contact a proximal end of a valve body member 137. During a cleaning procedure, a spring 135 can be biased so as to maintain the valve body member 137 at the proximal position shown in FIGS. 10B-10C. In the proximal position shown in FIGS. 10B-10C, seals 136 can block the second composition from flowing along the second supply line 114. During a filling procedure, the drive member 117 can push the valve body member 137 distally D so as to overcome the proximally-biased force of the spring 135. As shown in FIG. 10C, the distal portion of the valve body member 137 can include a plurality of the seals 136 (e.g., o-rings) disposed on opposite sides of one or more ports 140 formed through a peripheral wall of the drive member 117. When the valve body member 137 is driven sufficiently distal D such that the port(s) 140 are disposed distal a shoulder 139 of a receiver 138, the second composition can be urged radially outward through the port(s) 140, through the receiver 138, and into the second composition supply line 114.

Thus, in FIGS. 10A-10C, the drive member 117 of the reservoir 116 can push the valve body member 137 distally to expose the port(s) 140 in the receiver 138. Pressurized fluid can cause the plunger 134 to expel the second composition through the upstream portion 114B, the port(s) 140, the receiver 138, and into the second supply line 114. Moreover, in the illustrated embodiment, the distal sliding movement of the track 132 and slideable portion 126A of the outlet line 126 can cause the slideable portion 126A to break a fluid seal between the outer shell 145 and the plate 141 or slidable track 132. Waste fluid (e.g., excess filling material, biological fluids, etc.) may be drawn proximally into the waste canister 143 defined at least in part by a distal portion of the outer shell 145. The waste fluid can accordingly collect within the waste canister 143 of the treatment device 100, and may not be transferred to the console. Although the waste canister 143 is shown as being inside the treatment device 100, in other embodiments, the waste canister 143 can be located outside the treatment device 100.

FIGS. 11A-11B illustrate a distal portion 145 of a treatment instrument 101, according to various embodiments. Unless otherwise noted, the components of FIGS. 11A-11B can be the same as or similar to like-numbered components of FIGS. 1A-10C. For example, the distal portion 145 can include a guide tube 102, a plurality of openings 104, and an impingement plate 110. A plurality of outlet ports 127 can be arranged circumferentially about the guide tube 102 to draw waste fluid from the treatment region. A sealing cap 125 can be coupled to or formed with the treatment instrument 101. In the embodiment of FIGS. 11A-11B, the distal portion 145 can be removably coupled with one or more of the evacuation line 126, the first composition supply line 112, and the second composition supply line 114. For example, a connector 142 (such as a luer lock connector) can be configured to removably connect to the second composition supply line 114 to fluidly connect the second supply line 114 with the mixing chamber 106 of the distal portion 145. The clinician can rotate or twist the connector 142 to the second supply line 114 in a proximal portion of the treatment instrument 101.

FIGS. 12A-12E illustrate another embodiment of a delivery device 100 that includes a treatment instrument 101 configured to clean and/or fill a treatment region of the tooth. Unless otherwise noted, components of FIGS. 12A-12E may be generally similar to or the same as like-numbered components of FIGS. 1A-11B. In the embodiment of FIGS. 12A-12E, the reservoir 116 for holding and supplying the second composition of the filling material can be separate from the handpiece body of the treatment instrument 101 that includes the high pressure line for the first composition supply line 112. In some embodiments, the handpiece body can be reusable, and the reservoir 116 can be disposable. In other embodiments, the handpiece body and the reservoir 116 can be disposable. In various embodiments, the clinician can removably engage the reservoir 116 with the device 100 and can drive the plunger 134 distally to urge the second composition through the second supply line 114. As explained above, a valve 118 can be provided between the reservoir 116 and the second supply line 114 to controllably permit or block the flow of the second composition into the second supply line 114. The valve 118 can include any suitable type of valve, including, e.g., a rupture valve, a pinch valve, a sliding valve, etc. For example, in FIG. 12B, the valve 118 can comprise a rupture valve including a spike 144. When the valve body is driven distally, the spike 144 can pierce the valve body 120. The second composition can be driven through a fluid pathway within the spike 144 in some embodiments. In various embodiments, the clinician can manually engage the plunger 134. In other embodiments, the plunger 134 can be driven pneumatically by a pressurized fluid, as explained above.

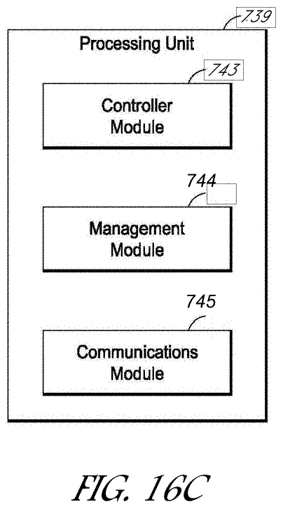

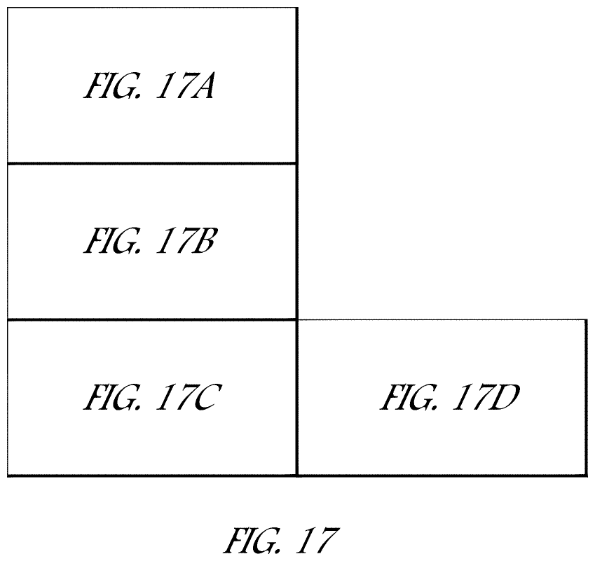

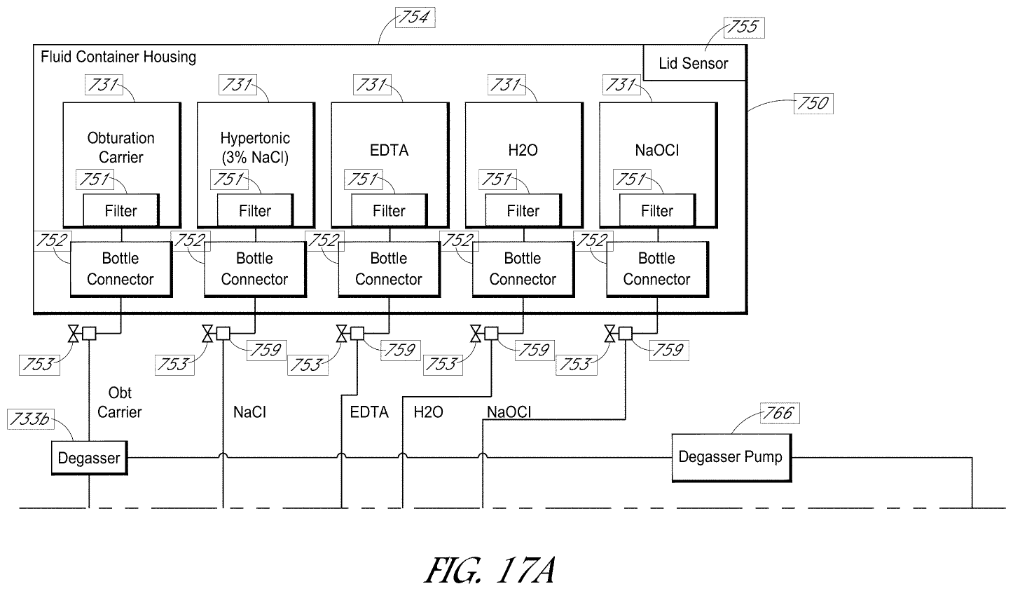

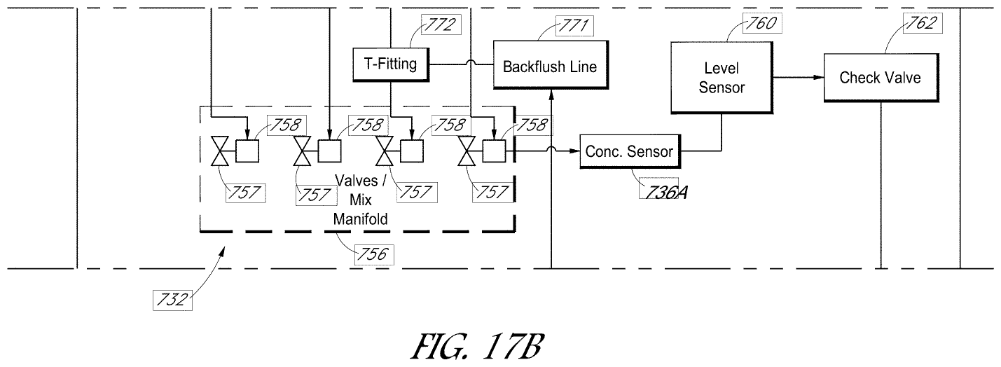

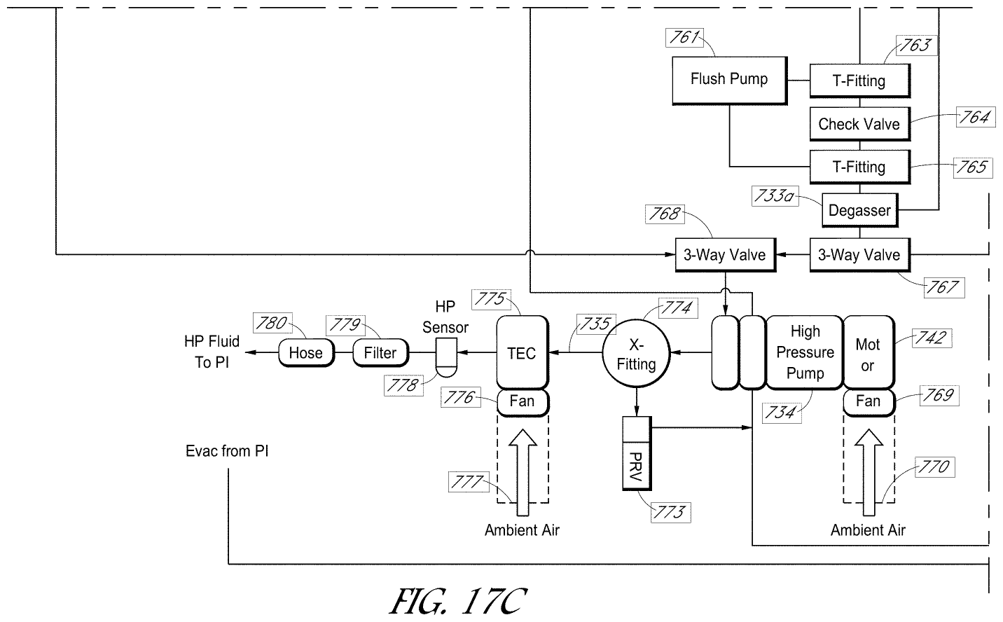

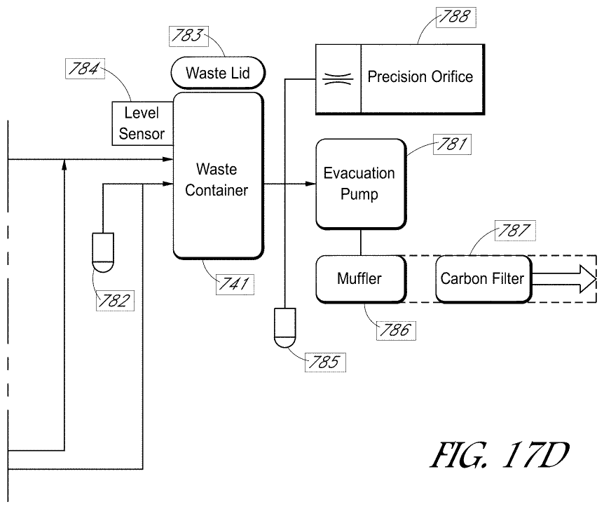

FIGS. 13A-13E illustrate various examples of evacuation systems 160 for removing waste from the treatment region of the tooth. The evacuation systems 160 described in FIGS. 13A-13E can be used in combination with the features of the console 2 illustrated and described herein in connection with FIGS. 16A-26. The evacuation systems 160 can beneficially be configured to remove one or more of cleaning fluids, components of filling materials, mixed filling materials, biological materials, etc. In FIG. 13A, the evacuation system 160 can include an evacuation or waste line 126 that conveys waste fluids from the treatment region. In various embodiments, the waste line 126 can comprise a single use conduit; in other embodiments, the waste line 126 can be reused in multiple procedures. The system 160 of FIG. 13A can include first and second valves 153A, 153B that can control the flow of waste fluids from the treatment region. For example, during a cleaning procedure, the first valve 153A can be opened, and the second valve 153B can be closed. An evacuation pump (not shown) can draw waste cleaning fluids and biological material proximally through a first cleaning fluid evacuation line 150A, into the console 2, through the first valve 153A, and into a console waste container 152. During a filling procedure, the second valve 153B can be opened, and the first valve 153A can be closed. The evacuation pump can draw waste filling material (and possibly biological material) through a second filling material evacuation line 150B, and into a secondary filling waste container 151. Beneficially, the use of the secondary filling waste container 151 can allow the waste filling material to be stored outside the console, which can reduce deterioration or damage due to the repeated delivery of waste filling material to conduit(s) within the console.

Turning to FIG. 13B, the evacuation system 160 can include the evacuation or waste line 126 which can transport waste cleaning fluids, waste filling materials or components thereof, and/or biological waste materials to a waste container 151, which may be located outside the console 2. As shown in FIG. 13B, an evacuation or vacuum pump 154 can be provided in the console 2 to draw the waste fluids to the waste container 151 from the treatment region. The waste container 151 can be located outside the console and can be emptied or discarded after cleaning and/or filling procedure(s).

In FIG. 13C, the evacuation or waste line 126 can convey waste cleaning fluids, waste filling materials or components thereof, and/or biological waste materials to a channel 155 (labeled tunnel evacuation tube) in the console 2. The channel 155 can convey the waste fluids to the waste container 152 in the console 2. The channel 155 can comprise a disposable or removable cartridge that is removably connected to the console 2 and the waste container 152. After cleaning and/or filling procedure(s), the channel 155 can be discarded. The removable channel 155 can convey both cleaning and filling waste materials to the waste container 152. Because the channel 155 may be disposable, the conduits within the console may not be damaged by repeated delivery of waste filling materials therethrough.

Turning to FIG. 13D, the evacuation system 160 may be similar to the system 160 shown in FIG. 13A. The evacuation system 160 can be fluidly connected to the treatment instrument 101, which can comprise any of the treatment instruments 101 disclosed herein. The valves 153A, 153B can be selectively opened and closed to draw waste cleaning fluids or waste filling fluids to the waste containers 151, 152 as explained above. In the embodiment of FIG. 13D, the secondary waste container 151 can be located at or near the treatment instrument 101. For example, the secondary waste container 151 can be connected to the conduits (such as the high pressure conduit 112) that couples the treatment instrument 101 to the console 2.

Turning to FIG. 13E, the evacuation system 160 can include secondary waste container 151 upstream of waste container 152. The secondary waste container 151 can be located outside the console 2 in some embodiments. The secondary waste container 151 can include a filter configured to filter out waste filling material such that waste filling material is retained within the secondary waste container 151. Thus, waste cleaning fluids can pass through the filter of the secondary waste container 151 and can pass through to the waste container 152. By contrast, waste cleaning fluids can be retained by the filter within secondary waste container 151.

FIGS. 13F-13P are schematic perspective views illustrating additional examples of treatment instruments 101, according to various embodiments. Unless otherwise noted, components of FIGS. 13F-13P may be the same as or generally similar to like-numbered components of FIGS. 1A-13E. As explained herein, various embodiments can include systems configured to combine multiple compositions in the treatment instrument 101 or at the treatment region. Any suitable number of compositions can be combined in any suitable type of dental treatment, such as cleaning treatments, filling treatments, coating and remineralization treatments, etc. For example, in some embodiments, two components (e.g., Part A (or Component A) and Part B (or Component B)) can be combined to form a suitable treatment fluid. In some embodiments, three components (e.g., Part A, Part B, and Part C) can be combined to form the treatment fluid. In some embodiments, more than three components can be combined or mixed to form the treatment fluid. In some embodiments, only one component (e.g., component A) can be used to form the treatment fluid. As explained herein, the component materials can comprise a fluid (e.g., a flowable material), such as a liquid, a paste, a gel, a gas, a powder or solid particulates entrained with a gas, etc. The embodiments of FIGS. 13F-13P can be combined with any of the embodiments disclosed herein.

As explained above, the treatment instrument 101 can include the first supply line 112, the second supply line 114, and the outlet line 126. The first supply line can 112 can comprise a high pressure supply line to deliver one or more compositions to the pressure wave generator 5. The pressure wave generator 5 (e.g., an orifice or nozzle 108) can be used to form a liquid jet (or a stream). As explained above, compositions delivered through the nozzle 108 can comprise liquids with a suitably low viscosity that can form a coherent, collimated jet. The second supply line 114 can comprise a second composition including any suitable flowable material(s) to the treatment instrument 101 (e.g., to the fluid platform 3 and chamber 6). The second composition can comprise a liquid (low viscosity or high viscosity), a gel, a paste, a gas, or solid particulates entrained with a gas. In various embodiments, the second supply line 114 may not comprise a highly pressurized line but instead can comprise a low pressure supply line in which the second composition 67 is delivered at a lower pressure than the first composition 65. The outlet line 126 can convey outgoing fluid (e.g., waste fluid) to a waste reservoir.

In the embodiments disclosed herein, the fluid compositions (e.g., Part A, Part B, Part C, etc.) can be delivered to the supply lines 112, 114 from a reservoir or container in the console 2, from a reservoir or container outside the console 2, from a reservoir 116 or container on, in or coupled to the treatment instrument 101, or along the conduits 9 that connect the treatment instrument 101 and the console 2. For example, as shown in FIG. 13F, Part A and Part B can be supplied to the fluid platform 3 along the first supply line 112 (e.g., a high pressure line) and can be formed into a liquid jet by the orifice 108. In some embodiments, the first composition 65 can comprise a mixture of Parts A and B in which the mixture forms the liquid jet. In other embodiments, Parts A and B are delivered sequentially to the fluid platform 3 and treatment region.

Turning to FIGS. 13G and 131, in some embodiments, Part A can be supplied along the second supply line 114, and Part B can be supplied along the first supply line 112 (FIG. 13G) from respective containers in the console 2 (or outside the console 2), or vice versa (FIG. 13I). As shown in FIG. 13H, Part A can be provided in a reservoir 116 disposed in or on the treatment instrument 101, as shown, for example, in FIGS. 6A-8B, 10A-10D. In some embodiments, as shown in FIGS. 12A-12B, the reservoir 116 can be mechanically connected to the treatment instrument 101. Further, in the embodiments of FIGS. 3A-5I, the second composition 67 can be supplied to the second supply line 114 from a reservoir 116 disposed in or on the treatment instrument 101, or mechanically connected to the treatment instrument 101. In FIG. 3H, the Part B can be supplied to the treatment instrument 101 along the first supply line 112. Parts A and B can mix within the treatment instrument 101 (e.g., within the guide channel 106 or the chamber 6) as explained herein. In other embodiments, Parts A and B can mix at the treatment region outside the treatment instrument 101. In other embodiments, Parts A and B can be delivered sequentially to the treatment region.

Turning to FIG. 13J, in some embodiments, Parts A and B can be supplied to the treatment instrument along the second supply line 114 from container(s) inside or outside the console 2. A third component, Part C, can be supplied to the treatment instrument 101 along the first supply line 114 from a container in the console 2. In FIG. 13K, Parts A and B can be provided in one or multiple reservoirs 116 in, on, or connected to the treatment instrument 101. Parts A and B can be delivered to the second supply line 114. Part C can be supplied to the first supply line 112, e.g., from a container inside the console 2. Turning to FIG. 13L, one or more reservoirs 116 can be provided on the second supply line 114 between the treatment instrument 101 and the console 2. As shown in FIG. 13L, Parts A and B can be stored in the reservoir(s) 116, and can be delivered to the treatment instrument 101 along the second supply line 114. Part C can be delivered to the treatment instrument 101 along the first supply line 112 from the console 2.

FIG. 13M illustrates a treatment instrument 101 with one or multiple reservoirs 116 disposed inside the treatment instrument 101, e.g., inside the handpiece body. The reservoir(s) 116 can comprise a variable-volume bag in some embodiments. For example, the reservoir(s) 116 can comprise a bag having a rupture valve (or other type of valve or vent) and one or more chambers to hold one or more material components. The second supply line 114 (e.g., a low pressure line) can introduce fluid (e.g., air, part of a material component, water, etc.) to the reservoir 116. The introduced fluid can be supplied at a pressure sufficient to rupture the seal in an adjacent chamber.

In some embodiments, the reservoir 116 comprises a single chamber for holding Part A, and Part B can be supplied (e.g., by a pump in the console 2) to rupture the valve and deliver Parts A and B to the fluid platform 3. In some embodiments, the reservoir 116 comprises a single chamber for holding Part A, and a gas (e.g., air) can be supplied to rupture the valve and deliver Part A to the fluid platform 3. In other embodiments, the reservoir 116 comprises a plurality of chambers, for example two chambers. A first chamber of the reservoir 116 can hold Part A, and the second line 114 can supply Part B to a second chamber to rupture the seal between the chambers and mix Parts A and B. In some embodiments, the first chamber can hold Part A, and air can be supplied to the second chamber to rupture the seal between the first and second chambers. In some embodiments, Part A can be stored in the first chamber, and Part B can be stored in the second chamber. Air can be supplied along the second supply line 114 to rupture the seals or valves separating the first and second chambers of the reservoir 116. In still other embodiments, the reservoir 116 can comprise more than two chambers (e.g., three chambers). The first and second chambers can respectively hold Parts A and B. The second supply line can supply a gas to the third chamber to rupture the seal or valve between the first and second chambers.

FIG. 13N illustrates a treatment instrument 101 with one or multiple reservoirs 116 disposed on and coupled to the treatment instrument 101, e.g., disposed on and coupled to an exterior surface of the handpiece body. The reservoir(s) 116 can include one or multiple chambers as explained above in connection with FIG. 13M. The reservoir 116 can comprise a valve or diaphragm. The reservoir 116 can comprise a cartridge with a connector that removably connects to the treatment instrument 101. In some embodiments, the connection of the reservoir 116 to the treatment instrument 101 can puncture the valve or diaphragm to allow the flow of the composition in the reservoir 116. The reservoir 116 can comprise a valve or diaphragm. Part A can be provided on one side of the diaphragm. The second line 114 can deliver Part B to other side to rupture the diaphragm or valve and enable flow and/or mixing of Parts A and B. In other embodiments, air or other fluid in the second line 114 can apply a pressure to the diaphragm to cause the diaphragm or valve to rupture. The second supply line 114 can be connected to the treatment instrument 101 as shown, or in other embodiments, the second supply line 114 can connect to the reservoir 116.

FIGS. 13O and 13P illustrate another example of a treatment instrument 101 that includes a button 168 configured to enable flow and/or mixing of material component(s) in the reservoir 116. The button 168 can comprise a spike or other component that, when pressed, breaks the seal formed by the reservoir 116. The seal may be located on the reservoir 116 or cartridge, or at an end of an injection tube between the reservoir 116 and the second supply line 114. The button 168 can accordingly enable flow of the second composition along the second supply line 114 by popping the seal that seals the reservoir 116. In other embodiments, the button 168 may be reversible, or on/off, such that the clinician can selectively start and stop delivery of the second composition with a pressure assist from the console 2 through the second supply line 114.

FIG. 14 is a schematic system diagram of a pneumatic drive system 170 configured to supply pressurized fluid (e.g., pressurized air) to the treatment instrument 101 to drive the second composition along the second supply line 114. FIG. 15 is a schematic perspective view of the pneumatic drive system 170 shown in FIG. 14. As explained above, pressurized air can be driven from the console 2 to the treatment instrument 101 along an air supply line. The pressurized air can drive the second composition (for example, by way of a plunger) into the second supply line 114.

As shown in FIGS. 14 and 15, the pneumatic drive system 170 can include an air compressor 171. The air compressor 171 can pressurize air at pressures up to, for example, 70 psi. The air compressor 171 can pressurize the air to any suitable desired or programmed pressure. Charged or compressed air can be stored in a compressed air reservoir 172. A distribution manifold 173 with a pressure feedback sensor can also be provided. The pressure sensor can provide feedback to the console system board or processing electronics to complete a closed feedback loop. A plurality of valves 174 (e.g., three valves), which can comprise discrete solenoid valves, can be provided. Two valves 174 can be plumbed to be normally open when the console 2 has no power. One of the two valves can be used to vent the air in front of the compressor 171 so it does not start under pressure. Once the pump turns on then the valve can be activated to charge the system 170. The second of two valves can be normally open and can completely discharge the air pressure when power is turned off. The third valve can be normally closed and can dispense the second composition (e.g., paste) in the treatment instrument 101 when energized. The valves 174 can be controlled by a controller in the console 2. The pressure sensor can give feedback pressure to the control board. The set points for pressure can be controlled through software programmed to be executed by the controller or other processing electronics in the console 2. Hysteresis can also be controlled through software programmed to be executed by the controller or other processing electronics in the console 2.

### VI. Examples of Dental Treatment Systems

A. Description of Console Components

FIG. 16A is a schematic system diagram of a system 700 according to some embodiments. The system 700 can include a console 2 coupled to an interface member 4. As explained herein, the interface member 4 can be configured to releasably couple to a treatment instrument 101 (such as a treatment handpiece or treatment cap). The console 2 (e.g., the housing) can include multiple components configured for various treatment procedures, such as tooth cleaning procedures, coating procedures, remineralization procedures, filling procedures, etc. In particular, the console 2 can include one or more fluid containers 731 configured to store various types of treatment fluids. As shown in FIG. 16A, for example, the fluid reservoirs may store water and multiple chemicals, such as Chemical A and Chemical B (or any suitable number of corresponding chemicals). The multiple chemicals can comprise fluid compositions delivered to the treatment instrument 101 by way of the fluid supply lines 112, 114.

In some embodiments, system 700 can include one more containers 731 positioned exterior to the console 2. For example, as shown in FIG. 700, a container storing a chemical, Chemical C, is positioned outside of the console 2. One or more chemical or other fluid compositions positioned in containers 731 outside of the console 2 can be delivered to the treatment instrument by way of the second fluid composition supply line 114, for example, by way of the interface member 4. Additional fluid supply lines can be provided to deliver the fluids to the treatment instrument 101.

In some treatments, it may be desirable to mix the one or more fluids stored in the containers 731 within the console 2, e.g., prior to delivery to the treatment instrument 101. Accordingly, a mixing system 732 can be provided to mix the fluids to a desired amount. As explained herein, in some treatment procedures, the use of degassed liquids may be desirable. For example, degassed fluids may be useful in enhancing cavitation when used in cleaning procedures. A degassing system or degasser 733 can be provided in the console to substantially remove, or reduce, the amount of dissolved gases in the fluid supplied to the treatment instrument 101. As shown in FIG. 16A, in some embodiments, the degassing system 733 may be disposed downstream of the mixing system 732, but in some arrangements the degassing system 733 may be upstream of the mixing system 732. In the embodiment of FIG. 16A, for example, the desired treatment fluid can be mixed, and, subsequently, dissolved gases (such as dissolved oxygen) can be removed from the mixed fluid.

A high-pressure pump 734 can be provided in the console to drive treatment fluid to the interface member 4 and/or treatment instrument 101. The pump 734 may be a chemical resistant, high-pressure pump in some arrangements such that the pump 734 can accommodate both high pressure fluid flow and the chemical properties of the treatment fluid without experiencing corrosion or other deleterious effects. The pump 734 can be in fluid communication with the interface member 4 by way of a fluid pathway 735. The fluid pathway 735 may similarly be made of a material and structure such that the pathway 735 is resistant to corrosion or other negative effects caused by the treatment fluids. The fluid pathway 735 may also be configured to support high-pressure fluid flow therethrough. As explained herein, the interface member 4 can releasably or removably couple with a treatment instrument 101 to supply treatment fluid to the treatment instrument 101 by way of the first supply line 112.

A pump 834 can be provided outside of the console 2 to drive fluid from the container(s) 731 outside of the console to the interface member 4 and/or treatment instrument 101. In some embodiments, the pump 834 can be a lower pressure pump. In some embodiments, the low pressure pump 834 can be configured to drive fluid at a lower pressure or at a lower flow rate than the pump 734 (e.g., at a flow rate less than 60% of the flow rate of the pump 734, at a flow rate between 30% to 50% of the flow rate of the pump 734, or any other suitable range). In some embodiments, the pump 734 and the pump 834 may be structurally different, for example, to drive fluids at different pressures or flow rates. In other embodiments, the pump 734 and pump 834 may be structurally similar or structurally the same, but can be operated differently to drive fluids at different pressures or flow rates.

The pump 834 may be a chemical resistant, low-pressure pump in some arrangements such that the pump 834 can accommodate both low pressure fluid flow and the chemical properties of the treatment fluid without experiencing corrosion or other deleterious effects. The pump 834 can be in fluid communication with the interface member 4 by way of a fluid pathway 835. The fluid pathway 835 may similarly be made of a material and structure such that the pathway is resistant to corrosion or other negative effects caused by the treatment fluids. The fluid pathway 835 may also be configured to support low-pressure fluid flow therethrough. As explained herein, the interface member 4 can releasably or removably couple with a treatment instrument 101 to supply treatment fluid to the treatment instrument 101 by way of the second supply line 114. As explained above, the low pressure pump 834 can drive (or assist in driving) the second composition 67 to the fluid platform 3. In some embodiments, however, the liquid jet can draw the second composition to the fluid platform 3 without requiring the use of the low pressure pump 834.

In the embodiment of FIG. 16A, the console 2 can include one or more monitoring sensors 738 disposed downstream of the fluid containers 731. The monitoring sensors 738 can be part of a monitoring system and can measure various properties of the fluids before mixing and/or degassing the fluids. For example, as shown in FIG. 16A, the sensors 738 can measure at least one of concentration (C) and temperature (T) of the treatment fluids before mixing. The console 2 can further include a monitoring apparatus 736 downstream of the degassing system 733 and mixing system 732. The monitoring apparatus 736 can measure at least one of concentration (C), temperature (T), and dissolved oxygen (DO) content of the degassed and mixed solution. In some embodiments, the monitoring apparatus 736 can include one or more concentration sensors, temperature sensors, and/or dissolved oxygen sensors.

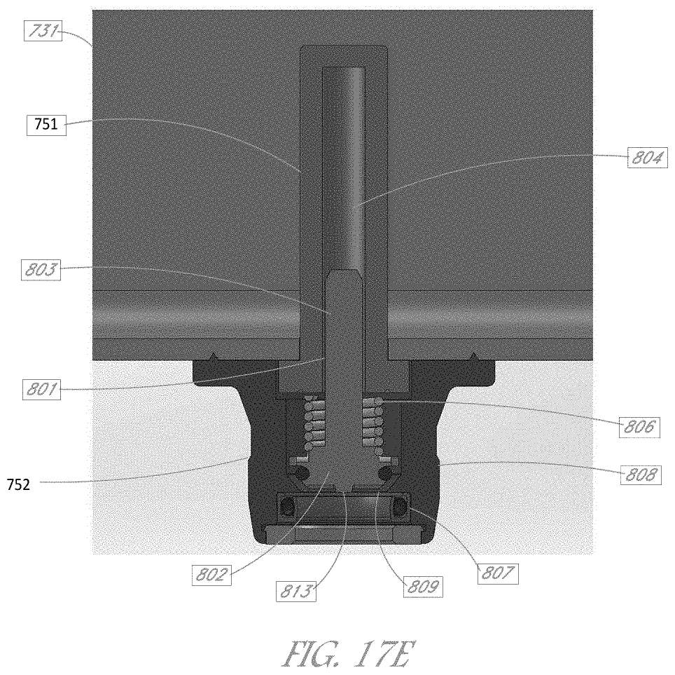

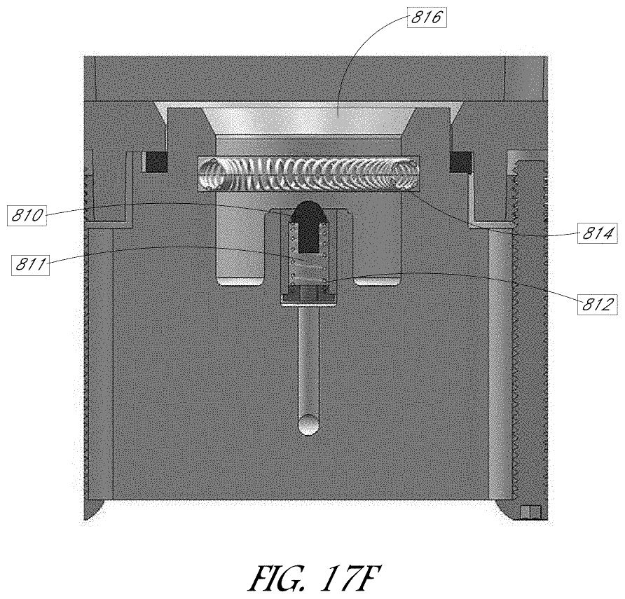

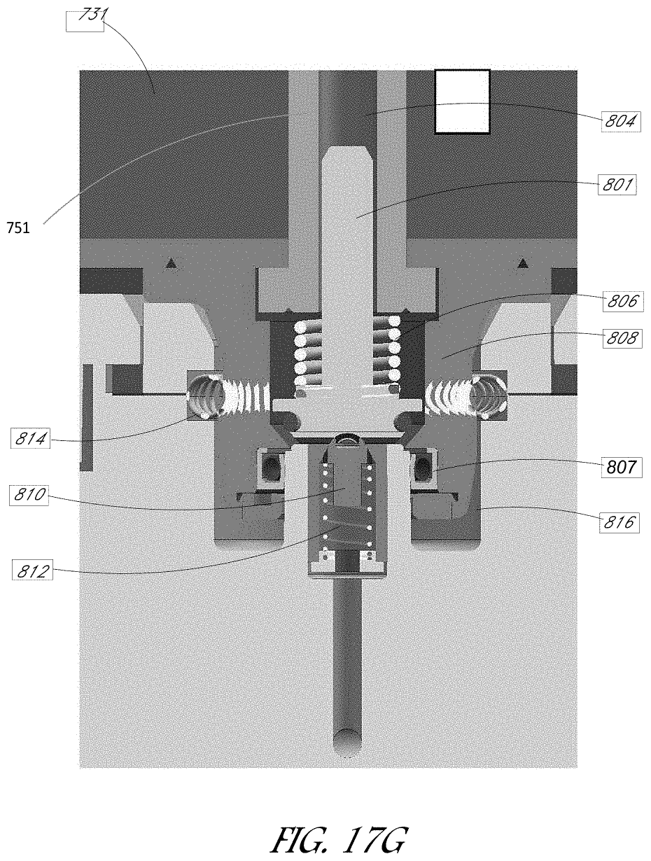

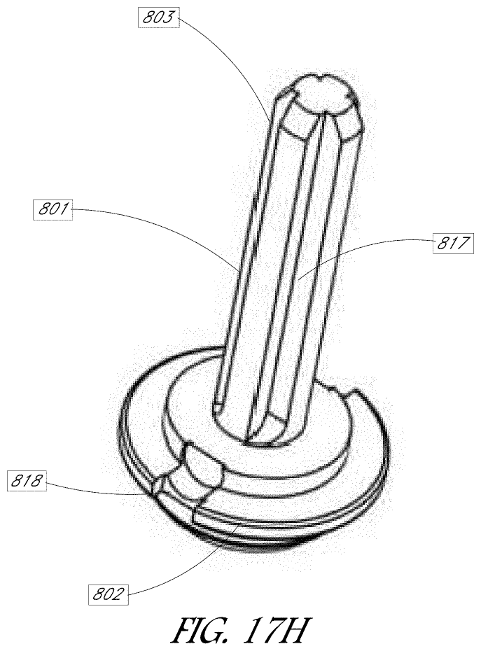

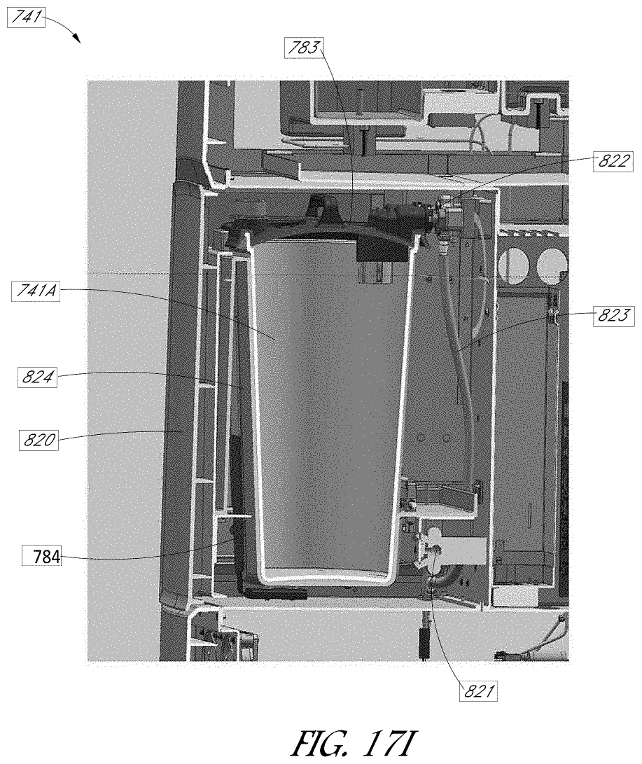

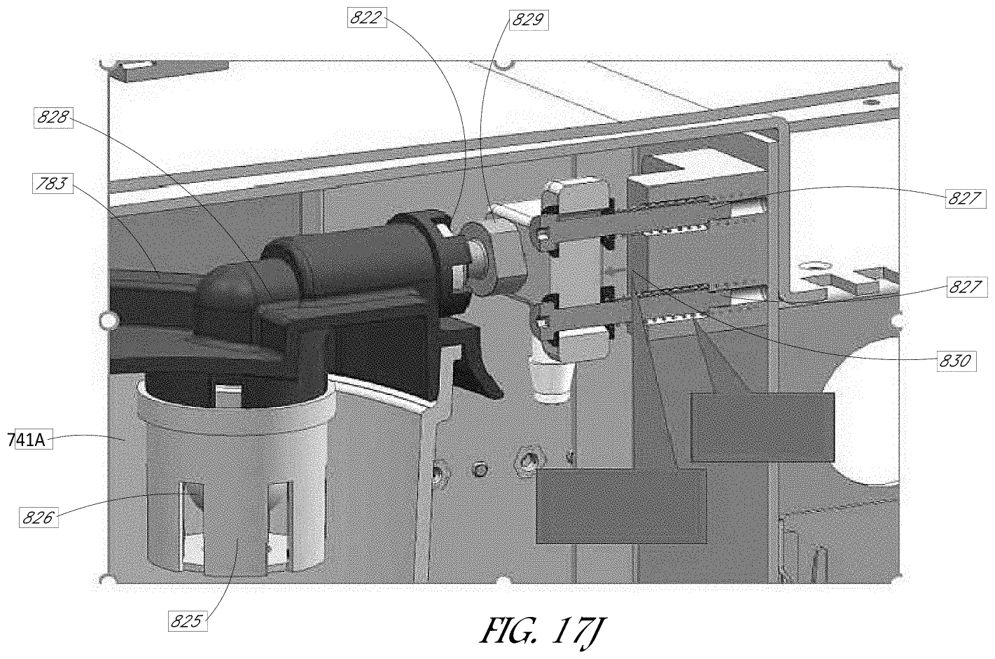

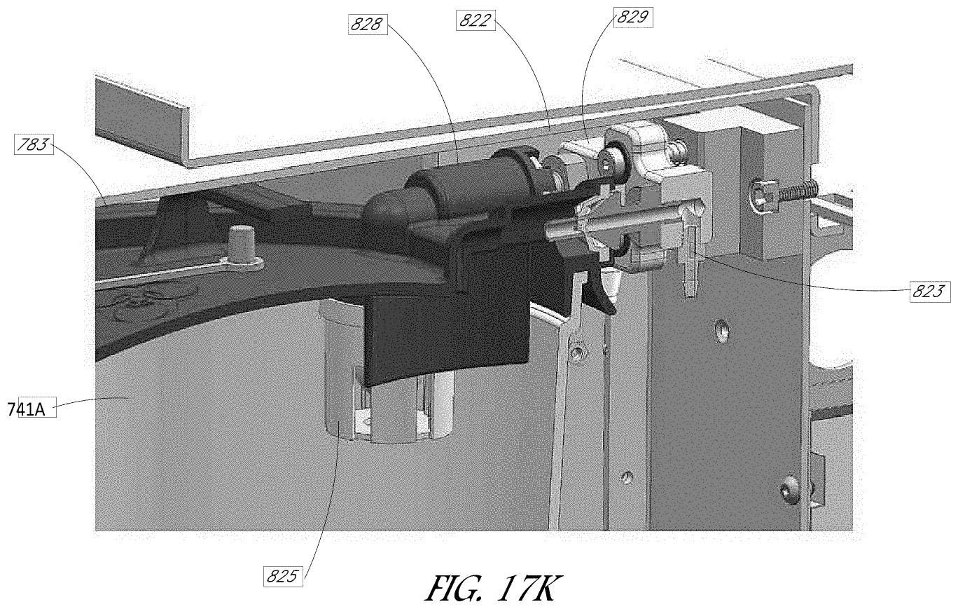

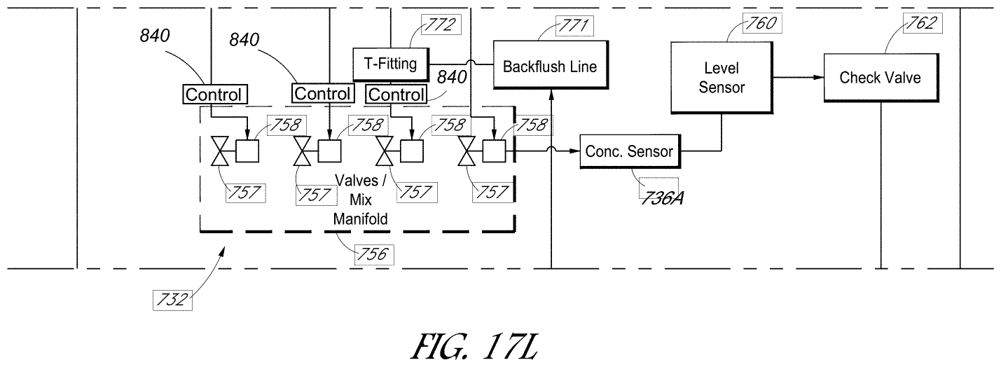

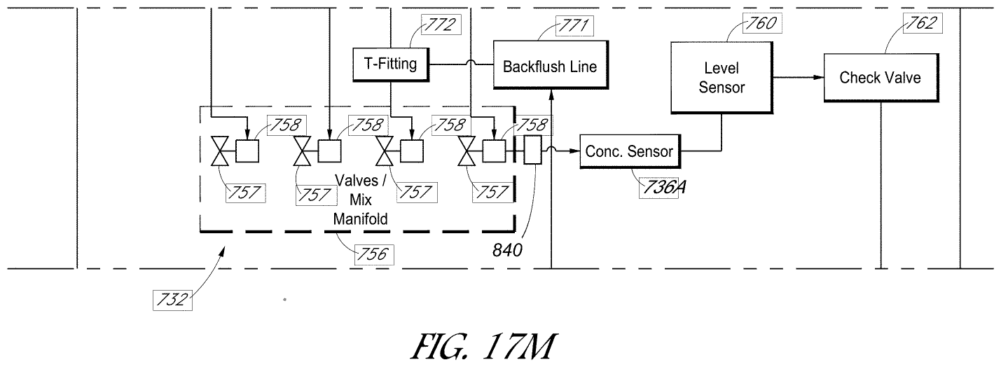

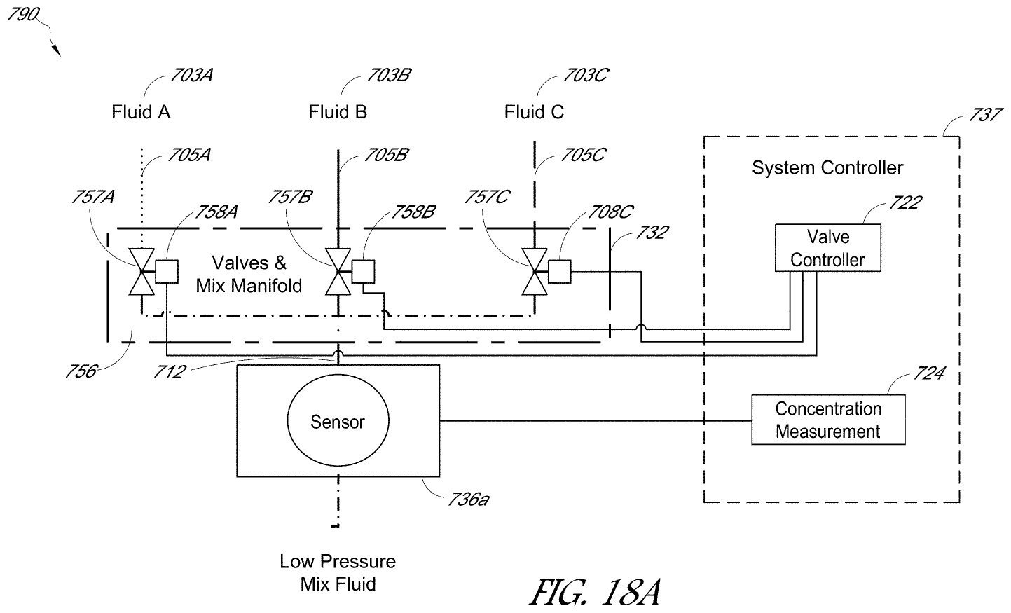

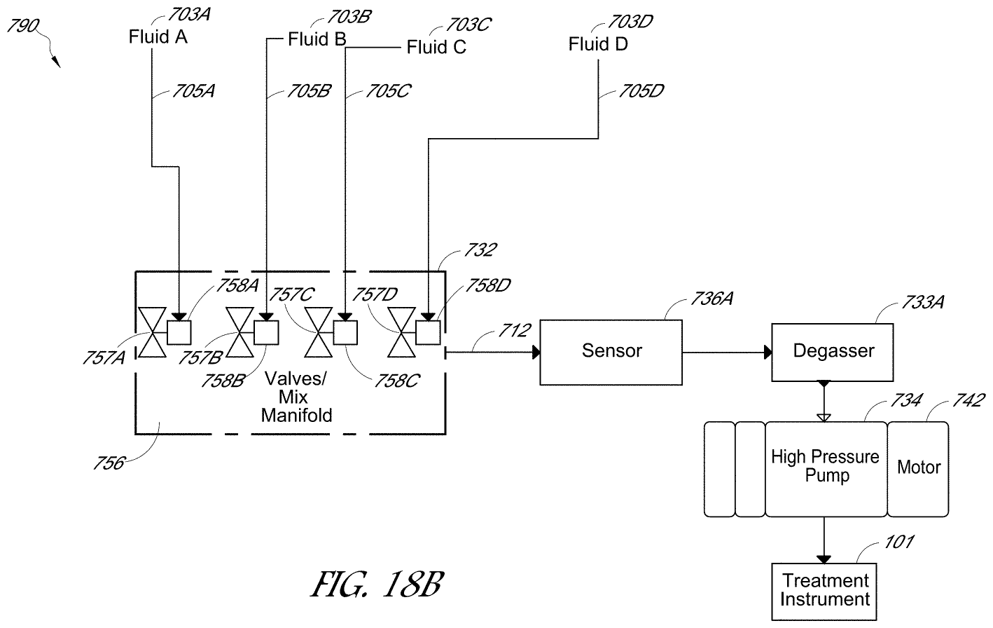

Furthermore, the system 700 shown in FIG. 16A can include a controller 737 in electrical and data communication with the components of the system 700. The controller 737 can include various units and/or modules. For example, the controller 737 can include a processing unit 739 and a power unit 740. The controller 737 can be in electrical and data communication with the fluid containers 731 (and/or with valves that are associated with the containers 731) and the sensors 738 to control and measure the fluids supplied by the containers 731. The controller 737 can also communicate with the mixing system 732 and the degassing system 733 to control the amount of fluid mixing and degassing, respectively. Further, the controller 737 can be in electrical and data communication with the monitoring apparatus 736 to manage the properties of the fluid supplied to the pump 734. The pump 734 can be driven by the motor 742 that can be controlled by the controller 737. Similarly, the pump 834 can be driven by a motor that can be controlled by the controller 737. In some embodiments, the controller 737 can send instructions (e.g., a signal) to the pump 734 to drive a first treatment fluid (for example, a treatment fluid from the mixing system 732 including one or more of water, Chemical A, and Chemical B) at a first flow rate and the controller 737 can send instructions (e.g., a signal) to the pump 834 to drive a second composition (for example, Chemical C) at a second flow rate different than the first flow rate. Flow rate may additionally be affected by the temperature of the fluid, which can, for example, affect viscosity. In some embodiments, one or more temperature controls can be positioned to change the temperature of the fluid, either upstream of downstream of the pump 734 and/or the pump 834 to achieve a desired flow rate. The temperature controls can include one or more heaters and/or coolers. In some embodiments, the temperature controls can include use thermoelectric cooling (for example, by using the Peltier effect). In some embodiments, the temperature controls can include one or more Peltier modules. In some embodiments, the temperature controls can be in electrical and/or data communication with the controller 737. The controller 737 can provide instructions (e.g., send a signal) to the one or more temperature control modules to change the temperature of fluids within the system 700. Examples of temperature control modules 840 and a thermoelectric cooler 775 are described with respect to FIGS. 17A-M. In alternative embodiments, one or more sensors, for example, sensors 738 or monitoring apparatus 736, may detect the temperature of the fluid, and the pump 734 and/or pump 834 can be controlled to change the flow rate in response to the detected temperatures.

In addition, the controller 737 of the console 2 can communicate with the interface member 4, and thus the treatment instrument 101, by way of electrical and data pathways passing through the interface member 4 and to the treatment instrument 101. The controller 737 can couple to the user interface 728, through which the user can control the treatment procedures and/or monitor the progress of the treatment procedures and the system 700.

FIG. 16B is a schematic system diagram of the system 700, according to another embodiment. As with the embodiment of FIG. 16A, the system 700 of FIG. 16B can include a console 2 having one or more fluid containers 731, one or more sensors 738, one or more degassers 733, a pump 734, a fluid pathway 735, an interface member 4, and a waste system 741. However, unlike the embodiment of FIG. 16A, the system 1 shown in FIG. 16B includes the pump 834, the fluid containers 731 in communication with the pump 834, and the lower pressure fluid pathway 835 within the console 2. FIG. 16B also illustrates that a plurality of fluid containers 731 can communicate with the pump 834 to provide a fluid composition flowing at a lower pressure along the fluid pathway 835 to be delivered to the treatment instrument by way of the supply line 114. As shown, in FIG. 16B, the fluids from the fluid containers 731 in communication with the fluid pathway 835 can flow through one or more sensors 738 and degassing systems 733. In some embodiments, a mixing system 732 can also be present to mix the fluids from the containers 731 in communication with the fluid pathway 835.

1. Fluid Reservoirs

The fluid containers 731 shown in FIGS. 16A-B can be any suitable type of reservoir or container and can contain any suitable type of treatment fluid used in the system's treatment procedures. For example, the containers 731 may comprise plastic bins or containers, such as high-density polyethylene (HDPE). Various sizes (such as 250 mL, 500 mL, 2L, etc.) may be suitable. In other embodiments, the containers 731 may comprise glass, a plastic bag (e.g., an IV bag), or any other suitable material. The containers 731 may comprise any material that is chemically resistant to the treatment fluids stored in the containers 731 such that the containers 731 do not chemically degrade. The containers 731 may, in some arrangements, be disposed in a drawer or other compartment that is slidably removed relative to the console 2. The containers 731 may be designed to have a volume sufficient for treatment of at least one patient, e.g., for at least one treatment procedure. In other embodiments, the containers 731 may have a volume sufficient to treat multiple patients. A liquid level sensor may also be provided to measure and/or monitor the volume of fluid in each container 731. For example, the liquid level sensor can comprise a capacitive sensor. In some embodiments, for example, a capacitive sensor manufactured by Sensortechnics™, a part of First Sensor AG, of Berlin, Germany, may be used. Any suitable type of level sensor can be used, such as an optical sensor, a hydrostatic level sensor, etc. A quick connect coupler may be provided to couple the containers 731 to outlet tubing. In some embodiments, the containers 731 may be disposable such that the clinician can dispose of the containers 731 after each treatment. In other arrangements, the containers 731 may be re-usable for a number of treatments. In some embodiments, a valve, such as a duck-bill valve, can be provided so as to allow air in the container 731 to prevent a vacuum from forming in the container 731.

Any suitable number of containers 731 may be disposed in the console 2. As shown in FIG. 16A, for example, three containers 731 may be used in the console 2. One container 731 may contain water (e.g., distilled water, purified water, etc.). Another container 731 may contain a Chemical A. In some embodiments, Chemical A may include a cleaning treatment fluid, such as bleach, for dissociating diseased tissue from the tooth 10. Another container 731 may contain a Chemical B. Chemical B may comprise another cleaning treatment fluid, such as EDTA, for removing calcified deposits and/or a smear layer from the tooth 10. Indeed, any suitable treatment fluid may be stored in the containers 731, including, e.g., bleach, EDTA, water, a medical-grade saline solution, an antiseptic or antibiotic solution (e.g., sodium hypochlorite), a solution with chemicals or medications, medicaments, surfactants, nanoparticles, etc.

In some embodiments, any suitable number of containers 731 may be disposed outside of the console 2. As shown in FIG. 16A, for example, one container 731 may be used outside the console 2. The container 731 may contain a Chemical C. The container 731 outside the console 2 can include any suitable treatment fluid including, e.g. bleach, EDTA, water, a medical-grade saline solution, an antiseptic or antibiotic solution (e.g., sodium hypochlorite), a solution with chemicals or medications, medicaments, surfactants, nanoparticles, etc.

In some embodiments, as explained above, the system 700 can be configured for obturation and/or restoration procedures. In such embodiments, the containers 731 can contain a suitable obturation and/or restoration material. For example, the containers 731 may contain a root canal filling resin, a gutta percha-based material, a calcium hydroxide-based material, a dental cement material, a dental cement comprising zinc oxide, a filing material comprising particles responsive to a non-contacting force field, a filling material comprising nanoparticles, a flowable filling material, a syringeable filling material, a liner, a sealer, a cement, a paste, and a gel. The obturation material may be disposed in the container 731 in a flowable state, which may be hardened to a solid or semisolid state.

The fluids in the containers 731 may be in fluid communication with the other components of the console 2 by way of tubes coupled to outlets of the containers 731. Valves may be provided downstream of the containers to selectively open and close fluid pathways between the containers 731 and the remainder of the system. The valves may be controllably actuated using the controller 737 in some embodiments.

2. Degassing System

As explained herein, it can be advantageous in some treatment procedures to supply a fluid (e.g., a liquid) that is substantially free of dissolved gases. For example, dental cleaning treatments can be enhanced by using treatment fluids that are degassed so that small passageways in or through the tooth are not blocked by bubbles and/or so that cavitation can be enhanced, as explained herein. Accordingly, the degassing system 733 may be configured to remove dissolved gases (such as oxygen) from each treatment fluid to a desired amount.

The degassing system 733 can comprise any suitable degassing apparatus, such as the PermSelect® silicone membrane module available from MedArray, Inc. (Ann Arbor, Mich.). Other examples of degassing units that can be used in various embodiments include: a Liqui-Cel® MiniModule® Membrane Contactor available from Membrana—Charlotte (Charlotte, N.C.); and a FiberFlo® hollow fiber cartridge filter (0.03 micron absolute) available from Mar Cor Purification (Skippack, Pa.). The degassing can be done using any of the following degassing techniques or combinations of thereof: heating, helium sparging, vacuum degassing, filtering, freeze-pump-thawing, and sonication. In some embodiments, degassing the fluid can include de-bubbling the fluid to remove any small gas bubbles that form or may be present in the fluid. De-bubbling can be provided by filtering the fluid. In some embodiments, the fluid may not be degassed (e.g., removing gas dissolved at the molecular level), but can be passed through a de-bubbler to remove the small gas bubbles from the fluid.

As explained herein, the degassing system 733 can be provided upstream or downstream of the mixing system 732. In some arrangements, the degassing system 733 is disposed upstream of the mixing system 732, and each treatment fluid may pass through a separate degassing apparatus. One advantage of disposing the degassing system upstream of the mixing system 732 is that solutes may be added after degassing such that the solutes do not pass through (and possibly degrade) the degassing system 733. In some arrangements, the degassing system 733 may be configured to be chemically compatible with the chemicals used in the treatment solutions. The degassing system 733 can be disposed downstream of the mixing system 732 such that the mixed fluid is degassed in a single degasser. In still other embodiments, the degassing system 733 and the mixing system 732 may be combined into a single unit that both mixes and degases the treatment fluid.

In some embodiments, the degassed fluid has a dissolved gas content that is reduced to approximately 10%-40% of its “normal” amount as delivered from a source of fluid (e.g., before degassing). In other embodiments, the dissolved gas content of the degassed fluid can be reduced to approximately 5%-50% or 1%-70% of the normal gas content of the fluid. In some treatments, the dissolved gas content can be less than about 70%, less than about 50%, less than about 40%, less than about 30%, less than about 20%, less than about 10%, less than about 5%, or less than about 1% of the normal gas amount. In some implementations, it may be desired that the fluid entering the treatment instrument 101 be degassed to a certain degree (e.g., about 40% of normal dissolved gas amount in one example). In some such implementations, the degassing system 733 may “over-degas” the solvent so that the solvent's dissolved gas content is below the desired degree (e.g., about 35% in this example) so that when solute(s) are added by the mixing system 732, the resulting fluid (solvent plus solute) is degassed to less than the desired degree (e.g., adding un-degassed antiseptic solution may raise the dissolved gas content to 38% in this example).

3. Mixing System

In different treatment procedures, it may be desirable to mix the treatment fluids supplied by the containers 731 to a desired concentration, e.g., drawing and mixing a proper volume ratio of treatment chemicals. For example, in some cleaning treatments, it may be desirable to mix bleach or EDTA with water to a desired concentration, to enhance the cleaning effects for the particular procedure, whether a root canal cleaning procedure, a caries removal procedure, or a hygiene procedure (e.g., removing undesirable dental deposits such as plaque, calculus, etc.). The mixing system may adjust a multiple-way valve that is electronically or mechanically controlled to draw the correct amount of chemicals to prepare the prescribed concentration of the treatment solution. For example, different amounts of different chemicals can be mixed by activating a valve to selectively alternate between the different chemicals. As one example, if the system 700 is to mix water and Chemical A by a particular amount, then the valve can be activated to alternate selection of water and Chemical A. Accordingly, if the desired mixture is to include more Chemical A than water by a particular concentration, then the valve can be activated longer for Chemical A than for the water by a particular amount. For example, a flow selection valve, for example as manufactured by Bio-Chem Fluidics Inc., of Boonton, N.J., may be used in some embodiments.

The mixing system may include a fluid flow control system. The fluid flow control system may be passive in some arrangements, and the mixing ratio may be adjusted by using proportional valves. The proportional valve may be a multiple inlet port solenoid valve. The proportional flow may be achieved by, for example, adjusting cross-sections or pulsating valve openings. The fluid flow control system may be active and the mixing ratio may be adjusted using positive displacement metering pumps. The active configuration may include a holding chamber to adjust for the overall system flow rate.

Accordingly, the mixing system 732 can be configured to mix the appropriate volumes of each fluid together in a mixing chamber. The controller 737 can be programmed to operate the mixing system 732 such that the inputs to the mixing system 732 comprise the appropriate amounts or volumes of each treatment fluid. The controller 737 can also be programmed to selectively output the mixed fluid to the downstream components.

4. Pump

The pump 734 can be any suitable high-pressure pump that is configured to pressurize the treatment fluid to a desired pressure. In some embodiments, the pump 734 can be driven by the motor 742 or other suitable mechanism. For example, one or more pistons can be activated by the motor 742 to generate positive pressure flow through the pump 734. The pump 734 may be a constant pressure or a constant flow rate pump in various arrangements. The pump 734 can drive the pressurized fluid to the interface member 4 by way of the fluid pathway 735. A pressure sensor may be used to sense the pressure of the liquid and communicate pressure information to the controller 737. The controller 737 can use the pressure information to make adjustments to the motor 742 and/or the pump 734 to provide a target pressure for the fluid delivered to the interface 4 and treatment instrument 101. For example, in embodiments in which the pump 734 comprises a piston pump, the controller 737 may signal the motor 742 to drive the piston more rapidly or more slowly, depending on the pressure information from the pressure sensor. The pump 734 may be actuated continuously or cyclically in various arrangements. The pump 734 can be any suitable type of pump. The motor 742 can be any suitable type of motor.

The high pressure pump 734 can deliver pressurized fluid to the interface member 4 (by way of the first composition supply line 112) and treatment instrument 101 sufficient to create a fluid jet, in some embodiments. For example, in some embodiments utilizing a fluid jet, the pressure of the liquid that can be delivered to the interface member 4 and/or treatment instrument 101 can be adjusted within a range from about 500 psi to about 50,000 psi. In certain embodiments, it has been found that a pressure range from about 2,000 psi to about 15,000 psi produces jets that are particularly effective for cleaning treatments. In some embodiments, the pressure can be between about 8,000 psi and about 11,000 psi, for example, about 9,200 psi in one arrangement. In another arrangement, the pressure can be about 10,000 psi.

The low pressure pump 834 can be any suitable low-pressure pump that is configured to pressurize the treatment fluid to a desired pressure. In some embodiments, the pump 834 can be driven by a motor, such as motor 742, or other suitable mechanism. For example, one or more pistons can be activated by the motor to generate positive pressure flow through the pump 834. The pump 834 may be a constant pressure or a constant flow rate pump in various arrangements. The pump 834 can drive the pressurized fluid to the interface member 4 by way of the fluid pathway 835. A pressure sensor may be used to sense the pressure of the liquid and communicate pressure information to the controller 737. The controller 737 can use the pressure information to make adjustments to the motor and/or the pump 834 to provide a target pressure for the fluid delivered to the interface 4 and treatment instrument 101. For example, in embodiments in which the pump 834 comprises a piston pump, the controller 737 may signal the motor to drive the piston more rapidly or more slowly, depending on the pressure information from the pressure sensor. The pump 834 may be actuated continuously or cyclically in various arrangements. The pump 834 can be any suitable type of pump. The motor can be any suitable type of motor.

In some embodiments, the pressure of the liquid that can be delivered to the interface member 4 and/or treatment instrument 101 from the pump 834 can be adjusted within a range below 500 psi.

5. Fluid Pathway

The fluid pathway 735 can convey the pressurized fluid from the pump 734 to the interface member 4. The fluid pathway 735 can be configured to accommodate the high-pressure fluid delivered by the pump 734 and the various chemistries of the treatment fluids passing through the pathway 735. The fluid pathway 735 can also be flexible such that the clinician can manipulate the fluid pathway 735 before, during, or after treatment. For example, in some embodiments, the fluid pathway 735 can comprise one or more tubes disposed between the pump 734 and the interface member 4. The tubes can comprise any suitable high-pressure, chemical-resistant material, such as a polymer or a chemical-resistant metal such as titanium.

The fluid pathway 835 can convey the pressurized fluid from the pump 834 to the interface member 4 and the second composition supply line 114 of the treatment instrument 101. The fluid pathway 835 can be configured to accommodate the low-pressure fluid delivered by the pump 834 and the various chemistries of the treatment fluids passing through the pathway 835. The fluid pathway 835 can also be flexible such that the clinician can manipulate the fluid pathway 835 before, during, or after treatment. For example, in some embodiments, the fluid pathway 835 can comprise one or more tubes disposed between the pump 834 and the interface member 4. The tubes can comprise any suitable low-pressure, chemical-resistant material, such as a polymer or a chemical-resistant metal such as titanium.

6. Waste System

The console 2 can also include a waste system 41 configured to convey waste fluids or materials from the treatment instrument 101 back to a waste reservoir or container. The waste container may be positioned with or near the containers 731 discussed above, or it may be positioned separately in the console 2. For example, during some dental treatment procedures, such as cleaning procedures, the treatment instrument 101 (such as a handpiece) may include a suction port and/or vents that are configured to transport waste fluids or particles from the treatment tooth 10 back to the console 2 to the waste system 741. The waste system 741 can couple to the treatment instrument 101 by way of one or more waste lines. The waste lines may comprise tubes that extend from the treatment instrument 101 back to the console 2. Although the waste system 741 is shown as coupling to the interface member 4 in FIG. 16A-B, in some embodiments, the waste system 741 may have a separate interface or connector that couples to the treatment instrument 101. For example, the waste line or tubes may be threaded, snapped, or otherwise engaged with the treatment instrument 101. In some embodiments, the waste lines are disposed on or through the interface member 4 to connect to the treatment instrument 101.

A vacuum pump can be provided to provide suction between the tooth treatment instrument 101 and the console 2 by way of the waste lines. One example of a suitable vacuum pump is manufactured by Brenner-Fiedler & Associates, Inc., of Riverside, Calif. For example, the suction port may be similar to evacuation units found in dental offices. For example, some dental evacuation units are designed to operate at about −6 in-Hg to about −8 in-Hg and have an airflow rate of about 7 standard cubic feet per minute (SCFM) per chairside high-volume inlet. Independent vacuum systems can be used. In one embodiment, the operating pressure of the evacuation unit is about −4 to −10 in-Hg. In other embodiments, the operating pressure is in a range of about −0.1 to −5 in-Hg or −5 to −10 in-Hg or −10 to −20 in-Hg, or other values. In some embodiments, the flow provided by the evacuation unit can be pulsating. In another embodiment, the evacuation unit flow can be intermittent. In one embodiment, the evacuation unit flow can be substantially uniform. The air flow rate of the evacuation unit can be 5 to 9 SCFM or 2 to 13 SCFM or 0.1 to 7 SCFM or 7 to 15 SCFM or 15 to 30 SCFM or 30 to 50 SCFM, or other values.

7. Console Monitoring System

The console monitoring systems disclosed herein can include monitoring sensors 738 and/or the monitoring apparatus 736 illustrated in FIG. 16A. For example, the monitoring sensors 738 may be disposed downstream of the fluid containers 731 before the mixing system 732 and degassing system 733. The monitoring sensors 738 can measure various properties of the treatment fluids before mixing and degassing to ensure that the fluids are adequately mixed and/or degassed. For example, concentration sensors can be provided to measure the concentration of each fluid. The controller 737 can utilize information about the concentration of each treatment fluid to determine how much of each fluid to add in the mixing system 732 to achieve the desired mixtures.

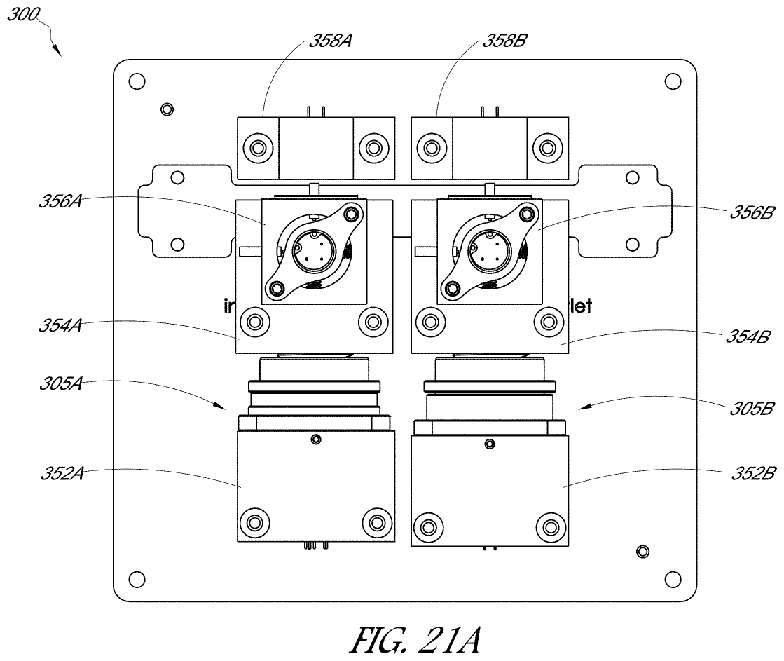

The concentration sensors can be any suitable type of sensor capable of measuring the concentration of the fluids. The concentration sensor may directly measure concentration in some embodiments. The concentration sensor may also indirectly measure concentration by measuring pH, oxidation reduction potential (ORP), optical density, electrical conductivity, etc. A concentration sensor may check the prepared treatment fluid concentration and send feedback to the mixing valves if adjustments are desired to bring the prepared treatment solutions concentration to the prescribed value. Some concentration sensors may measure the conductivity of the solution to determine the concentration. One example of such a concentration sensor is manufactured by Mettler-Toledo, of Greifensee, Switzerland. Embodiments of concentration sensors are described with respect to FIGS. 20-26.

In addition, the sensors 738 may comprise temperature sensors to measure the temperature of the solution. It may be desirable to maintain the treatment fluid at a temperature that is not too hot or not too cold for the mixing and degassing procedures. Accordingly, temperature sensors (e.g., thermocouples or any other suitable temperature sensor) may be disposed in contact or proximate the fluid along fluid lines leading from the containers 731 to the mixing and degassing systems. The controller 737 can receive the temperature data from the temperature sensors to monitor the temperature at various locations in the console 2.

Other sensors, such as pressure sensors, dissolved oxygen sensors, etc. may be provided downstream of the fluid containers 731 before the mixing and degassing systems.

The monitoring apparatus 736 disposed downstream the degassing system 733 and mixing system 732 in FIG. 16A may be provided to measure various properties of the treatment fluid after mixing and degassing. The monitoring apparatus 736 may include any suitable sensors, such as concentration sensors, temperature sensors, dissolved oxygen sensors, pressure sensors, etc. The concentration sensors may be similar to those described above and can measure the resulting concentration of the fluid after mixing. Similarly, the temperature sensors can be configured to measure the temperature of the mixed, degassed fluid before delivery to the treatment instrument 101 and patient. It can be important to ensure that the temperature is not too hot and not too cold so as to avoid harming the patient and/or tooth 10.

In addition, a dissolved oxygen (DO) sensor can be provided to measure the amount of dissolved gases remaining in the mixed, degassed fluid, which may be representative of the amount of air dissolved in the liquid. The dissolved oxygen sensor may check the level of dissolved oxygen in the treatment fluid, and, if the dissolved oxygen level is not sufficient, the system may be disabled in some arrangements, or the controller 737 can instruct the console 2 to engage in further degassing. Any suitable dissolved oxygen sensor can be used, including, e.g., optical sensors. One example of such a dissolved oxygen sensor is manufactured by PreSens Precision Sensing GmbH of Regensburg, Germany.

In addition, one or more pressure sensors may be disposed upstream or downstream of the pump 734 and/or the pump 834 to measure the pressure of liquid output from the pump 734 and/or the pump 834, as explained above. Furthermore, as above, the controller 737 can receive and process the data output from the monitoring apparatus 736, including data from sensors, such as concentration sensors, temperature sensors, pressure sensors, dissolved oxygen sensors, etc. The feedback received from the controller 737 can be used to adjust the various processes performed in the console until the desired concentrations, temperatures, pressures, flow rates, and amounts of dissolved oxygen are suitable for a particular treatment procedure.

8. User Interface

The user interface 728 can be configured to receive instructions from the clinician and/or to display data to the clinician regarding a treatment procedure and/or a status of the system. The user interface 728 can include a display configured to display data regarding a procedure to the clinician. The display may comprise a touch-screen display, in which the clinician can also send instructions to the system 700 by way of the display. In other arrangements, the user interface 728 can include a separate keyboard, keypad, joy stick, etc. to enable the clinician to send instructions to the console 2 and system 700. In some embodiments, the user interface 728 may include controls for a dental practitioner to operate a liquid jet apparatus. For example, the controls can include a foot switch to actuate or deactuate the jet (e.g., which may be coupled to the treatment instrument 101).

The clinician can interact with the user interface 728 to select a treatment procedure, e.g., to select whether a particular procedure is a cleaning procedure (e.g., of root canals, caries, undesirable deposits, etc.), an obturation procedure, a restoration procedure, etc. Once the procedure type is selected, the clinician can activate the procedure and can monitor the status of the procedure on the display. For example, the clinician may set a desired pressure for the pump, or other desired parameters for the jet. The clinician can set when the procedure is to begin and end by way of the interface 728. Furthermore, the clinician can use the user interface 728 to communicate various data about the procedure to other entities, as explained in more detail herein with respect to the various communications aspects of the system 700. In some arrangements, the clinician can interact with the user interface 728 to access patient medical records or other data about the patient. In some embodiments, the display of the user interface 728 can display images or video of the progress of a procedure, e.g., how much of a root canal has been cleaned, filled, etc. The clinician can interact with the user interface 728 in some aspects to determine how much supply of various materials is on hand, and can access patient scheduling systems. The user interface 728 may also have emergency systems by which the clinician can shut down the system 700 in case of emergency. In some arrangements, the system 700 may automatically contact emergency responders, or the user interface 728 can include a button or other interface by which the clinician can actively seek emergency responders.

9. Control Unit

The controller 737 can receive data from and send instructions to the various components of the console 2, the interface member 4, and the treatment instrument 101. For example, as shown in FIG. 16A, the controller 737 can be in electrical and/or data communication with the fluid containers 731, the monitoring sensors 738 and apparatus 736, the mixing system 732, the degassing system 733, the pump 734, the interface member 4, the user interface 728, and any other suitable components of the system 700 (e.g., the low pressure pump 834). The controller 737 may comprise a microprocessor, a special or general purpose computer, a floating point gate array, and/or a programmable logic device. Programmable instructions for carrying out the various processes disclosed herein may be stored on any suitable computer readable medium, such as a non-transitory computer readable medium (e.g., a RAM, ROM, or any other suitable memory device). In some embodiments, the controller 737 may include a power unit 740 configured to supply electrical power to the various system components.

The controller 737 can include a processing unit 739 configured to receive, send, and/or process data regarding the system components. For example, the processing unit 739 can receive signals from the sensors 738 and monitoring apparatus 736, and can process and store those signals for later use. The processing unit 739 can send instructions to valves that control the flow of fluid from the containers 731 to selectively actuate the valves in a desired manner, e.g., to selectively cause fluid to flow from the containers 731. The processing unit 739 can similarly control the operation of the mixing system 732 to ensure that the proper proportions of fluids are mixed together. The processing unit 739 can control the operation of the degassing system 733 to accurately and precisely degas the treatment fluids.

The processing unit 739 can send and receive instructions from the pump 734 (or a motor coupled to the pump 734) and/or the pump 834 (or a motor coupled to the pump 834). As explained above, the processing unit 739 can determine (e.g., by way of a sensor) the pressure of the fluid at the output of the pump 734 and/or the pump 834, and can send instructions to the motor and pump 734 and/or the motor and pump 834 to adjust the pressure output at the pump 734 and/or the pump 834 to the desired level. As explained above, various control algorithms (such as PID control) may be implemented to achieve the desired pump output. In some embodiments, the pump 734 and the pump 834 can receive instructions to adjust the pressure outputs at the pump 734 and the pump 834 so that the pressure output at the pump 734 is different than the pressure output at the pump 834. In some embodiments, the pump 734 and the pump 834 can receive instructions to adjust the outputs of the pump 734 and the pump 834 so that the flow rate of the fluid composition driven by the pump 834 is different than the flow rate of the fluid composition driven by the pump 734. For example, the outputs can be adjusted so that the flow rate of the fluid composition driven by the pump 834 is less than the flow rate of the fluid composition driven by the pump 734, (e.g., at a flow rate less than 60% of the flow rate of the pump 734, at a flow rate between 30% to 50% of the flow rate of the pump 734, or any other suitable range). In some arrangements, the console 2 and processing unit 739 can be programmed to deliver the treatment fluid at prescribed pressure oscillations. For example, the processing unit 739 can be programmed to control the shear thinning properties of the fluid and/or to produce the desired pressure waves for propagating at the treatment region of the tooth 10. The pressure oscillations may be generated by the delivery mechanism (e.g., by way of the pump 734 and the controller 737), or by way of a secondary mechanism or process (e.g., ultrasonic agitation), or a combination of both.

The processing unit 739 can also communicate with the user interface 728 to receive inputs from the clinician and to send data about the procedure to be displayed to the clinician. The processing unit 739 can communicate with the treatment instrument 101 and the working end of the system by passing through or along the interface member 4 in some embodiments. In other embodiments, the electrical and data pathways (which may include optical fibers or wireless data transmission devices) may connect to the treatment instrument 101 separate from the interface member 4.

As explained in more detail herein, the controller 737 can also communicate with external entities regarding the status of a procedure or about the history of procedures performed on the system 700. The controller 737 can be configured to access patient medical records and/or patient scheduling systems. The controller 737 can also monitor office inventory, including the amounts of fluids and other materials used for procedures, as explained herein. As explained herein, the controller 737 can therefore include any suitable communications modules to enable the system 700 to communicate with external entities (such as suppliers, emergency responders, patients, etc.).

B. Dental Office Management Systems and Networks

The system 700 disclosed herein can advantageously act as a core component of the dental office. The console 2 can act as a gateway to the system 700 by way of the user interface 728 illustrated herein, or by way of remote access using wireless or wired network communications. Indeed, in some embodiments, the clinician can access and/or manage many of the typical day-to-day aspects of the dental office, including treatment procedures, dental devices and apparatus, diagnostic, evaluation and imaging procedures and systems, patient health and billing records, scheduling systems, inventory systems, emergency systems, and various other systems that are used by dentists, endodontists, and other clinicians.

FIG. 16C is a schematic diagram of the processing unit 39, according to some embodiments. The processing unit 739 can include or communicate with various software modules that, when executed by a processor, perform the various methods and procedures disclosed herein. The software modules can be stored on a non-transitory computer readable medium, such as a memory device (e.g., RAM, ROM, flash, or any other suitable memory known to those of skill in the art). For example, the processing unit can comprise a controller module 743. The controller module 743 may be configured or programmed to control the operation of the treatment procedure components in the system 700. As explained above with respect to FIG. 16A, for example, the controller module 743 may be configured to control the operation of at least one of the containers 731, the monitoring sensors 738 and apparatus 736, the mixing system 732, the degassing system 733, the motor 742, the pump 734, valves, various components of the treatment instrument 101, other sensors (e.g., pressure sensors, etc.), and other mechanical, electrical, or fluidic components. The controller module 43 may also be configured to receive data from and send instructions to these components to monitor and manage the operation of the system 700. For example, the controller module 43 may be programmed to receive and process instructions input to the user interface 728 by the clinician, and may be programmed to display or notify the clinician about the status of the system 700 or procedures by way of the user interface 728. The controller module 43 may be programmed to communicate with the manufacturer, the distributor and/or the service provider, and to report status of the system and receive updates, e.g. software updates for the console 2.

The processing unit 739 can also include a management module 44 configured to store, organize, and/or manage data about the system 700 and about the procedures performed by the system 700. For example, the management module 44 can be programmed to monitor the number and type of procedures performed by the system 700, and can log the history of the system 700 (e.g., the date, time and length of the procedure, the clinician who performed the procedure, etc.). The management module 744 can associate each procedure with a particular patient and can store events recorded by the system 700 and/or by the clinician (by way of the user interface 728). For example, if a particular event occurs during a cleaning procedure (e.g., the patient requires a second visit due to uncontrollable pain or drainage), then the clinician may record such an event using the user interface 728, or various sensors of the system 700 may automatically store such events to the system 700. As explained herein, the system 700 can include various verification devices to ensure that the treatment instrument 101 (e.g., a handpiece) is a valid, sterile handpiece. The management module 44 can store such verification data for the system 700.

Moreover, the management module 744 can track the amount of treatment materials and disposable devices that are associated with the system 700. For example, the management module 744 can track each procedure and can receive information from the system sensors to determine how much of each type of treatment fluid remains in the fluid containers 731. The management module may make the determination based on the number of treatment procedures that drew from the containers 731, or the fluid level sensors disposed on or near the reservoirs may send a signal to the controller 737 indicating that additional fluid is needed at the system 700. The controller 737 and/or management module 744 can send a signal to the clinician (e.g., by way of the user interface 728) that additional fluids should be added to the system 700 and/or console 2. Furthermore, the management module 44 may indicate that additional treatment instruments 101 (e.g., handpieces) should be ordered based on the number of procedures performed by the system 700 and the initial number of treatment instruments 101 supplied to the system 700. Likewise, the management module can track the amount of obturation and/or restoration materials available and can notify the clinician that additional materials should be supplied.

The management module 744 may also track the number of procedures that each system component has been active. For example, the management module 744 can track how many procedures have been performed by the mixing system 732, the degassing system 733, the monitoring sensors or apparatus, the pump 734, the motor 742, the pump 834, a motor in communication with the pump 834, the fluid pathway 735, the interface 704, etc. If the number of procedures exceeds desired safety levels for the particular component, then the management module 744 can send a signal to the clinician (e.g., by way of the user interface 728) that replacement components should be installed. Furthermore, if one of the sensors signals that a particular component is damaged, then the management module 744 can also notify the clinician that the damaged component should be replaced or fixed. The management module 744 can also be configured to notify the manufacturer, distributor and/or the service provider and can report the matter requesting maintenance or repair. The management module 744 can also determine when the waste system 741 is full of waste fluids and particles, and can signal the clinician that the waste system 741 should be emptied or replaced.

The processing unit 739 can also include a communications module 745 configured to provide data communication with external systems (e.g., external systems in the dental office, external supplier systems, etc.) and/or external entities (e.g., persons, businesses, or organizations). The communications module 745 can be configured to communicate with the external systems and/or entities by way of any suitable communications system, such as wireless (e.g. 802.11 networking protocols), Bluetooth, wired networks (e.g., fiber optic lines), mobile telephone networks (e.g., 3G, 4G, etc.), etc. The communications module 745 can also communicate with other system components, by way of direct wire communications, wireless networking, radio frequency identification (RFID), etc.

Additional details about dental treatment systems, methods, and consoles may be found in U.S. Pat. No. 9,504,536, issued Nov. 29, 2016, filed Feb. 4, 2014, entitled “DENTAL TREATMENT SYSTEM,” and International Application Publication WO 2014/121293 (PCT/US2014/014732), having an international filing date of Feb. 4, 2014, entitled “DENTAL TREATMENT SYSTEM,” each of which is incorporated by reference herein in its entirety and for all purposes.

C. Additional Dental Treatment System Embodiments

FIG. 17 depicts a schematic system diagram of an embodiment of a dental treatment system 700. One or more components of the system 700 can be housed within a console, such as console 2 described herein. FIGS. 17A-D depict enlarged sections of portions of the system 700 of FIG. 17.

As shown in FIGS. 17-17D, the system 700 includes a fluid container housing 750. The fluid container housing 750 can house a plurality of fluid containers 731 containing dental treatment fluids. As shown in FIGS. 17-17D, the fluid container housing 750 can include an obturation carrier container 731, a hypertonic container 731, an EDTA container 731, an H₂O container 731, and an NAOCl container 731. Each of the containers 731 can include an integrated filter 751.

In some embodiments, the containers 731 can be removably secured to the container housing 750. For example, in some embodiments, the containers 731 can be coupled to the container housing 750 via a spring latch having a positive lock. The spring latch can click or otherwise provide an indication that the containers are secured. In some embodiments, the containers can be sized for multiple treatments, such as for example, six (6) treatments.

Each container 731 can be coupled to a bottle or container connector 752. Each container connector 752 can be coupled to a 2-way valve 753. Each 2-way valve can include a control 759, which can be in communication with a controller to cause opening and closing of the valve 753. In some embodiments, a container connector 752 can comprise a plunger, a spring, and an O-ring establishing a connection between the container and the 2-way valve. In some embodiments, the container connector 752 is configured to close when the bottle is disengaged from the container housing 750 or two-way valve 753 and configured to open and seal when the container connecter 752 engages the container housing 750 or two-way valve 753. In some embodiments, the container connector 752 is ultrasonically welded to the containers 731.

FIG. 17E illustrates an embodiment of the container connector 752. The container connector can include a housing 808 that can be coupled to the container 731. In certain embodiments, the housing 808 can be ultrasonically welded to the container 731. In certain embodiments, the material(s) forming the container 731 and/or housing 808 can be selected to support ultrasonic welding of the housing 808 to the container 731 and/or to support contact with corrosive materials, e.g., bleach. For example, in some embodiments, one or both of the container 731, the housing 808, and/or any other suitable components of the container connector 752 can be formed of high-density polyethylene (HDPE) or any other suitable material.

A filter 751 can be provided to filter fluid flowing from the container 731 into the container connector 752. In some embodiments, the filter 751 can be coupled to or integrally formed with the container 731. In some embodiments, the filter 751 can be formed of a porous material. In some embodiments, the filter 751 can be formed of a chemically-resistant or corrosion resistant metal, for example to support contact with bleach. In some embodiments, the filter 751 can comprise a porous titanium filter. In some embodiments, the filter 751 can be sintered to the container 731. In some embodiments, the filter can include a lumen 804. Fluid from container 731 can pass through the filter 751 and into the lumen 804 to flow through the container connector 752.

The container connector 752 can include a sealing mechanism to prevent fluid from leaking from the container 731 when the container 731 is disengaged from the console 2. For example, in some embodiments, the container 731 can include a poppet 801. The poppet 801 can include a head 802 and a shaft 803. The shaft 803 can be positioned to move within the lumen 804 of the filter 751. A spring 806 can apply a biasing force to the poppet 801 to cause the poppet to obstruct a flow of fluid through an orifice 809 when the container 731 is disengaged from the console 2. In some embodiments, the spring 806 can be positioned between a distal side of the filter 751 and a proximal side of the head 802 of the poppet 801. When the poppet 801 engages the console 2, the poppet 801 can move proximally towards the container 731 to allow the flow of fluid through the orifice 809 and into a fluid line within the console 2. The poppet 801 can further include a protrusion 813 at a distal end of the poppet 801. The protrusion 813 can be positioned to interact with a portion of a receiver in the console to facilitate the flow of fluid from the container 731 into the console 2. The container connector 751 can further include a seal 807 to form a fluid seal with the console 2 when the container connector 751 is coupled to the console 2.

FIG. 17F illustrates an embodiment of a receiver 816 of the console 2 for receiving the container connector 752. The receiver 816 can include a sealing mechanism for preventing the evaporation of fluid within the console 2 when the container 731 is disengaged from the console 2. For example, in some embodiments, the receiver can include a plunger 810 coupled to a spring 812. The plunger 810 can be positioned within a lumen 811. The lumen 811 can be positioned to receive fluid from the container connector 752. Fluid can flow through the lumen 811 to a fluid line within the console 2. The spring 812 can bias the plunger 810 so as to seal an orifice at a proximal end of the lumen 811 when the container 731 is disengaged from the console 2, for example, to prevent the evaporation of fluid within the console 2. The seal provided by the plunger 110 can also prevent debris buildup due to liquid evaporation.

The receiver 816 can also include a retention spring 814. The retention spring 814 can apply a force to the container connector 752 to prevent the container connector 752 from disengagement from the receiver 816.

FIG. 17G illustrates the container connector 752 engaged with the receiver 816. When the container connector 752 is engaged with the receiver 816 the protrusion 813 of the poppet 801 can contact a proximal end of the plunger 810. In some embodiments, contact between the protrusion 813 of the poppet 801 and the plunger 810 can cause the poppet 801 to move proximally towards the container 731 (in a direction opposite the biasing force of the spring 806) to allow the flow of fluid from the container 731 through the orifice 809. In some embodiments, contact between the protrusion 813 of the poppet 801 and the plunger 810 can cause the plunger 810 to move distally within the lumen 811 (in a direction opposite the biasing force of the spring 812) to allow the flow of fluid from the container connector 752 into the lumen 811. The fluid can flow though the lumen 811 into a fluid line of the console 2.

In some embodiments, the spring force of the spring 806 is greater than the spring force of the spring 812. In such embodiments, the retention spring 814 can prevent disengagement of the container 731 from the console 2 due to the force of the spring 806, for example, when the levels of fluid in the container 731 are low resulting in less force countering the force of the spring 806. The retention spring 814 can therefore maintain the connection between the container 731 and the console 2 to maintain fluid flow regardless of the level of fluid within the container 731.

In some embodiments, the filter lumen 804 can be sized, shaped, and/or otherwise configured to position the poppet 801 through communication with the poppet shaft 803 so that the poppet 801 is aligned within the housing 808. In some embodiments, the filter lumen 804 can be sized, shaped, and/or otherwise configured to position the poppet 801 through communication with the poppet shaft 803 so that the protrusion 813 of the poppet 801 is aligned with the plunger 810 of the receiver 816 when the container connector 752 engages the receiver 816.

In some embodiments, the connection between the container connector 752 and the receiver 816 can allow for the use of a level sensor, such as a pressure transducer, within the console to sense the level of fluid within the container 731, for example, by measuring the pressure head. In some embodiments, the position of the container connecter 752 at the bottom of the container 731 can allow for the use of a level sensor, such as a pressure transducer, within the console to sense the level of fluid within the container 731, for example, by measuring the pressure head. In some embodiments, the position of the container connector 752 at the bottom of the container 731 can also facilitate refill of the container without interrupting a treatment procedure, for example, by allowing additional fluid to be added into the container 731 through an opening at another region (for example, a top section) of the bottle.

FIG. 17H illustrates a perspective view of the poppet 801. The poppet 801 can include one or more channels 817 extending along the shaft 803 to allow the flow of fluid through the filter lumen 804 when the shaft 803 is positioned within the filter lumen 804. The poppet 801 can include recesses 818 within the head 802 of the poppet 801 to allow the flow of fluid through the head of the poppet 801 when the container connecter 752 is engaged to the receiver 816.

In some embodiments, the fluid container housing 750 includes a lid 754 that can be opened to permit access to the interior of the fluid container housing 750 and closed to prevent access to the interior of the fluid container housing 750. In some embodiments, the lid 754 is coupled to a lid sensor 755. The lid sensor 755 can detect an opening and/or a closing of the lid 754.

In some embodiments, it may be desirable to mix the dental fluids stored in the containers 731. In some embodiments, the system 700 can include a mixing system 732 to mix the dental fluids, such as hypertonic, EDTA, H₂O, and NaOCl, to a desired amount. In some embodiments, the mixing system 732 can include a mixing manifold 756. The mixing manifold 756 can include valves 757 coupled to fluid lines from each of the containers 731 having dental fluid to be mixed. The valves 757 can include valve controls 758, which can be in communication with a controller to cause opening and closing of the valves 757. In some embodiments, the valves 757 can be selectively opened and closed to allow desired amounts of treatment fluids to flow through the mixing manifold 756. Embodiments of mixing systems are discussed in further detail herein.

In some embodiments, the system 700 can include a concentration sensor 736a. The concentration sensor 736a can be positioned downstream of the mixing system 732 to detect a concentration of a mixed delivery fluid from the mixing manifold 756. Embodiments of concentration sensors are discussed in further detail herein.

In some embodiments, the system 700 can include a level sensor 760. In some embodiments, the level sensor 760 can be positioned downstream the of concentration sensor 736a. The delivery fluid can flow from the concentration sensor 736a to the level sensor 760. In some embodiments, the level sensor 760 can include a pressure transducer. The level sensor 760 can provide data for determining an amount of fluid in each fluid container 731. For example, in embodiments in which the level sensor 760 includes a pressure transducer, the level sensor can measure a pressure head in each container 731. In some embodiments, the amount of fluid within a container 731 is measured while the valve 753 of the container 731 of interest is opened and the valves 753 for each of the other containers 731 are closed. Measurement is performed while the flow of fluid is stopped within the system 700.

In some embodiments, coupling a fluid container 731 to the system 700 results in the formation of air bubbles in the fluid. In some embodiments, a defined amount of fluid is flushed prior to taking a measurement using the level sensor 760 in order to remove the air bubbles so that only the fluid of interest is measured. For example, in some embodiments, the defined amount of fluid is flushed using a flush pump 761 positioned downstream of the level sensor 760.

In some embodiments, a defined amount of fluid is flushed after it has been determined that the lid 754 has been opened and closed using the lid sensor 755. An opening and closing of the lid 754 may indicate connection of a new fluid container 731 or disconnection and reconnection of a fluid container 731. Accordingly, in some embodiments, it is assumed that an opening and closing of the lid 754 results in the formation of air bubbles in the fluids within the fluid container 731.

In some embodiments, a check valve 762 and a t-fitting 763 are positioned between the level sensor 760 and the flush pump 761.

In some embodiments, fluid can flow from the t-fitting 763 to the flush pump 761 and/or from the t-fitting 763 to another check valve 764. Fluid can flow from the flush pump 761 and/or check valve 764 to another t-fitting 765.

In some embodiments, the system 700 can include a degassing system or degasser 733a. The degasser 733a can remove, or reduce, the amount of dissolved gasses in a dental fluid. In some embodiments, as shown in FIGS. 17-17D, the degasser 733a can be positioned downstream of the mixing system 732. In the embodiment of FIGS. 17-17D for example, the desired treatment fluid is mixed, and, subsequently, dissolved gases (such as dissolved oxygen) can be removed from the mixed fluid. In some embodiments, after the second t-fitting 765, the delivery fluid flows into the degasser 733a.

In some embodiments, as shown in FIGS. 17-17D, filling material (e.g., obturation material) does not flow into the mixing system 732, but instead flows from an obturation container 731 into a second degasser 733b. In some embodiments, each of the first degasser 733a and the second degasser 733b are coupled to a degasser pump 766. The degasser pump 766 can comprise a flush pump. In some embodiments, the degasser pump 766 can purge a first fluid within the degasser 733a or the degasser 733b to allow degassing of a second fluid.

Delivery fluid can flow from the first degasser 733a to a first three-way valve 767. From the first three-way valve 767, the delivery fluid can flow to a waste container 741 and/or to a second three-way valve 768. Obturation material can also flow from the second degasser to the second three-way valve 768.

In some embodiments, the system 700 can include a high pressure pump 734. The second three-way valve 768 can selectively open and close to allow delivery fluid from the mixing system 732 or obturation material to flow to the high pressure pump 734. The high pressure pump 734 can drive delivery fluid and/or obturation material along a high pressure fluid pathway 735, for example, to a treatment instrument 101. The pump 734 may be a chemical resistant, high-pressure pump in some arrangements such that the pump 734 can accommodate both high pressure fluid flow and the chemical properties of the treatment fluid without experiencing corrosion or other deleterious effects. The fluid pathway 735 may similarly be made of a material and structure such that the pathway 735 is resistant to corrosion or other negative effects caused by the treatment fluids. The fluid pathway 735 may also be configured to support high-pressure fluid flow therethrough.

As shown in FIGS. 17A-D, in some embodiments, the high pressure pump 734 can include a motor 742, a fan 769, and an inlet 770 for ambient air inflow.

In some embodiments, the high pressure pump 734 can be in fluid communication with the waste container 741 via a waste line such that the high pressure pump 734 can selectively direct fluid to the waste container 741.

In some embodiments, a water container 731 can also be used to supply a backflush line 771 to the pump 734. It can be advantageous in some embodiments to clear the pump 734 of fluids and/or other materials after prior treatments or runs. Accordingly, water can be supplied by way of the backflush line 771 to the pump 734. The water can pass through the pump 734 and substantially flush the pump 734 of undesirable materials. The waste line can convey the flushed water and waste materials from the pump 734 to the waste container 741. A t-fitting 772 may be positioned to allow the flow of water from the water container 731 to both the mixing system 732 and the backflush line 771. To supply water to the pump 734, a suitable valve may be used. For example, in some embodiments, a solenoid valve may be used.

In some embodiments, a pressure relief valve 773 can be positioned along the pathway 735. In some embodiments, the pathway 735 includes a cross-fitting 774. The cross-fitting 774 can be in fluid communication with the pressure relief valve 773 which can be in fluid communication with the waste container 741 to allow the flow of fluid from the cross-fitting 773 to the waste container in order to limit pressure within the system 700. In some embodiments, a controller sets a pressure to dispense fluid to a treatment device.

In some embodiments, system 700 can include a thermoelectric cooler 775. As shown in FIGS. 17A-C, the thermoelectric cooler 775 can be positioned along the pathway 735. In some embodiments, the cooler can be positioned downstream of the cross-fitting 773. In some embodiments, the thermoelectric cooler 775 can include a fan 776 and an inlet 777 for ambient air inflow. The thermoelectric cooler 775 can be used to control a temperature of the delivery fluid delivered to the patient. Fluid that is too hot can damage or burn the gums. In some embodiments, a temperature controller can control the thermoelectric cooler 775 to control the temperature of the fluid delivered to the patient. In some embodiments, it is advantageous to control the temperature of the fluid delivered to the patient as close to the point of delivery as possible to reduce the likelihood of changes to the temperature of the fluid. In some embodiments, a Peltier cold plate and tube can be used to control the temperature of the fluid delivered to the patient.

In some embodiments, the system 700 can include a high pressure sensor 778 position along the pathway 735. In some embodiments, the high pressure sensor 778 can be positioned downstream of the thermoelectric cooler.

In some embodiments, the system 700 can include a high pressure filter 779 and a high pressure hose 780 positioned along the pathway 735. Pressurized delivery fluid can flow from the high pressure sensor to through the high pressure filter 779 and through the high pressure hose 780.

As described herein, the pressurized delivery fluid in the high pressure pathway can be directed to a treatment instrument 101 for use in a treatment procedure. In some embodiments, the treatment instrument 101 can be coupled to the high pressure hose 780 to receive pressurized delivery fluid therefrom.

In some embodiments, waste fluid can flow from the treatment instrument 101 to the waste container 741 along an evacuation pathway. In some embodiments waste fluid can be drawn to the waste container 741, for example, by a vacuum or evacuation pump 781. In some embodiments, a wet evacuation vacuum sensor 782 can detect pressure in the evacuation pathway between the handpiece and the waste container.

In some embodiments, the waste container 741 can include a waste lid 783. In some embodiments, the waste container 741 can include a level sensor 784 configured to detect a level of waste fluid within the waste container 741.

In some embodiments, the evacuation pump 781 can draw fluid from the waste container 741. A dry evacuation vacuum sensor 785 can detect pressure in an evacuation line between the waste container and the evacuation pump 781. In some embodiments, the evacuation pump 782 can be coupled to a muffler 786. In some embodiments, the system 700 can include a carbon filter 787. The carbon filter 787 can reduce odors caused by the mixing of chemicals within the system 700, for example, by removing gases produces by the dental fluids.

In some embodiments, the evacuation pump 742 can be used to regulate the vacuum level in the system 700 based on the type of treatment procedure being performed. Different procedures may require different vacuum levels. The vacuum sensors 782 and 785 may facilitate monitoring and adjustment of the vacuum levels. In some embodiments, the evacuation pump 742 can be controlled to maintain a particular pressure value.

In some embodiments, fluid can flow from the waste container 741a to a precision orifice 788.

FIG. 17I illustrates an embodiment of a waste container system 741 including a waste container 741a. As shown in FIG. 17I, the waste container 741a can be positioned in a holder 824. The holder 824 can be positioned within a drawer 820 of the console 2. As shown in FIGS. 17J and 17K, the waste container 741a can include a first connector 828 configured to engage a second connector 829 within the console 2 to form a vacuum seal interface 822 to couple the waste container 741a to a vacuum line 823 for delivery waste to the waste container 741a. The vacuum line 823 may be in fluid communication with the outlet line 126 described herein. The first connector 828 can be in the form of a rubber gasket. In some embodiments, the connector 828 and/or the connector 829 can be shaped, positioned, or otherwise configured so that when the drawer is fully inserted into the console 2, the connectors 828 and 829 mate to form the vacuum seal interface 822. The waste container 741a can further couple to the console 2 via a ball latch 821, which can assist in maintaining the vacuum seal interface 822. Similarly, the components of the ball latch 821 can be shaped, positioned, or otherwise configured to mate when the drawer is fully inserted into the console 2.

As shown in FIG. 17I, a level sensor 784 can be positioned to detect a level of waste within the waste container 741a. In the embodiment of FIG. 17I, the level sensor 784 is coupled to holder 824. When the container 741a is positioned within the holder 824, the sensor 784 can detect a waste level within the waste container 741a. In certain embodiments, the level sensor 784 can include a capacitive strip. The capacitive strip can measure the height of fluid within the container 741a. Measurements by the sensor 784 can be used to determine if the waste container 741a has a sufficient capacity to receive waste from a predetermined procedure by a processor, for example, by the processing unit 739. In some embodiments, the processing unit 739 can determine a number of remaining procedures that can be performed without extending beyond a maximum capacity level or other predetermined capacity level of the waste container 741a. In some embodiments, a digital count can be provided in which a height corresponds to a number of treatment procedures.

As described herein, the level sensor 784 is positioned on the holder 824 and not on the container 741a. Positioning of the sensor 784 on the holder 824 can allow for the sensor 784 to be used with multiple containers 741a. Positioning of the sensor 784 on the holder 824 instead of the container 741 also allows for a user to position the container 741a within the drawer 820 without having to form an electrical connection for the sensor 784 or position the container 741a in a particular orientation based on the location of the sensor 784. In other embodiments, the sensor 784 may be positioned on the container 741a.

In some embodiments, the holder 824 can form an air tight seal with the outer wall of the container 741a so that no air gap is present between the wall of the holder 824 to which the sensor 784 is coupled and the adjacent wall of the container 741a. The absence of an air gap may improve the accuracy of the reading of the sensor 784. In some embodiments, the connector 829 can include a plurality of springs 827, as shown in FIG. 17J, that provide a constant load on the waste container 741a when the connector 828 is coupled to the connector 829 to maintain the vacuum seal interface 822. A gap 830 allows the springs 827 to compress when the container 741a is loaded into the console 2. The sensor 784 can be positioned on the holder 824 on a wall opposite of the connector 829 so that the springs 827 provide a constant load on the container 741a in a direction towards the sensor 784 so that the wall of the container 741 is airtight with the wall of the holder 820 adjacent the sensor 784 so that no air gap is positioned between the sensor 784 and the interior of the waste container 741a.

As shown in FIGS. 17I-K, the connector 828 can be positioned on the lid 783 so that fluid enters the container 741a through the lid 783 at the upper most portion of the waste container 741a. A basket 825 can extend from the lid 783. The basket 825 can house a ball 826. The basket 825 and ball 826 can form a float valve which can form a seal with the connector 828 to stop flow from the vacuum line 823 into the container 741a if the waste container 741a is full of waste material. Although the embodiment of FIGS. 17I-17K are shown in connection with a waste container, the connectors, sensors, and other components of FIGS. 17I-17K can be used with any suitable container of the console 2 that is to be connected in a similar manner, e.g., including fluid supply containers 731.

As described above, in some embodiments, the system 700 can be part of a console, such as console 2. The console can include a user interface, such as user interface 28, and a control unit, such as control unit 39. In some embodiments, the console can include a power unit, such as power unit 40 for supplying electrical power to the various components of system 700.

In some embodiments, the system 700 can include a secondary power supply, such as a battery. The secondary power supply can be configured to maintain at least some functions of the system 700 if the system is disconnected from a primary power supply, for example, if the system 700 is unplugged from an electrical outlet. For example, in some embodiments, the secondary power supply can provide power for checking of sensors, displaying fluid levels, etc.

In some embodiments, the system 700 can include an ethernet over AC power. The ethernet over AC power allows the system 700 to connect using Wi-Fi or ethernet. The ethernet over AC power allows for moving the system to different locations in a dental office. The ethernet over AC power also facilitates communication in areas of a dental office that may experience reduced Wi-Fi, for example, areas lined with lead.

In some embodiments, multiple consoles, for example, housing systems 700, can communicate with each other. For example, in some embodiments, each console can include a display which can display the status of other consoles in which it is in communication. In some embodiments, the display screens can display the current status of a procedure or an error in a procedure from another console. In some embodiments, the display screens can provide a dashboard of all procedures performed on all coupled consoles. In some embodiments, a console can include a button or other trigger that can be pressed to initiate a display on other connected consoles. For example, a button can be used to transmit a request for assistance or attention to other consoles.

As described above, in some embodiments, the system 700 can be configured to deliver fluid to a treatment instrument 101. In some embodiments, the treatment instrument 101 can be used for both obturation and cleaning. In some embodiments, the treatment instrument 101 can be configured to receive both obturation material and a cleaning fluid. In some embodiments, the treatment system can be configured to receive a paste or abrasive slurry and a high pressure fluid. In some embodiments, the paste can be positioned within a syringe within the handpiece.

In some embodiments, high pressure air is delivered to the syringe in the handpiece to deliver the paste. In some embodiments, an air compressor, storage tank, and bleed off valves are used to deliver high pressure air to the syringe. In some embodiments, the pressure of the high pressure air can be adjusted to maintain a pressure profile for distribution of the paste.

In some embodiments, the system 700 can deliver a radiopaque liquid. In some embodiments, a radiopaque liquid can be delivered to a treatment region of a tooth to allow for x-rays as evidence of a treatment procedure for providing to an insurance company. In some embodiments, the radiopaque liquid can dissipate over time.

In some embodiments, a method for cleaning only necrotic tissue in a tooth is provided. In some embodiments, it is possible to detect a difference between necrotic and vital tissue. Vital tissue can be soggier and take longer to clean. In some embodiments, necrotic tissue and vital tissue can be detected and/or measured in aspiration from the tooth.

In some embodiments, a time for cleaning a canal filled entirely with necrotic tissue can be determined. Because it takes longer to clean vital tissue than necrotic tissue, the canal can be cleaned for the only time required for cleaning a canal filled entirely with necrotic tissue, and some amount of vital tissue will be left in the canal if the canal includes any vital tissue. In some embodiments, growth promoting fluid can be added during or after cleaning to promote growth of the remaining vital tissue. In some embodiments, the growth promoting fluid can be radiopaque.

### VII. Concentration Monitoring Systems and Methods

### A. Fluid Delivery System

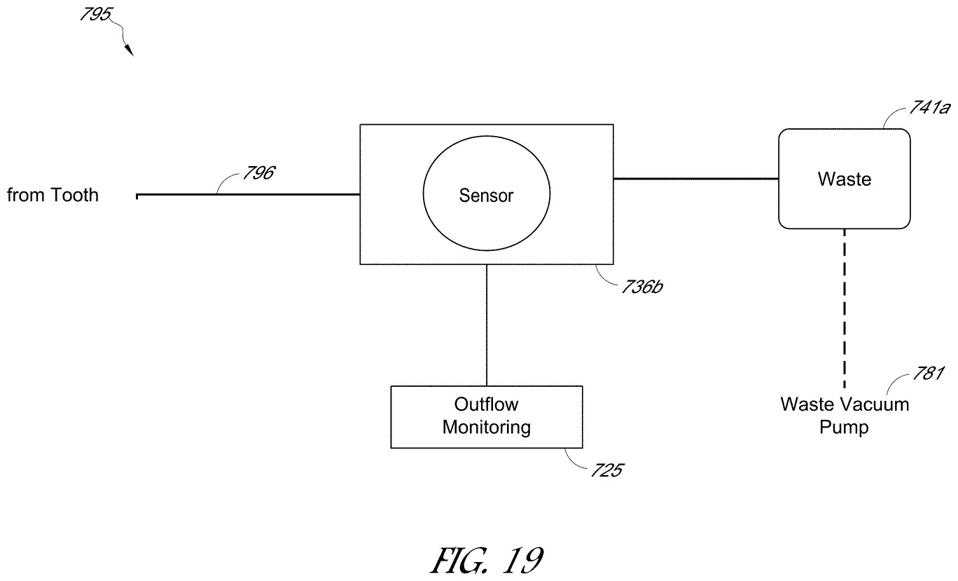

FIG. 18A illustrates a system 790 for delivering fluid at a controlled concentration. The system 790 disclosed herein can be used with various types of treatment procedures. In some embodiments, the system 790 can serve as a subsystem of system 700. In some embodiments, various components of the system 790 can be used in addition to or instead of various components described with respect to system 700. In some embodiments, the system 790 can include one or more of the various components and/or functionalities described with respect to system 700. Moreover, the system 790 can be combined with any of the systems and components described with respect to system 700.

The system 790 includes a mixing system 732. The mixing system 732 is configured to receive a plurality of fluids 703A-C from one or more fluid sources. The fluid source(s) can be supplied from one or more corresponding reservoirs or tanks disposed in a console, such as for example, one or more fluid containers 731. The mixing system 732 can receive the plurality of fluids via a plurality of fluid lines 705A-C.

As described in further detail herein, the fluids 703A-C can include various chemical species suitable for use in dental treatment. For example, in certain embodiments, fluids 703A-C can be NaOCl (bleach), water (H₂O), and ethylenediaminetetraacetic acid (EDTA), respectively.

In different treatment procedures, it may be desirable to mix various fluids, such as two or more of the fluids 703A-C, to a desired concentration, e.g., by drawing and mixing a proper volume ratio of treatment chemicals. For example, in some dental cleaning treatments, it may be desirable to mix bleach or EDTA with water to a desired concentration, to enhance the cleaning effects for the particular procedure, whether a root canal cleaning procedure, a caries removal procedure, or a hygiene procedure (e.g., removing undesirable dental deposits such as plaque, calculus, etc.). In other embodiments, the system 100 can measure concentration(s) of filling materials, including multi-component filling materials.

The mixing system 732 can include a mix manifold 756 housing a plurality of valves 757A-C. The valves 757A, 757B, and 757C can selectively permit and restrict the flow of fluids 703A, 703B, and 703C, respectively, into a delivery fluid line 712 to facilitate the mixture of two or more of the fluids 703A, 703B, and 703C into a delivery fluid or treatment fluid. The mixing system 732 may adjust one or more of the valves 757A, 757B, and 757C to draw the correct amount of fluids 703A-C to produce a delivery fluid or treatment fluid having a controlled concentration. The mixing system 732 can comprise a controller that includes processing electronics configured to adjust the valves 757A-C as explained herein.

As used herein, a line, such as fluid delivery line 712, can refer to a conduit or any other structure capable of housing or retaining fluid as the fluid progresses through a treatment system, such as for example, a chamber, a container, or any other suitable structure.

For example, different amounts of two or more of the fluids 703A-C can be mixed by opening and closing the valves 757A-C with a valve timing proportional to a target concentration of a delivery fluid. In other words, the valve 757A, 757B, and 757C can be selectively opened for lengths of time proportional to the amounts of fluids 703A, 703B, and 703C, respectively, desired in a target concentration. Accordingly, if a target concentration includes more of fluid 703A than fluid 703B by a particular concentration, the valve 757A can be opened for longer than the valve 757B by a particular amount of time. As an example, the mixing system 732 can be used to mix H₂O with NaOCl or EDTA to dilute the concentration of NaOCl or EDTA to a desired concentration.

In some embodiments, the system 790 can include a controller 737 in electrical and data communication with the components of the system 790, such as the valves 757A-C. The system controller 737 can include various units and/or modules, and processing electronics configured to send control instructions to the system components In some embodiments, multiple controllers 737 can be used for controlling different aspects of the system 790 and/or system 700.

In some embodiments, the system controller 737 can be in electrical and data communication with the mixing system 732. The system controller 737 can include a valve controller 722 in electrical and data communication with the valves 757A-C. The valve controller 722 can cause the valves 737A-C to open and close so as to produce a delivery fluid having a controlled concentration. The valve controller 722 can be in electrical and data communication with valve controls 758A-C of the valves 757A-C. The valve controller 722 can actuate the valve controls 758A-C to cause the valves 757A-C to open and close so as to produce a delivery fluid having a controlled concentration.

In some embodiments, controller 737 can be in electrical and data communication with one or more sensors. The controller 737 can be configured to receive feedback from the one or more sensors and adjust the opening and closing of the valves 757A-C in accordance with the feedback.

In some embodiments, the system 790 can include a concentration sensor 736a. In some embodiments, the sensor 736a can include any of the same or similar features and functions as the sensors 738 and/or monitoring apparatus 736. In some embodiments, the system 700 can include one or more sensors 736a in addition to or instead of one or more of the sensors 738 and the monitoring apparatus 736.

The concentration sensor 736a can comprise any suitable type of sensor capable of measuring the concentration of the fluids. For example, the concentration sensor 736a can comprise a photometer in various embodiments. In some embodiments, sensor 736a can measure one or more of absorbance, transmittance, scattering, etc.

The concentration sensor 736a can be positioned downstream of the mixing system and can be configured to measure the concentration of the delivery fluid provided by the mixing system 732. The concentration sensor 736a can directly measure concentration in some embodiments. The concentration sensor 736a can also indirectly measure concentration by measuring pH, oxidation reduction potential (ORP), optical density, electrical conductivity, etc. Some concentration sensors may measure the conductivity of the solution to determine the concentration. In some embodiments, the concentration sensor is positioned to measure the delivery fluid as the delivery fluid flows through the delivery fluid line 712, before being delivered to the treatment region of the tooth.

The concentration sensor 736a can be in electrical and data communication with the controller 737 and can provide data to the controller 737 regarding the concentration of the delivery fluid. In some embodiments, the controller 737 can include a concentration measurement module 724 configured to receive, process, and/or store data from the concentration sensor 736a.

The system controller 737 can adjust the opening and closing of the valves 757A-C in response to the data from the concentration sensor 736a. In some embodiments, the system controller 737 can adjust the timing of the opening and closing of the one or more valves 757A-C in response to data from the concentration sensor 130. In such embodiments, the valve controller 722 can be a proportional-integral-derivative (PID) controller. The feedback loop described herein may use the PID controller to compensate for variability in the valves, flow rate and/or concentration to provide a desired concentration of a delivery fluid to a treatment device, such as a treatment handpiece or other instrument used to, for example, clean a tooth.

In some embodiments, the concentration of a label on a fluid container, such as a bleach container, can be entered into a console or scanned by a sensor of the console, and a mixing system, such as mixing system 732, can dilute the fluid within the fluid container ratiometrically.

In some embodiments, a delivery fluid can be delivered from the system 790 to a treatment device, such as a treatment handpiece, or other instrument used to, for example, clean a tooth.

FIG. 18B illustrates another embodiment of a system 790 for delivering fluid at a controlled concentration. The system 790 of FIG. 18B includes a fluid 703D, a fluid line 705D, a valve 708D, and a valve control 758D. In some embodiments, the fluid 703D comprises hypertonic fluid. The hypertonic fluid can comprise NaCl. In some embodiments, the hypertonic fluid comprises 3% NaCl.

As shown in FIG. 18B, the system 790 includes a degasser 733a. The degasser 733a can have any of the same or similar features or functions as the degasser 733a. For example, the degasser 733a can remove dissolved gases from the treatment fluid(s), which can improve the cleaning (or filling) performance of the treatment instrument 101. In some embodiments, the sensor 736a can be positioned between the mixing system 732 and the degasser 733a. In some embodiments, it may be advantageous to position the sensor 736a in close proximity to the mixing system 732, such as for example, between the mixing system 732 and the degasser 733a. The proximity of the sensor 736a to the mixing system 732 can affect the rate or timing at which the data measured by the sensor 736a can be used to adjust the operation of the mix manifold to cause the mixing system 732 to provided a delivery fluid having a desired concentration, for example, using a feedback loop as described with respect to FIG. 18A. A sensor 736a at a first distance from the mixing system 732 can provide data to a controller, such as controller 737, earlier or faster than a sensor 736a positioned at a second distance from the mixing system farther than the first distance. In some embodiments, a sensor 736a positioned between the mixing system 732 and degasser 733a can provide data to a controller, such as controller 737, earlier or faster than a sensor 736a positioned downstream of both the mixing system 732 and degasser 733a. In some embodiments degassing is performed over an extended duration of time. In such embodiments, feedback can be provided faster from a sensor 736a positioned before the degasser 733a than after the degasser 733a. Thus, positioning the sensor 736a between the mixing system 732 and the degasser 733a can increase the response time of the controller 737 in comparison to embodiments in which the sensor 736a is positioned after the degasser 733a.

As described herein, a sensor 736a positioned after the mixing system 732 can facilitate the measurement of the concentrations of various components within the mixed delivery fluid. Measuring the concentrations of the components after mixing can allow for fewer sensors in comparison to embodiments in which multiple sensors are used to measure the concentrations of various components prior to mixing in a mixing system.

Although not shown in FIG. 18B, in some embodiments, the mix manifold and concentration sensor can be electrical and data communication with a system controller such as system controller 737 as shown in FIG. 18A.

The embodiment of the system 790 shown in FIG. 18B also includes a high pressure pump 734 positioned downstream of the degasser 733a. The high pressure pump 734 can have any of the same or similar features or functions as the high pressure pump 734. The high pressure pump 734 can drive treatment fluid to a treatment instrument 101. The pump 734 can be driven by the motor 742 that can be controlled by a controller, such as controller 737.

In cleaning procedures, the delivery fluid can comprise a treatment fluid that can be introduced into the tooth to assist in removing unhealthy or undesirable materials from the tooth. The treatment fluids can be selected based on the chemical properties of the fluids when reacting with the undesirable or unhealthy material to be removed from the tooth. The treatment fluids disclosed herein can include any suitable fluid, including, e.g., water, saline, etc. Various chemicals can be added to treatment fluid for various purposes, including, e.g., tissue dissolving agents (e.g., NaOCl or bleach), disinfectants (e.g., chlorhexidine), anesthesia, fluoride therapy agents, ethylenediaminetetraacetic acid (EDTA), citric acid, and any other suitable chemicals. For example, any other antibacterial, decalcifying, disinfecting, mineralizing, or whitening solutions may be used as well. The clinician can supply the various fluids to the tooth in one or more treatment cycles, and can supply different fluids sequentially or simultaneously.

During some treatment cycles, bleach-based solutions (e.g., solutions including NaOCl) can be used to dissociate diseased tissue (e.g., diseased organic matter in the root canal) and/or to remove bacteria, biofilm or endotoxins (Lipopolysaccharide or LPS) from the tooth. One example of a treatment solution comprises water or saline with 0.3% to 6% bleach (NaOCl). In some methods, tissue dissolution and dental deposit removal in the presence of bleach may not occur when the bleach concentration is less than 1%. In some treatment methods disclosed herein, tissue dissolution and dental deposit removal can occur at smaller (or much smaller) concentrations.

During other treatment cycles, the clinician can supply an EDTA-based solution to remove undesirable or unhealthy calcified material from the tooth. For example, if a portion of the tooth and/or root canal is shaped or otherwise instrumented during the procedure, a smear layer may form on the walls of the canal. The smear layer can include a semi-crystalline layer of debris, which may include remnants of pulp, bacteria, dentin, and other materials. Treatment fluids that include EDTA may be used to remove part or all of the smear layer, and/or calcified deposits on the tooth. EDTA may also be used to remove dentin packed into isthmuses and lateral canals during the instrumentation process. EDTA may also be used to remove a microscopic layer off enamel and cleaning and staining purposes. Other chemicals such as citric acid may also be used for similar purposes.

During yet other cycles, for example, the clinician may supply a treatment fluid that comprises substantially water. The water can be used to assist in irrigating the tooth before, during, and/or after the treatment. For example, the water can be supplied to remove remnants of other treatment fluids (e.g., bleach or EDTA) between treatment cycles. Because bleach has a pH that tends to be a base and because EDTA is an acid, it can be important to purge the tooth between bleach and EDTA treatments to avoid potentially damaging chemical reactions. Furthermore, the water can be supplied with a sufficient momentum to help remove detached materials that are disrupted during the treatment. For example, the water can be used to convey waste material from the tooth.

Various solutions may be used in combination at the same time or sequentially at suitable concentrations. In some embodiments, chemicals and the concentrations of the chemicals can be varied throughout the procedure by the system 100 to improve patient outcomes. For example, during an example treatment procedure, the clinician can alternate between the use of water, bleach, and EDTA, in order to achieve the advantages associated with each of these chemicals using the system 100. In one example, the clinician may begin with a water cycle to clean out any initial debris, then proceed with a bleach cycle to dissociate diseased tissue and bacteria from the tooth. A water cycle may then be used to remove the bleach and any remaining detached materials from the tooth. The clinician may then supply EDTA to the tooth to remove calcified deposits and/or portions of a smear layer from the tooth. Water can then be supplied to remove the EDTA and any remaining detached material from the tooth before a subsequent bleach cycle. The clinician can continually shift between cycles of treatment fluid throughout the procedure using the system 100. The above example is for illustrative purposes only. It should be appreciated that the order of the cycling of treatment liquids may vary in any suitable manner and order.

Thus, the treatment fluids used in the embodiments disclosed herein can react chemically with the undesirable or unhealthy materials to dissociate the unhealthy materials from the healthy portions of the tooth. The treatment fluids can also be used to irrigate waste fluid and/or detached or delaminated materials out of the tooth. In some embodiments, the treatment solution (including any suitable composition) can be degassed, which may improve cavitation and/or reduce the presence of gas bubbles in some treatments. In some embodiments, the dissolved gas content can be less than about 1% by volume.

B. Outflow Monitoring System

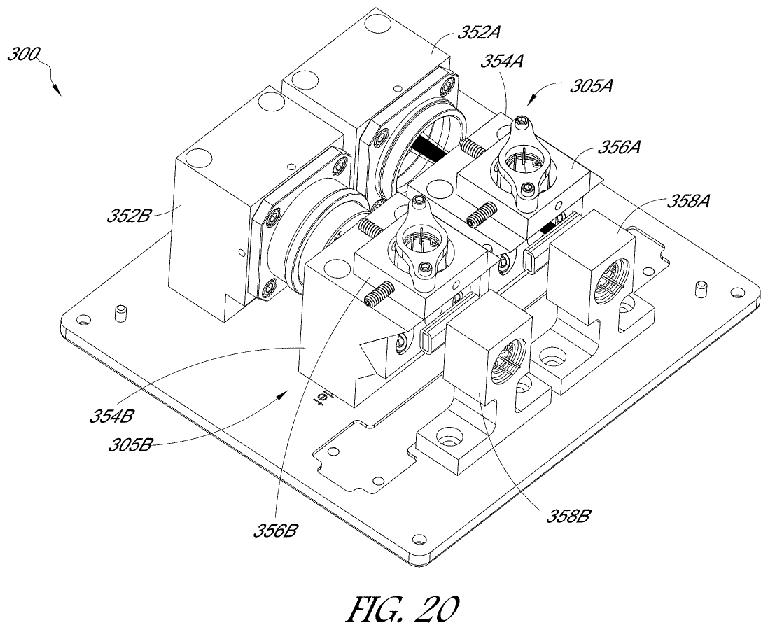

FIG. 19 illustrates an embodiment of a monitoring system 795. In some embodiments, the monitoring system 795 can monitor fluid outflow from a tooth, for example, after the fluid has been used in a dental treatment procedure. The monitoring system 795 can detect and measure amounts of biological compounds and/or provide information on the fluid being removed from the tooth.

In some embodiments, the system 795 can serve as a subsystem of system 700. In some embodiments, various components of the system 795 can be used in addition to or instead of various components described with respect to system 700. In some embodiments, the system 795 can include one or more of the various components and/or functionalities described with respect to system 700. Moreover, the system 795 can be combined with any of the systems and components described with respect to system 700.

In some embodiments, the monitoring system 795 can include one or more sensors configured to measure properties of fluid being removed from the tooth. For example, the monitoring system 795 can include a concentration sensor 736b configured to measure the concentration of fluid flowing out of the tooth. In some embodiments, the sensor 736b can include any of the same or similar features and functions as the sensor 736a, the sensors 738 and/or monitoring apparatus 736. In some embodiments, the system 700 can include one or more sensors 736b in addition to or instead of one or more of the sensors 738, the monitoring apparatus 736, and the sensor 736a.

The concentration sensor 736b can comprise any suitable type of sensor capable of measuring the concentration of the fluids. For example, in some embodiments, the concentration sensor 736b comprises a photometer. In some embodiments, sensor 736b can measure one or more of absorbance, transmittance, scattering, etc.

The concentration sensor 736b can directly measure concentration in some embodiments. The concentration sensor 736b can also indirectly measure concentration by measuring pH, oxidation reduction potential (ORP), optical density, electrical conductivity, etc. Some concentration sensors may measure the conductivity of the solution to determine the concentration.

As shown in FIG. 19, the concentration sensor 736b can be positioned along a waste path 796 for fluid being removed from the tooth. For example, in some embodiments, the concentration sensor 736b can be positioned along a waste path in a treatment device, such as a treatment handpiece, or other instrument used to, for example, clean a treatment region of a tooth. In some embodiments, the concentration sensor 736b can be positioned along a waste path in tubing that receives waste fluid from a treatment device or in a waste collection container or canister 741a (e.g., in a dental treatment console). In some embodiments, the concentration sensor 736b can be positioned along a waste path between the tooth and a waste vacuum pump 781, which can apply suction forces to draw the waste fluid from the tooth. In some embodiments, the fluid being removed from the tooth is a mixture, such as a slurry, of gas, such as air, and liquid. In some embodiments, the concentration sensor 736b is configured to measure concentration of the mixture of gas and liquid. In some embodiments, the system 200 includes a gas and liquid separator positioned between the tooth and the sensor 736b. In some embodiments, the sensor 736b is configured to measure the concentration of the liquid after gas and liquid separation. In some embodiments, the sensor 736b is configured to measure the concentration of the gas after gas and liquid separation. In some embodiments, multiple sensors 736b are employed. One sensor 736b can be configured to measure the concentration of the gas after gas and liquid separation, and one sensor 736b can be configured to measure the concentration of the liquid after gas and liquid separation.

In some embodiments, the concentration sensor 736b can be in electrical and data communication with an outflow monitoring module 725. In some embodiments, the outflow monitoring module can receive, process, and/or store concentration measurement data from the concentration sensor 736b. In some embodiments, the outflow monitoring module 725 can be in part of or in electrical and data communication with a system controller, such as system controller 737.

In some embodiments, the concentration sensor 736b can be configured to monitor the fluid outflow from the tooth for obturation fluid. Monitoring for obturation fluid can facilitate a determination that the tooth has been completely filled with obturation fluid.

In some embodiments, the concentration sensor 736b can be configured to monitor the fluid outflow from the tooth for necrotic tissue. Monitoring the fluid outflow of the tooth for necrotic tissue can facilitate a determination that a tooth has been exhumed of necrotic tissue only. In some embodiments, it may be advantageous to measure light scattering to measure necrotic tissue or other particles in the fluid.

In various embodiments, the system 795 can be used to analyze and monitor the waste fluid collected from the tooth. In various embodiments, the system 795 can be configured to detect blood from the treatment region of the tooth. If evidence of patient bleeding is detected by the monitoring system 795, such as for example, detection of an amount or concentration of blood above a threshold level, a control feedback loop for autonomous hemostatic intervention can be activated, for example, by the outflow monitoring module 725. With the detection of blood, the system 795 can initiate an alert to a main console control system, such as for example, the system controller 120, which then triggers a response to reduce the flow of bleeding. For example, the system 795 can temporarily halt the delivery of treatment fluids to the tooth, and can deliver a bolus or a series of bolus pulses of an anti-hemorrhagic agent. Alternatively, the system 795 can inject the anti-hemorrhagic agent to be entrained with the treatment fluid or entrained with a different regimen of treatment fluid, e.g., at a lower flow rate. In another embodiment, the system 795 can cause an extended halt of fluid delivery to give the patient's body time to naturally stem the bleeding. The system 795 can include a user interface so that the clinician can monitor a visual display on a screen of a console informing the user of blood detection and indicating the protocol being followed. The autonomous hemostatic intervention can also be designed as a threshold-based response. For example, based on a quantification of the level of bleeding, the dosage of the anti-hemmorhagic can be adjusted accordingly. For example, lesser amounts or shorter periods of blood perfusion can correspond to smaller dosages of the anti-hemmorhagic agent. Furthermore, the feedback between the outflow monitoring module 725 and the hemostatic response can be continuous such that the dosage is adjusted in real-time. For example, a smaller dose of the anti-hemmorhagic agent can be administered initially. If blood is still detected after the initial dose of the anti-hemmorhagic agent, the dosage of the anti-hemmorhagic agent can be increased incrementally until blood is no longer detected above the threshold value. Similar approaches can be used to detect bacteria in the waste fluid and can trigger the flow of an antibacterial agent into the fluid flowing into the tooth.

Outflow monitoring can also include the use of a light scatter or turbidity system to measure suspended solids in the outflow steam. A light scatter or turbidity system can be used to measure the biological compounds such as, but not limited to, blood, dentin and soft tissue.

Additional details about outflow monitoring systems and methods may be found in U.S. Pat. No. 9,675,426, issued Jun. 13, 2017, filed Oct. 21, 2011, entitled “APPARATUS, METHODS, AND COMPOSITIONS FOR ENDODONTIC TREATMENTS,” and International Application Publication WO 2012/054905 (PCT/US2011/057401), having an international filing date of Oct. 21, 2011, entitled “APPARATUS, METHODS, AND COMPOSITIONS FOR ENDODONTIC TREATMENTS,” each of which is incorporated by reference herein in its entirety and for all purposes

C. Concentration Sensor Systems

As described herein, various embodiments can employ one or more concentration sensors, such as sensors 736a and 736b, for measuring a concentration of one or more synthetic or biological chemical species in a flowing solution of dental fluids. In some embodiments, the concentration sensors can perform measurements in real time and in situ. In certain embodiments, one or more of the concentration sensors 736a and 736b, the sensor 738, and the monitoring apparatus 736 can include one or more of the sensor systems (e.g., system 300, system 400, system 500, and system 600) or components thereof described in this section.

1. Photometer Sensor Systems

In some embodiments, the concentration sensors described herein can comprise photometers or photometer sensor systems.

In some embodiments, the photometer sensor systems can measure one or more of absorbance, transmittance, scattering, etc.

In some embodiments, spectrophotometry is used to measure properties of dental fluids. Various embodiments disclosed herein include a method using spectrophotometry to directly measure, in real time and in situ, the concentration of synthetic or biological chemical species in a flowing solution of dental fluids in the inflow or outflow condition.

Various embodiments disclosed herein include the use of a spectrophotometric technique to directly measure the presence of biological compounds, such as oxygenated or deoxygenated hemoglobin, that are important for intraoperative monitoring as a feedback loop for patient treatment and procedure assistance.

In some embodiments, a photometer sensor can provide a more direct measurement of fluid chemistry than alternative sensing methods. In some embodiments, a photometer sensor can be less susceptible to additives that are added to the fluid than alternative sensing methods. It is known that some chemicals, such as NaOCl or EDTA, include additional chemistries to, for example, stabilize and extend the shelf life of the product. In some embodiments, a photometer sensor can provide more accurate results for fluids coming from multiple chemical manufacturers.

a. Uncoupled Arrangement

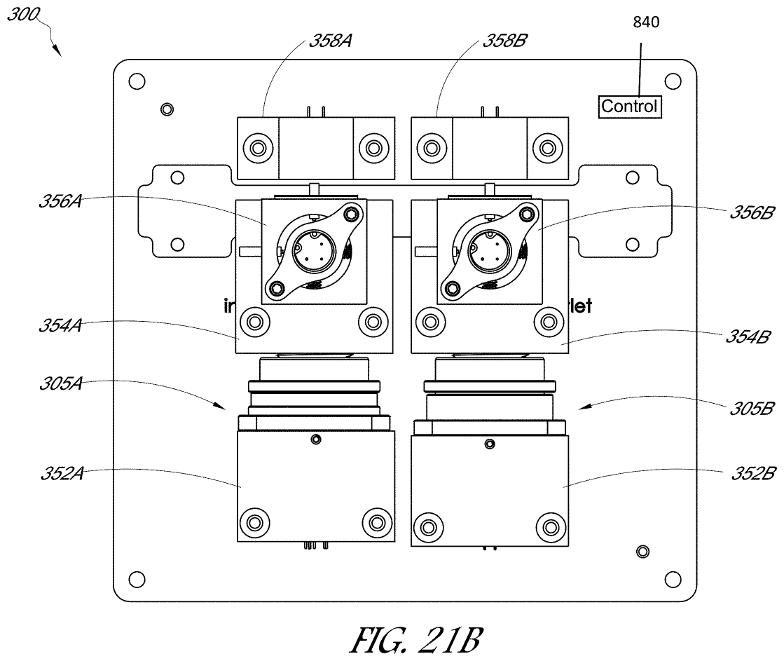

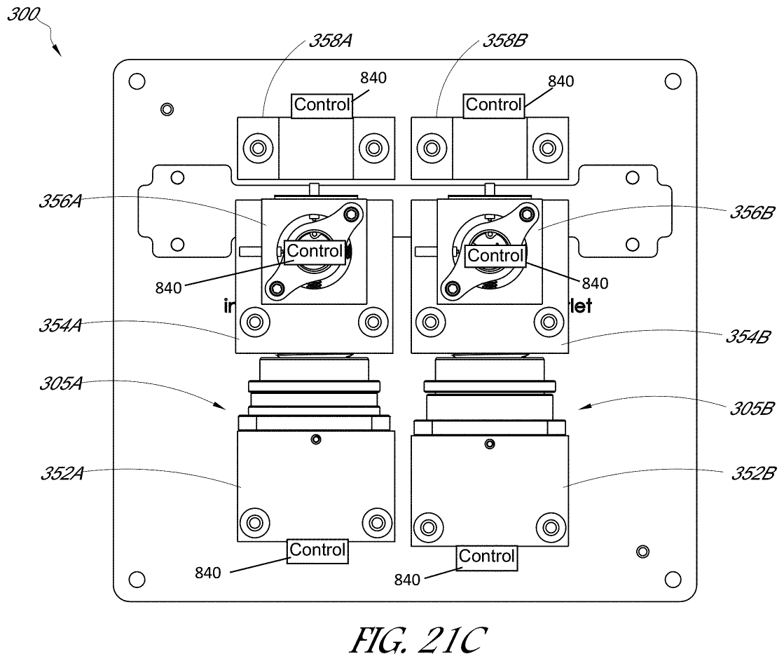

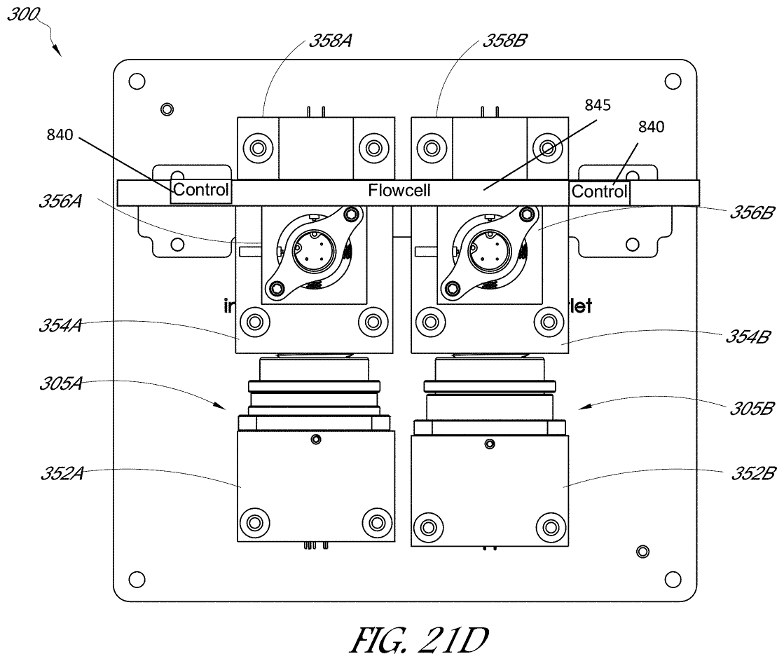

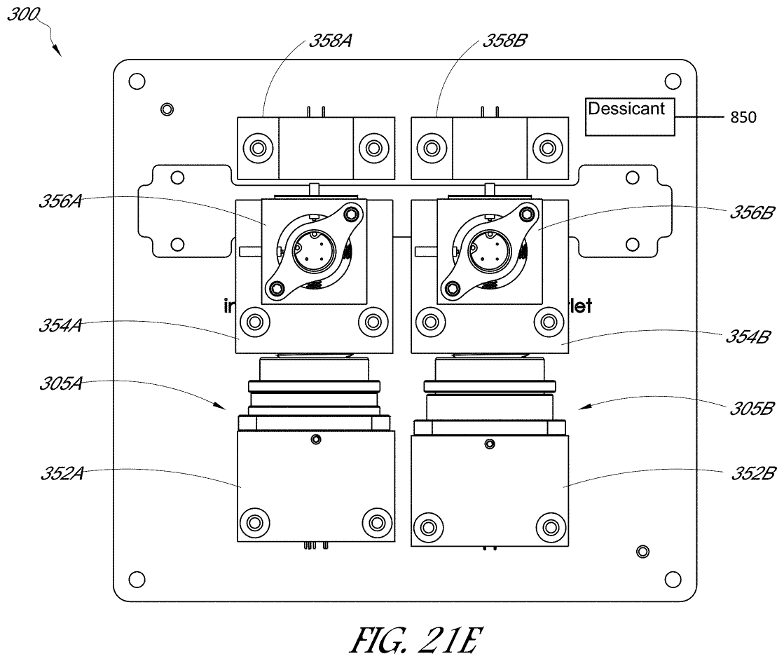

FIGS. 20 and 21 illustrates an embodiment of an illumination system 300. The illumination system can be used for the measurement of one or more chemical species. For example, in certain embodiments, the illumination system 300 can comprise a dual wavelength illumination system used for measurement of two chemical species, such as for example, NaOCl and EDTA. The dual wavelength illumination system 300 can be configured to produce a plurality of wavelengths, e.g., two wavelengths, which can be chosen based on regions in which appropriate levels of absorbance occur for the two chemical species. For example, when the two chemical species are NaOCl and EDTA, wavelengths of illumination can comprise 360 nm and 255 nm, respectively (e.g., in a range of 335 nm to 385 nm for NaOCl and in a range of 230 nm to 280 nm for EDTA).

In some embodiments, the dual wavelength illumination system 300 can include a first photometer 305A and a second photometer 305B. Each of the first photometer 305A and second photometer 305B can be configured to measure one of the two chemical species in a dental fluid.

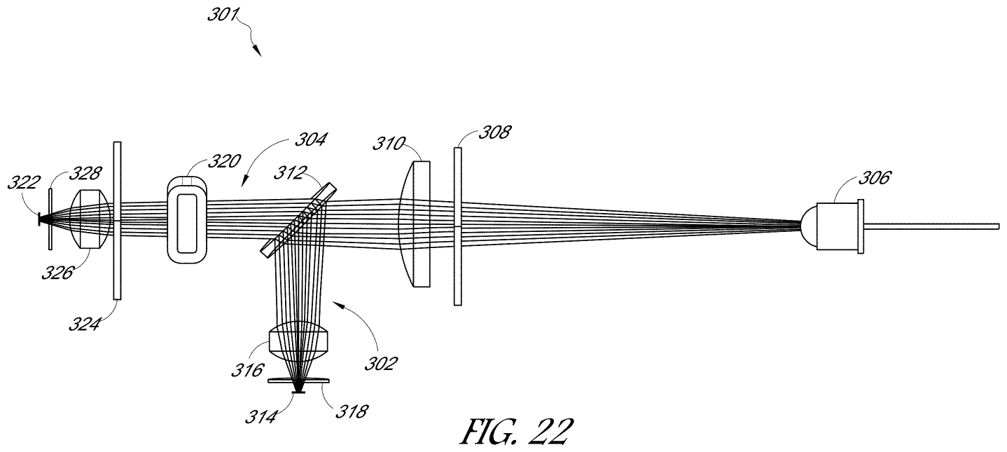

In the dual wavelength illumination system 300, the illumination configuration can include two separate illumination paths, which are referred to as “symmetric independent uncoupled” paths herein. In some embodiments, each of the first photometer 305A and the second photometer 305B includes one of the two symmetric independent uncoupled paths. An example embodiment of a path 301 is shown in FIG. 22.

The path 301 includes a reference sub-path 302 and a collection sub-path 304. The path 301 includes a light source 306. The light source 306 can be configured to emit a particular wavelength or range of wavelengths. In some embodiments, the light source 306 can comprise an LED, or light emitting diode.

The path 301 can include an aperture 308 positioned downstream of the light source 306. The aperture 308 can define an opening through which light emitted from the light source 306 can travel. Downstream of the aperture 306 is a collimating lens 310. Downstream of the collimating lens 310 is a beam splitter 312. The beam splitter 312 can split light from the collimating lens 310 into two light beams, one light beam directed through the reference sub-path 302 and another light beam directed through the collection sub-path 304. Along the reference sub-path 302, light is directed from the beam splitter 312 to a reference photodiode 314. The reference sub-path 302 includes a converging or double convex lens 316 and a lens 318 between the beam splitter 312 and reference photodiode 314.

Along the collection sub-path 304, light is directed from the beam splitter 312 through a flow cell 320 and to a collection photodiode 322. In some embodiments, the flow cell 320 can be formed of glass or any other suitable material. The flow cell 320 can be configured to receive a dental fluid for measurement. In some embodiments, the flow cell is part of or coupled to a dental fluid delivery or treatment line or a dental fluid outflow or waste line.

The collection sub-path 304 also include an aperture 324, a converging or double convex lens 326, and a lens 328 between the flow cell 320 and the collection photodiode 322.

In some embodiments, one or more of the light source 306, aperture 308, lens 310, beam splitter 312, lens 316, lens 318, photodiode 314, aperture 324, lens 328 and photodiode 322 can be chosen from commercially available products.

In a dual wavelength illumination arrangement, two paths 301 can be utilized, each path 301 emitting light at a wavelength based on regions in which an appropriate level of absorbance occur for a chemical species of interest, as described above. For example, in certain embodiments, each of the photometers 305A and 305B can include a path 301. For example, when the two chemical species are NaOCl and EDTA, a first path 301 can emit a wavelength of 360 nm for measurement of NaOCl (e.g., in a range of 335 nm to 385 nm) and a second path 301 can emit a wavelength of 255 nm for measurement of EDTA (e.g., in a range of 230 nm to 280 nm). In some embodiments, the illumination wavelengths can extend between 200 nm and 400 nm.

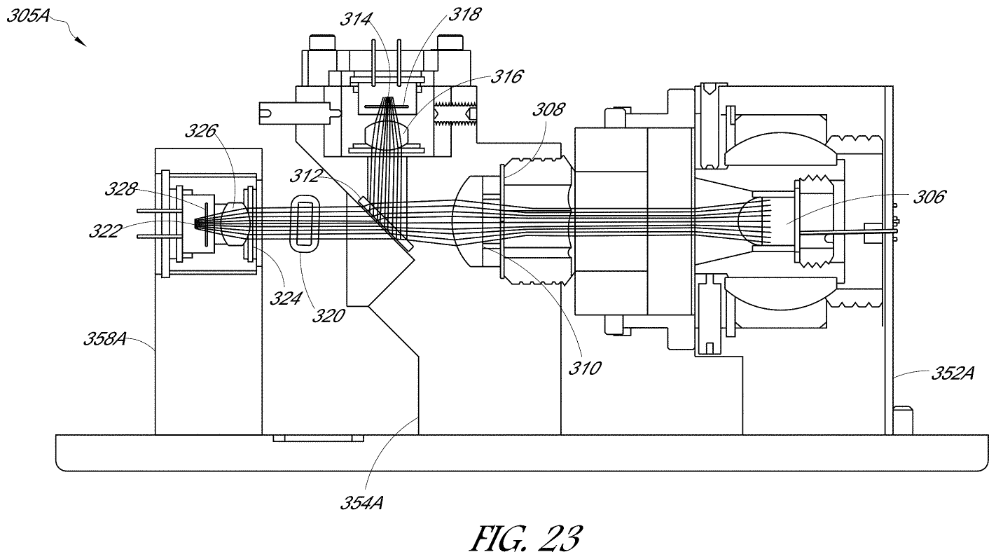

FIG. 23 depicts a cross-sectional view of the photometer 305A. The channel 350 includes the path 301 and a plurality of housings configured to support the components of the path 301.

The photometer 305A can include a light source mount 352A configured to secure and support the light source 306.

The photometer 305A can include an optics block 354A housing one or more of the lens 310 and the beam splitter 312. The photometer 305A can include a reference detector mount 356A configured to house components of the reference sub-path 302. The reference detector mount 356A can house the reference photodiode 314. The reference detector mount 356A can also house the lens 316 and the lens 318.

The photometer 305A can include a measurement detector mount 358A configured to house the collection photodiode 322. The measurement detector mount 358A can also house the lens 326 and the lens 328.

Similarly, as shown in FIG. 20, the photometer 305B can includes a light source mount 352B, an optics block 354B, a reference detector mount 356B, and a measurement detector mount 358B configured to house and support components of a path 301.

While the system 300 is described as a dual-wavelength illumination system herein, additional photometers may be used to provide additional wavelengths for the measurement of additional chemical species. For example, three photometers can be used to provide three different wavelengths for the measurement of three chemical species, four photometers can be used to provide four difference wavelengths for the measurement of four chemical species, etc.

Although measurement of EDTA and bleach are described above, the system 300 may be used to measure the concentration of a variety of dental fluids or materials, such as for example, NaCl, H₂O obturation material, necrotic tissue, etc.

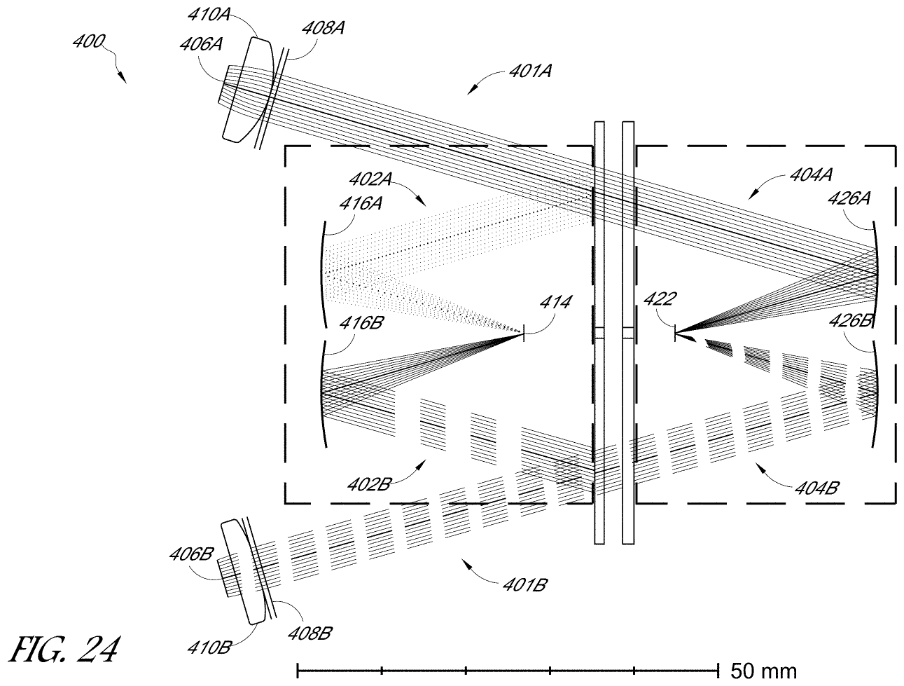

FIG. 24 depicts an embodiment of an illumination system 400. The illumination system can be used for the measurement of one or more chemical species. For example, in certain embodiments, the illumination system 400 can comprise a dual wavelength illumination system used for measurement of two chemical species, such as for example, NaOCl and EDTA. The dual wavelength illumination system 400 can be configured to produce a plurality of wavelengths, e.g., two wavelengths, which can be chosen based on regions in which appropriate levels of absorbance occur for the two chemical species. For example, when the two chemical species are NaOCl and EDTA, wavelengths of illumination can comprise 360 nm and 255 nm, respectively (e.g., in a range of 335 nm to 385 nm for NaOCl and in a range of 230 nm to 280 nm for EDTA).

The illumination configuration of the dual wavelength illumination system 400 can include two symmetric independent uncoupled paths.

The system 400 includes two separate paths 401A and 401B. The path 401A includes a reference sub-path 402A and a collection sub-path 404A. The path 401A includes a light source 406A. The light source 406A can be configured to emit a particular wavelength or range of wavelengths. In some embodiments, the light source 406A can comprise an LED, or light emitting diode.

The path 401A can include a collimating lens 410A downstream of the light source 406A. Downstream of the collimating lens 410A is an aperture 408A. Downstream of the aperture 408A is a flow cell 420. The flow cell 420 and liquid running through the flow cell 420 can reflect a portion of the light and allow a portion of the light to pass through. The flow cell 420 and liquid running through the flow cell 420 can act as a beam splitter. The flow cell 420 and liquid running through the flow cell can split light from the aperture 408A into two light beams, one light beam directed through the reference sub-path 402A and another light beam directed through the collection sub-path 404A.

Along the reference sub-path 402A, light is directed from the flow cell 420 to a concave mirror 416A. Light is directed from the concave mirror to a reference photodiode 414.

Along the collection sub-path 404A, light is directed through the flow cell 420 to a concave mirror 426A. Light is directed from the concave mirror 426A to a reference photodiode 422.

The path 401B includes a reference sub-path 402B and a collection sub-path 404B. The path 401B includes a light source 406B. The light source 406B can be configured to emit a particular wavelength or range of wavelengths. In some embodiments, the light source 406B can comprise an LED, or light emitting diode.

The path 401B can include a collimating lens 410B downstream of the light source 406B. Downstream of the collimating lens 410B is an aperture 408B. Downstream of the aperture 408B is the flow cell 420. The flow cell 420 and liquid running through the flow cell 420 can reflect a portion of the light and allow a portion of the light to pass through. The flow cell 420 and liquid running through the flow cell 420 can act as a beam splitter. The flow cell 420 and liquid running through the flow cell can split light from the aperture 408B into two light beams, one light beam directed through the reference sub-path 402B and another light beam directed through the collection sub-path 404B.

Along the reference sub-path 402B, light is directed from the flow cell 420 to a concave mirror 416B. Light is directed from the concave mirror to the reference photodiode 414.

Along the collection sub-path 404B, light is directed through the flow cell 420 to a concave mirror 426B. Light is directed from the concave mirror 426B to the reference photodiode 422.

In some embodiments, one or more of the light source 406A, light source 406B, lens 410A, lens 410B, aperture 408A, aperture 408B, mirror 416A, mirror 416B, photodiode 414, mirror 426A, mirror 426B, and photodiode 422 can be chosen from commercially available products.

In some embodiments, the flow cell 420 can be formed of glass or any other suitable material. The flow cell 420 can be configured to receive a dental fluid for measurement. In some embodiments, the flow cell 420 is part of or coupled to a dental fluid delivery or treatment line or a dental fluid outflow or waste line.

The illumination system 400 is configured to facilitate measurement at both a reference photodiode and a collection photodiode without requiring a beam splitter. As described herein, the flow cell 420 can reflect a portion of the light directed at the flow cell 420 and allow a portion of the light to pass through. By reflecting a portion of the light directed at the flow cell 420 and allowing a portion of the light to pass through, the flow cell 420 and liquid running through the flow cell 420 can be used instead of a beam splitter. In some embodiments, different fluids running through the flow cell can have different characteristics that cause differences in reflection and transmission of light. In some embodiments, a beam splitter, such as beam splitter 312 can advantageously provide consistent beam splitting so as to ensure a known constant energy through the flow cell.

Although the illumination system 400 is described as a dual-wavelength illumination system herein, in certain embodiments, the illumination system can be configured for the measurement of additional chemical species. For example, in some embodiments, three different wavelengths can be used for the measurement of three chemical species, four wavelengths can be used for the measurement of four chemical species, etc.

Although measurement of EDTA and bleach are described above, the system 400 may be used to measure the concentration of a variety of dental fluids or materials, such as for example, NaCl, H₂O obturation material, necrotic tissue, etc.

b. Coupled Arrangement

In alternative embodiments, a coupled arrangement can be provided for dual wavelength or multi-wavelength illumination. In a coupled arrangement, a plurality of illumination wavelengths can traverse a common path. For example, in some embodiments, a plurality of light sources, such as light source 306, configured to produce different wavelengths can be coupled to the same path. In some embodiments, the two light sources, such as light sources 306, can be coupled to the same path using a dichroic mirror having a transmission profile (longpass or shortpass) selected to transmit a collimated beam of one wavelength and to reflect a second beam of a different wavelength.

In some embodiments, a combined fiber-freespace system can be implemented in which each illumination wavelength is coupled into fiber optics and passed into a fiber-optic switch. The gate of the fiber optic switch can be synchronized with LED source switching. After passing into the fiber-optic switch, the light can be collimated once more using freespace optics and retaining the same freespace arrangement described above.

c. Broadband Arrangement

In alternative embodiments, broadband illumination can be utilized across the UV-visible spectrum, at wavelengths between approximately 190 nm and 800 nm. In various embodiments, light at wavelengths extending from 190 nm to 800 nm can be utilized as a broadband illumination source. In such embodiments, a geometrical arrangement of components of the optical system can include a single, common tilted path and a single reflected sub-path focusing light into a reference spectrometer and a single collection sub-path focused into a collection spectrometer. The mechanism of focusing the light into the spectrometers can be either free space or free space coupled to a fiber optic passage into the spectrometer.

In some embodiments, a broadband light source, such as a broadband LED, can be used as the light source 306 in photometers 305A and 305B of the illumination system 300 to form a broadband illumination system.

The use of broadband illumination can increase the chemical versatility of the illumination system as the concentration of any species eluting through the flow cell, which has absorption in the UV-visible range, can be determined. In some embodiments, spectral deconvolution numerical methods can be used to facilitate the simultaneous measurement of multiple species at the same time regardless of spectral absorption overlap between the species. For example, due to the linear proportionality of the absorbance phenomena assuming that n species obey Beer's law, the absorbance at a range of wavelengths, λᵢ, of n species at time t:

$$A ( {λ}_{i} , t ) = {\sum }_{i} {A}_{n} ( {λ}_{i} , t ) \qquad ( Equation 1 )$$

If the pure (“basis”) absorbance spectra of each species is known, a linear least squares fitting technique or a linear algebra technique can be used to determine the time dependent concentration profile of each species.

While spectrometers are described above, in some embodiments, other suitable types of detector technology can be used, such as for example, a photodiode array (PDA), a multichannel photomultiplier tube (PMT) or a variable slit that spatially traverses (raster scans) across a spectrally dispersed beam and a spectrum is created from a series of intensity measurements at each slit scan location.

This optical-based method for the in situ real-time measurement of chemical species can also be applied to biological molecules in an outflow or waste path for a dental treatment procedure. For example, hemoglobin in the outflow path or waste path can be measured during a root canal procedure to alert the clinician of blood perfusion into the root canal system during the root canal procedure. This information can provide an indication to the clinician to terminate or modify the procedure.

In other embodiments, the measurement of hemoglobin can be performed qualitatively. In such embodiments, only the presence of hemoglobin is detected and it is not quantified by using Beer's law to calculate concentration.

d. Modular Arrangement

In some embodiments, modular mounted optics can be employed. One or more components of the sensor system may be interchanged depending on the chemistry to be measured. For example, in some embodiments, one or more of the components of the system 300 or the system 400, such as the light source mounts 352A-B, optics blocks 354A-B, reference detector mount 356A-B, and a measurement detector mount 358A-B, may be interchanged depending on the chemistry to be measured.

The modular components can include different optical properties to allow for the assembly of a photometer having a suitable wavelength to measure a desired chemistry. In some embodiments, the modular components can be interchanged by an end user or field service depending on implementation. The modular components, for example, can include an optics cartridge that is interchanged within a slot or opening in the system 300 or 400. The modularity of the system can provide for assembly of a plurality of photometer modules allowing a broad availability of chemicals to be used with the system.

e. Temperature Controls

In embodiments of optical-based concentration measurement systems, the accuracy of the sensor can be sensitive to changes in ambient temperature and fluid temperature. In some embodiments, fluid temperature can be controlled prior to fluid entering the concentration sensor, for example, using one or more temperature controls, such as thermoelectric coolers and/or heaters. FIG. 17L illustrates an alternative embodiment of the section of the system 700 shown in FIG. 17B. As shown in FIG. 17L, the system 700 can include one or more temperature controls 840 positioned to change the temperature of fluids along the fluid lines between the containers 731 and the mixing system 732. The temperature controls 840 can include one or more heaters and/or coolers. In some embodiments, the temperature controls can include use thermoelectric cooling (for example, by using the Peltier effect). In some embodiments, the temperature controls can include one or more Peltier modules. As shown in FIG. 17L, each of the fluid lines for NaCl, EDTA, and H₂O include temperature control 840. The embodiment of FIG. 171L allows for the control of the temperatures of individual fluids prior to mixing. The temperature controls 840 can receive instructions from the controller 737 to change the temperature of the fluids to a desired temperature or to be within a desired range of temperatures. In some embodiments, the temperature controls 840 can include one or more sensors to detect the temperature of the fluid flowing into the temperature control 840 and/or the temperature of the fluid flowing out of the temperature control 840 after the temperature of the fluid has been changed. In other embodiments, one or more temperature sensors can be positioned upstream of the temperature controls 840 to determine the fluid temperature prior to entering the temperature control. One or more temperature sensors can be positioned downstream of the temperature controls 840 but upstream of the concentration sensor 736a to measure the temperature of the fluid after the temperature control 840 has changed the temperature of the fluid. Readings from the temperature sensors can be provided to the processing unit 739 and can be used to determine amounts of temperature change to be applied by the temperature controls 840.

FIG. 17M illustrates an alternative embodiment of the section of the system 700 shown in FIG. 17B. As shown in FIG. 17M, the system 700 can include one or more temperature controls 840 positioned between the mixing system 732 and the concentration sensor 736a to change the temperature of fluids along the fluid lines between the containers 731 and the mixing system 732. The embodiment of FIG. 17M allows for control of the temperature of the delivery fluid after fluids are combined in the mixing system. This arrangement can allow for the temperature change to be performed in close proximity to the concentration sensor 736a to reduce potential changes in temperature between the temperature control 840 and the sensor 736a. As described with respect to FIG. 17L, the temperature controls 840 can receive instructions from the controller 737 to change the temperature of the mixed delivery fluid to a desired temperature or to be within a desired range of temperatures. The temperature control 840 can include one or more temperature sensors to detect the temperature of the fluid flowing into the temperature control 840 and/or the temperature of the fluid flowing out of the temperature control 840 after the temperature of the fluid has been changed. In other embodiments, one or more temperature sensors can be positioned upstream of the temperature control 840 to determine the fluid temperature prior to entering the temperature control. One or more temperature sensors can be positioned downstream of the temperature control 840 but upstream of the concentration sensor 736a to measure the temperature of the fluid after the temperature control 840 has changed the temperature of the fluid. Readings from the temperature sensors can be provided to the processing unit 739 and can be used to determine amounts of temperature change to be applied by the temperature controls 840.

In some embodiments, one or more temperature controls 840, such as thermoelectric coolers or heaters, can be positioned to change the ambient temperature at the location of the concentration sensor. For example, FIG. 21B depicts an alternative embodiment of the system 300 having a temperature control 840 position to change the temperature adjacent the optical components of the system 300. FIG. 21C depicts an alternative of the system 300 having a plurality of temperature controls 840 coupled to components of the sensor system including, for example, the light source mounts 352a and 352b, the reference detector mounts 356a and 356b, and the measurement detector mounts 358a and 358b. In the embodiments of FIGS. 21B and 21C, the temperature control(s) 840 can receive instructions from the controller 737 to change the temperature of the ambient environment adjacent the system 300. One or more temperature sensors can be part of the temperature controls 840 or positioned adjacent the system 300 to detect the ambient temperature. Readings from the temperature sensors can be provided to the processing unit 739 and can be used to determine amounts of temperature change to be applied by the temperature control(s) 840.

In some embodiments, fluid temperature, ambient temperature, and optical signals from the concentration sensor can be measured in experiments to create a multi-factorial regression that aligns with the collected data. A regression equation can then be used to calculate concentration based on measurements of the fluid temperature, ambient temperature, and optical signal. This method can facilitate calculation of concentration without requiring temperature controls 840. However, in some embodiments, temperature controls 840 may be used in addition to a regression equation.

f. Condensation Controls

In embodiments of optical-based concentration measurement systems, the accuracy of the sensor can be sensitive to condensation. For example, in some embodiments, as shown in FIG. 21D, a flowcell 845 can extend through the sensor system 300. Sensor system 300 can measure the concentration of fluid flowing through the flowcell 845. In some embodiments, the flowcell can be susceptible to condensation, for example, in embodiments having glass flow cells. In some embodiments, one or more temperature controls 840 can coupled to the glass flowcell 845 to change the temperature of the flowcell to prevent condensation. In some embodiments, the temperature controls 840 can receive instructions from the controller 737 to change the temperature of the flowcell. One or more temperature sensors can be part of the temperature controls 840 or positioned on the flowcell 845 to detect the temperature of the flowcell 845. Readings from the temperature sensors can be provided to the processing unit 739 and can be used to determine amounts of temperature change to be applied by the temperature controls 840.

In some embodiments, fluid temperature can be controlled prior to fluid entering the concentration sensor, for example, using one or more temperature controls 840 as described with respect to FIGS. 17L and 17M to maintain the temperature of the fluids above a dewpoint so as to prevent condensation.

In some embodiments, ambient temperature can be controlled adjacent the concentration sensor and/or adjacent to a flowcell to maintain the temperature above the dewpoint temperature, for example using one or more temperature controls 840 positioned adjacent to the sensor as described with respect to FIG. 21B.

In some embodiments, as shown in FIG. 21E, one or more desiccants 850 can be positioned adjacent to the concentration sensor and/or adjacent to a flowcell. The dessicant(s) 850 can reduce humidity to prevent condensation.

2. Ultrasonic Concentration Measurement

In some embodiments, the concentration sensors described herein can comprise ultrasonic sensors or ultrasonic sensor systems. For example, in various embodiments, the concentration sensors described herein can comprise ultrasonic transducers or ultrasonic transducer systems.

In some embodiments, ultrasonic sensors or ultrasonic sensor systems are used to measure properties of dental fluids. Various embodiments disclosed herein include a method using ultrasonic sensors or ultrasonic sensor systems to directly measure, in real time and in situ, the concentration of synthetic or biological chemical species in a flowing solution of dental fluids in the inflow or outflow condition.

Ultrasonic sensors or ultrasonic sensor systems, such as for example, ultrasonic transducers or ultrasonic transducer systems, can measure the speed of sound waves propagating in a dental fluid. These sensors or sensor systems can detect the time of flight of a signal traveling through a fluid of unknown concentration. Fluid density changes with concentration, which affects the time of flight of a signal through fluid. By measuring the time of flight of a signal through a fluid over a known distance, concentration of the fluid can be determined.

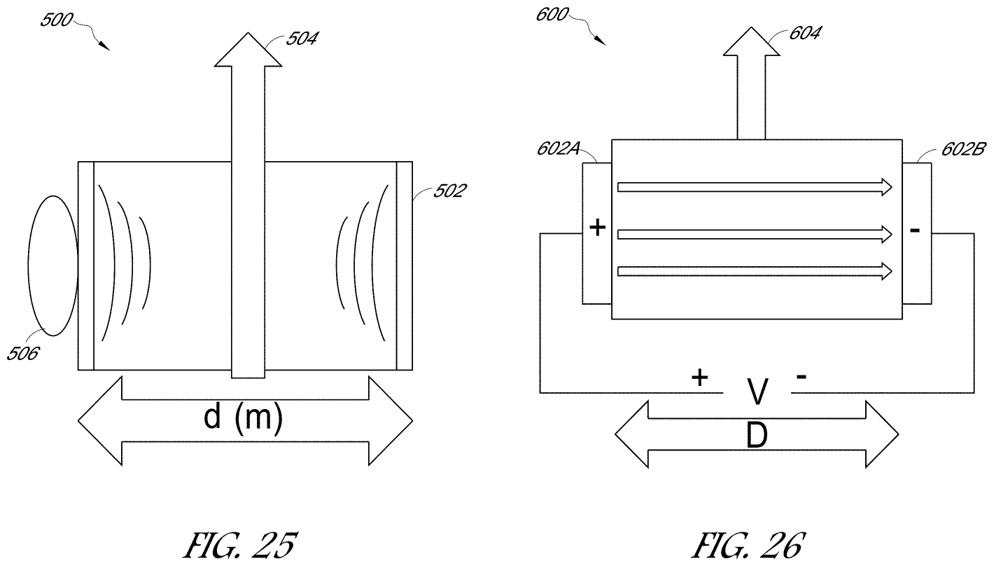

FIG. 25 depicts an embodiment of an ultrasonic transducer system 500. The system 500 is configured to measure concentration of a dental fluid in a flow cell 502. In some embodiments, the flow cell 502 is part of or coupled to a dental fluid delivery or treatment line or a dental fluid outflow or waste line. An arrow 504 depicts a direction of flow of the dental fluid within the flow cell 502.

The system 500 includes an ultrasonic transducer 506. The ultrasonic transducer can be positioned and/or otherwise configured to transmit a signal through the dental fluid in the flow cell 502 and determine the amount of time that the signal travels through the dental fluid (time of flight).

A signal produced by the ultrasonic transducer 506 can travel through the dental fluid within the flow cell 502 over a distance d. As shown in FIG. 25, the distance d can be a width of the flow cell 502, or in other words, a distance between a first side of the flow cell 502 and a second side of the flow cell 502 opposite the first side.

As shown in FIG. 25, concentration can be indirectly measured using the following equation:

$$C ∝ \frac{2 d}{TOF} \qquad ( Equation 2 )$$

where C is the concentration of fluid, d is the distance across the dental fluid and TOF is the time of flight. In some embodiments, the TOF can be characterized with the fluid being measured by taking a plurality of concentration measurements and a plurality of TOF measurements to create a TOF vs. concentration curve. The TOF vs. concentration curve can be used to determine the concentration of the dental fluid. In some embodiments, the TOF can be characterized with the fluid being measured by taking a plurality of concentration measurements and a plurality of TOF measurements to create an equation to correlate TOF to concentration.

3. Flame Ionization Detection (FID)

In some embodiments, the concentration sensors described herein can comprise flame ionization detectors or flame ionization detector systems.

In some embodiments, flame ionization detectors or flame ionization detector systems are used to measure properties of dental fluids. Various embodiments disclosed herein include a method using flame ionization detectors or flame ionization detector systems to measure the concentration of analytes or other components in a gas stream. For example, a sample of the dental fluid can be converted to gas for analysis, and the flame ionization detectors or flame ionization detector systems can measure the concentration of analytes or other components in the resulting gas stream. In other embodiments, the flame ionization detectors can measure the concentration of analytes or other components in a gas stream emitted from a dental treatment fluid. In some embodiments, flame ionization detectors or flame ionization detector systems can measure other properties proportional to the concentration of analytes or other components.

In some embodiments, gas chromatography is used to measure properties of dental fluids. Various embodiments disclosed herein include a method using gas chromatography to measure the concentration of analytes in a gas stream from a sample of dental fluid converted to a gas or a gas stream emitted from a dental fluid. In some embodiments, gas chromatography can measure other properties proportional to the concentration of analytes or other components. The flame ionization detectors of flame ionization detector systems can be used in a gas chromatography based method for measuring properties of a dental fluid.

4. Atomic Absorption Systems

In some embodiments, the concentration sensors described herein can comprise atomic absorption sensors or atomic absorption systems.

In some embodiments, atomic absorption sensors or atomic absorption systems are used to measure properties of dental fluids. Various embodiments disclosed herein include a method using atomic absorption sensors or atomic absorption systems to measure the concentration of elements in a gas stream. For example, atomic absorption sensors or atomic absorption systems can measure the concentration of elements in a sample of dental fluid converted to a gas or in a gas stream emitted from a dental treatment fluid. In some embodiments, atomic absorption sensors or atomic absorption systems can measure other properties proportional to the concentration of elements.

5. Dilution with a Standard Fluid

In some embodiments, the concentration sensors described herein can comprise sensors and systems configured to measure the absorbance of a diluted fluid comprising a dental fluid of interest. A known standard fluid utilizing a dye (visible spectrum) can be created. A fixed volume of the standard fluid can be mixed with the dental fluid of interest to create a diluted fluid. The concentration of the known standard fluid can be known prior to mixing with the dental fluid of interest. The absorbance of the diluted fluid can be measured to determine the concentration of the dental fluid.

In some embodiments, the absorbance of the diluted fluid can be measured using photometer sensors or photometer sensor systems, such as system 300 and system 400.

6. pH Measurement

In some embodiments, the concentration sensors described herein can comprise pH sensors or pH measurement systems.

In some embodiments, pH sensors or pH measurement systems are used to measure properties of dental fluids. Various embodiments disclosed herein include a method using pH sensors or pH measurement systems to measure the concentration of synthetic or biological chemical species in a flowing solution of dental fluids in the inflow or outflow condition.

In some embodiments, a correlation curve between pH and the concentration of the fluid of interest can be established.

7. Mass Spectrometry (Optical, Vacuum) or Liquid Chromatography

In some embodiments, the concentration sensors described herein can comprise mass spectrometers or mass spectrometry systems.

In some embodiments, mass spectrometers or mass spectrometry systems are used to measure properties of dental fluids. Various embodiments disclosed herein include a method using mass spectrometers or mass spectrometry systems to measure a mass-to-charge ratio of ions in a dental fluid, such as for example, in a flowing solution of dental fluids in the inflow or outflow condition.

In some embodiments, the mass spectrometer or mass spectrometry system can be an optical mass spectrometer or mass spectrometry system. In some embodiments, the mass spectrometer or mass spectrometry system can be a vacuum mass spectrometer or mass spectrometry system. In some embodiments, the mass spectrometer or mass spectrometry system can be a liquid chromatography mass spectrometer or mass spectrometry system.

8. Ion Measurement System (Biosensors, Electrochemistry Electrodes, etc.)

In some embodiments, the concentration sensors described herein can comprise ion measurement systems. In some embodiments, an ion measurement system can include one or more biosensors, electrochemistry electrodes, or other suitable sensors.

In some embodiments, an ion measurement system is used to measure properties of dental fluids. Various embodiments disclosed herein include a method using an ion measurement system to measure components in a dental fluid, such as for example, in a flowing solution of dental fluids in the inflow or outflow condition, utilizing electrochemistry.

9. Viscosity of Fluid

In some embodiments, the concentration sensors described herein can comprise a system for measuring viscosity.

In some embodiments, a system for measuring viscosity is used to measure properties of dental fluids. Various embodiments disclosed herein include a method using a system for measuring viscosity to determine a concentration of a dental fluid, such as for example, a flowing solution of dental fluids in the inflow or outflow condition. In some embodiments, a concentration to viscosity correlation curve is established.

In some embodiments, concentration is determined after measuring viscosity based on the concentration to viscosity correlation curve.

10. Depigmentation of a Known Material

In some embodiments, the concentration sensors described herein can comprise a system for measuring depigmentation of a known material.

In some embodiments, a system for measuring depigmentation of a known material is used to measure properties of dental fluids. Various embodiments disclosed herein include a method using a system for measuring depigmentation of a known material to determine a concentration of a dental fluid, such as for example, a flowing solution of dental fluids in the inflow or outflow condition.

In some embodiments, a known material can be exposed to a dental fluid that causes depigmentation, such as for example, bleach. The rate at which the dental fluid changes the know material can be determined and used to determine the concentration of the dental fluid, such as bleach.

11. Reaction with a Known Chemical

In some embodiments, the concentration sensors described herein can comprise a system for measuring a precipitate formed by a chemical indicator and a dental fluid.

In some embodiments, a fixed volume of a chemical indicator of known concentration, such as for example, silver nitrate, and a fixed volume of a dental fluid, such as for example, NaOCl, can be combined. The material that precipitates out of the combination can be measured to determine the concentration of the dental fluid. For example, when silver nitrate and NaOCL combine, silver chloride precipitates out. The silver chloride can be measured to determine the concentration of NaOCl in the dental fluid.

12. Measurement of Heat of Reaction

In some embodiments, the concentration sensors described herein can comprise a system for measuring heat of an exothermic reaction.

In some embodiments, a known volume and concentration of a first fluid, such as EDTA, can be mixed with a known volume and unknown concentration of a second fluid, such as bleach. The concentration of the second fluid can be determined by measuring the heat of the reaction.

13. Chlorine Gas Detector

In some embodiments, the concentration sensors described herein can comprise a chlorine gas sensor or chlorine gas sensor system.

Various embodiments disclosed herein include a method of using a chlorine gas sensor or chlorine gas sensor system to measure gas emission from NaOCl or CL gas emitted from a reaction of NaOCl and other fluids in a dental fluid solution, such as for example, in a flowing solution of dental fluids in the inflow or outflow condition. In some embodiments, a chlorine gas sensor or chlorine gas sensor system can be used to measure gas emission from NaOCl or Cl gas emitted from a reaction of NaOCl and EDTA.

14. Capacitance

In some embodiments, the concentration sensors described herein can comprise a capacitance sensor or capacitance sensor system.

Various embodiments disclosed herein include a method of using a capacitance sensor or capacitance sensor system to determine a concentration of a dental fluid, such as for example, a flowing solution of dental fluids in the inflow or outflow condition.

Capacitances changes with changes in concentration. In some embodiments, a capacitance to concentration curve can be established for a fluid of interest. The concentration of the fluid can be determined after measuring capacitance based on the capacitance to concentration curve.

FIG. 26 depicts an embodiment of a capacitance measurement system 600. The system 600 is configured to measure the capacitance of fluid flowing between parallel plates 602A-B of opposite polarity and having a surface area A. The direction of flow of the dental fluid between the plates 602A-B is depicted by arrow 604. The plates 602A-B are separated by a distance D.

A voltage can be supplied to the plates, and the resultant current can be measured by the system 600. By measuring the resultant current, the capacitance can be determined. The capacitance changes due to permittivity (Co) of the fluid changing with concentration.

Capacitance is defined by the following equation:

$$c = {ɛ}_{0} ( \frac{A}{D} ) \qquad ( Equation 3 )$$

where c is the capacitance, ε₀ is the permittivity of the fluid, A is the surface area of one of the plates 602A-B, and D is the distance between the plates 602A-B.

Current is defined by the following equation:

$$I = c ( \frac{δ V}{δ T} ) \qquad ( Equation 4 )$$

where I is the current, c is the capacitance, V is the voltage, and T is time.

Using Equations 3 and 4, permittivity (Co) can be solved for. As described above, permittivity changes with concentration. Therefore, a conductivity vs. concentration curve can be established to measure concentration.

15. Hall Effect Sensor

In some embodiments, the concentration sensors described herein can comprise a Hall effect sensor or Hall effect sensor system.

Various embodiments disclosed herein include a method of using a Hall effect sensor or Hall effect sensor system to determine a concentration of a dental fluid, such as for example, a flowing solution of dental fluids in the inflow or outflow condition.

In some embodiments, a Hall effect sensor of Hall effect sensor system can measure conductivity. In some embodiments, an electrical current can be passed through a dental fluid solution by applying a voltage to the fluid. A Hall effect sensor or Hall effect sensor system can quantify the current running through the solution. A Hall effect sensor or Hall effect sensor system can measure the magnetic field produced by the current to quantify the current. The concentration of the fluid can affect the conductive property of the fluid and, therefore, the current and magnetic field. Accordingly, the magnetic field measurements by the Hall effect sensor or Hall effect sensor system can be used to determine the concentration of the fluid.

16. Light Scatter Sensor (including Turbidity)

The concentration sensor can comprise of a light scattering sensor system. This will include a light source and photodetector(s) with a fluid, possibly contained in a flow cell. For example, in some embodiments, the illumination system 300 or illumination system 400 can operate as a light scattering sensor system.

In some embodiments, light is emitted onto a flow cell containing the dental fluid of interest, and scattered light or transmittance is detected, for example, by a photodetector. In such and embodiment, the amount of light measured by the photodetector or other sensor can be proportional to the amount and size of solids suspended in the fluid.

In an alternative embodiment, a light scatter sensor can measure the turbidity of the dental fluid. Turbidity may similarly measure scattered light or transmittance on a photodetector. However, turbidity is typically measured in the visible wavelength spectrum. Therefore, an illumination system for measuring turbidity can comprise a visible light source.

17. Measurement of Other Physical or Chemical Properties

Although various arrangements for measuring concentration are discussed, the foregoing systems, sensors, and methods may be used to measure other physical and chemical properties, such as for example, temperature, dissolved gas content, bubbles in fluids, purity of the chemicals, flow rate, or any other suitable property of a dental fluid.

18. Methods of Use

The sensors and sensor systems described herein, such as system 300 and system 400, can be used in a variety of dental treatment procedures. For example, the sensors and sensor systems described herein, such as system 300 and system 400, may be used as the sensors 736a, sensors 736b, sensors 738, and/or monitoring apparatus 736 in the system 700, as the sensor 736a in system 790, or as the sensor 736b in the system 795.

In some embodiments, the sensors or sensor systems described herein can be used to measure gases emitted from fluids, such as chlorine from NaOCl. Measurement of such gases can allow a physician to limit the exposure of such gases to the environment.

In some embodiments, the sensors or sensor systems described herein can be used to monitor a dental treatment or delivery fluid to measure the fluid quality to facilitate a determination that the fluid is sanitary for use. In such embodiments, the sensor or sensor systems can measure dissolved solids, chlorine, organics, etc. In some embodiments, these sensors may be used in conjunction with the use of a separate or a combined high powered UV lamp that kills bacteria and viruses in the fluid. These methods can allow users the flexibility to use tap water versus distilled water in a treatment or delivery fluid.

In some embodiments, the sensors or sensor systems described herein can be used to monitor the effectiveness of a degasser in systems in which a dental treatment or delivery fluid is degassed prior to use. The sensor or sensor systems can measure nitrogen, for example, to determine the amount of dissolved gas in a fluid. Such measurements can be effective in determining life or wear on a degasser over time and trigger the need for preventative maintenance of the degasser.

In some embodiments, the sensors or sensor systems described herein can be used to monitor bubbles in the fluid path. For example, a photometer and the refraction/scatter off the surface of the bubble. Alternately, bubble detection can be combined with a photometer being used for measuring a specific fluid property therefore allowing both the measurement of bubbles and the fluid property using the same photometer.

In some embodiments, the sensors or sensor systems described herein can be used to measure cavitation performance in a tooth using light generated from the sonoluminescence effect. For example, in some embodiments, a modified photometer, such as a photometer using a fiber optic, can be used to measure cavitation performance in the tooth using light generated from the sonoluminescence effect. Such embodiments may require specific chemistries and temperatures.

Reference throughout this specification to “some embodiments” or “an embodiment” means that a particular feature, structure, element, act, or characteristic described in connection with the embodiment is included in at least one embodiment. Thus, appearances of the phrases “in some embodiments” or “in an embodiment” in various places throughout this specification are not necessarily all referring to the same embodiment and may refer to one or more of the same or different embodiments. Furthermore, the particular features, structures, elements, acts, or characteristics may be combined in any suitable manner (including differently than shown or described) in other embodiments. Further, in various embodiments, features, structures, elements, acts, or characteristics can be combined, merged, rearranged, reordered, or left out altogether. Thus, no single feature, structure, element, act, or characteristic or group of features, structures, elements, acts, or characteristics is necessary or required for each embodiment. All possible combinations and subcombinations are intended to fall within the scope of this disclosure.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

The foregoing description sets forth various example embodiments and other illustrative, but non-limiting, embodiments of the inventions disclosed herein. The description provides details regarding combinations, modes, and uses of the disclosed inventions. Other variations, combinations, modifications, equivalents, modes, uses, implementations, and/or applications of the disclosed features and aspects of the embodiments are also within the scope of this disclosure, including those that become apparent to those of skill in the art upon reading this specification. Additionally, certain objects and advantages of the inventions are described herein. It is to be understood that not necessarily all such objects or advantages may be achieved in any particular embodiment. Thus, for example, those skilled in the art will recognize that the inventions may be embodied or carried out in a manner that achieves or optimizes one advantage or group of advantages as taught herein without necessarily achieving other objects or advantages as may be taught or suggested herein. Also, in any method or process disclosed herein, the acts or operations making up the method or process may be performed in any suitable sequence and are not necessarily limited to any particular disclosed sequence.

1. A treatment instrument comprising:
a fluid platform comprising a chamber and an access port to provide fluid communication between a treatment region of the tooth and the chamber, the chamber having a central axis;
a first fluid supply port disposed to direct a fluid stream of a first material into the chamber along a stream axis non-parallel to the central axis; and
a second supply port distal the first fluid supply port, the second supply port disposed to direct a second material to be entrained with the fluid stream into the chamber.

2. The treatment instrument of claim 1, wherein the first fluid supply port comprises a nozzle configured to form a liquid jet comprising the first material.

3. The treatment instrument of claim 1, further comprising a first composition supply line to deliver the first material to the first supply port and a second composition supply line to deliver the second material to the second supply port.

4. The treatment instrument of claim 3, wherein the fluid platform comprises a manifold body having an inner sidewall that at least partially defines the chamber and a supply pathway in the manifold body, the supply pathway in fluid communication with the second supply port.

5. (canceled)

6. (canceled)

7. (canceled)

8. (canceled)

9. (canceled)

10. (canceled)

11. The treatment instrument of claim 1, further comprising a pressure wave generator configured to generate pressure waves having sufficient energy to treat the treatment region.

12. The treatment instrument of claim 11, wherein the pressure wave generator comprises the first fluid supply port.

13. The treatment instrument of claim 1, further comprising a suction port exposed to the chamber.

14. (canceled)

15. The treatment instrument of claim 13, further comprising a vent exposed to ambient air, the vent in fluid communication with an outlet line connected to the suction port, the vent positioned along the outlet line at a location downstream of the suction port.

16. The treatment instrument of claim 1, wherein the first fluid supply port is disposed to direct the fluid stream across the chamber to impinge on a portion of a wall of the chamber opposite the first fluid supply port.

17. (canceled)

18. (canceled)

19. (canceled)

20. A treatment instrument comprising:
a fluid platform comprising a chamber and a mounting surface configured to be positioned against a tooth to retain fluid in the chamber between the fluid platform and the tooth, the fluid platform having an access port to provide fluid communication between a treatment region of the tooth and the chamber;
a first fluid supply port disposed to direct a fluid stream of a first material into the chamber; and
a second supply port distal the first fluid supply port, the second supply port disposed to direct a second material to be entrained with the fluid stream into the chamber.

21. The treatment instrument of claim 20, wherein the first fluid supply port comprises a nozzle configured to form a liquid jet comprising the first material.

22. The treatment instrument of claim 20, further comprising a first composition supply line to deliver the first material to the first supply port and a second composition supply line to deliver the second material to the second supply port.

23. The treatment instrument of claim 22, wherein the fluid platform comprises a manifold body having an inner sidewall that at least partially defines the chamber and a supply pathway in the manifold body, the supply pathway in fluid communication with the second supply port.

24. (canceled)

25. (canceled)

26. (canceled)

27. (canceled)

28. (canceled)

29. (canceled)

30. The treatment instrument of claim 20, further comprising a pressure wave generator configured to generate pressure waves having sufficient energy to treat the treatment region.

31. The treatment instrument of claim 30, wherein the pressure wave generator comprises the first fluid supply port.

32. The treatment instrument of claim 20, further comprising a suction port exposed to the chamber.

33. The treatment instrument of claim 32, wherein the chamber has a maximum lateral dimension in a plane extending substantially transverse to a central axis of the chamber, the plane delimited by the wall along a boundary, a projection of the suction port onto the plane being closer to the boundary than to the central axis of the chamber.

34. The treatment instrument of claim 32, further comprising a vent exposed to ambient air, the vent in fluid communication with an outlet line connected to the suction port, the vent positioned along the outlet line at a location downstream of the suction port.

35. The treatment instrument of claim 20, wherein the first fluid supply port is disposed to direct the fluid stream across the chamber to impinge on a portion of a wall of the chamber opposite the first fluid supply port.

36. (canceled)

37. (canceled)

38. A treatment instrument comprising:
a fluid platform comprising a chamber and an access port to provide fluid communication between a treatment region of a tooth and the chamber, the fluid platform comprising a manifold body having an inner sidewall that at least partially defines the chamber and a supply pathway in the manifold body;
a first fluid supply port disposed to direct a fluid stream of a first material into the chamber; and
a second supply port in fluid communication with the supply pathway, the second supply port disposed to direct a second material from the supply pathway into the chamber.

39. The treatment instrument of claim 38, wherein the first fluid supply port comprises a nozzle configured to form a liquid jet of the first material.

40. (canceled)

41. (canceled)

42. (canceled)

43. (canceled)

44. (canceled)

45. (canceled)

46. (canceled)

47. The treatment instrument of claim 38, further comprising a pressure wave generator configured to generate pressure waves having sufficient energy to treat the treatment region.

48. The treatment instrument of claim 47, wherein the pressure wave generator comprises the first fluid supply port.

49. The treatment instrument of claim 38, further comprising a suction port exposed to the chamber.

50. (canceled)

51. The treatment instrument of claim 49, further comprising a vent exposed to ambient air, the vent in fluid communication with an outlet line connected to the suction port, the vent positioned along the outlet line at a location downstream of the suction port.

52. The treatment instrument of claim 38, wherein the first fluid supply port is disposed to direct the fluid stream across the chamber to impinge on a portion of a wall of the chamber opposite the first fluid supply port.

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. A treatment instrument comprising:
a fluid platform comprising a chamber and an access port to provide fluid communication between a treatment region of the tooth and the chamber;
a first fluid supply port disposed to direct a fluid stream of a first material into the chamber to generate rotational fluid motion in the chamber; and
a second supply port disposed to supply a second material into the rotational fluid motion generated in the chamber.

67. (canceled)

68. The treatment instrument of claim 66, wherein the first fluid supply port comprises a nozzle configured to form a liquid jet comprising the first material.

69. The treatment instrument of claim 66, further comprising a first composition supply line to deliver the first material to the first supply port and a second composition supply line to deliver the second material to the second supply port.

70. The treatment instrument of claim 69, wherein the fluid platform comprises a manifold body having an inner sidewall that at least partially defines the chamber and a supply pathway in the manifold body, the supply pathway in fluid communication with the second supply port.

71. (canceled)

72. (canceled)

73. (canceled)

74. (canceled)

75. (canceled)

76. (canceled)

77. The treatment instrument of claim 66, further comprising a pressure wave generator configured to generate pressure waves having sufficient energy to treat the treatment region.

78. (canceled)

79. The treatment instrument of claim 66, further comprising a suction port exposed to the chamber.

80. (canceled)

81. The treatment instrument of claim 79, further comprising a vent exposed to ambient air, the vent in fluid communication with an outlet line connected to the suction port, the vent positioned along the outlet line at a location downstream of the suction port.

82. The treatment instrument of claim 79, wherein the first fluid supply port is disposed to direct the fluid stream across the chamber to impinge on a portion of a wall of the chamber opposite the first fluid supply port.

83. (canceled)

84. (canceled)

85. (canceled)

86. A method of treating a tooth, the method comprising:
directing a fluid stream of a first material into a chamber in a manner generating rotational fluid motion in the chamber; and
supplying a second material into the rotational fluid motion generated in the chamber.

87. The method of claim 86, wherein directing the fluid stream comprises directing a liquid jet into the chamber.

88. (canceled)

89. The method of claim 86, wherein supplying the second material comprises directing the second material along a flow pathway within a manifold that at least partially defines the chamber.

90. (canceled)

91. (canceled)

92. (canceled)

93. (canceled)

94. (canceled)

95. A treatment instrument comprising:
a first composition supply line;
a second composition supply line;
a chamber in fluid communication with the first composition supply line and the second composition supply line; and
a pressure wave generator comprising an orifice in fluid communication with the first composition supply line, the orifice sized and shaped to pressurize a carrier liquid delivered by the first composition supply line to the chamber,
wherein the second composition supply line delivers a component to the chamber at a location distal the orifice so as to form a mixture of the component and the carrier liquid,
wherein the pressure wave generator is configured to generate pressure waves having sufficient energy to cause the mixture to substantially fill a treatment region of a tooth.

96. The treatment instrument of claim 95, wherein the pressure wave generator comprises a liquid jet device, with the orifice sized to form the liquid jet.

97. (canceled)

98. (canceled)

99. (canceled)

100. The treatment instrument of claim 95, further comprising a fluid platform comprising a manifold body that at least partially defines the chamber, the manifold body comprising a supply pathway that includes the second composition supply line.

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. The treatment instrument of claim 95, wherein the treatment instrument has a cleaning mode in which the pressure wave generator is configured to clean a treatment region of the tooth and a filling mode in which the pressure wave generator is configured to fill the treatment region of the tooth.

117. (canceled)

118. (canceled)

119. (canceled)

120. (canceled)

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. A method for coating a treatment region of a tooth, the method comprising:
supplying a coating agent to the treatment region; and
activating a pressure wave generator to cause the coating agent to flow through the treatment region to coat or remineralize the treatment region.

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)

159. (canceled)

160. (canceled)

161. (canceled)

162. A treatment instrument for treating a tooth, the treatment instrument comprising:
a pressure wave generator comprising an elongated actuator having a longitudinal axis, the actuator configured to oscillate along the longitudinal axis to generate pressure waves in liquid supplied to a treatment region of the tooth, the pressure waves having sufficient energy to treat the treatment region.

163. (canceled)

164. (canceled)

165. (canceled)

166. (canceled)

167. (canceled)

168. (canceled)

169. (canceled)

170. A dental treatment system comprising:
a first pump coupled to a first fluid supply line;
a second pump coupled to a second fluid supply line; and
a controller in communication with the first pump to send a first signal to the first pump to drive a first fluid composition through the first fluid supply line at a first flow rate, the controller in communication with the second pump to send a second signal to the second pump to drive a second fluid composition through the second fluid supply line at a second flow rate different from the first flow rate.

171. (canceled)

172. (canceled)

173. (canceled)

174. (canceled)

175. (canceled)

176. (canceled)

177. (canceled)

178. (canceled)

179. (canceled)

180. (canceled)

181. (canceled)

182. (canceled)

183. (canceled)

184. (canceled)

185. (canceled)

186. (canceled)

187. (canceled)

188. (canceled)

189. (canceled)

190. (canceled)

191. (canceled)

192. (canceled)

193. (canceled)

194. (canceled)

195. (canceled)

196. (canceled)

197. (canceled)

198. (canceled)

199. (canceled)

200. (canceled)

201. (canceled)

202. (canceled)

203. (canceled)

204. (canceled)

205. (canceled)

206. (canceled)

207. (canceled)

208. (canceled)

209. (canceled)

210. (canceled)

211. (canceled)

212. (canceled)

213. (canceled)

214. (canceled)

215. (canceled)

216. A dental treatment system comprising:
a mixing system configured to receive a plurality of fluids for the dental treatment, the mixing system comprising:
a first valve selectively controlling flow of a first fluid of a plurality of fluids into a fluid delivery line; and
a second valve selectively controlling flow of a second fluid of a plurality of fluids into a fluid delivery line, the mixing system being configured to mix at least the first fluid and the second fluid by facilitating the flow of both the first fluid and the second fluid into at least the fluid delivery line to produce a delivery fluid;
a degassing system receiving the delivery fluid and removing dissolved gases from the delivery fluid;
an interface member configured to connect to a dental treatment instrument, the interface member being configured to receive the delivery fluid after dissolved gases are removed from the delivery fluid;
a concentration sensor system disposed between the mixing system and the degassing system, the concentration sensor system measuring a concentration of at least one component of the delivery fluid to be supplied to the degassing system; and
a controller in communication with the concentration sensor system and the mixing system, the controller configured to receive concentration measurement data from the concentration sensor system and to adjust the operation of one or both of the first valve and the second valve to adjust the concentration of the at least one component of the delivery fluid based on the measurement data from the concentration sensor system.

217. (canceled)

218. (canceled)

219. (canceled)

220. (canceled)

221. (canceled)

222. (canceled)

223. (canceled)

224. (canceled)

225. (canceled)

226. (canceled)

227. (canceled)

228. (canceled)

229. (canceled)

230. (canceled)

231. (canceled)

232. (canceled)

233. (canceled)

234. (canceled)

235. (canceled)

236. (canceled)

237. (canceled)

238. (canceled)

239. (canceled)

240. (canceled)

241. (canceled)

242. (canceled)

243. (canceled)

244. (canceled)

245. (canceled)

246. (canceled)

247. (canceled)

248. (canceled)

249. (canceled)

250. (canceled)

251. (canceled)

252. (canceled)

253. (canceled)

254. (canceled)

255. (canceled)

256. (canceled)

257. A dental treatment system comprising:
a mixing system configured to mix a plurality of fluids to produce a delivery fluid;
an interface member configured to connect to a dental treatment instrument, the interface member being configured to receive the delivery fluid from the mixing system;
a concentration sensor system positioned between the mixing system and the treatment instrument, the concentration sensor system comprising:
a first light source configured to emit light at a first wavelength and direct light through the delivery fluid while the delivery fluid flows between the mixing system and the treatment instrument, the first wavelength being suitable for measurement of a concentration of a first fluid component within the delivery fluid;
a first collection photodiode configured to receive light directed from the first light source through the delivery fluid;
a second light source configured to emit light at a second wavelength different from the first wavelength and to direct light through the delivery fluid while the delivery fluid flows between the mixing system and the treatment instrument, the second wavelength being suitable for measurement of a concentration of a second fluid component within the delivery fluid; and
a second collection photodiode configured to receive light directed from the second light source through the delivery fluid; and
a controller in communication with the concentration sensor system and the mixing system, the controller configured to receive concentration measurement data from the concentration sensor system and to control the operation of the mixing system to adjust the concentration of at least one component of the delivery fluid based at least in part on the concentration measurement data from the concentration sensor system.

258. (canceled)

259. (canceled)

260. (canceled)

261. (canceled)

262. (canceled)

263. (canceled)

264. (canceled)

265. (canceled)

266. (canceled)

267. (canceled)

268. (canceled)

269. (canceled)

270. (canceled)

271. (canceled)

272. (canceled)

273. (canceled)

274. (canceled)

275. (canceled)

276. (canceled)

277. (canceled)

278. (canceled)

279. (canceled)

280. (canceled)
